(19) United States
(12) Patent Application Publication
(10) Pub. No.: US 2026/0109868 A1
(43) Pub. Date: Apr. 23, 2026

(54) COATED ARTICLES WITH A SURFACE-MODIFYING LAYER AND METHODS OF MAKING THE SAME

(71) Applicant: CORNING INCORPORATED, CORNING, NY (US)

(72) Inventors: Robert Alan Bellman, Ithaca, NY (US); Philip Simon Brown, Big Flats, NY (US); Cody Vic Cushman, Painted Post, NY (US); Dean Joseph Mastropietro, Corning, NY (US); Boon Ching Tee, Big Flats, NY (US); Binwei Zhang, Horseheads, NY (US)

(21) Appl. No.: 19/476,028

(22) PCT Filed: Nov. 25, 2024
(86) PCT No.: PCT/US2024/057255

§ 371 Date: Oct. 16, 2025

Related U.S. Application Data
(60) Provisional application No. 63/603,156, filed on Nov. 28, 2023.
(60) Provisional application No. 63/669,001, filed on Jul. 9, 2024.

(51) Int. Cl. C09D 5/16; C03C 17/30; C08G 77/04; C08G 77/18; C09D 183/04; C09D 183/06

(52) U.S. Cl. CPC C09D 5/1675; C03C 17/30; C08G 77/045; C08G 77/18; C09D 183/04; C09D 183/06; C03C 2217/76; C03C 2218/151

(57) ABSTRACT

Coated articles are described herein including a fluorine-free surface-modifying layer. The surface-modifying layer includes an alkyl silane at an exterior surface. The alkyl silane can be (i) bonded to another part of the coated article by a silane group and/or (ii) a silane group of the alkyl silane is a free end of the alkyl silane. In aspects, the surface-modifying layer can be a fingerprint-hiding coating exhibiting a water contact angle from 90° to 120°, an oleic acid contact angle of 40° or less, and a coefficient of friction of 0.25 or less. When a simulated fingerprint is applied to the surface-modifying layer in a Simulated Fingerprint Test, the surface-modifying layer exhibits a mean gray level of 150 or less and/or a haze of 8% or less. Methods of forming the coated article can include reacting an alkyl silane including at least two reactive groups to form the surface-modifying layer.

### CLAIM OF PRIORITY

This application claims the benefit of priority under 35 U.S.C. § 119 of U.S. Provisional Application Ser. No. 63/603,156 filed on Nov. 28, 2023, and U.S. Provisional Application Ser. No. 63/669,001 filed on Jul. 9, 2024, the contents of which are relied upon and incorporated herein by reference in their entirety.

### FIELD

The present disclosure relates generally to coated articles with a surface-modifying layer (e.g., fingerprint-hiding coating) and methods of making the same and, more particularly, to coated articles comprising a surface-modifying layer (e.g., fingerprint-hiding coating) that is fluorine-free and methods of making coated articles.

### BACKGROUND

Glass, glass-ceramic, and ceramic materials are commonly used in various consumer electronic products including display devices, for example, liquid crystal displays (LCDs), electrophoretic displays (EPD), organic light-emitting diode displays (OLEDs), plasma display panels (PDPs), or the like. For example, chemically strengthened glass is favored for many touch-screen products, including cell phones, music players, e-book readers, notepads, tablets, laptop computers, automatic teller machines, and other similar devices. Many of these glass, glass-ceramic, and ceramic materials are also employed in displays and display devices of consumer electronic products that do not have touch-screen capability but are prone to direct human contact, including desktop computers, laptop computers, elevator screens, equipment displays, and others. Glass, glass-ceramic, and ceramic materials are often treated to provide aesthetic and functional characteristics based on the end-use application of the material. For example, anti-reflective, anti-glare, anti-fingerprint, and fingerprint-hiding treatments are common treatments used on materials used in touch-screen products.

The durability of some types of treatments, such as an anti-fingerprint coating or a fingerprint-hiding coating, can be limited, especially when used in combination with other treatments, for example an anti-reflective coating. It is known to use fluorinated silanes, for example fluoroethersilanes, which can bind to the surface as a monolayer or multilayer, to form coatings with a thickness from 2 nm to 5 nm. Once this nanoscale coating is abraded away, the surface no longer exhibits repellant properties. Attempts to improve the durability and adhesion of an ETC coating include roughening the underlying surface that the ETC coating is disposed on.

Consequently, there is a need for a new surface-modifying layer (e.g., fingerprint-hiding coating) that can be used with glass, glass-ceramic, and/or ceramic articles with improved abrasion resistance and/or that can be used in conjunction with other treatments, for example, an anti-reflective coating. This need and others are addressed by the present disclosure.

### SUMMARY

The above need and other needs are addressed by the present disclosure which provides a surface-modifying layer (e.g., fingerprint-hiding coating) or a coated article containing the same that can reduce a visibility and/or color shift associated with disposing a fingerprint thereon. Providing a low polar surface energy and/or a high dispersive surface energy a can enable oils (e.g., fingerprint oil) to be dispersed across the fingerprint-hiding surface (e.g., oleophilic), which can decrease a visibility and/or a color shift associated with fingerprints. For example, providing an alkyl silane can enable a low polar surface energy and high dispersive surface energy of the fingerprint-hiding coating, which can enable the fingerprint-hiding coating to be oleophilic. Providing a high diiodomethane contact angle (e.g., about 60° or more) and/or a low hexadecane contact angle (e.g., 20° or less) can reduce the visibility and/or color shift associated with fingerprints by enabling fingerprint oil to be dispersed across the surface-modifying layer (e.g., fingerprint-hiding coating) rather than beading up into pronounced droplets. Providing a low oleic acid contact angle (e.g., about 40° or less or 35° or less) can reduce the visibility and/or color shift associated with fingerprints by enabling fingerprint oil to be dispersed across the surface-modifying layer (e.g., fingerprint-hiding coating) rather than beading up into pronounced droplets. Providing a high water contact angle (e.g., about 90° or more or about 100° or more) can enhance the removal of aqueous material (e.g., water droplets, sweat droplets) from the surface-modifying layer (e.g., fingerprint-hiding coating). Consequently, the fingerprint-hiding coating can be hydrophobic and oleophilic.

Providing a surface-modifying layer (e.g., fingerprint-hiding coating) in accordance with the aspects of the disclosure can exhibit good abrasion resistance (e.g., an abraded water contact angle of about 80° or more or 90° or more after 2,000 cycles and/or 3,500 cycles in a Steel Wool Abrasion Test, a cheesecloth-abraded water contact angle of about 80° or more or 90° or more after 200,000 cycles in a Cheesecloth Abrasion Test, or a rubber-abraded water contact angle of about 80° or more or 90° or more after 3,000 cycles in a Rubber Abrasion Test), for example, maintaining a hydrophobic and/or oleophilic character. The surface-modifying layer (e.g., fingerprint-hiding coating) can exhibit good adhesion to the surface that is disposed on, for example, a surface of a substrate or an optical stack. Providing a thickness of the surface-modifying layer (e.g., fingerprint-hiding coating) from about 1 nm to 75 nm (e.g., from about 2 nm to 5 nm) can provide good durability fingerprint-hiding coating while minimizing the amount of material required to achieve the above-mentioned effects.

As discussed herein, the properties of the present disclosure are different from the corresponding properties of Comparative Examples discussed herein in a statistically significant way that demonstrates that the surface-modifying layer (e.g., fingerprint-hiding coating) of the present disclosure does a better job of “hiding” visual effects associated with an applied fingerprint than the Comparative Examples. Providing a fluorine-free fingerprint-hiding coating can be cheaper to produce and/or more environmentally friendly.

The surface-modifying layer (e.g., fingerprint-hiding coating) can comprise an oligomer of one or more alkyl silanes, a polymer of one or more alkyl silanes, or both. As used herein, the term “polymer” may generally refer to oligomers, polymers, or combinations thereof. The alkyl silane can be a bis-silane or a tris-silane, which can produce a polymer or copolymer with disiloxane bonds between at least a pair of monomers.

In aspects, the surface-modifying layer (e.g., fingerprint-hiding coating) can be bonded to and/or disposed on a planarization layer 123. The planarization layer can comprise a silica or an at least partial silica-like network. Providing a silica or a partial silica-like network can enable the planarization layer to be stiff (e.g., elastic modulus of about 9 GPa or more) while allowing the surface-modifying layer (e.g., fingerprint-hiding coating) to remain flexible enough to withstand abrasion.

The substrate can comprise a glass-based, glass-ceramic, and/or ceramic-based material, which can provide good dimensional stability, good impact resistance, and/or good puncture resistance. The glass-based, glass-ceramic, and/or ceramic-based substrate can comprise one or more compressive stress regions, which can further provide increased impact resistance and/or increased puncture resistance.

Some example aspects of the disclosure are described below with the understanding that any of the features of the various aspects may be used alone or in combination with one another.

Aspect 1. A coated article comprising:
a substrate comprising a first major surface; and
a fingerprint-hiding coating disposed over the first major surface, the fingerprint-hiding coating comprising an exterior surface of the coated article, wherein the fingerprint-hiding coating is fluorine-free,
wherein the fingerprint-hiding coating exhibits;
   a water contact angle from 90° to 120°;
   an oleic acid contact angle of 40° or less; and
   a coefficient of friction of the exterior surface is 0.25 or less.

Aspect 2. The coated article of aspect 1, wherein the fingerprint-hiding coating comprises an alkyl silane at the exterior surface, wherein;
the alkyl silane is bonded to the substrate by a silane group, the alkyl silane is bonded to another part of the fingerprint-hiding coating by a silane group, or both;
the silane group of the alkyl silane is at a free end of the alkyl silane; or both.

Aspect 3. The coated article of aspect 2, wherein the fingerprint-hiding coating comprises an oligomer of the alkyl silane, a polymer of the alkyl silane, or both.

Aspect 4. The coated article of aspect 3, wherein the oligomer of the alkyl silane, the polymer of the alkyl silane, or both comprises at least one of;
a dialkyl siloxane block;
a dimethylsiloxane block bonding monomers of the oligomer of the alkyl silane, the polymer of the alkyl silane, or both, together; or
a disiloxane group bonding monomers of the oligomer of the alkyl silane, the polymer of the alkyl silane, or both, together.

Aspect 5. The coated article of any one of aspects 2-4, wherein the alkyl silane is substantially free of chlorine.

Aspect 6. The coated article of any one of aspects 1-5, wherein the fingerprint-hiding coating comprises an oligomer of the alkyl silane, a polymer of the alkyl silane, or both, wherein the oligomer of the alkyl silane, the polymer of the alkyl silane, or both, comprise a structure {OSi(R′)₂[CH₂]ₘ[Si(R″)₂O]ₙSi(R′)₂[CH₂]ₚSi(R″)₂}_{q}R, wherein m and p are independently selected from 3 to 34, R′ and R″ are independently selected from CH₃ and CH₂CH₃, n is 1 or more, q is 1 or more, R is selected from a group consisting of a hydroxyl group, a chloro group, a bromo group, an alkyl silane, an alkoxide, or combinations thereof.

Aspect 7. The coated article of aspect 6, wherein, in the structure, at least one of;
n is 1, and q is from 1 to 100; or
n is 1, m is 8, p is 8, and q is from 1 to 100.

Aspect 8. The coated article of aspect 6, wherein, in the structure, at least one of;
n is 2, and q is from 1 to 100;
n is 2, m is 8, p is 8, and q is from 1 to 100;
n is 2 or more, and q is from 1 to 100; or
n is 2 or more, m is 8, p is 8, and q is from 1 to 100.

Aspect 9. The coated article of any one of aspects 6-8, wherein the fingerprint-hiding coating comprises an oligomer of the alkyl silane, a polymer of the alkyl silane, or both, wherein the oligomer of the alkyl silane, the polymer of the alkyl silane, or both, comprise a condensation product of monomeric units comprising {Si(R′)₂[CH₂]ₘSi(R′)₂O}, wherein each R′ is independently selected from CH₃ and CH₂CH₃, and m is from 3 to 34.

Aspect 10. The coated article of aspect 9, wherein R′ is CH₃, and m is 8.

Aspect 11. The coated article of aspect 9 or aspect 10, wherein the condensation product further comprises monomeric units comprising {R″Si(OCH₃)₂}, {R″Si(OCH₃)}, {R″Si}, {R″Si(OCH₃)₂(OH)}, {R″Si(OCH₃)(OH)₂}, {R″Si(OH)₃}, or combinations thereof, wherein R″ is a (C5-C38) alkyl, and optionally, wherein at least a portion of the monomeric units are linked to the substrate.

Aspect 12. The coated article of aspect 11, wherein a ratio of the monomeric units comprising {Si(R′)₂[CH₂]ₘSi(R′)₂O} to the monomeric units comprising {R″Si(OCH₃)₂}, {R″Si(OCH₃)}, {R″Si}, {R″Si(OCH₃)₂(OH)}, {R″Si(OCH₃)(OH)₂}, {R″Si(OH)₃}, or combinations thereof, is from 10:1 to 1:10.

Aspect 13. The coated article of any one of aspects 6-12, wherein the fingerprint-hiding coating comprises an oligomer of the alkyl silane, a polymer of the alkyl silane, or both, wherein the oligomer of the alkyl silane, the polymer of the alkyl silane, or both, comprise a condensation product of monomeric units comprising {OSi(CH₃)₂[CH₂]₈Si(CH₃)₂} and monomeric units comprising {(CH₃)(CH₂)₁₇Si(OCH₃)}, {(CH₃)(CH₂)₁₇Si}, or combinations thereof.

Aspect 14. The coated article of aspect 13, wherein a ratio of the monomeric units comprising {OSi(CH₃)₂[CH₂]₈Si(CH₃)₂} to the monomeric units comprising {(CH₃)(CH₂)₁₇Si(OCH₃)₂}, {(CH₃)(CH₂)₁₇Si(OCH₃)}, {(CH₃)(CH₂)₁₇Si}, or combinations thereof is from 10:1 to 1:10.

Aspect 15. The coated article of aspect 2, wherein the fingerprint-hiding coating comprises an oligomer of the alkyl silane, a polymer of the alkyl silane, or both, wherein the oligomer of the alkyl silane, the polymer of the alkyl silane, or both, comprise a structure {OSi(R)₂[CH₂]ₘ[Si(R)₂O]ₙSi(R)₂[CH₂]ₚSi(R)₂}_{q}R, wherein m and p are independently selected from 3 to 34, each R is independently selected from OCH₃, OH, and OSi(R′)₂[CH₂]_{m′}, m′ is independently selected from 3 to 34, n is 1 or more, q is 1 or more, and each R′ is independently selected from a group consisting of OCH₃, and OH.

Aspect 16. The coated article of aspect 15, wherein, in the structure, at least one; n is 1, and q is from 1 to 100; or n is 1, m is 8, p is 8, and q is from 1 to 100.

Aspect 17. The coated article of aspect 15, wherein, in the structure, at least one; n is 1, and q is from 1 to 100; or n is 1, m is 6, p is 6, and q is from 1 to 100.

Aspect 18. The coated article of aspect 15 wherein, in the structure, at least one of;
n is 2, and q is from 1 to 100;
n is 2, m is 8, p is 8, and q is from 1 to 100;
n is 2, m is 6, p is 6, and q is from 1 to 100;
n is 2 or more, and q is from 1 to 100;
n is 2 or more, m is 8, p is 8, and q is from 1 to 100; or
n is 2 or more, m is 6, p is 6, and q is from 1 to 100.

Aspect 19. The coated article of any one of aspects 15-17 wherein the fingerprint-hiding coating comprises an oligomer of the alkyl silane, a polymer of the alkyl silane, or both, wherein the oligomer of the alkyl silane, the polymer of the alkyl silane, or both, comprise a condensation product of monomeric units comprising {(OSi(R)₂[CH₂]ₘSi(R)₂}, wherein each R is independently selected from OCH₃ and OH, and m is from 3 to 34.

Aspect 20. The coated article of aspect 18, wherein R is OCH₃, and m is 8.

Aspect 21. The coated article of aspect 18, wherein R is OCH₃, and m is 6.

Aspect 22. The coated article of any one of aspects 18-21, wherein the condensation product further comprises monomeric units comprising {{R″Si(OCH₃)₂}, {R″Si(OCH₃)}, {R″Si}, {R″Si(OCH₃)₂(OH)}, {R″Si(OCH₃)(OH)₂}, {R″Si(OH)₃}, or combinations thereof, wherein R″ is a (C5-C38) alkyl, and optionally, wherein at least a portion of the monomeric units are linked to the substrate.

Aspect 23. The coated article of aspect 21, wherein a ratio of the monomeric units comprising {(OSi(R)₂[CH₂]ₘSi(R)₂} to the monomeric units comprising-{R″Si(OCH₃)₂}, {R″Si(OCH₃)}, {R″Si}, {R″Si(OCH₃)₂(OH)}, {R″Si(OCH₃)(OH)₂}, {R″Si(OH)₃}, or combinations thereof is from 10:1 to 1:10.

Aspect 24. The coated article of any one of aspects 21-23, wherein the fingerprint-hiding coating comprises an oligomer of the alkyl silane, a polymer of the alkyl silane, or both, wherein the oligomer of the alkyl silane, the polymer of the alkyl silane, or both, comprise a condensation product of monomeric units comprising {(OSi(OCH₃)₂[CH₂]₈Si(OCH₃)₂} and monomeric units comprising {(CH₃)(CH₂)₁₇Si(OCH₃)}, {(CH₃)(CH₂)₁₇Si}, or combinations thereof.

Aspect 25. The coated article of aspect 24, wherein a ratio of the monomeric units comprising {(OSi(OCH₃)₂[CH₂]₈Si(OCH₃)₂} to the monomeric units comprising {(CH₃)(CH₂)₁₇Si(OCH₃)}, {(CH₃)(CH₂)₁₇Si}, or combinations thereof is from 10:1 to 1:10.

Aspect 26. The coated article of aspect 24, wherein a ratio of the monomeric units comprising {(OSi(OCH₃)₂[CH₂]₈Si(OCH₃)₂} to the monomeric units comprising {(CH₃)(CH₂)₁₇Si(OCH₃)}, {(CH₃)(CH₂)₁₇Si}, or combinations thereof is from 1:1 to 1:10.

Aspect 27. The coated article of any one of aspects 21-23, wherein the fingerprint-hiding coating comprises an oligomer of the alkyl silane, a polymer of the alkyl silane, or both, wherein the oligomer of the alkyl silane, the polymer of the alkyl silane, or both, comprise a condensation product of monomeric units comprising {(OSi(OCH₃)₂[CH₂]₆Si(OCH₃)₂} and monomeric units comprising {(CH₃)(CH₂)₁₇Si(OCH₃)}, {(CH₃)(CH₂)₁₇Si}, or combinations thereof.

Aspect 28. The coated article of aspect 27, wherein a ratio of the monomeric units comprising {(OSi(OCH₃)₂[CH₂]₆Si(OCH₃)₂} to the monomeric units comprising {(CH₃)(CH₂)₁₇Si(OCH₃)}, {(CH₃)(CH₂)₁₇Si}, or combinations thereof is from 10:1 to 1:10.

Aspect 29. The coated article of aspect 27, wherein a ratio of the monomeric units comprising {(OSi(OCH₃)₂[CH₂]₆Si(OCH₃)₂} to the monomeric units comprising {(CH₃)(CH₂)₁₇Si(OCH₃)}, {(CH₃)(CH₂)₁₇Si}, or combinations thereof is from 1:1 to 1:10.

Aspect 30. The coated article of any one of aspects 1-29, wherein the fingerprint-hiding coating exhibits the oleic acid contact angle of 30° or less.

Aspect 31. The coated article of any one of aspects 1-30, wherein the fingerprint-hiding coating exhibits at least one of;
a voltage of about 15 Volts or less in a Tribocharging test; or
a voltage difference between a peripheral contact region and a center contact region of about 5 Volts or less in the Tribocharging test.

Aspect 32. The coated article of any one of aspects 1-31, wherein when a simulated fingerprint is applied to the fingerprint-hiding coating in a Simulated Fingerprint Test, the fingerprint-hiding coating exhibits at least one of;
an effective diameter of droplets of the simulated fingerprint of 10 μm or more;
a mean height of droplets of the simulated fingerprint on the exterior surface of 0.15 μm or less; or
a spherical cap radius of droplets of the simulated fingerprint of 40 μm or more.

Aspect 33. The coated article of any one of aspects 1-32, wherein when a simulated fingerprint is applied to the fingerprint-hiding coating in a Simulated Fingerprint Test, the fingerprint-hiding coating exhibits;
a core material value Vmc of a droplet of the simulated fingerprint of 0.10 μm³/μm² or more between areal material ratios of 10% and 90%.

Aspect 34. The coated article of aspect 33, wherein the fingerprint-hiding coating exhibits at least one of;
a ratio of a volume of the droplet to an area of the droplet is 0.78 μm³/μm² or less;
a ratio of a height of the droplet to the area of the droplet is 0.005 μm/μm² or less;
a total area of the simulated fingerprint over the exterior surface of 150,000 μm² or more;
a haze of 8% or less with the simulated fingerprint applied to the fingerprint-hiding coating in the Simulated Fingerprint Test;
a center of a sphere modeled on the droplet of the simulated fingerprint is located greater than 30 μm from the exterior surface of the fingerprint-hiding coating;
a mean gray level is 150 or less as measured in a Gray Level Test of coated article with the simulated fingerprint applied to the fingerprint-hiding coating in the Simulated Fingerprint Test; or
a normalized gray level is 2.0 or less as measured in a Normalized Gray Level Test of coated article with the simulated fingerprint applied to the fingerprint-hiding coating in the Simulated Fingerprint Test.

Aspect 35. The coated article of any one of aspects 1-34, wherein the fingerprint-hiding coating comprises at least one of;
a polar surface energy of from 2 milliNewtons per meter to 6 milliNewtons per meter; or
a total surface energy of from 25 milliNewtons per meter to 35 milliNewtons per meter.

Aspect 36. The coated article of any one of aspects 1-35, wherein the fingerprint-hiding coating comprises a thickness from 1 nanometer to 75 nanometers.

Aspect 37. The coated article of any one of aspects 1-36, wherein the exterior surface of the fingerprint-hiding coating comprises from 0.5 atom % to 2 atom % of a non-fluorine halogen.

Aspect 38. The coated article of any one of aspects 1-37, wherein the exterior surface of the fingerprint-hiding coating is free of a transition metal-containing compound.

Aspect 39. The coated article of any one of aspects 1-38, wherein the fingerprint-hiding coating exhibits at least one of;
a cheesecloth-abraded water contact angle of about 80° or more after being subjected to 200,000 cycles of in a Cheesecloth Abrasion Test; or
a rubber-abraded water contact angle of about 80° or more after being abraded for 3,000 cycles in a Rubber Abrasion Test.

Aspect 40. The coated article of any one of aspects 1-39, further comprising a planarization layer positioned between the substrate and the fingerprint-hiding coating, the fingerprint-hiding coating disposed on the planarization layer, the planarization layer exhibiting at least one of;
from 50% to 90% of silicon atoms of the planarization layer are in a silica-like network; a ratio of Si—O—Si bonds to Si atoms in the planarization layer is from about 2 to about 3; or a molar ratio of hydrogen to silicon in the planarization layer is about 0.2 or more.

Aspect 41. The coated article of aspect 40, wherein the planarization layer comprises a refractive index ranging from 1.37 to 1.55.

Aspect 42. The coated article of any one of aspects 40-41, wherein the planarization layer comprises an elastic modulus ranging from about 9 GigaPascals to about 70 GigaPascals.

Aspect 43. The coated article of any one of aspects 40-42, wherein the planarization layer exhibits at least one of;
an abraded water contact angle of about 80° or more after being abraded for 2,000 cycles in a Steel Wool Abrasion test;
a cheesecloth-abraded water contact angle of about 80° or more after being subjected to 200,000 cycles of in a Cheesecloth Abrasion Test; or
a rubber-abraded water contact angle of about 80° or more after being abraded for 3,000 cycles in a Rubber Abrasion Test.

Aspect 44. The coated article of any one of aspects 1-43, further comprising at least one of;
an anti-reflective coating positioned between the fingerprint-hiding coating and the substrate; or
a gradient coating comprising a refractive index gradient positioned between the fingerprint-hiding coating and the substrate.

Aspect 45. The coated article of any one of aspects 1-44, further comprising an optical stack positioned between the fingerprint-hiding coating and the substrate, wherein the optical stack comprises an anti-reflective coating, a band-pass filter coating, an edge neutral mirror, a beam splitter coating, a multi-layer high-reflectance coating, or an edge filter coating.

Aspect 46. The coated article of aspect 45, wherein the optical stack has a stack thickness from about 10 nanometers to about 10 micrometers.

Aspect 47. The coated article of aspect 46, wherein the stack thickness of the optical stack is from about 50 nanometers to about 5 micrometers.

Aspect 48. The coated article of any one of aspects 46-47, wherein the stack thickness of the optical stack is from about 50 nanometers to about 500 nanometers.

Aspect 49. The coated article of any one of aspects 45-48, wherein the optical stack comprises a scratch resistant layer, and the scratch resistant layer has a scratch-resistant thickness from 0.05 micrometers to 3 micrometers.

Aspect 50. The coated article of any one of aspects 45-49, wherein the coated article including the optical stack and the fingerprint-hiding coating exhibits a hardness of 8 GigaPascals or greater measured by a Berkovich Indenter Hardness test.

Aspect 51. The coated article of any one of aspects 45-50, wherein the optical stack comprises one or more of a silicon-containing oxide, a silicon-containing nitride, a silicon-containing oxynitride, and Nb₂O₅.

Aspect 52. The coated article of any one of aspects 45-51, wherein the optical stack comprises two or more layers with different refractive indices including at least a first low refractive index (RI) layer and a second high refractive index (RI) layer, wherein the absolute value of a difference between the first low RI layer and the second high RI layer is 0.2 or more, and further wherein the optical stack comprises one or more of a silicon-containing oxide, a silicon-containing nitride, a silicon-containing oxynitride, and Nb₂O₅.

Aspect 53. The coated article of any one of aspects 1-52, wherein the substrate is a textured substrate.

Aspect 54. The coated article of aspect 53, wherein the coated article further comprises an anti-reflective coating or a gradient coating positioned between the fingerprint-hiding coating and the textured substrate.

Aspect 55. The coated article of aspect 54, wherein a thickness of the anti-reflective coating is from about 200 nanometers to about 3 micrometers.

Aspect 56. The coated article of any one of aspects 1-52, wherein the substrate is a polymer substrate.

Aspect 57. A coated article comprising:
a substrate comprising a first major surface; and
a fingerprint-hiding coating disposed over the first major surface, the fingerprint-hiding coating comprising an exterior surface of the coated article, wherein;
the fingerprint-hiding coating is fluorine-free,
the fingerprint-hiding comprises an oligomer of an alkyl silane, a polymer of the alkyl silane, or both, wherein the oligomer of the alkyl silane, the polymer of the alkyl silane, or both, comprise a structure {OSi(R′)₂[CH₂]ₘ[Si(R″)₂O]ₙSi(R′)₂[CH₂]ₚSi(R″)₂}_{q}R, wherein m and p are independently selected from 3 to 34, R′ and R″ are independently selected from CH₃ and CH₂CH₃, n is 1 or more, q is 1 or more, R is selected from a group consisting of a hydroxyl group, a chloro group, a bromo group, an alkyl silane, an alkoxide, or combinations thereof.

Aspect 58. The coated article of aspect 57, wherein R″ is CH₃.

Aspect 59. The coated article of any one of aspects 57-58, wherein, in the structure, at least one;
n is 1, and q is from 1 to 100; or
n is 1, m is 8, p is 8, and q is from 1 to 100.

Aspect 60. The coated article of any one of aspects 57-59, wherein, in the structure, at least one of;
n is 2, and q is from 1 to 100;
n is 2, m is 8, p is 8, and q is from 1 to 100;
n is 2 or more, and q is from 1 to 100; or
n is 2 or more, m is 8, p is 8, and q is from 1 to 100.

Aspect 61. A coated article comprising:
a substrate comprising a first major surface; and
a fingerprint-hiding coating disposed over the first major surface, the fingerprint-hiding coating comprising an exterior surface of the coated article, wherein;
the fingerprint-hiding coating is fluorine-free,
the fingerprint-hiding comprises an oligomer of an alkyl silane, a polymer of the alkyl silane, or both, wherein the oligomer of the alkyl silane, the polymer of the alkyl silane, or both, comprise a condensation product of monomeric units comprising {Si(R′)₂[CH₂]ₘSi(R′)₂O}, wherein each R′ is independently selected from CH₃ and CH₂CH₃, and m is from 3 to 34.

Aspect 62. The coated article of aspect 61, wherein R′ is CH₃.

Aspect 63. The coated article of aspect 61, wherein R′ is CH₃, and m is 8.

Aspect 64. The coated article of any one of aspects 61-63, wherein the condensation product further comprises monomeric units comprising {R″Si(OCH₃)₂}, {R″Si(OCH₃)}, {R″Si}, {R″Si(OCH₃)₂(OH)}, {R″Si(OCH₃)(OH)₂}, {R″Si(OH)₃}, or combinations thereof, wherein R″ is a (C5-C38) alkyl, and optionally, wherein at least a portion of the monomeric units are linked to the substrate.

Aspect 65. The coated article of aspect 64, wherein a ratio of the monomeric units comprising {Si(R′)₂[CH₂]ₘSi(R′)₂O} to the monomeric units comprising {R″Si(OCH₃)₂}, {R″Si(OCH}, {R″Si}, {Si(OCH₃)₂(OH)}, {R″Si(OCH₃)(OH)}, {R″Si(OH)₃}, or combinations thereof is from 10:1 to 1:10.

Aspect 66. The coated article of any one of aspects 61-65, wherein the oligomer of the alkyl silane, the polymer of the alkyl silane, or both, comprise a condensation product of monomeric units comprising {OSi(CH₃)₂[CH₂]₈Si(CH₃)₂} and monomeric units comprising {(CH₃)(CH₂)₁₇Si(OCH₃)}, {(CH₃)(CH₂)₁₇Si}, or combinations thereof.

Aspect 67. The coated article of aspect 66, wherein a ratio of the monomeric units comprising {OSi(CH₃)₂[CH₂]₈Si(CH₃)₂} to the monomeric units comprising {(CH₃)(CH₂)₁₇Si(OCH₃)₂}, {(CH₃)(CH₂)₁₇Si(OCH₃)}, {(CH₃)(CH₂)₁₇Si}, or combinations thereof is from 10:1 to 1:10.

Aspect 68. The coated article of any one of aspects 57-67, wherein the fingerprint-hiding coating exhibits at least one of;
a cheesecloth-abraded water contact angle of about 80° or more after being subjected to 200,000 cycles of in a Cheesecloth Abrasion Test; or
a rubber-abraded water contact angle of about 80° or more after being abraded for 3,000 cycles in a Rubber Abrasion Test.

Aspect 69. The coated article of any one of aspects 57-68, further comprising an optical stack positioned between the fingerprint-hiding coating and the substrate, wherein the optical stack comprises an anti-reflective coating, a band-pass filter coating, an edge neutral mirror, a beam splitter coating, a multi-layer high-reflectance coating, or an edge filter coating.

Aspect 70. The coated article of any one of aspects 57-69 wherein the substrate is a textured substrate.

Aspect 71. The coated article of aspect 70, wherein the coated article further comprises an anti-reflective coating or a gradient coating positioned between the fingerprint-hiding coating and the textured substrate.

Aspect 72. The coated article of any one of aspects 57-68, wherein the substrate is a polymer substrate.

Aspect 73. A coated article comprising:
a substrate comprising a first major surface; and
a fingerprint-hiding coating disposed over the first major surface, the fingerprint-hiding coating comprising an exterior surface of the coated article, wherein;
the fingerprint-hiding coating is fluorine-free;
the fingerprint-hiding comprises an oligomer of an alkyl silane, a polymer of the alkyl silane, or both, wherein the oligomer of the alkyl silane, the polymer of the alkyl silane, or both, comprise a structure {OSi(R)₂[CH₂]ₘ[Si(R)₂O]ₙSi(R)₂[CH₂]ₚSi(R)₂}_{q}R, wherein m and p are independently selected from 3 to 34, each R is independently selected from OCH₃, OH, and OSi(R′)₂[CH₂]_{m′}, m′ is independently selected from 3 to 34, n is 1 or more, q is 1 or more, and each R′ is independently selected from a group consisting of OCH₃, and OH.

Aspect 74. The coated article of aspect 73, wherein the alkyl silane is chlorine-free.

Aspect 75. The coated article of aspect 73 or aspect 74, wherein R′ is OCH₃.

Aspect 76. The coated article of any one of aspects 73-75, wherein, in the structure, at least one;
n is 1, and q is from 1 to 100; or
n is 1, m is 8, p is 8, and q is from 1 to 100.

Aspect 77. The coated article of any one of aspects 73-75, in the structure, at least one;
n is 1, and q is from 1 to 100; or
n is 1, m is 6, p is 6, and q is from 1 to 100.

Aspect 78. The coated article of any one of aspects 73-75 wherein, in the structure, at least one of;
n is 2, and q is from 1 to 100;
n is 2, m is 8, p is 8, and q is from 1 to 100;
n is 2, m is 6, p is 6, and q is from 1 to 100;
n is 2 or more, and q is from 1 to 100;
n is 2 or more, m is 8, p is 8, and q is from 1 to 100; or
n is 2 or more, m is 6, p is 6, and q is from 1 to 100.

Aspect 79. A coated article comprising:
a substrate comprising a first major surface; and
a fingerprint-hiding coating disposed over the first major surface, the fingerprint-hiding coating comprising an exterior surface of the coated article, wherein;
the fingerprint-hiding coating is fluorine-free,
the fingerprint-hiding comprises an oligomer of an alkyl silane, a polymer of the alkyl silane, or both, wherein the oligomer of the alkyl silane, the polymer of the alkyl silane, or both, comprise a condensation product of monomeric units comprising {(OSi(R)₂[CH₂]ₘSi(R)₂}, wherein each R is independently selected from OCH₃ and OH, and m is from 3 to 34.

Aspect 80. The coated article of aspect 79, wherein R is OCH₃, and m is 8.

Aspect 81. The coated article of aspect 80, wherein R is OCH₃, and m is 6.

Aspect 82. The coated article of any one of aspects 79-81, wherein the condensation product further comprises monomeric units comprising {{R″Si(OCH₃)₂}, {R″Si(OCH₃)}, {R″Si}, {R″Si(OCH₃)₂(OH)}, {R″Si(OCH₃)(OH)₂}, {R″Si(OH)₃}, or combinations thereof, wherein R″ is a (C5-C38) alkyl, and optionally, wherein at least a portion of the monomeric units are linked to the substrate.

Aspect 83. The coated article of aspect 82, wherein a ratio of the monomeric units comprising {(OSi(R)₂[CH₂]ₘSi(R)₂} to the monomeric units comprising {R″Si(OCH₃)₂}, {R″Si(OCH₃)}, {R″Si}, {R″Si(OCH₃)₂(OH)}, {R″Si(OCH₃)(OH)₂}, {R″Si(OH)₃}, or combinations thereof, is from 10:1 to 1:10.

Aspect 84. The coated article of aspect 82, wherein a ratio of the monomeric units comprising {(OSi(R)₂[CH₂]ₘSi(R)₂} to the monomeric units comprising {R″Si(OCH₃)₂}, {R″Si(OCH₃)}, {R″Si}, {R″Si(OCH₃)₂(OH)}, {R″Si(OCH₃)(OH)₂}, {R″Si(OH)₃}, or combinations thereof, is from 1:1 to 1:10.

Aspect 85. The coated article of any one of aspects 79-84, wherein the oligomer of the alkyl silane, the polymer of the alkyl silane, or both, comprise a condensation product of monomeric units comprising {(OSi(OCH₃)₂[CH₂]₈Si(OCH₃)₂} and monomeric units comprising {(CH₃)(CH₂)₁₇Si(OCH₃)}, {(CH₃)(CH₂)₁₇Si}, or combinations thereof.

Aspect 86. The coated article of aspect 85, wherein a ratio of the monomeric units comprising {(OSi(OCH₃)₂[CH₂]₈Si(OCH₃)₂} to the monomeric units comprising {(CH₃)(CH₂)₁₇Si(OCH₃)}, {(CH₃)(CH₂)₁₇Si}, or combinations thereof is from 10:1 to 1:10.

Aspect 87. The coated article of aspect 85, a ratio of the monomeric units comprising {(OSi(OCH₃)₂[CH₂]₈Si(OCH₃)₂} to the monomeric units comprising {(CH₃)(CH₂)₁₇Si(OCH₃)}, {(CH₃)(CH₂)₁₇Si}, or combinations thereof is from 1:1 to 1:10.

Aspect 88. The coated article of any one of aspects 79-84, wherein the oligomer of the alkyl silane, the polymer of the alkyl silane, or both, comprise a condensation product of monomeric units comprising {(OSi(OCH₃)₂[CH₂]₆Si(OCH₃)₂} and monomeric units comprising {(CH₃)(CH₂)₁₇Si(OCH₃)}, {(CH₃)(CH₂)₁₇Si}, or combinations thereof.

Aspect 89. The coated article of aspect 88, wherein a ratio of the monomeric units comprising {(OSi(OCH₃)₂[CH₂]₆Si(OCH₃)₂} to the monomeric units comprising {(CH₃)(CH₂)₁₇Si(OCH₃)}, {(CH₃)(CH₂)₁₇Si}, or combinations thereof is from 10:1 to 1:10.

Aspect 90. The coated article of aspect 89, wherein a ratio of the monomeric units comprising {(OSi(OCH₃)₂[CH₂]₆Si(OCH₃)₂} to the monomeric units comprising {(CH₃)(CH₂)₁₇Si(OCH₃)}, {(CH₃)(CH₂)₁₇Si}, or combinations thereof is from 10:1 to 1:10.

Aspect 91. The coated article of any one of aspects 79-90, wherein the fingerprint-hiding coating exhibits at least one of;
a cheesecloth-abraded water contact angle of about 80° or more after being subjected to 200,000 cycles of in a Cheesecloth Abrasion Test; or
a rubber-abraded water contact angle of about 80° or more after being abraded for 3,000 cycles in a Rubber Abrasion Test.

Aspect 92. The coated article of any one of aspects 79-91, further comprising an optical stack positioned between the fingerprint-hiding coating and the substrate, wherein the optical stack comprises an anti-reflective coating, a band-pass filter coating, an edge neutral mirror, a beam splitter coating, a multi-layer high-reflectance coating, or an edge filter coating.

Aspect 93. The coated article of any one of aspects 79-92 wherein the substrate is a textured substrate.

Aspect 94. The coated article of aspect 93, wherein the coated article further comprises an anti-reflective coating or a gradient coating positioned between the fingerprint-hiding coating and the textured substrate.

Aspect 95. The coated article of any one of aspects 79-94, wherein the substrate is a polymer substrate.

Aspect 96. A coated article comprising:
a substrate comprising a first major surface;
a planarization layer disposed over the first major surface, the planarization layer comprising a thickness between a first surface area and a second surface area opposite the first surface area from about 10 nanometers to about 600 nanometers, the second surface area facing the first major surface; and
a fingerprint-hiding coating disposed on the first surface area of the planarization layer, the fingerprint-hiding coating comprising an exterior surface of the coated article, wherein;
the fingerprint-hiding coating is fluorine-free;
the fingerprint-hiding coating comprises an oligomer of an alkyl silane, a polymer of the alkyl silane, or both, wherein the oligomer of the alkyl silane, the polymer of the alkyl silane, or both, comprise a structure {OSi(R′)₂[CH₂]ₘ[Si(R″)₂O]ₙSi(R′)₂[CH₂]ₚSi(R″)₂}_{q}R, wherein m and p are independently selected from 3 to 34, R′ and R″ are independently selected from CH₃ and CH₂CH₃, n is 1 or more, q is 1 or more, R is selected from a group consisting of a hydroxyl group, a chloro group, a bromo group, an alkyl silane, an alkoxide, or combinations thereof.

Aspect 97. The coated article of aspect 96, wherein the planarization layer comprises at least one of;
from 50% to 90% of silicon atoms of the planarization layer are in a silica-like network; a ratio of Si—O—Si bonds to Si atoms in the planarization layer is from about 2 to about 3; or
a molar ratio of hydrogen to silica of about 0.2 or more.

Aspect 98. The coated article of any one of aspects 96-97, wherein the planarization layer comprises an elastic modulus ranging from about 9 GigaPascals to about 70 GigaPascals.

Aspect 99. The coated article of any one of aspects 96-98, wherein R″ is CH₃.

Aspect 100. The coated article of any one of aspects 96-99, wherein, in the structure, at least one;
n is 1, and q is from 1 to 100; or
n is 1, m is 8, p is 8, and q is from 1 to 100.

Aspect 101. The coated article of any one of aspects 96-99, wherein, in the structure, at least one of;
n is 2, and q is from 1 to 100;
n is 2, m is 8, p is 8, and q is from 1 to 100;
n is 2 or more, and q is from 1 to 100; or
n is 2 or more, m is 8, p is 8, and q is from 1 to 100.

Aspect 102. A coated article comprising:
a substrate comprising a first major surface;
a planarization layer disposed over the first major surface, the planarization layer comprising a thickness between a first surface area and a second surface area opposite the first surface area from about 10 nanometers to about 600 nanometers, the second surface area facing the first major surface; and
a fingerprint-hiding coating disposed on the first surface area of the planarization layer,
the fingerprint-hiding coating comprising an exterior surface of the coated article, wherein;
the fingerprint-hiding coating is fluorine-free: the fingerprint-hiding coating comprises an oligomer of an alkyl silane, a polymer of the alkyl silane, or both, wherein the oligomer of the alkyl silane, the polymer of the alkyl silane, or both, comprise a condensation product of monomeric units comprising {Si(R′)₂[CH₂]ₘSi(R′)₂O}, wherein each R′ is independently selected from CH₃ and CH₂CH₃, and m is from 3 to 34.

Aspect 103. The coated article of aspect 102, wherein the planarization layer comprises at least one of;
from 50% to 90% of silicon atoms of the planarization layer are in a silica-like network;
a ratio of Si—O—Si bonds to Si atoms in the planarization layer is from about 2 to about 3; or
a molar ratio of hydrogen to silica of about 0.2 or more.

Aspect 104. The coated article of any one of aspects 102-103, wherein the planarization layer comprises an elastic modulus ranging from about 9 GigaPascals to about 70 GigaPascals.

Aspect 105. The coated article of any one of aspects 102-104, wherein R′ is CH₃, and m is 8.

Aspect 106. The coated article of any one of aspects 102-105, wherein the condensation product further comprises monomeric units comprising {R″Si(OCH₃)₂}, {R″Si(OCH₃)}, {R″Si}, {R″Si(OCH₃)₂(OH)}, {R″Si(OCH₃)(OH)₂}, {R″Si(OH)₃}, or combinations thereof, wherein R″ is a (C5-C38) alkyl, and optionally, wherein at least a portion of the monomeric units are linked to the substrate.

Aspect 107. The coated article of aspect 106, wherein a ratio of the monomeric units comprising {OSi(R′)₂[CH₂]ₘSi(R′)₂} to the monomeric units comprising {R″Si(OCH₃)₃} is from 10:1 to 1:10.

Aspect 108. The coated article of any one of aspects 102-107, wherein the fingerprint-hiding coating comprises an oligomer of the alkyl silane, a polymer of the alkyl silane, or both, wherein the oligomer of the alkyl silane, the polymer of the alkyl silane, or both, comprise a condensation product of monomeric units comprising {OSi(CH₃)₂[CH₂]₈Si(CH₃)₂} and monomeric units comprising {(CH₃)(CH₂)₁₇Si(OCH₃)}, {(CH₃)(CH₂)₁₇Si}, or combinations thereof.

Aspect 109. The coated article of aspect 108, wherein a ratio of the monomeric units comprising {OSi(CH₃)₂[CH₂]₈Si(CH₃)₂} to the monomeric units comprising {(CH₃)(CH₂)₁₇Si(OCH₃)₂}, {(CH₃)(CH₂)₁₇Si(OCH₃)}, {(CH₃)(CH₂)₁₇Si}, or combinations thereof is from 10:1 to 1:10.

Aspect 110. The coated article of aspect 108, wherein a ratio of the monomeric units comprising {OSi(CH₃)₂[CH₂]₈Si(CH₃)₂} to the monomeric units comprising {(CH₃)(CH₂)₁₇Si(OCH₃)₂}, {(CH₃)(CH₂)₁₇Si(OCH₃)}, {(CH₃)(CH₂)₁₇Si}, or combinations thereof is from 11:1 to 1:10.

Aspect 111. The coated article of any one of aspects 102-110, wherein the planarization layer exhibits at least one of;
an abraded water contact angle of about 80° or more after being abraded for 2,000 cycles in a Steel Wool Abrasion test;
a cheesecloth-abraded water contact angle of about 80° or more after being subjected to 200,000 cycles of in a Cheesecloth Abrasion Test; or
a rubber-abraded water contact angle of about 80° or more after being abraded for 3,000 cycles in a Rubber Abrasion Test.

Aspect 112. The coated article of any one of aspects 102-111, further comprising an optical stack positioned between the planarization layer and the substrate, wherein the optical stack comprises an anti-reflective coating, a band-pass filter coating, an edge neutral mirror, a beam splitter coating, a multi-layer high-reflectance coating, or an edge filter coating.

Aspect 113. The coated article of any one of aspects 102-112, wherein the substrate is a textured substrate.

Aspect 114. The coated article of aspect 113, wherein the coated article further comprises an anti-reflective coating or a gradient coating positioned between the planarization layer and the textured substrate.

Aspect 115. The coated article of any one of aspects 102-114, wherein the substrate is a polymer substrate.

Aspect 116. A coated article comprising:
a substrate comprising a first major surface;
a planarization layer disposed over the first major surface, the planarization layer comprising a thickness between a first surface area and a second surface area opposite the first surface area from about 10 nanometers to about 600 nanometers, the second surface area facing the first major surface; and
a fingerprint-hiding coating disposed on the first surface area of the planarization layer, the fingerprint-hiding coating comprising an exterior surface of the coated article, wherein;
the fingerprint-hiding coating is fluorine-free;
the fingerprint-hiding coating comprises an oligomer of an alkyl silane, a polymer of the alkyl silane, or both, wherein the oligomer of the alkyl silane, the polymer of the alkyl silane, or both, comprise a structure {OSi(R)₂[CH₂]ₘ[Si(R)₂O]ₙSi(R)₂[CH₂]ₚSi(R)₂}_{q}R, wherein m and p are independently selected from 3 to 34, each R is independently selected from OCH₃, OH, and OSi(R′)₂[CH₂]_{m′}, m′ is independently selected from 3 to 34, n is 1 or more, q is 1 or more, and each R′ is independently selected from a group consisting of OCH₃, and OH.

Aspect 117. The coated article of aspect 116, wherein the planarization layer comprises at least one of;
from 50% to 90% of silicon atoms of the planarization layer are in a silica-like network;
a ratio of Si—O—Si bonds to Si atoms in the planarization layer is from about 2 to about 3; or
a molar ratio of hydrogen to silica of about 0.2 or more.

Aspect 118. The coated article of any one of aspects 116-117, wherein the planarization layer comprises an elastic modulus ranging from about 9 GigaPascals to about 70 GigaPascals.

Aspect 119. The coated article of any one of aspects 116-118, wherein, in the structure, at least one;
n is 1, and q is from 1 to 100; or
n is 1, m is 8, p is 8, and q is from 1 to 100.

Aspect 120. The coated article of any one of aspects 116-119, wherein, in the structure, at least one;
n is 1, and q is from 1 to 100; or
n is 1, m is 6, p is 6, and q is from 1 to 100.

Aspect 121. The coated article of any one of aspects 116-118, wherein, in the structure, at least one of;
n is 2, and q is from 1 to 100;
n is 2, m is 8, p is 8, and q is from 1 to 100;
n is 2, m is 6, p is 6, and q is from 1 to 100;
n is 2 or more, and q is from 1 to 100;
n is 2 or more, m is 8, p is 8, and q is from 1 to 100; or
n is 2 or more, m is 6, p is 6, and q is from 1 to 100.

Aspect 122. A coated article comprising:
a substrate comprising a first major surface;
a planarization layer disposed over the first major surface, the planarization layer comprising a thickness between a first surface area and a second surface area opposite the first surface area from about 10 nanometers to about 600 nanometers, the second surface area facing the first major surface; and
a fingerprint-hiding coating disposed on the first surface area of the planarization layer, the fingerprint-hiding coating comprising an exterior surface of the coated article, wherein;
the fingerprint-hiding coating is fluorine-free;
the fingerprint-hiding coating comprises an oligomer of an alkyl silane, a polymer of the alkyl silane, or both, wherein the oligomer of the alkyl silane, the polymer of the alkyl silane, or both, comprise a condensation product of monomeric units comprising {(OSi(R)₂[CH₂]ₘSi(R)₂}, wherein each R is independently selected from OCH₃ and OH, and m is from 3 to 34.

Aspect 123. The coated article of aspect 122, wherein R is OCH₃, and m is 8.

Aspect 124. The coated article of aspect 122, wherein R is OCH₃, and m is 6.

Aspect 125. The coated article of any one of aspects 122-124, wherein the condensation product further comprises monomeric units comprising {R″Si(OCH₃)₂}, {R″Si(OCH₃)}, {R″Si}, {R″Si(OCH₃)₂(OH)}, {R″Si(OCH₃)(OH)₂}, {R″Si(OH)₃}, or combinations thereof, wherein R″ is a (C5-C38) alkyl, and optionally, wherein at least a portion of the monomeric units are linked to the substrate.

Aspect 126. The coated article of aspect 125, wherein a ratio of the monomeric units comprising {(OSi(R)₂[CH₂]ₘSi(R)₂} to the monomeric units comprising {R″Si(OCH₃)₂}. {R″Si(OCH₃)}, {R″Si}, {R″Si(OCH₃)₂(OH)}, {R″Si(OCH₃)(OH)₂}, {R″Si(OH)₃}, or combinations thereof, is from 10:1 to 1:10.

Aspect 127. The coated article of aspect 125, wherein a ratio of the monomeric units comprising {(OSi(R)₂[CH₂]ₘSi(R)₂} to the monomeric units comprising {R″Si(OCH₃)₂}, {R″Si(OCH₃)}, {R″Si}, {R″Si(OCH₃)₂(OH)}, {R″Si(OCH₃)(OH)₂}, {R″Si(OH)₃}, or combinations thereof, is from 1:1 to 1:10.

Aspect 128. The coated article of any one of aspects 125-127, wherein the oligomer of the alkyl silane, the polymer of the alkyl silane, or both, comprise a condensation product of monomeric units comprising {(OSi(OCH₃)₂[CH₂]₈Si(OCH₃)₂} and monomeric units comprising {(CH₃)(CH₂)₁₇Si(OCH₃)}, {(CH₃)(CH₂)₁₇Si}, or combinations thereof.

Aspect 129. The coated article of aspect 128, wherein a ratio of the monomeric units comprising {(OSi(OCH₃)₂[CH₂]₈Si(OCH₃)₂} to the monomeric units comprising {(CH₃)(CH₂)₁₇Si(OCH₃)}, {(CH₃)(CH₂)₁₇Si}, or combinations thereof is from 10:1 to 1:10.

Aspect 130. The coated article of aspect 128, wherein a ratio of the monomeric units comprising {(OSi(OCH₃)₂[CH₂]₈Si(OCH₃)₂} to the monomeric units comprising {(CH₃)(CH₂)₁₇Si(OCH₃)}, {(CH₃)(CH₂)₁₇Si}, or combinations thereof is from 11:1 to 1:10.

Aspect 131. The coated article of any one of aspects 125-127, wherein the oligomer of the alkyl silane, the polymer of the alkyl silane, or both, comprise a condensation product of monomeric units comprising {(OSi(OCH₃)₂[CH₂]₆Si(OCH₃)₂} and monomeric units comprising {(CH₃)(CH₂)₁₇Si(OCH₃)}, {(CH₃)(CH₂)₁₇Si}, or combinations thereof.

Aspect 132. The coated article of aspect 131, wherein a ratio of the monomeric units comprising {(OSi(OCH₃)₂[CH₂]₆Si(OCH₃)₂} to the monomeric units comprising {(CH₃)(CH₂)₁₇Si(OCH₃)}, {(CH₃)(CH₂)₁₇Si}, or combinations thereof is from 10:1 to 1:10.

Aspect 133. The coated article of aspect 131, wherein a ratio of the monomeric units comprising {(OSi(OCH₃)₂[CH₂]₆Si(OCH₃)₂} to the monomeric units comprising {(CH₃)(CH₂)₁₇Si(OCH₃)}, {(CH₃)(CH₂)₁₇Si}, or combinations thereof is from 11:1 to 1:10.

Aspect 134. A method of forming a coated article comprising:
disposing an alkyl silane on a first major surface of a substrate, the alkyl silane comprising a C3-C34 alkyl group, and the alkyl silane comprising at least two reactive groups independently selected from a silane, a non-fluorine halogen, or combinations thereof; and
reacting the alkyl silane to form a fingerprint-hiding coating on the first major surface of the substrate,
wherein the fingerprint-hiding coating exhibits;
   a water contact angle from 90° to 120°;
   an oleic acid contact angle of 40° or less; and
   a coefficient of friction of the exterior surface is 0.25 or less.

Aspect 135. The method of aspect 134, wherein the disposing comprises spray coating the alkyl silane on the first major surface.

Aspect 136. The method of any one of aspects 134-135, wherein the reacting comprises heating the alkyl silane at a temperature of about 80° C. to about 250° C., for a period of time from about 10 minutes to about 8 hours.

Aspect 137. The method of any one of aspects 134-135, wherein the reacting comprises disposing the alkyl silane on the planarization layer at a temperature from about 20° C. to about 40° C., for a period of time from about 1 hour to about 24 hours.

Aspect 138. The method of any one of aspects 134-137, wherein two of the at least two reactive groups are located at opposite ends of the alkyl silane.

Aspect 139. The method of any one of aspects 134-138, wherein the alkyl silane comprises an alkyl trichlorosilane, an alkyl dichloromethoxy silane, an alkyl chlorodimethoxysilane, an alkyl dichloromethylsilane, an alkyl chlorodimethylsilane, an alkyl trimethoxysilane, an alkyl triethoxysilane, or combinations thereof.

Aspect 140. The method of any one of aspects 134-139, wherein the alkyl silane comprises an alkyl chlorodimethylsilane and an alkyl trimethoxysilane.

Aspect 141. The method of aspect 140, wherein the alkyl trimethoxysilane is octadecyl trimethoxysilane.

Aspect 142. The method of any one of aspects 139-141, wherein an amount of the alkyl trimethoxysilane as a wt % of a total amount of the alkyl silane is from about 1% to about 90%.

Aspect 143. The method of aspect 142, wherein the amount of the alkyl trimethoxysilane as a wt % of the total amount of the alkyl silane is from about 25% to about 75%.

Aspect 144. The method of any one of aspects 134-143, wherein the alkyl silane comprises 1,8-bis(chlorodimethylsilyl)ocatane, chloropropyltrimethoxysilane, octadecyl trimethoxysilane, or combinations thereof.

Aspect 145. The method of any one of aspects 134-143, wherein the alkyl silane comprises 1,8-bis(trimethoxysilyl)octane, 1,6-bis(trimethoxysilyl) hexane, octadecyl trimethoxysilane, or combinations thereof.

Aspect 146. The method of any one of aspects 134-145, wherein the alkyl silane is chlorine-free.

Aspect 147. The method of any one of aspects 134-146, wherein the alkyl silane comprises an alkyl trimethoxysilyl and an alkyl trimethoxysilane.

Aspect 148. The method of aspect 147, wherein the alkyl trimethoxysilane is octadecyl trimethoxysilane.

Aspect 149. The method of any one of aspects 147-148, wherein an amount of the alkyl trimethoxysilane as a wt % of a total amount of the alkyl silane is from about 1% to about 90%.

Aspect 150. The method of aspect 149, wherein the amount of the alkyl trimethoxysilane as a wt % of the total amount of the alkyl silane is from about 10% to about 50%.

Aspect 151. The method of any one of aspects 134-150 or 253-259 inclusive, wherein the alkyl silane further comprises a dimethylsilane with silanes at both ends of the dimethylsilane.

Aspect 152. The method of aspect 151, wherein the dimethylsilane is dichloro-tetramethyl-disiloxane.

Aspect 153. The method of any one of aspects 151-152, wherein an amount of the dimethylsilane as a wt % of a total amount of the alkyl silane is from about 1% to about 90%.

Aspect 154. The method of aspect 153, wherein the amount of the dimethylsilane as a wt % of the total amount of the alkyl silane is from about 25% to about 75%.

Aspect 155. The method of any one of aspects 134-146, wherein the alkyl silane consists of a single alkyl silane compound.

Aspect 156. The method of any one of aspects 134-155, wherein the disposing the alkyl silane comprises disposing a solution containing the alkyl silane, wherein a pH of the solution is from 6 to 8.

Aspect 157. The method of any one of aspects 134-156, wherein the fingerprint-hiding coating comprises an oligomer of the alkyl silane, a polymer of the alkyl silane, or both.

Aspect 158. The method of any one of aspects 134-157, wherein the fingerprint-hiding coating further comprises;
the alkyl silane is bonded to the substrate by a silane group, the alkyl silane is bonded to another part of the coated article by a silane group, or both;
a silane group of the alkyl silane is at a free end of the alkyl silane; or both.

Aspect 159. The method of any one of aspects 157-158, wherein the oligomer of the alkyl silane, the polymer of the alkyl silane, or both, comprise a dialkyl siloxane block.

Aspect 160. The method of any one of aspects 157-159, wherein monomeric units comprising the oligomer of the alkyl silane, monomeric units comprising the polymer of the alkyl silane, or both, are bonded together by a disiloxane group.

Aspect 161. The method of any one of aspects 157-160, wherein monomeric units comprising the oligomer of the alkyl silane, monomeric units comprising the polymer of the alkyl silane, or both, are bonded together by a dimethylsiloxane block.

Aspect 162. The method of any one of aspects 157-161, wherein the fingerprint-hiding coating comprises an oligomer of the alkyl silane, a polymer of the alkyl silane, or both, wherein the oligomer of the alkyl silane, the polymer of the alkyl silane, or both, comprise a structure {OSi(R′)₂[CH₂]ₘ[Si(R″)₂O]ₙSi(R′)₂[CH₂]ₚSi(R″)₂}_{q}R, wherein m and p are independently selected from 3 to 34, R′ and R″ are independently selected from CH₃ and CH₂CH₃, n is 1 or more, q is 1 or more, R is selected from a group consisting of a hydroxyl group, a chloro group, a bromo group, an alkyl silane, an alkoxide, or combinations thereof.

Aspect 163. The method of aspect 162, wherein R″ is CH₃.

Aspect 164. The method of any one of aspects 162-163, wherein, in the structure, at least one;
n is 1, and q is from 1 to 100; or
n is 1, m is 8, p is 8, and q is from 1 to 100.

Aspect 165. The method of any one of aspects 162-163, wherein, in the structure, at least one of;
n is 2, and q is from 1 to 100;
n is 2, m is 8, p is 8, and q is from 1 to 100;
n is 2 or more, and q is from 1 to 100; or
n is 2 or more, m is 8, p is 8, and q is from 1 to 100.

Aspect 166. The method of any one of aspects 157-161, wherein the fingerprint-hiding comprises an oligomer of the alkyl silane, a polymer of the alkyl silane, or both, wherein the oligomer of the alkyl silane, the polymer of the alkyl silane, or both, comprise a condensation product of monomeric units comprising {Si(R′)₂[CH₂]ₘSi(R′)₂O}, wherein each R′ is independently selected from CH₃ and CH₂CH₃, and m is from 3 to 34.

Aspect 167. The method of aspect 166, wherein R′ is CH₃.

Aspect 168. The method of aspect 166, wherein R′ is CH₃, and m is 8.

Aspect 169. The method of any of aspects 166-168 wherein the condensation product further comprises monomeric units comprising {{R″Si(OCH₃)₂}, {R″Si(OCH₃)}, {R″Si}, {R″Si(OCH₃)₂(OH)}, {R″Si(OCH₃)(OH)₂}, {R″Si(OH)₃}, or combinations thereof, wherein R″ is a (C5-C38) alkyl, and optionally, wherein at least a portion of the monomeric units are linked to the substrate.

Aspect 170. The method of aspect 169, wherein a ratio of the monomeric units comprising {Si(R′)₂[CH₂]ₘSi(R′)₂O} to the monomeric units comprising {{R″Si(OCH₃)₂}, {R″Si(OCH₃)}, {R″Si}, {R″Si(OCH₃)₂(OH)}, {R″Si(OCH₃)(OH)₂}, {R″Si(OH)₃}, or combinations thereof, is from 10:1 to 1:10.

Aspect 171. The method of any of aspects 169-170 wherein the oligomer of the alkyl silane, the polymer of the alkyl silane, or both, comprise a condensation product of monomeric units comprising {OSi(CH₃)₂[CH₂]₈Si(CH₃)₂} and monomeric units comprising {(CH₃)(CH₂)₁₇Si(OCH₃)}, {(CH₃)(CH₂)₁₇Si}, or combinations thereof.

Aspect 172. The method of aspect 171, wherein a ratio of the monomeric units comprising {OSi(CH₃)₂[CH₂]₈Si(CH₃)₂} to the monomeric units comprising {(CH₃)(CH₂)₁₇Si(OCH₃)₂}, {(CH₃)(CH₂)₁₇Si(OCH₃)}, {(CH₃)(CH₂)₁₇Si}, or combinations thereof is from 10:1 to 1:10.

Aspect 173. The method of any one of aspects 157-161, wherein the fingerprint-hiding coating comprises an oligomer of the alkyl silane, a polymer of the alkyl silane, or both, wherein the oligomer of the alkyl silane, the polymer of the alkyl silane, or both, comprise a structure {OSi(R)₂[CH₂]ₘ[Si(R)₂O]ₙSi(R)₂[CH₂]ₚSi(R)₂}_{q}R, wherein m and p are independently selected from 3 to 34, each R is independently selected from OCH₃, OH, and OSi(R′)₂[CH₂]_{m′}, m′ is independently selected from 3 to 34, n is 1 or more, q is 1 or more, and each R′ is independently selected from a group consisting of OCH₃, and OH.

Aspect 174. The method of aspect 173, wherein the alkyl silane is chlorine-free.

Aspect 175. The method of any of aspects 173-174, wherein R′ is OCH₃.

Aspect 176. The method of any of aspects 173-175, wherein, in the structure, at least one;
n is 1, and q is from 1 to 100; or
n is 1, m is 8, p is 8, and q is from 1 to 100.

Aspect 177. The method of any of aspects 173-175, wherein, in the structure, at least one;
n is 1, and q is from 1 to 100; or
n is 1, m is 6, p is 6, and q is from 1 to 100.

Aspect 178. The method of any of aspects 173-175, wherein, in the structure, at least one of;
n is 2, and q is from 1 to 100;
n is 2, m is 8, p is 8, and q is from 1 to 100;
n is 2, m is 6, p is 6, and q is from 1 to 100;
n is 2 or more, and q is from 1 to 100; or
n is 2 or more, m is 8, p is 8, and q is from 1 to 100; or
n is 2 or more, m is 6, p is 6, and q is from 1 to 100.

Aspect 179. The method of any one of aspects 157-161, wherein the fingerprint-hiding comprises an oligomer of the alkyl silane, a polymer of the alkyl silane, or both, wherein the oligomer of the alkyl silane, the polymer of the alkyl silane, or both, comprise a condensation product of monomeric units comprising {(OSi(R)₂[CH₂]ₘSi(R)₂}, wherein each R is independently selected from OCH₃ and OH, and m is from 3 to 34.

Aspect 180. The method of aspect 179, wherein R is OCH₃, and m is 8.

Aspect 181. The method of aspect 179, wherein R is OCH₃, and m is 6.

Aspect 182. The method of any one of aspects 179-181, wherein the condensation product further comprises monomeric units comprising {R″Si(OCH₃)₂}, {R″Si(OCH₃)}, {R″Si}, {R″Si(OCH₃)₂(OH)}, {R″Si(OCH₃)(OH)₂}, {R″Si(OH)₃}, or combinations thereof, wherein R″ is a (C5-C38) alkyl, and optionally, wherein at least a portion of the monomeric units are linked to the substrate.

Aspect 183. The method of aspect 182, wherein a ratio of the monomeric units comprising {(OSi(R)₂[CH₂]ₘSi(R)₂} to the monomeric units comprising {R″Si(OCH₃)₂}, {R″Si(OCH₃)}, {R″Si}, {R″Si(OCH₃)₂(OH)}, {R″Si(OCH₃)(OH)₂}, {R″Si(OH)₃}, or combinations thereof, is from 10:1 to 1:10.

Aspect 184. The method of aspect 182, wherein a ratio of the monomeric units comprising {(OSi(R)₂[CH₂]ₘSi(R)₂} to the monomeric units comprising {R″Si(OCH₃)₂}, {R″Si(OCH₃)}, {R″Si}, {R″Si(OCH₃)₂(OH)}, {R″Si(OCH₃)(OH)₂}, {R″Si(OH)₃}, or combinations thereof, is from 1:1 to 1:10.

Aspect 185. The method of any one of aspects 179-184, wherein the oligomer of the alkyl silane, the polymer of the alkyl silane, or both, comprise a condensation product of monomeric units comprising {(OSi(OCH₃)₂[CH₂]₈Si(OCH₃)₂} and monomeric units comprising {(CH₃)(CH₂)₁₇Si(OCH₃)}, {(CH₃)(CH₂)₁₇Si}, or combinations thereof.

Aspect 186. The method of aspect 185, wherein a ratio of the monomeric units comprising {(OSi(OCH₃)₂[CH₂]₈Si(OCH₃)₂} to the monomeric units comprising {(CH₃)(CH₂)₁₇Si(OCH₃)}, {(CH₃)(CH₂)₁₇Si}, or combinations thereof is from 10:1 to 1:10.

187. The method of aspect 185, wherein a ratio of the monomeric units comprising {(OSi(OCH₃)₂[CH₂]₈Si(OCH₃)₂} to the monomeric units comprising {(CH₃)(CH₂)₁₇Si(OCH₃)}, {(CH₃)(CH₂)₁₇Si}, or combinations thereof is from 1:1 to 1:10.

Aspect 188. The method of any one of aspects 179-184, wherein the oligomer of the alkyl silane, the polymer of the alkyl silane, or both, comprise a condensation product of monomeric units comprising {(OSi(OCH₃)₂[CH₂]₆Si(OCH₃)₂} and monomeric units comprising {(CH₃)(CH₂)₁₇Si(OCH₃)}, {(CH₃)(CH₂)₁₇Si}, or combinations thereof.

Aspect 189. The method of aspect 188, wherein a ratio of the monomeric units comprising {(OSi(OCH₃)₂[CH₂]₆Si(OCH₃)₂} to the monomeric comprising {(CH₃)(CH₂)₁₇Si(OCH₃)}, {(CH₃)(CH₂)₁₇Si}, or combinations thereof is from 10:1 to 1:10.

Aspect 190. The method of aspect 188, wherein a ratio of the monomeric units comprising {(OSi(OCH₃)₂[CH₂]₆Si(OCH₃)₂} to the monomeric units comprising {(CH₃)(CH₂)₁₇Si(OCH₃)}, {(CH₃)(CH₂)₁₇Si}, or combinations thereof is from 11:1 to 1:10.

Aspect 191. A method of forming a coated article comprising:
evaporating a functionalized polyhedral oligomeric silsesquioxane onto a first major surface of a substrate;
impinging an ion beam at the first major surface of the substrate, the impinging occurs in a chamber comprising a chamber pressure ranging from about 10-Pascal to about 1 Pascal, the ion beam is generated using a discharge current from about 0.25 Amps to about 1 Amp to form a planarization laver; and then
reacting material of the planarization layer with a alkyl silane to form a fingerprint-hiding coating, the alkyl silane comprising 3 or more carbons, wherein the silane comprises at least two reactive groups independently selected from a silane, a non-fluorine halogen, or combinations thereof,
wherein the fingerprint-hiding coating exhibits;
   a water contact angle from 90° to 120°;
   an oleic acid contact angle of 40° or less; and
   a coefficient of friction of the exterior surface is 0.25 or less.

Aspect 192. The method of aspect 191, wherein the functionalized polyhedral oligomeric silsesquioxane is at least partially functionalized by at least one of: an alkene comprising from 2 to 8 carbons, an alkane comprising from 1 to 8 carbons, or combinations thereof.

Aspect 193. The method of any one of aspects 191-192, wherein the evaporating the functionalized polyhedral oligomeric silsesquioxane and the impinging occur simultaneously.

Aspect 194. The method of any one of aspects 191-193, wherein the reacting comprises evaporating the alkyl silane at a temperature of about 80° C. to about 250° C., for a period of time from about 10 minutes to about 8 hours.

Aspect 195. The method of any one of aspects 191-194, wherein the reacting comprises disposing the alkyl silane on the planarization layer at a temperature from about 20° C. to about 40° C., for a period of time from about 1 hour to about 24 hours.

Aspect 196. The method of any one of aspects 191-195, wherein two of the at least two reactive groups are located at opposite ends of the alkyl silane.

Aspect 197. The method of any one of aspects 191-196, wherein the alkyl silane comprises an alkyl trichlorosilane, an alkyl dichloromethoxy silane, an alkyl chlorodimethoxysilane, an alkyl dichloromethylsilane, an alkyl chlorodimethylsilane, an alkyl trimethoxysilane, an alkyl triethoxysilane, or combinations thereof.

Aspect 198. The method of any one of aspects 191-197, wherein the alkyl silane comprises an alkyl chlorodimethylsilane and an alkyl trimethoxysilane.

Aspect 199. The method of aspect 199, wherein the alkyl trimethoxysilane is octadecyl trimethoxysilane.

Aspect 200. The method of any one of aspects 198-199, wherein an amount of the alkyl trimethoxysilane as a wt % of a total amount of the alkyl silane is from about 1% to about 90%.

Aspect 201. The method of aspect 200, wherein the amount of the alkyl trimethoxysilane as a wt % of the total amount of the alkyl silane is from about 25% to about 75%.

Aspect 202. The method of any one of aspects 191-201, wherein the alkyl silane comprises 1,8-bis(chlorodimethylsilyl)ocatane, chloropropyltrimethoxysilane, octadecyl trimethoxysilane, or combinations thereof.

Aspect 203. The method of any one of aspects 191-201, wherein the alkyl silane comprises 1,8-bis(trimethoxysilyl)octane, 1,6-bis(trimethoxysilyl) hexane, octadecyl trimethoxysilane, or combinations thereof.

Aspect 204. The method of any one of aspects 191-201, wherein the alkyl silane is chlorine-free.

Aspect 205. The method of any one of aspects 134-204, wherein the alkyl silane comprises an alkyl trimethoxysilyl and an alkyl trimethoxysilane.

Aspect 206. The method of aspect 205, wherein the alkyl trimethoxysilane is octadecyl trimethoxysilane.

Aspect 207. The method of any one of aspects 205-206, wherein an amount of the alkyl trimethoxysilane as a wt % of a total amount of the alkyl silane is from about 1% to about 90%.

Aspect 208. The method of aspect 207, wherein the amount of the alkyl trimethoxysilane as a wt % of the total amount of the alkyl silane is from about 10% to about 50%.

Aspect 209. The method of any one of aspects 191-208, wherein the alkyl silane further comprises a dimethylsilane with silanes at both ends of the dimethylsilane.

Aspect 210. The method of aspect 209, wherein the dimethylsilane is dichloro-tetramethyl-disiloxane.

Aspect 211. The method of any one of aspects 209-210, wherein an amount of the dimethylsilane as a wt % of a total amount of the alkyl silane is from about 1% to about 90%.

Aspect 212. The method of aspect 211, wherein the amount of the dimethylsilane as a wt % of the total amount of the alkyl silane is from about 25% to about 75%.

Aspect 213. The method of any one of aspects 191-204, wherein the alkyl silane consists of a single alkyl silane compound.

Aspect 214. The method of any one of aspects 191-213, wherein the disposing the alkyl silane comprises disposing a solution containing the alkyl silane, wherein a pH of the solution is from 6 to 8.

Aspect 215. The method of any one of aspects 191-214, wherein the planarization layer exhibiting at least one of;
from 50% to 90% of silicon atoms of the planarization layer are in a silica-like network;
a ratio of Si—O—Si bonds to Si atoms in the planarization layer is from about 2 to about 3; or
a molar ratio of hydrogen to silicon in the planarization layer is about 0.2 or more.

Aspect 216. The method of any one of aspects 191-215, wherein the fingerprint-hiding coating comprises an oligomer of the alkyl silane, a polymer of the alkyl silane, or both.

Aspect 217. The method of any one of aspects 119-216, wherein the fingerprint-hiding coating further comprises;
the alkyl silane is bonded to the planarization layer by a silane group;
a silane group of the alkyl silane is at a free end of the alkyl silane; or both.

Aspect 218. The method of any one of aspects 216-217, wherein the oligomer of the alkyl silane, the polymer of the alkyl silane, or both, comprise a dialkyl siloxane block.

Aspect 219. The method of any one of aspects 216-218, wherein monomeric units comprising the oligomer of the alkyl silane, monomeric units comprising the polymer of the alkyl silane, or both, are bonded together by a disiloxane group.

Aspect 220. The method of any one of aspects 216-219, wherein monomeric units comprising the oligomer of the alkyl silane, monomeric units comprising the polymer of the alkyl silane, or both, are bonded together by a dimethylsiloxane block.

Aspect 221. The method of any one of aspects 216-220, wherein the fingerprint-hiding coating comprises an oligomer of the alkyl silane, a polymer of the alkyl silane, or both, wherein the oligomer of the alkyl silane, the polymer of the alkyl silane, or both, comprise a structure {OSi(R′)₂[CH₂]ₘ[Si(R″)₂O]ₙSi(R′)₂[CH₂]ₚSi(R″)₂}_{q}R, wherein m and p are independently selected from 3 to 34, R′ and R″ are independently selected from CH₃ and CH₂CH₃, n is 1 or more, q is 1 or more, R is selected from a group consisting of a hydroxyl group, a chloro group, a bromo group, an alkyl silane, an alkoxide, or combinations thereof.

Aspect 222. The method of aspect 221, wherein R″ is CH₃.

Aspect 223. The method of any one of aspects 221-222, wherein, in the structure, at least one;
n is 1, and q is from 1 to 100; or
n is 1, m is 8, p is 8, and q is from 1 to 100.

Aspect 224. The method of any one of aspects 221-222, wherein, in the structure, at least one of;
n is 2, and q is from 1 to 100;
n is 2, m is 8, p is 8, and q is from 1 to 100;
n is 2 or more, and q is from 1 to 100; or
n is 2 or more, m is 8, p is 8, and q is from 1 to 100.

Aspect 225. The method of any one of aspects 216-220, wherein the fingerprint-hiding comprises an oligomer of the alkyl silane, a polymer of the alkyl silane, or both, wherein the oligomer of the alkyl silane, the polymer of the alkyl silane, or both, comprise a condensation product of monomeric units comprising {Si(R′)₂[CH₂]ₘSi(R′)₂O}, wherein each R′ is independently selected from CH₃ and CH₂CH₃, and m is from 3 to 34.

Aspect 226. The method of aspect 225, wherein R′ is CH₃.

Aspect 227. The method of aspect 225, wherein R′ is CH₃, and m is 8.

Aspect 228. The method of any of aspects 225-227, wherein the condensation product further comprises monomeric units comprising {{R″Si(OCH₃)₂}, {R″Si(OCH₃)}, {R″Si}, {R″Si(OCH₃)₂(OH)}, {R″Si(OCH₃)(OH)₂}, {R″Si(OH)₃}, or combinations thereof, wherein R″ is a (C5-C38) alkyl, and optionally, wherein at least a portion of the monomeric units are linked to the substrate.

Aspect 229. The method of aspect 228, wherein a ratio of the monomeric units comprising {Si(R′)₂[CH₂]ₘSi(R′)₂O} to the monomeric units comprising {R″Si(OCH₃)₂}, {R″Si(OCH₃)}, {R″Si}, {R″Si(OCH₃)₂(OH)}, {R″Si(OCH₃)(OH)₂}, {R″Si(OH)₃}, or combinations thereof, is from 10:1 to 1:10.

Aspect 230. The method of any of aspects 228-229, wherein the oligomer of the alkyl silane, the polymer of the alkyl silane, or both, comprise a condensation product of monomeric units comprising {OSi(CH₃)₂[CH₂]₈Si(CH₃)₂} and monomeric units comprising {(CH₃)(CH₂)₁₇Si(OCH₃)}, {(CH₃)(CH₂)₁₇Si}, or combinations thereof

Aspect 231. The method of aspect 230, wherein a ratio of the monomeric units comprising {OSi(CH₃)₂[CH₂]₈Si(CH₃)₂} to the monomeric units comprising {(CH₃)(CH₂)₁₇Si(OCH₃)₂}, {(CH₃)(CH₂)₁₇Si(OCH₃)}, {(CH₃)(CH₂)₁₇Si}, or combinations thereof is from 10:1 to 1:10.

Aspect 232. The method of any one of aspects 216-220, wherein the fingerprint-hiding coating comprises an oligomer of the alkyl silane, a polymer of the alkyl silane, or both, wherein the oligomer of the alkyl silane, the polymer of the alkyl silane, or both, comprise a structure {OSi(R)₂[CH₂]ₘ[Si(R)₂O]ₙSi(R)₂[CH₂]ₚSi(R)₂}_{q}R, wherein m and p are independently selected from 3 to 34, each R is independently selected from OCH₃, OH, and OSi(R′)₂[CH₂]_{m′}, m′ is independently selected from 3 to 34, n is 1 or more, q is 1 or more, and each R′ is independently selected from a group consisting of OCH₃, and OH.

Aspect 233. The method of aspect 232, wherein the alkyl silane is chlorine-free.

Aspect 234. The method of any of aspects 232-233, wherein R′ is OCH₃.

Aspect 235. The method of any one of aspects 232-234, wherein, in the structure, at least one;
n is 1, and q is from 1 to 100; or
n is 1, m is 8, p is 8, and q is from 1 to 100.

Aspect 236. The method of any one of aspects 232-234, wherein, in the structure, at least one;
n is 1, and q is from 1 to 100; or
n is 1, m is 6, p is 6, and q is from 1 to 100.

Aspect 237. The method of any one of aspects 232-234, wherein, in the structure, at least one of;
n is 2, and q is from 1 to 100;
n is 2, m is 8, p is 8, and q is from 1 to 100;
n is 2, m is 6, p is 6, and q is from 1 to 100;
n is 2 or more, and q is from 1 to 100;
n is 2 or more, m is 8, p is 8, and q is from 1 to 100; or
n is 2 or more, m is 6, p is 6, and q is from 1 to 100.

Aspect 238. The method of any one of aspects 216-220, wherein the fingerprint-hiding comprises an oligomer of the alkyl silane, a polymer of the alkyl silane, or both, wherein the oligomer of the alkyl silane, the polymer of the alkyl silane, or both, comprise a condensation product of monomeric units comprising {(OSi(R)₂[CH₂]ₘSi(R)₂}, wherein each R is independently selected from OCH₃ and OH, and m is from 3 to 34.

Aspect 239. The method of aspect 238, wherein R is OCH₃, and m is 8.

Aspect 240. The method of aspect 238, wherein R is OCH₃, and m is 6.

Aspect 241. The method of any one of aspects 238-240, wherein the condensation product further comprises monomeric units comprising {R″Si(OCH₃)₂}, {R″Si(OCH₃)}, {R″Si}, {R″Si(OCH₃)₂(OH)}, {R″Si(OCH₃)(OH)₂}, {R″Si(OH)₃}, or combinations thereof, wherein R″ is a (C5-C38) alkyl, and optionally, wherein at least a portion of the monomeric units are linked to the substrate.

Aspect 242. The method of aspect 241, wherein a ratio of the monomeric units comprising {(OSi(R)₂[CH₂]ₘSi(R)₂} to the monomeric units comprising {R″Si(OCH₃)₂}, {R″Si(OCH₃)}, {R″Si}, {R″Si(OCH₃)₂(OH)}, {R″Si(OCH₃)(OH)₂}, {R″Si(OH)₃}, or combinations thereof, is from 10:1 to 1:10.

Aspect 243. The method of aspect 241, wherein a ratio of the monomeric units comprising {(OSi(R)₂[CH₂]ₘSi(R)₂} to the monomeric units comprising {R″Si(OCH₃)₂}, {R″Si(OCH₃)}, {R″Si}, {R″Si(OCH₃)₂(OH)}, {R″Si(OCH₃)(OH)₂}, {R″Si(OH)₃}, or combinations thereof, is from 1:1 to 1:10.

Aspect 244. The method of any one of aspects 238-243, wherein the oligomer of the alkyl silane, the polymer of the alkyl silane, or both, comprise a condensation product of monomeric units comprising {(OSi(OCH₃)₂[CH₂]₈Si(OCH₃)₂} and monomeric units comprising {(CH₃)(CH₂)₁₇Si(OCH₃)}, {(CH₃)(CH₂)₁₇Si}, or combinations thereof.

Aspect 245. The method of aspect 244, wherein a ratio of the monomeric units comprising {(OSi(OCH₃)₂[CH₂]₈Si(OCH₃)₂} to the monomeric units comprising {(CH₃)(CH₂)₁₇Si(OCH₃)}, {(CH₃)(CH₂)₁₇Si}, or combinations thereof is from 10:1 to 1:10.

Aspect 246. The method of aspect 244, wherein a ratio of the monomeric units comprising {(OSi(OCH₃)₂[CH₂]₈Si(OCH₃)₂} to the monomeric units comprising {(CH₃)(CH₂)₁₇Si(OCH₃)}, {(CH₃)(CH₂)₁₇Si}, or combinations thereof is from 1:1 to 1:10.

Aspect 247. The method of any one of aspects 238-243 wherein the oligomer of the alkyl silane, the polymer of the alkyl silane, or both, comprise a condensation product of monomeric units comprising {(OSi(OCH₃)₂[CH₂]₆Si(OCH₃)₂} and monomeric units comprising {(CH₃)(CH₂)₁₇Si(OCH₃)}, {(CH₃)(CH₂)₁₇Si}, or combinations thereof.

Aspect 248. The method of aspect 247, wherein a ratio of the monomeric units comprising {(OSi(OCH₃)₂[CH₂]₆Si(OCH₃)₂} to the monomeric units comprising {(CH₃)(CH₂)₁₇Si(OCH₃)}, {(CH₃)(CH₂)₁₇Si}, or combinations thereof is from 10:1 to 1:10.

Aspect 249. The method of aspect 247, wherein a ratio of the monomeric units comprising {(OSi(OCH₃)₂[CH₂]₆Si(OCH₃)₂} to the monomeric units comprising {(CH₃)(CH₂)₁₇Si(OCH₃)}, {(CH₃)(CH₂)₁₇Si}, or combinations thereof is from 10:1 to 1:10.

Aspect 250. The coated article of any one of aspects 6-14, wherein R is selected from a methoxy group, an ethoxy group, a hydroxy group, or combinations thereof.

Aspect 251. The coated article of any one of aspects 57-60, wherein R is selected from a methoxy group, an ethoxy group, a hydroxy group, or combinations thereof.

Aspect 252. The coated article of any one of aspects 96-101, wherein R is selected from a methoxy group, an ethoxy group, a hydroxy group, or combinations thereof.

Aspect 253. The method of any one of aspects 134-138, wherein the alkyl silane comprises an alkyl trichlorosilane, an alkyl dichloromethoxy silane, an alkyl chlorodimethoxysilane, an alkyl dichloromethylsilane, an alkyl chlorodimethylsilane, an alkyl trimethoxysilane, an alkyl triethoxysilane, an alkyl dimethylmethoxysilane, an alkyl dimethylethoxysilane or combinations thereof.

Aspect 254. The method of any one of aspects 134-139, wherein the alkyl silane comprises an alkyl dimethylmethoxysilane and an alkyl trimethoxysilane.

Aspect 255. The method of any one of aspects 253-254, wherein the alkyl trimethoxysilane is octadecyl trimethoxysilane.

Aspect 256. The method of any one of aspects 253-255, wherein an amount of the alkyl trimethoxysilane as a wt % of a total amount of the alkyl silane is from about 1% to about 90%.

Aspect 257. The method of aspect 256, wherein the amount of the alkyl trimethoxysilane as a wt % of the total amount of the alkyl silane is from about 25% to about 75%.

Aspect 258. The method of any one of aspects 134-143 or 253-257 inclusive, wherein the alkyl silane comprises 1,8-bis(dimethylmethoxysilyl)octane, octadecyl trimethoxysilane, or combinations thereof.

Aspect 259. The method of any one of aspects 253-258, wherein the alkyl silane is chlorine-free.

Aspect 260. The method of any one of aspects 191-196, wherein the alkyl silane comprises an alkyl trichlorosilane, an alkyl dichloromethoxy silane, an alkyl chlorodimethoxysilane, an alkyl dichloromethylsilane, an alkyl chlorodimethylsilane, an alkyl trimethoxysilane, an alkyl triethoxysilane, an alkyl dimethylmethoxysilane, an alkyl dimethylethoxysilane or combinations thereof.

Aspect 261. The method of any one of aspects 191-196 wherein the alkyl silane comprises an alkyl dimethylmethoxysilane and an alkyl trimethoxysilane.

Aspect 262. The method of any one of aspects 260-261, wherein the alkyl trimethoxysilane is octadecyl trimethoxysilane.

Aspect 263. The method of any one of aspects 261-262, wherein an amount of the alkyl trimethoxysilane as a wt % of a total amount of the alkyl silane is from about 1% to about 90%.

Aspect 264. The method of aspect 263, wherein the amount of the alkyl trimethoxysilane as a wt % of the total amount of the alkyl silane is from about 25% to about 75%.

Aspect 265. The method of any one of aspects 191-201 or 260-264 inclusive, wherein the alkyl silane comprises 1,8-bis(dimethylmethoxysilyl)octane, octadecyl trimethoxysilane, or combinations thereof.

Aspect 266. The method of any one of aspects 221-231, wherein R is selected from a methoxy group, an ethoxy group, a hydroxy group, or combinations thereof.

Aspect 267. The method of any one of aspects 221-231, wherein R is selected from a methoxy group, an ethoxy group, or combinations thereof.

Aspect 268. The method of any one of aspects 221-231, wherein R is a methoxy group.

Aspect 269. The coated article of any one of aspect 1-5, wherein the fingerprint-hiding coating comprises an oligomer of an alkyl silane, a polymer of the alkyl silane, or both, wherein the oligomer of the alkyl silane, the polymer of the alkyl silane, or both, comprise a structure {OSi(R′)₂[CH₂]ₘ[Si(R″)₂O]ₙSi(R′)₂[CH₂]ₚSi(R″)₂}_{q}R, wherein m and p are independently selected from 3 to 34, R′ and R″ are independently selected from CH₃ and CH₂CH₃, n is 1 or more, q is 1 or more, R is selected from a group consisting of a hydroxyl group, a chloro group, a bromo group, an alkyl silane, an alkoxide, or combinations thereof.

Aspect 270. The coated article of any one of aspects 1-5 or 269 inclusive, wherein the fingerprint-hiding coating comprises an oligomer of the alkyl silane, a polymer of the alkyl silane, or both, wherein the oligomer of the alkyl silane, the polymer of the alkyl silane, or both, comprise a condensation product of monomeric units comprising {Si(R′)₂[CH₂]ₘSi(R′)₂O}, wherein each R′ is independently selected from CH₃ and CH₂CH₃, and m is from 3 to 34, and monomeric units comprising {R⁴Si(OCH₃)₂}, {R⁴Si(OCH₃)}, {R⁴Si}, {R⁴Si(OCH₃)₂(OH)}, {R⁴Si(OCH₃)(OH)₂}, {R⁴Si(OH)₃}, or combinations thereof, wherein R⁴ is a (C5-C38) alkyl; optionally, wherein at least a portion of the monomeric units are linked to the substrate; and wherein a ratio of the monomeric units comprising {Si(R′)₂[CH₂]ₘSi(R′)₂O} to the monomeric units comprising {R⁴Si(OCH₃)₂}, {R⁴Si(OCH₃)}, {R⁴Si}, {R⁴Si(OCH₃)₂(OH)}, {R⁴Si(OCH₃)(OH)₂}, {R⁴Si(OH)₃}, or combinations thereof, is 10:1 to 1:10.

Aspect 271. The coated article of any one of aspects 1-6 or 269-270 inclusive, wherein the fingerprint-hiding coating comprises an oligomer of the alkyl silane, a polymer of the alkyl silane, or both, wherein the oligomer of the alkyl silane, the polymer of the alkyl silane, or both, comprise a condensation product of monomeric units comprising {OSi(CH₃)₂[CH₂]₈Si(CH₃)₂} and monomeric units comprising {(CH₃)(CH₂)₁₇Si(OCH₃)}. {(CH₃)(CH₂)₁₇Si}, or combinations thereof; and wherein a ratio of the monomeric units comprising {OSi(CH₃)₂[CH₂]₈Si(CH₃)₂} to the monomeric units comprising {(CH₃)(CH₂)₁₇Si(OCH₃)}, {(CH₃)(CH₂)₁₇Si}, or combinations thereof is 10:1 to 1:10.

Aspect 272. The coated article of any one of aspects 1-271, wherein the fingerprint-hiding coating exhibits at least one of: a voltage of about 15 Volts or less in a Tribocharging test; or a voltage difference between a peripheral contact region and a center contact region of about 5 Volts or less in the Tribocharging test.

Aspect 273. The coated article of any one of aspects 1-272, wherein when a simulated fingerprint is applied to the fingerprint-hiding coating in a Simulated Fingerprint Test, the fingerprint-hiding coating exhibits at least one of: an effective diameter of droplets of the simulated fingerprint of 10 μm or more: a mean height of droplets of the simulated fingerprint on the exterior surface of 0.15 μm or less; or a spherical cap radius of droplets of the simulated fingerprint of 40 μm or more.

Aspect 274. The coated article of any one of aspects 1-273, wherein when a simulated fingerprint is applied to the fingerprint-hiding coating in a Simulated Fingerprint Test, the fingerprint-hiding coating exhibits: a core material value Vmc of a droplet of the simulated fingerprint of 0.10 μm³/μm² or more between areal material ratios of 10% and 90%.

Aspect 275. The coated article of aspect 274, wherein the fingerprint-hiding coating exhibits at least one of: a ratio of a volume of the droplet to an area of the droplet is 0.78 μm³/μm² or less: a ratio of a height of the droplet to the area of the droplet is 0.005 μm/μm² or less: a total area of the simulated fingerprint over the exterior surface of 150,000 μm² or more: a haze of 8% or less with the simulated fingerprint applied to the fingerprint-hiding coating in the Simulated Fingerprint Test: a center of a sphere modeled on the droplet of the simulated fingerprint is located greater than 30 μm from the exterior surface of the fingerprint-hiding coating: a mean gray level is 150 or less as measured in a Gray Level Test of coated article with the simulated fingerprint applied to the fingerprint-hiding coating in the Simulated Fingerprint Test; or a normalized gray level is 2.0 or less as measured in a Normalized Gray Level Test of coated article with the simulated fingerprint applied to the fingerprint-hiding coating in the Simulated Fingerprint Test.

Aspect 276. The coated article of any one of aspects 1-275, wherein the fingerprint-hiding coating comprises a thickness from 1 nanometer to 75 nanometers.

Aspect 277. The coated article of any one of aspects 1-276, wherein the fingerprint-hiding coating exhibits at least one of: a cheesecloth-abraded water contact angle of about 80° or more after being subjected to 200,000 cycles of in a Cheesecloth Abrasion Test; or a rubber-abraded water contact angle of about 80° or more after being abraded for 3,000 cycles in a Rubber Abrasion Test.

Aspect 278. The coated article of any one of aspects 1-277, further comprising a planarization layer positioned between the substrate and the fingerprint-hiding coating, the fingerprint-hiding coating disposed on the planarization layer, the planarization layer exhibiting at least one of: from 50% to 90% of silicon atoms of the planarization layer are in a silica-like network: a molar ratio of hydrogen to silicon in the planarization layer is about 0.2 or more; or a refractive index ranging from 1.37 to 1.55.

Aspect 279. The coated article of aspect 278, wherein the planarization layer exhibits at least one of: an abraded water contact angle of about 80° or more after being abraded for 2,000 cycles in a Steel Wool Abrasion test: a cheesecloth-abraded water contact angle of about 80° or more after being subjected to 200,000 cycles of in a Cheesecloth Abrasion Test; or a rubber-abraded water contact angle of about 80° or more after being abraded for 3,000 cycles in a Rubber Abrasion Test.

Aspect 280. The coated article of any one of aspects 1-279, further comprising at least one of: an anti-reflective coating positioned between the fingerprint-hiding coating and the substrate; or a gradient coating comprising a refractive index gradient positioned between the fingerprint-hiding coating and the substrate.

Aspect 281. The coated article of any one of aspects 1-280, wherein the substrate is a metal, glass, glass ceramic, or polymer substrate.

Aspect 282. The coated article of any one of aspects 1-281, wherein the fingerprint-hiding coating is substantially free of halogens.

Aspect 283. A coated article comprising: a substrate comprising a first major surface; and a fingerprint-hiding coating disposed over the first major surface, the fingerprint-hiding coating comprising an exterior surface of the coated article, wherein: the fingerprint-hiding coating is fluorine-free, the fingerprint-hiding coating is substantially free of halogens and comprises an oligomer of the alkyl silane, a polymer of the alkyl silane, or both, wherein the oligomer of the alkyl silane, the polymer of the alkyl silane, or both, comprise a structure {OSi(R′)₂[CH₂]ₘ[Si(R″)₂O]ₙSi(R′)₂[CH₂]ₚSi(R″)₂}_{q}R, wherein m and p are independently selected from 3 to 34, R′ and R″ are independently selected from CH₃ and CH₂CH₃, n is 1 or more, q is 1 or more, R is selected from a group consisting of a hydroxyl group, a chloro group, a bromo group, an alkyl silane, an alkoxide, or combinations thereof.

Aspect 284. A coated article comprising: a substrate comprising a first major surface: a planarization layer disposed over the first major surface, the planarization layer comprising a thickness between a first surface area and a second surface area opposite the first surface area from about 10 nanometers to about 600 nanometers, the second surface area facing the first major surface; and a fingerprint-hiding coating disposed on the first surface area of the planarization layer, the fingerprint-hiding coating comprising an exterior surface of the coated article, wherein: the fingerprint-hiding coating is fluorine-free: the fingerprint-hiding coating is substantially free of halogens and comprises an oligomer of the alkyl silane, a polymer of the alkyl silane, or both, wherein the oligomer of the alkyl silane, the polymer of the alkyl silane, or both, comprise a structure {OSi(R′)₂[CH₂]ₘ[Si(R″)₂O]ₙSi(R′)₂[CH₂]ₚSi(R″)₂}_{q}R, wherein m and p are independently selected from 3 to 34, R′ and R″ are independently selected from CH₃ and CH₂CH₃, n is 1 or more, q is 1 or more, R is selected from a group consisting of a hydroxyl group, a chloro group, a bromo group, an alkyl silane, an alkoxide, or combinations thereof.

### BRIEF DESCRIPTION OF THE DRAWINGS

The above and other features and advantages of aspects of the present disclosure are better understood when the following detailed description is read with reference to the accompanying drawings, in which;

FIGS. 1, 2A, 2B, and 2C are schematic views of exemplary coated articles according to aspects;

FIG. 3 is a schematic plan view of an example consumer electronic device according to aspects;

FIG. 4 is a schematic perspective view of the example consumer electronic device of FIG. 3;

FIG. 5 schematically illustrates a functionalized polyhedral oligomeric silsesquioxane (POSS) compound;

FIG. 6 schematically illustrates a reaction of polysilazane (PHPS);

FIGS. 7-8 are flow charts illustrating example methods of making coated articles in accordance with aspects of the disclosure;

FIG. 9 schematically illustrates a step(s) in methods of making a coated article comprising evaporating a functionalized POSS and impinging an ion beam on a first major surface of a substrate;

FIG. 10 schematically illustrates a step in methods of making a coated article comprising reacting material at the first major surface with an alkyl silane;

FIG. 11 schematically illustrates a step in methods of making a coated article comprising disposing a solution over a first major surface of a substrate;

FIG. 12 schematically illustrates a step in methods of making a coated article comprising heating the solution on the first major surface;

FIG. 13 schematically illustrates a step in methods of making a coated article comprising spraying an alkyl silane and reacting the alkyl silane;

FIG. 14 schematically illustrates simulated fingerprints applied to Examples 1-2 and Comparative Examples XX-YY;

FIG. 15 schematically illustrates the results of cleaning simulated fingerprints applied to Example 1 and Comparative Examples YY-ZZ;

FIG. 16 schematically illustrates (a) simulated fingerprints applied to Examples 1-2 and Comparative Examples XX-YY and (b) a distribution of droplet sizes associated with the simulated fingerprint as measured by white light interferometry with the vertical axis (i.e., y-axis) and horizontal axis (i.e., x-axis) corresponding to physical locations in μm;

FIGS. 17A-17H shows chemical structure for alkyl silane compounds used to form Examples 1-2, Comparative Example EEE, Comparative Example XX, and Examples 46-71;

FIG. 18A shows a polymeric structure of a surface-modifying layer in accordance with aspects of the disclosure;

FIG. 18B shows a polymeric structure of a surface-modifying layer in accordance with aspects of the disclosure;

FIG. 18C shows a polymeric structure of a surface-modifying layer in accordance with aspects of the disclosure;

FIG. 19A-19C shows spatial plots of water contact angle for Examples 1-2 and Comparative Example XX, respectively, with the vertical axis (i.e., y-axis) and horizontal axis (i.e., x-axis) corresponding to physical locations in millimeters;

FIG. 20 shows mean gray level on the vertical axis (i.e., y-axis) as a function of oleic acid contact angle in degrees on the horizontal axis (i.e., x-axis) for Examples 1-2 and Comparative Examples XX-YY;

FIG. 21 shows haze in % on the vertical axis (i.e., y-axis) as a function of oleic acid contact angle in degrees on the horizontal axis (i.e., x-axis) for Examples 1-2 and Comparative Examples XX-YY;

FIG. 22 shows mean height of droplets of the artificial fingerprint in μm on the vertical axis (i.e., y-axis) as a function of oleic acid contact angle in degrees on the horizontal axis (i.e., x-axis) for Examples 1-2 and Comparative Examples XX-YY;

FIG. 23 shows an average ratio of mean height to area of droplets of the artificial fingerprint (in μm/μm² or μm⁻¹) on the vertical axis (i.e., y-axis) as a function of oleic acid contact angle in degrees on the horizontal axis (i.e., x-axis) for Examples 1-2 and Comparative Examples XX-YY;

FIG. 24 shows a mean spherical cap radius of droplets of the artificial fingerprint in μm on the vertical axis (i.e., y-axis) as a function of oleic acid contact angle in degrees on the horizontal axis (i.e., x-axis) for Examples 1-2 and Comparative Examples XX-YY;

FIG. 25 shows a total area of the droplets of the artificial fingerprint in μm² on the vertical axis (i.e., y-axis) as a function of oleic acid contact angle in degrees on the horizontal axis (i.e., x-axis) for Examples 1-2 and Comparative Examples XX-YY;

FIG. 26 shows an average ratio of a volume of a droplet of the artificial fingerprint to an area of the droplet (in μm³/μm² or μm) on the vertical axis (i.e. y-axis) as a function of oleic acid contact angle in degrees on the horizontal axis (i.e., x-axis) for Examples 1-2 and Comparative Examples XX-YY; and

FIG. 27 shows haze in % on the vertical axis (i.e., y-axis) as a function of mean gray level on the horizontal axis (i.e., x-axis) for Examples 1-2 and Comparative Examples XX-YY;

FIG. 28 schematically illustrates simulated fingerprints applied to Examples 3-8 and Comparative Examples DD-GG;

FIG. 29 schematically illustrates the Tribocharging Test;

FIG. 30 schematically illustrates voltages as contours with the vertical axis (i.e., y-axis) and horizontal axis (i.e., x-axis) corresponding to physical locations inside region 2911 of FIG. 29;

FIG. 31 schematically illustrates tribocharging voltages for Example 8 and Comparative Examples AA and XX—YY where the vertical axis (i.e., y-axis) corresponds to voltage in Volts;

FIGS. 32-33 schematically illustrate tribocharging voltages in terms of Volts on the vertical axis (i.e., y-axis) as a function of time in seconds after the Tribocharging Test is complete on the horizontal axis (i.e., x-axis);

FIG. 34 schematically illustrates molar ratios of hydrogen to silicon (vertical axis-y-axis) as measured by dynamic secondary-ion mass spectrometry (D-SIMS) for Examples 35-44 and Comparative Examples JJ-KK; and

FIGS. 35, 36A, 36B, and 36C are schematic views of exemplary coated articles according to aspects;

FIG. 37 shows static water contact angle in degrees on the vertical axis (i.e., y-axis) as a function of rubber abrasion test cycles on the horizontal axis (i.e., x-axis) for Example 46-53;

FIG. 38 schematically illustrates simulated fingerprints applied to Examples 46-63;

FIG. 39 shows normalized gray level on the vertical axis (i.e., y-axis) as a function of 1,8-bis(chlorodimethylsilyl)octane (BISCO) precursor volume percent relative to a total amount of BISCO and octadecyl trimethoxysilane on the horizontal axis (i.e., x-axis) for Examples 46-53;

FIG. 40 schematically illustrates simulated fingerprints applied to Examples 54-57;

FIG. 41 shows static water contact angle in degrees on the vertical axis (i.e., y-axis) as a function of rubber abrasion test cycles on the horizontal axis (i.e., x-axis) to Examples 54-57;

FIG. 42 schematically illustrates simulated fingerprints applied to Examples 58-61;

FIG. 43 shows static water contact angle in degrees on the vertical axis (i.e., y-axis) as a function of rubber abrasion test cycles on the horizontal axis (i.e., x-axis) for Examples 58-61;

FIG. 44 shows normalized gray level of a human fingerprint on the vertical axis (i.e., y-axis) as a function of the number of wipes on the horizontal axis (i.e., x-axis) for Example 54 before and after capping treatment;

FIG. 45 schematically depicts a positive ion Time-of-Flight Secondary Ion Mass Spectrometry (TOF-SIMS) spectrum with intensity on the vertical axis (i.e., y-axis) as a function of mass-to-charge ratio (m/z) for Example 46;

FIG. 46 schematically depicts a positive ion Time-of-Flight Secondary Ion Mass Spectrometry (TOF-SIMS) spectra with intensity on the vertical axis (i.e., y-axis) as a function of mass-to-charge ratio (m/z) for polydimethylsiloxane (PDMS);

FIG. 47 schematically depicts a positive ion Time-of-Flight Secondary Ion Mass Spectrometry (TOF-SIMS) spectrum with intensity on the vertical axis (i.e., y-axis) as a function of mass-to-charge ratio (m/z) for Example 54;

FIG. 48 schematically depicts a Time-of-Flight Secondary Ion Mass Spectrometry (TOF-SIMS) spectrum with intensity on the vertical axis (i.e., y-axis) as a function of mass-to-charge ratio (m/z) for octadecyl trimethoxysilane (OTS).

FIG. 49 schematically depicts TOF-SIMS spatial plots at various mass-to-charge ratios (m/z) of Example 49 (BISCO:OTS of 50:50);

FIG. 50 schematically depicts TOF-SIMS spatial plots of green/blue overlay for C₂H₅⁺ and Si₂C₄H₁₃O⁺ of Examples 49-51 (BISCO:OTS of 50:50, 40:60, and 30:70);

FIG. 51 schematically depicts TOF-SIMS spatial plots at regions of interest for BISCO and OTS of Example 49 (BISCO:OTS of 50:50);

FIG. 52 schematically depicts positive ion Time-of-Flight Secondary Ion Mass Spectrometry (TOF-SIMS) spectra with intensity on the vertical axis (i.e., y-axis) as a function of mass-to-charge ratio (m/z) for the BISCO region of interest of FIG. 51, the OTS region of interest of FIG. 51, a pure BISCO reference, and a pure OTS reference; and

FIG. 53 shows an intensity of a Si₂C₄H₁₃O⁺/C₂H₅⁺ ratio on the vertical axis (i.e., y-axis), as measured in FIG. 52 for the BISCO region of interest of FIG. 51, the OTS region of interest of FIG. 51, the pure BISCO reference, and the pure OTS reference;

FIG. 54 shows static water contact angle in degrees on the vertical axis (i.e., y-axis) as a function of rubber abrasion test cycles on the horizontal axis (i.e., x-axis) for Examples 62-63;

FIG. 55 shows static water contact angle in degrees on the vertical axis (i.e., y-axis) as a function of rubber abrasion test cycles on the horizontal axis (i.e., x-axis) for Examples 64-65;

FIG. 56 shows static water contact angle in degrees on the vertical axis (i.e., y-axis) as a function of rubber abrasion test cycles on the horizontal axis (i.e., x-axis) for Examples 66 and 68;

FIG. 57 schematically illustrates simulated fingerprints applied to Examples 66-67; and

FIG. 58 schematically illustrates simulated fingerprints applied to Examples 50, 56, 62, 64, and 67.

Throughout the disclosure, the drawings are used to emphasize certain aspects. As such, it should not be assumed that the relative size of different regions, portions, and substrates shown in the drawings are proportional to its actual relative size, unless explicitly indicated otherwise.

### DETAILED DESCRIPTION

Aspects will now be described more fully hereinafter with reference to the accompanying drawings in which example aspects are shown. Whenever possible, the same reference numerals are used throughout the drawings to refer to the same or like parts.

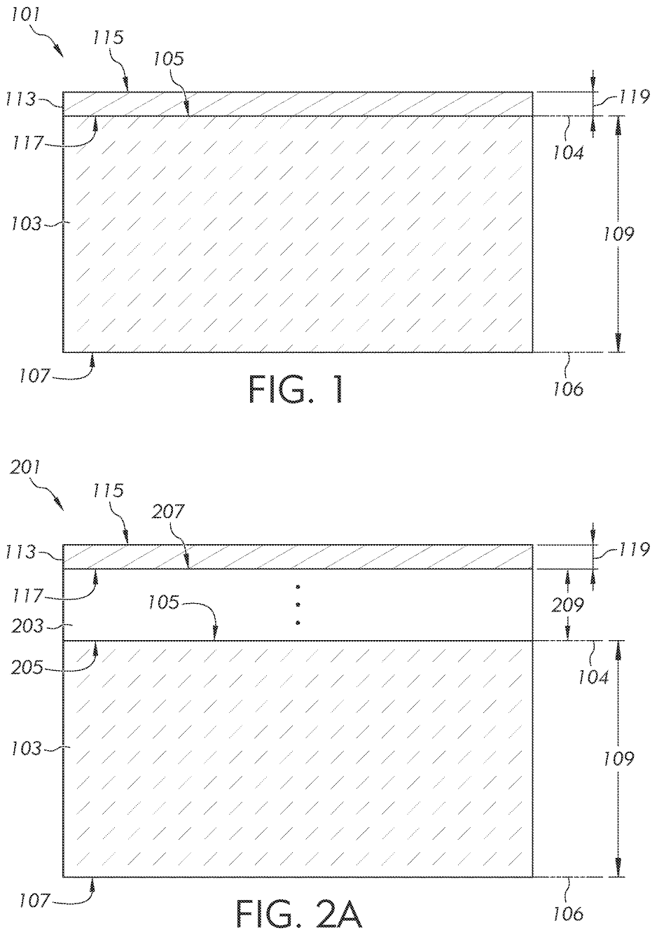

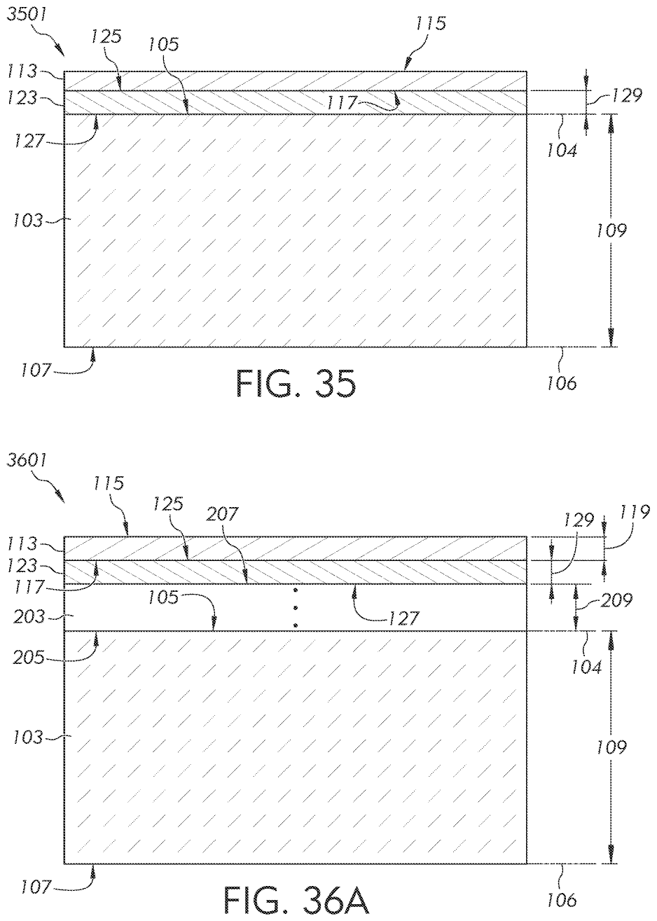

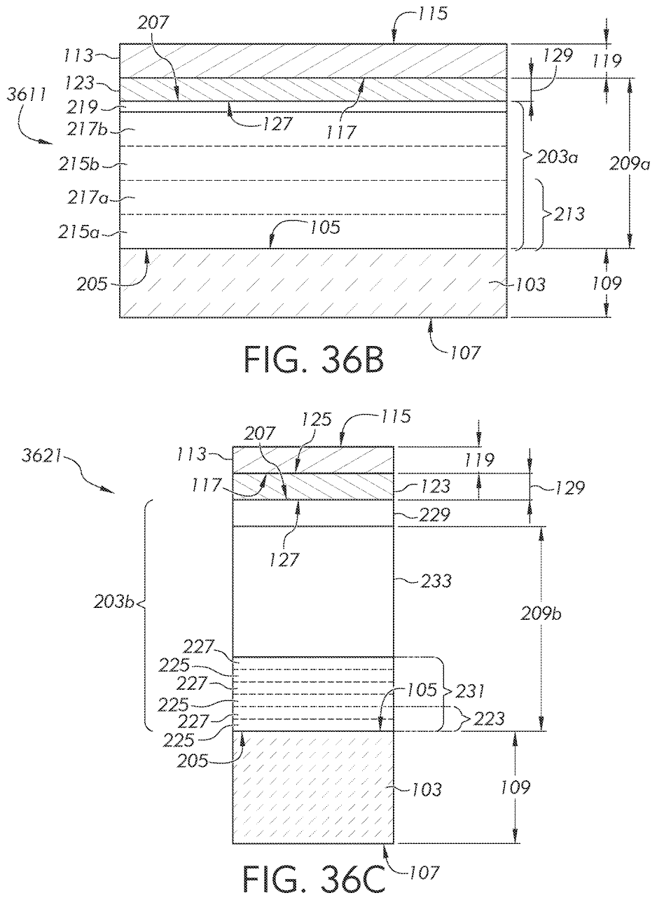

FIGS. 1, 2A-2C, 35, and 36A-36C illustrate views of a coated article 101, 201, 211, 221, 3501, 3601, 3611, or 3621 comprising a surface-modifying layer 113 (e.g., fingerprint-hiding coating) disposed over a substrate 103 in accordance with aspects of the disclosure. In aspects, as shown in FIGS. 35 and 36A-36C, the surface-modifying layer 113 (e.g., fingerprint-hiding coating) can be disposed on a planarization layer 123, where the planarization layer 123 is positioned between the surface-modifying layer 113 (e.g., fingerprint-hiding coating) and the substrate 103. Unless otherwise noted, a discussion of features of aspects of one surface-modifying layer 113 (e.g., fingerprint-hiding coating) or coated article can apply equally to corresponding features of any aspects of the disclosure. For example, identical part numbers throughout the disclosure can indicate that, in some aspects, the identified features are identical to one another and that the discussion of the identified feature of one aspect, unless otherwise noted, can apply equally to the identified feature of any of the other aspects of the disclosure.

As shown in FIGS. 1, 2A-2C, 35, and 36A-36C, the substrate 103 comprises a first major surface 105 and a second major surface 107 opposite the first major surface 105. As shown, the first major surface 105 can extend along a first plane 104, and/or the second major surface 107 can extend along a second plane 106. In aspects, as shown, the second plane 106 can be parallel to the first plane 104. As used herein, a substrate thickness 109 is defined between the first major surface 105 and the second major surface 107 as a distance between the first plane 104 and the second plane 106. In aspects, the substrate thickness 109 can be about 10 micrometers (μm) or more, about 25 μm or more, about 40 μm or more, about 60 μm or more, about 70 μm or more, about 80 μm or more, about 90 μm or more, about 100 μm or more, about 125 μm or more, about 150 μm or more, about 200 μm or more, about 300 μm or more, about 5 millimeters (mm) or less, about 3 mm or less, about 2 mm or less, about 1 mm or less, about 800 μm or less, about 500 μm or less, about 300 μm or less, about 200 μm or less, about 180 μm or less, or about 160 μm or less. In aspects, the substrate thickness 109 can range from about 10 μm to about 5 mm, from about 25 μm to about 3 mm, from about 40 μm to about 3 mm, from about 60 μm to about 2 mm, from about 70 μm to about 2 mm, from about 70 μm to about 1 mm, from about 70 μm to about 800 μm, from about 80 μm to about 500 μm, from about 90 μm 500 μm, from about 100 μm to about 200 μm, from about 125 μm to about 200 μm, from about 150 μm to about 200 μm, from about 150 μm to about 160 μm, or any range or subrange therebetween. Alternatively, the substrate thickness 109 can be from about 1 millimeter (mm) to about 5 mm, from about 1 mm to about 3 mm, or any range or subrange therebetween.

The substrate 103 can comprise a glass-based material, a glass-ceramic material, and/or a ceramic-based material having a pencil hardness of 8H or more, for example, 9H or more. As used herein, pencil hardness is measured using ASTM D 3363-20 with standard lead graded pencils. Providing a glass-based substrate, a glass-ceramic substrate, and/or a ceramic-based substrate can enhance puncture resistance and/or impact resistance. As used herein, “glass-based” includes both glasses and glass-ceramics, wherein glass-ceramics have one or more crystalline phases and an amorphous, residual glass phase. A glass-based material (e.g., glass-based substrate) may comprise an amorphous material (e.g., glass) and optionally one or more crystalline materials (e.g., ceramic). Exemplary glass-based materials may be an alkali-free glass and/or comprise a low content of alkali metals (e.g., R₂O of about 10 mol % or less, wherein R₂O comprises Li₂O Na₂O, and K₂O). As used herein, “ceramic-based” includes both ceramics and glass-ceramics, wherein glass-ceramics have one or more crystalline phases and an amorphous, residual glass phase. In aspects, ceramic-based materials can comprise one or more oxides, nitrides, oxynitrides, carbides, borides, and/or silicides. Throughout the disclosure, an elastic modulus (e.g., Young's modulus) of the substrate 103 is measured using ISO 527-1:2019. In aspects, the substrate 103 can comprise an elastic modulus ranging from about 10 GPa to about 100 GPa, from about 40 GPa to about 100 GPa, from about 60 GPa to about 100 GPa, from about 60 GPa to about 80 GPa, from about 80 GPa to about 100 GPa, or any range or subrange therebetween. In aspects, the substrate 103 may comprise a polymer substrate.

In aspects, the substrate 103 can be optically transparent. As used herein, “optically transparent” or “optically clear” means an average transmittance of 70% or more in the wavelength range of 400 nm to 750 nm through a 1.0 mm thick piece of a material. In aspects, an “optically transparent material” or an “optically clear material” may have an average transmittance of 75% or more, 80% or more, 85% or more, or 90% or more, 91% or more, 92% or more, 94% or more, 96% or more in the wavelength range of 400 nm to 750 nm through a 1.0 mm thick piece of the material. The average transmittance in the wavelength range of 400 nm to 700 nm is calculated by measuring the transmittance of whole number wavelengths from about 400 nm to about 700 nm and averaging the measurements.

In some aspects, the substrate 103, in addition to being transparent, can also be colored transparent, opaque, colored opaque, translucent, or colored translucent. As used herein “opaque” and “translucent” can mean as follows: opacity is the measure of impenetrability to visible light. An opaque object is neither transparent (allowing all light to pass through) nor translucent (allowing some light to pass through). When light strikes an interface between two substances, in general some may be reflected, some absorbed, some scattered, and the rest transmitted. An opaque substance transmits very little light, and therefore reflects, scatters, or absorbs most of it. Opacity depends on the frequency of the light being considered. For instance, some kinds of glass, while transparent in the visual range, are largely opaque to ultraviolet light. Further, the colored transparent, colored opaque, and colored translucent can be anyone of a variety of colors including, for example, black, white, green, yellow, pink, red, blue, orange, purple, brown etc.

In aspects, the coated article 101, 201, 211, 221, 3501, 3601, 3611, or 3621 comprising a glass-based substrate, a glass-ceramic substrate, and/or a ceramic-based substrate can comprise one or more compressive stress regions. In aspects, a compressive stress region may be created by chemically strengthening. Chemically strengthening may comprise an ion exchange process, where ions in a surface layer are replaced by—or exchanged with—larger ions having the same valence or oxidation state. Methods of chemically strengthening will be discussed later. Without wishing to be bound by theory, chemically strengthening the substrate 103 can enable good impact resistance, good puncture resistance, and/or enable small bend radii, for example, with the compressive stress from the chemical strengthening counteracting bend-induced tensile stress on the outermost surface of the substrate. A compressive stress region may extend into a portion of the first portion and/or the second portion for a depth called the depth of compression (DOC). As used herein, depth of compression means the depth at which the stress in the chemically strengthened substrates and/or portions described herein changes from compressive stress to tensile stress. Depth of compression may be measured by a surface stress meter or a scattered light polariscope (SCALP, wherein values reported herein were made using SCALP-5 made by Glasstress Co., Estonia) depending on the ion exchange treatment and the thickness of the article being measured. Where the stress in the substrate and/or portion is generated by exchanging potassium ions into the substrate, a surface stress meter, for example, the FSM-6000 (Orihara Industrial Co., Ltd. (Japan)), is used to measure depth of compression. Unless specified otherwise, compressive stress (including surface CS) is measured by surface stress meter (FSM) using commercially available instruments, for example the FSM-6000, manufactured by Orihara. Surface stress measurements rely upon the accurate measurement of the stress optical coefficient (SOC), which is related to the birefringence of the glass. Unless specified otherwise. SOC is measured according to Procedure C (Glass Disc Method) described in ASTM standard C770-16, entitled “Standard Test Method for Measurement of Glass Stress-Optical Coefficient.” the contents of which are incorporated herein by reference in their entirety. Where the stress is generated by exchanging sodium ions into the substrate, and the article being measured is thicker than about 400 μm. SCALP is used to measure the depth of compression and central tension (CT). Where the stress in the substrate and/or portion is generated by exchanging both potassium and sodium ions into the substrate and/or portion, and the article being measured is thicker than about 400 μm, the depth of compression and CT are measured by SCALP. Without wishing to be bound by theory, the exchange depth of sodium may indicate the depth of compression while the exchange depth of potassium ions may indicate a change in the magnitude of the compressive stress (but not the change in stress from compressive to tensile). The refracted near-field (RNF; the RNF method is described in U.S. Pat. No. 8,854,623, entitled “Systems and methods for measuring a profile characteristic of a glass sample”, which is incorporated herein by reference in its entirety) method also may be used to derive a graphical representation of the stress profile. When the RNF method is utilized to derive a graphical representation of the stress profile, the maximum central tension value provided by SCALP is utilized in the RNF method. The graphical representation of the stress profile derived by RNF is force balanced and calibrated to the maximum central tension value provided by a SCALP measurement. As used herein. “depth of layer” (DOL) means the depth that the ions have exchanged into the substrate and/or portion (e.g., sodium, potassium). Throughout the disclosure. DOL is measured in accordance with ASTM C-1422. Without wishing to be bound by theory, a DOL is usually greater than or equal to the corresponding DOC. Through the disclosure, when the maximum central tension cannot be measured directly by SCALP (as when the article being measured is thinner than about 400 μm) the maximum central tension can be approximated by a product of a maximum compressive stress and a depth of compression divided by the difference between the thickness of the substrate and twice the depth of compression, wherein the compressive stress and depth of compression are measured by FSM.

In aspects, the substrate 103 may comprise a first compressive stress region at the first major surface 105 that can extend to a first depth of compression from the first major surface 105. In aspects, the substrate 103 may comprise a second compressive stress region at the second major surface 107 that can extend to a second depth of compression from the second major surface 107. In aspects, the first depth of compression and/or the second depth of compression as a percentage of the substrate thickness 109 can be about 5% or more, about 10% or more, about 12% or more, about 15% or more, about 17% or more, about 30% or less, about 25% or less, about 22% or less, about 20% or less, about 17% or less, or about 15% or less. In aspects, the first depth of compression and/or the second depth of compression as a percentage of the substrate thickness 109 can range from about 5% to about 30%, from about 10% to about 25%, from about 10% to about 22%, from about 12% to about 20%, from about 12% to about 17%, from about 15% to about 17%, or any range or subrange therebetween. In aspects, the first depth of compression and/or the second depth of compression can be about 1 μm or more, about 10 μm or more, about 15 μm or more, about 20 μm or more, about 25 μm or more, about 30 μm or more, about 200 μm or less, about 150 μm or less, about 100 μm or less, about 60 μm or less, about 45 μm or less, about 30 μm or less, or about 20 μm or less. In aspects, the first depth of compression and/or the second depth of compression can range from about 1 μm to about 200 μm, from about 1 μm to about 150 μm, from about 10 μm to about 100 μm, from about 15 μm to about 600 μm, from about 20 μm to about 45 μm, from about 20 μm to about 30 μm, or any range or subrange therebetween. By providing a first depth of compression and/or a second depth of compression from about 1% to about 30% of the first thickness, good impact and/or puncture resistance can be enabled.

In aspects, the first compressive stress region can comprise a maximum first compressive stress, and/or the second compressive stress region can comprise a maximum second compressive stress. In further aspects, the maximum first compressive stress and/or the maximum second compressive stress can be about 100 MegaPascals (MPa) or more, about 300 MPa or more, 400 MPa or more, about 500 MPa or more, about 600 MPa or more, about 700 MPa or more, about 1,500 MPa or less, about 1,200 MPa or less, about 1,000 MPa or less, or about 800 MPa or less. In further aspects, the maximum first compressive stress and/or the maximum second compressive stress can range from about 100 MPa to about 1,500 MPa, from about 100 MPa to about 1,200 MPa, from about 300 MPa to about 1,200 MPa, from about 300 MPa to about 1,000 MPa, from about 400 MPa to about 1,000 MPa, from about 500 MPa to about 1,000 MPa, from about 600 MPa to about 90° MPa, from about 700 MPa to about 800 MPa, or any range or subrange therebetween. By providing a maximum first compressive stress and/or a maximum second compressive stress from about 100 MPa to about 1,500 MPa, good impact and/or puncture resistance can be enabled.

In aspects, the substrate 103 may comprise a tensile stress region. The tensile stress region can be positioned between the first compressive stress region and the second compressive stress region. In aspects, the tensile stress region can comprise a maximum tensile stress. In further aspects, the maximum first stress can be about 10 MPa or more, about 20 MPa or more, about 30 MPa or more, about 100 MPa or less, about 80 MPa or less, or about 60 MPa or less. In further aspects, the maximum tensile stress can range from about 10 MPa to about 100 MPa, from about 10 MPa to about 80 MPa, from about 10 MPa to about 60 MPa, from about 20 MPa to about 100 MPa, from about 20 MPa to about 80 MPa, from about 20 MPa to about 60 MPa, from about 30 MPa to about 100 MPa, from about 30 MPa to about 80 MPa, from about 30 MPa to about 60 MPa, or any range or subrange therebetween. Providing a maximum tensile stress from about 10 MPa to about 100 MPa can enable good impact and/or puncture resistance.

As used herein, if a first layer and/or component is described as “disposed over” a second layer and/or component, other layers may or may not be present between the first layer and/or component and the second layer and/or component. Furthermore, as used herein, “disposed over” does not refer to a relative position with reference to gravity. For example, a first layer and/or component can be considered “disposed over” a second layer and/or component, for example, when the first layer and/or component is positioned underneath, above, or to one side of a second layer and/or component. As used herein, a first layer and/or component described as “bonded to” a second layer and/or component means that the layers and/or components are bonded to each other, either by direct contact and/or bonding between the two layers and/or components or via an adhesive layer. As used herein, a first layer and/or component described as “contacting” or “in contact with” a second layer and/or components refers to direct contact and includes the situations where the layers and/or components are bonded to each other. As used herein, a first layer and/or component described as “disposed on” a second layer and/or component means that the layers do not have any other layers therebetween other than an optional layer of a coupling agent or are bonded together. Consequently, a first layer disposed over a second layer may further be disposed on, in contact with, and/or bonded to the second layer.

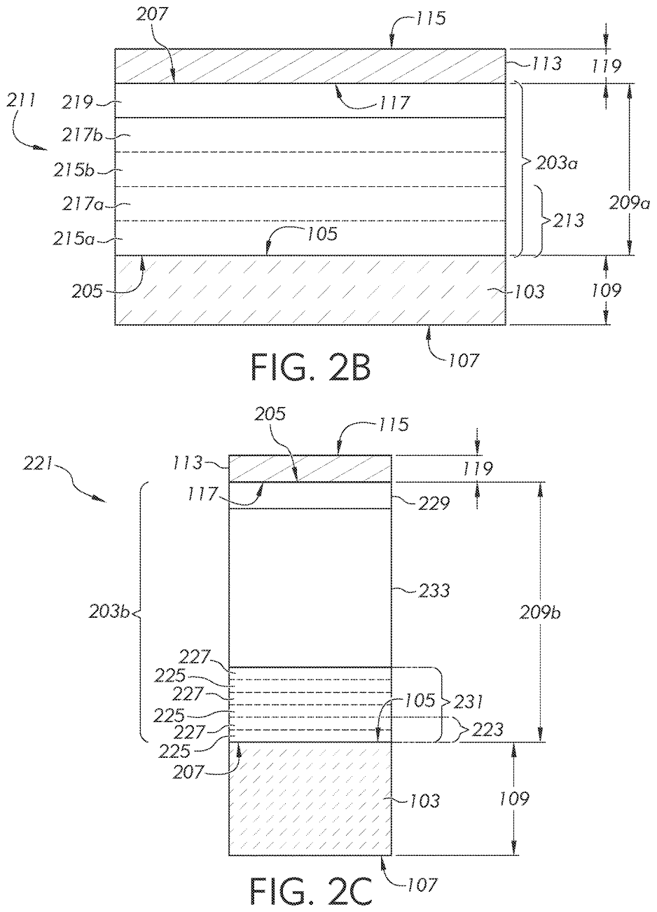

In aspects, as shown in FIGS. 2A-2C and 36A-36C, the coated article 201, 211, 221, 3601, 3611, or 3621 can comprise an optical stack 203 comprising a third major surface 205 disposed on the first major surface 105 of the substrate 103. As shown, the optical stack 203 can comprise a fourth major surface 207 opposite the third major surface 205 with a stack thickness 209 defined therebetween. In aspects, the stack thickness 209 can be about 10 nanometers (nm) or more, about 50 nm or more, about 100 nm or more, about 300 nm or more, about 500 nm or more, about 700 nm or more, about 1 μm or more, about 10 μm or less, about 5 μm or less, about 2 μm or less, or about 1 μm or less, aspects, the stack thickness 209 can range from about 10 nm to about 10 μm, from about 50 nm to about 5 μm, from about 100 nm to about 2 μm, from about 300 nm to about 1 μm, from about 500 nm to about 1 μm, or any range or subrange therebetween. In exemplary aspects, the stack thickness 209 can range from 10 nm to 10 μm, from 50 nm to 5 μm, or from 50 nm to 500 nm.

In further aspects, the optical stack 203 can comprise an anti-reflective (AR) coating, a band-pass filter coating, an edge neutral mirror, a beam splitter coating, a multi-layer high-reflectance coating, and/or an edge filter coating. For example, the anti-reflective coating of the optical stack 203 can be positioned between the surface-modifying layer 113 (e.g., fingerprint-hiding coating) and the substrate 103. In even further aspects, the optical stack 203 (e.g., anti-reflective coating) can comprise two or more layers with differing refractive index values, for example, with a first low refractive index (RI) from about 1.3 to about 1.6 and a second high refractive index (RI) from about 1.6 to about 3.0. In still further aspects, the two or more layers of the optical stack 203 can form an alternative set of layers, for example, 2 sets or more, 3 sets or more, 5 sets or more, or 10 sets or more, for example, from 2 to 15 periods, from 2 to 10 periods, from 2 to 12 periods, from 3 to 8 periods, from 3 to 6 periods, or any range or subrange therebetween.

In aspects, as shown in FIGS. 2B and 36B, the coated article 211 comprises optical stack 203a comprising a plurality of a silicon-containing oxide, a silicon-containing nitride, and/or a silicon-containing oxynitride layers. For example, the optical stack 203a can be an anti-reflective coating. As shown, the optical stack 203a can comprise one or more periods 213 comprising two or more layers with different refractive indices, for example, a first low RI layer 215a and a second high RI layer 217a. For example, the optical stack 203a shown in FIG. 2B has 2 periods 213 comprising first low RI layers 215a and 215b (L) and a second high RI layers 217a and 217b (H) that alternate in the following sequence of layers: L/H/L/H, although H/L/H/L could be provided in other aspects. An absolute value of a difference between the first low RI layer 215a and a second high RI layer 217a can be about 0.01 or more, about 0.05 or more, about 0.1 or more, or even 0.2 or more. Exemplary materials for the first low RI layer 215a include SiO₂, Al₂O₃, GeO₂, SiO₂, AlOₓN_{y}, SiOₓN_{y}, SiᵤAlᵥOₓN_{y}, MgO, and MgAl₂O₄. Exemplary materials for the second high RI layer 217a include SiᵤAlᵥOₓN_{y}, AlN, oxygen-doped SiNₓ, SiNₓ, Si₃N₄, AlOₓN_{y}, SiOₓN_{y}, Ta₂O₅, Nb₂O₅, HfO₂, TiO₂, ZrO₂, Y₂O₃. ZrO₂, Al₂O₃, and diamond-like carbon. The oxygen content of the materials for the high RI layer(s) 217a and 217b may be minimized, especially in SiNₓ or AlNₓ materials. The foregoing materials may be hydrogenated up to about 30% by weight. As used herein, it is to be understood that the subscripts (e.g., “u,” “v,” “x,” “y,” and “z”) range from greater than 0 to 1, where the subscripts sum to 1 to represent an “atomic fraction formula.” See, for example: (i) Charles Kittel. Introduction to Solid State Physics, seventh edition. John Wiley & Sons. Inc. NY. 1996. pp. 611-627; (ii) Smart and Moore. Solid State Chemistry. An introduction. Chapman & Hall University and Professional Division. London. 1992. pp. 136-151; and (iii) James F. Shackelford. Introduction to Materials Science for Engineers. Sixth Edition. Pearson Prentice Hall. New Jersey. 2005. pp. 404-418. The balance of the material (i.e., 1 minus the sum of the subscripts) is the first atom (e.g., SiNₓ with x=0.57 actually corresponds to Si_{0.43}N_{0.57}, which is the same as Si₃N₄). Also, the sum of all subscripts is greater than 0.

In aspects, the optical stack 203a can include the antireflective structure, antireflective coating, or outer optical film described in U.S. Pat. No. 10,948,629, issued Mar. 16, 2021, U.S. Published Application No. 2022/0011468, and/or WIPO Publication WO 2022/125846, which are incorporated by reference in their entirety. In aspects, as shown in FIG. 2B, the optical stack 203a can comprise a capping layer 219. In further aspects, the capping layer 219 can comprise a low refractive index material, which can be the same material as the first low RI layer 215a. In further aspects, the capping layer 219 can comprise a silicon-containing oxide (e.g., silicon dioxide), a silicon-containing nitride (e.g., an oxide-doped silicon nitride, silicon nitride, etc.), and a silicon-containing oxynitride (e.g., silicon oxynitride). An exemplary aspect of the capping layer is silicon dioxide (SiO₂). In aspects, as shown, the layer of the optical stack 203 closest to the substrate 103 can be a low index layer (i.e., first low RI layer 215a) and the layer closest to the surface-modifying layer 113 (FIG. 2B) or the planarization layer 123 (FIG. 36B) can be a low index layer (e.g., capping layer 219). An exemplary combination of materials for the optical stack is SiO₂ for the first low RI layer, silicon nitride (e.g., Si₃N₄, SiNₓ) or silicon oxynitride (SiOₓN_{y}) for the second high RI layer, and silicon dioxide (SiO₂) for the capping layer.

In aspects, the coated article 211 can comprise a stack thickness 209a corresponding to a physical thickness of the optical stack 203a in a range from about 50 nm to less than 500 nm, from about 75 nm to about 490 nm, from about 100 nm to about 180 nm, from about 125 nm to about 475 nm, from about 150 nm to about 450 nm, from about 175 nm to about 425 nm, from about 200 nm to about 400 nm, from about 225 nm to about 375 nm, from about 250 nm to about 350 nm, from about 250 nm to about 340 nm, or any range or subrange therebetween. As used herein, the term “optical thickness” is determined by (n*d), where “n” refers to the RI of the sub-layer and “d” refers to the physical thickness of the layer. In aspects, at least one layer in the optical stack 203a can have an optical thickness from about 2 nm to about 200 nm, from about 10 nm to about 100 nm, from about 15 nm to about 90 nm, from about 50 nm to about 80 nm, or any range or subrange therebetween. In further aspects, the first low RI layers 215a and 215b in periods 213 in the optical stack 203 can be within or more of the ranges mentioned in the previous sentence. In aspects, a combined physical thickness of the second high RI layers 217a and 217b can be about 90 nm or more, about 100 nm or more, about 120 nm or more, about 130 nm or more, about 150 nm or more, or less than 500 nm. For example, the combined physical thickness of the second high RI layers 217a and 217b can range from about 90 nm to less than 500 nm, from about 100 nm to about 300 nm, from about 120 nm to about 200 nm, or any range or subrange therebetween. In aspects, the combined physical thickness of the second high RI layers 217a and 217b as a percentage of the physical thickness of the stack thickness 209a can be about 30% or more, about 35% or more, about 40% or more, or about 45% or more, for example, ranging from about 35% to about 75%, from about 40% to about 65%, from about 45% to about 55%, or any range or subrange therebetween.

In aspects, the optical stack 203a of the coated article 211 can comprise a residual stress of less than about +50 MPa (tensile) to about −1000 MPa (compression). In some implementations of the article 100, the anti-reflective coating is characterized by a residual stress from about −50 MPa to about −1000 MPa (compression), or from about −75 MPa to about −800 MPa (compression). Unless otherwise noted, residual stress in the anti-reflective coating is obtained by measuring the curvature of the substrate 103 before and after deposition of the anti-reflective coating, and then calculating residual film stress according to the Stoney equation according to principles known and understood by those with ordinary skill in the field of the disclosure.

In aspects, the optical stack 203a and/or the coated article 211 may exhibit a visible photopic average reflectance of about 1% or less, about 0.9% or less, about 0.8% or less, about 0.7% or less, about 0.6% or less, about 0.5% or less, about 0.4% or less, about 0.3% or less, or about 0.2% or less, over the optical wavelength regime. These photopic average reflectance values may be exhibited at incident illumination angles in the range from about 0° to about 20°, from about 0° to about 40°, or from about 0° to about 60°. As used herein, “photopic average reflectance” mimics the response of the human eye by weighting the reflectance versus wavelength spectrum according to the human eye's sensitivity. Photopic average reflectance may also be referred to as the luminance, or tristimulus Y value of reflected light, according to known conventions, for example CIE color space conventions. The photopic average reflectance (Rₚ) is defined as the spectral reflectance, R(λ), multiplied by the illuminant spectrum, I(λ), and the CIE's color matching function, y(λ), related to the eye's spectral response:

$$〈 R \text{?} 〉 = \int \text{?} R ( λ ) \times \text{?} ( λ ) \times y ( λ ) d λ .$$

$$\text{?} \text{indicates text missing or illegible when filed}$$

Further, the article exhibits a CIE a* value, in reflectance, from about −10 to +2 and a CIE b* value, in reflectance, from −10 to +2, the CIE a* and CIE b* values each measured on the optical film structure at a normal incident illumination angle. In aspects, the optical stack 203a and/or the coated article 211 can exhibit a photopic average light transmission of about 90% or greater, 92% or greater, 94% or greater, 96% or greater, or 98% or greater, over the optical wavelength regime. In some embodiments, the optical stack 203a and/or the coated article 211 exhibits an average light transmission of about 87% or greater, 88% or greater, 89% or greater, 90% or greater, 91% or greater, 92% or greater, 93% or greater, 94% or greater, or 95% or greater, over the optical wavelength regime in the infrared spectrum from 800 nm to 1000 nm, from 90° nm to 1000 nm, or from 930 nm to 950 nm. In aspects, the optical stack 203a and/or the coated article 211 can exhibit a hardness of 8 GPa or greater measured at an indentation depth of about 100 nm or a maximum hardness of 9 GPa or greater measured over an indentation depth range from about 100 nm to about 500 nm, the hardness and the maximum hardness measured by a Berkovich Indenter Hardness Test (as defined below).

In aspects, as shown in FIGS. 2B and 36B, the coated article 211 comprises optical stack 203a comprising an optical film 231, a scratch-resistant layer 233, and an optional capping layer 229. In aspects, the optical stack 203b can include the scratch resistant coating, anti-reflective coating, and/or optical film structure described in U.S. Pat. No. 9,328,016, issued May 3, 2016, U.S. Pat. No. 9,684,097, issued Jun. 20, 2017, U.S. Pat. No. 9,703,011, issued Jul. 11, 2017, U.S. Pat. No. 9,079,802, issued Jul. 14, 2015, U.S. Pat. No. 9,726,786, issued Aug. 8, 2017, U.S. Pat. No. 10,416,352, issued Sep. 17, 2019, which are incorporated by reference in their entirety. For example, the optical stack 203b can be an anti-reflective coating and/or a scratch-resistant coating.

In further aspects, as shown in FIGS. 2C and 36C, the optical film 231 of the optical stack 203b can comprise one or more periods 223 comprising two or more layers with different refractive indices, for example, a first low RI layer 225 and a second high RI layer 227. For example, the optical stack 203b shown in FIG. 2C has 3 periods 223 forming the optical film 231 with alternating first low RI layers 225 and second high RI layers 227. In even further aspects, the optical film 231 can comprise any number of periods, for example, within one or more of the ranges discussed above for the optical stack 203a. An absolute value of a difference between the first low RI layers 225 and the second high RI layers 227 can be about 0.01 or more, about 0.05 or more, about 0.1 or more, or even 0.2 or more. In further aspects, the first low RI layers 225 can comprise any of the materials discussed above for the first low RI layer 215a, for example, silicon dioxide (SiO₂). In further aspects, the second high RI layers 227 can comprise any of the materials discussed above for the second high RI layer 217a, for example, SiOₓN_{y}. In further aspects, a layer of the first low RI sub-layers 225 and/or the second high RI sub-layers 227 can comprise an optical thickness (n*d) in the range from about 2 nm to about 200 nm, from about 10 nm to about 100 nm, from about 15 nm to about 100 nm, or any range or subrange therebetween. In even further aspects, all of the layers in the optical film 231 or all of the second high RI layers in the optical film 231 can have an optical thickness within one or more of the ranges mentioned in the previous sentence. In further aspects, a layer of the first low RI sub-layers 225 and/or the second high RI sub-layers 227 can comprise a physical thickness from about 10 nm to about 800 nm, from about 10 nm to about 500 nm, from about 10 nm to about 300 nm, from about 10 nm to about 200 nm, from about 20 nm to about 100 nm, or any range or subrange therebetween. In further aspects, the optical stack 203 and/or any one or of the layers or sections therein (e.g., optical film 231, a scratch-resistant layer 233, an optional capping layer 229) may exhibit an extinction coefficient (at a wavelength of about 400 nm) of about 10⁻⁴ or less.

In further aspects, as shown in FIGS. 2C and 36C, the scratch-resistant layer 233 can include an inorganic carbide, nitride, oxide, diamond-like material, or combination of these. Examples of suitable materials for the scratch-resistant layer 233 include metal oxides, metal nitrides, metal oxynitride, metal carbides, metal oxycarbides, and/or combinations thereof combination thereof. Exemplary metals include B, Al, Si, Ti, V, Cr, Y, Zr, Nb, Mo, Sn, Hf, Ta and W. Specific examples of materials that may be utilized in the scratch-resistant layer 233 may include Al₂O₃, AlN, AlOₓN_{y}, Si₃N₄, SiOₓN_{y}, Siᵤ AlᵥOₓN_{y}, diamond, diamond-like carbon, SiₓC_{y}, SiₓO_{y}C_{z}, ZrO₂, TiOₓN_{y}, or combinations thereof. In even further aspects, the scratch-resistant layer 233 can comprise the same material as the second high RI layers 227, for example, SiOₓN_{y}. In even further aspects, a physical thickness of the scratch-resistant layer and/or the optical stack can be from about 0.05 μm to about 3 μm, from about 0.1 μm to about 3 μm, from about 0.2 μm to about 3 μm, from about 0.3 μm to about 2.2 μm, from about 0.5 μm to about 2.1 μm, from about 1 μm to about 2.1 μm, from about 1.8 μm to about 2.1 μm, or any range or subrange therebetween. In exemplary aspects, a physical thickness of the scratch-resistant layer can be from 0.05 μm to 3 μm, from 0.3 μm to 2.2 μm, or from 1 μm to 2.1 μm. The scratch-resistant layer 233 and/or the optical stack 203b may exhibit a hardness of about 8 GPa or greater, about 10 GPa or greater, about 13 GPa or greater, or about 17 GPa or greater, as measured by the Berkovich Indenter Hardness Test (as described below).

Although not shown, it is to be understood that the scratch-resistant layer can be sandwiched by portions of the optical film. For example, 3 or more periods can be positioned between the scratch-resistant layer and the substrate while 2 or more periods can be positioned between the scratch-resistant layer and the surface-modifying layer (e.g., fingerprint-hiding coating).

In further aspects, as shown in FIG. 2C or 36C, the optical stack 203b can comprise capping layer 229 disposed over (e.g., disposed on) the scratch-resistant layer. In even further aspects, the capping layer 229 can include a low refractive index material, such as SiO₂, Al₂O₃, GeO₂, SiO₂, AlOₓN_{y}, SiOₓN_{y}, SiᵤAlᵥOₓN_{y}, MgO, MgF₂, BaF₂, CaF₂, DyF₃, YbF₃, YF₃, or CeF₃. In further aspects, the capping layer 229 can comprise the same material as the first high RI layers 225, for example, SiO₂. In further aspects, a thickness of the capping layer 229 can be from about 10 nm to about 120 nm, from about 20 nm to about 115 nm, from about 50 nm to about 110 nm, from about 80 nm to about 110 nm, from about 90 nm to about 105 nm, or any range or subrange therebetween. The capping layer 229 may exhibit an intrinsic hardness in the range from about 7 GPa to about 10 GPa, as measured by the Berkovich Indenter Hardness Test (as measured on the surface of a layer of the same material of the capping layer, formed in the same manner, but having a thickness of about 1 micrometer or greater).

In further aspects, a stack thickness 209b corresponding to a physical thickness of the optical stack 203b can range from about 0.2 μm to about 3 μm, from about 0.5 μm to about 3 μm, from about 1 μm to about 3 μm, from about 1.2 μm to about 3 μm, from about 1.5 μm to about 3 μm from about 2 μm to about 2.6 μm, or any range or subrange therebetween. In further aspects, the optical stack 203b can exhibit an average light reflectance of about 0.5% or less, about 0.25% or less, about 0.1% or less, or even 0.05% or less over the optical wavelength regime. In further aspects, the optical stack 203b can exhibit an average transmittance or average reflectance having an average oscillation amplitude of about 5 percentage points or less over the optical wavelength regime. In further aspects, the optical stack 203b may exhibit an average light transmission of 80% or greater, 82% or greater, 85% or greater, 90% or greater, 90.5% or greater, 91% or greater, 91.5% or greater, 92% or greater, 92.5% or greater, 93% or greater, 93.5% or greater, 94% or greater, 94.5% or greater, or 95% or greater.

The optical stack 203, 203a, or 203b may be formed using various deposition methods, for example, vacuum deposition techniques, chemical vapor deposition (e.g., plasma enhanced chemical vapor deposition (PECVD), low-pressure chemical vapor deposition, atmospheric pressure chemical vapor deposition, and plasma-enhanced atmospheric pressure chemical vapor deposition), physical vapor deposition (e.g., reactive or nonreactive sputtering or laser ablation), thermal or e-beam evaporation and/or atomic layer deposition. Liquid-based methods may also be used, for example, printing, spraying, or slot coating. Where vacuum deposition is utilized, inline processes may be used to form the optical stack 203, 203a, or 203b in one deposition run. In aspects, the vacuum deposition can be made by a linear PECVD source. In aspects, the optical stack 203, 203a, or 203b can be prepared using a sputtering process (e.g., a reactive sputtering process), chemical vapor deposition (CVD) process, plasma-enhanced chemical vapor deposition process, or some combination of these processes. In aspects, the optical stack 203a or 203b comprising low RI layer(s) 215a, 215b, or 225 and high RI layer(s) 217a, 217b, or 227 can be prepared according to a reactive sputtering process. According to some embodiments, optical stack 203a or 203b (including low RI layer 215a, 215b, or 225, high RI layer 217a, 217b, or 227 and capping layer 219 or 229) can be fabricated using a metal-mode, reactive sputtering in a rotary drum coater. The reactive sputtering process conditions were defined through careful experimentation to achieve the desired combinations of hardness, refractive index, optical transparency, low color, and controlled film stress.

In further aspects, the optical stack 203 can comprise a gradient coating comprising a refractive index gradient. For example, the gradient coating of the optical stack 203 can be positioned between the surface-modifying layer 113 (FIG. 2A) or the planarization layer 123 (FIG. 36A) and the substrate 103. In even further aspects, the refractive index gradient can span a range of refractive index values of about 0.2 or more, about 0.3 or more, about 0.4 or more, about 1 or less, about 0.8 or less, about 0.6 or less, or about 0.5 or less, for example, from about 0.2 to about 1, from about 0.3 to about 0.8, from about 0.4 to about 0.6, or any range or subrange therebetween. In even further aspects, the gradient coating can comprise a concentration gradient of one or more of oxygen, nitrogen, and/or silicon. It should be understood, however, that other functional coatings may be provided in the optical stack 203 to achieve predetermined optical properties of the coated article 201, 211, 221, 3501, 3601, 3611, or 3621.

According to one or more aspects, an anti-reflective coating can be used in combination with an anti-glare (AG) surface. Anti-glare surface treatments can impact the performance of anti-reflective coatings. Thus, selection of the proper anti-glare surface can be important for optimal performance, particularly in difficult use environments, such as vehicle interiors. In such environments, it may be beneficial for anti-glare surfaces on a cover glass to have the minimum sparkle and provide the appropriate anti-glare effect and tactile while meeting a required Contrast Ratio (CR) under sunlight. For example, a sample can be prepared with a chemically-etched Ultra-Low Sparkle (ULS) AG surface on a glass substrate made of Corning® Gorilla® Glass with an anti-reflective coating according to embodiments of this disclosure, and an easy-to-clean (ETC) coating to provide stable color appearance with wide-viewing angles to facilitate on sunlight viewability.

Anti-glare surfaces can be prepared on a Corning® Gorilla® Glass substrate by using a chemical etching method that enables ultra-low sparkle performance suitable for high resolution display up to 300 pixels per inch (PPI). Anti-glare glass optical properties can be analyzed, including with and without contributions from specular reflection (i.e., specular component excluded (SCE) or specular component included (SCI)), transmission haze, gloss, distinctness of image (DOI), and sparkle. Further information regarding these properties and how these measurement are made can be found in (1) C. Li and T. Ishikawa, Effective Surface Treatment on the Cover Glass for Auto-Interior Applications, SID Symposium Digest of Technical Papers Volume 1, Issue 36.4, pp. 467 (2016); (2) J. Gollier, G. A. Piech, S. D. Hart, J. A. West, H. Hovagimian, E. M. Kosik Williams, A. Stillwell and J. Ferwerda, Display Sparkle Measurement and Human Response, SID Symposium Digest of Technical Papers Volume 44, Issue 1 (2013); and (3) J. Ferwerda, A. Stillwell, H. Hovagimian and E. M. Kosik Williams, Perception of sparkle in anti-glare display screen, Journal of the SID, Vol 22, Issue 2 (2014), the contents of which are incorporated herein by reference.

The balance of the five metrics of SCE/SCI (see previous paragraph), transmission haze, gloss, distinctness of image (DOI), and sparkle is important for maximizing the benefits of an anti-glare for display readability, tactility on the glass surface, and the aesthetic appearance of high-performance touch displays in applications such as vehicle interiors. Sparkle is a micro-scattering interaction of the anti-glare surface with LCD pixels to create bright spots degrading image quality, especially at high resolution. The sparkle effect can be characterized using the method of the Pixel Power Deviation with reference (PPDr) to examine the sparkle effect on different resolution displays. For example, ultra-low sparkle anti-glare glass with less than 1% PPDr will have invisible sparkle effect on a display of less than 300 pixels-per-inch (PPI). However, up to 4% PPDr may be acceptable depending on the contents of display, based on the preference of the end-user. In vehicular or automotive interior settings, about 120 PPI to about 300 PPI is acceptable, and displays over 300 PPI have diminishing value.

In aspects, the substrate 103 and/or an anti-glare surface of the optical stack 203, 203a, and/or 203b can comprise a textured surface, for example, having particulates, a mechanically roughened surface, and/or a chemically roughened surface. In further aspects, the anti-glare and/or textured surface can be formed by treating the corresponding surface with an anti-glare treatment. Exemplary aspects of anti-glare treatments include chemical or physical surface treatment to form irregularities and/or etching the surface (e.g., with hydrofluoric acid) to create an etched region exhibiting anti-glare properties.

Throughout the disclosure, hardness of the optical stack is measured using the “Berkovich Indenter Hardness Test.” As used herein, the “Berkovich Indenter Hardness Test” measures the hardness of a material by indenting the surface (e.g., fourth major surface 207) with a diamond Berkovich indenter to form an indent to an indentation depth in the range from about 50 nm to about 1000 nm (or the entire thickness of the optical stack 203, 203a, or 203b, whichever is less) and measuring the hardness from this indentation at various points along the entire indentation depth range, along a specified segment of this indentation depth (e.g., in the depth range from about 100 nm to about 500 nm), or at a particular indentation depth (e.g., at a depth of 100 nm, at a depth of 500 nm, etc.) generally using the methods set forth in Oliver, W. C. and Pharr, G. M., “An improved technique for determining hardness and elastic modulus using load and displacement sensing indentation experiments”, J. Mater. Res., Vol. 7, No. 6, 1992, 1564-1583; and Oliver, W. C. and Pharr, G. M., “Measurement of Hardness and Elastic Modulus by Instrument Indentation: Advances in Understanding and Refinements to Methodology”, J Mater. Res., Vol. 19, No. 1, 2004, 3-20. Further, when hardness is measured over an indentation depth range (e.g., in the depth range from about 100 nm to about 500 nm), the results can be reported as a maximum hardness within the specified range, wherein the maximum is selected from the measurements taken at each depth within that range. As used herein, “hardness” and “maximum hardness” both refer to as-measured hardness values, not averages of hardness values. Similarly, when hardness is measured at an indentation depth, the value of the hardness obtained from the Berkovich Indenter Hardness Test is given for that particular indentation depth.

The optical stack 203, 203a or 203b, if present, can comprise a hardness of greater than about 8 GPa, by the Berkovich Indenter Hardness Test at an indentation depth of about 100 nm. The optical stack 203 may exhibit a hardness of about 8 GPa or greater, about 9 GPa or greater, about 10 GPa or greater, about 11 GPa or greater, about 12 GPa or greater, about 13 GPa or greater, about 14 GPa or greater, or about 15 GPa or greater by the Berkovich Indenter Hardness Test at an indentation depth of about 100 nm. For example, the optical stack 203 or 203a, including the surface-modifying layer 113 (e.g., fingerprint-hiding coating) and/or the planarization layer 123, as described herein, may exhibit a hardness of about 8 GPa or greater, about 10 GPa or greater or about 12 GPa or greater, by the Berkovich Indenter Hardness Test at an indentation depth of about 100 nm. In aspects, the optical stack 203 or 203b can exhibit a hardness ranging from about 8 GPa to about 30 GPa, from about 10 GPa to about 25 GPa, from about 12 GPa to about 20 GPa, from about 16 GPa to about 20 GPa, or any range or subrange therebetween. Such measured hardness values may be exhibited by the optical stack 203, 203a, or 203b and/or the coated article 101, 201, 211, 221, 3501, 3601, 3611, or 3621 over an indentation depth of about 50 nm or greater or about 100 nm or greater (e.g., from about 100 nm to about 300 nm, from about 100 nm to about 400 nm, from about 100 nm to about 500 nm, from about 100 nm to about 600 nm, from about 200 nm to about 300 nm, from about 200 nm to about 400 nm, from about 200 nm to about 500 nm, or from about 200 nm to about 600 nm). Similarly, maximum hardness values of about 8 GPa or greater, about 9 GPa or greater, about 10 GPa or greater, about 11 GPa or greater, about 12 GPa or greater, about 13 GPa or greater, about 14 GPa or greater, or about 15 GPa or greater by the Berkovich Indenter Hardness Test may be exhibited by the optical stack 203 and/or the coated article 101, 201, 211, 221, 3501, 3601, 3611, or 3621 over an indentation depth of about 50 nm or greater or about 100 nm or greater (e.g., from about 100 nm to about 300 nm, from about 100 nm to about 400 nm, from about 100 nm to about 500 nm, from about 100 nm to about 600 nm, from about 200 nm to about 300 nm, from about 200 nm to about 400 nm, from about 200 nm to about 500 nm, or from about 200 nm to about 600 nm).

As shown in FIGS. 1, 2A-2C, 35, and 36A-36C, the coated article 101, 201, 221, 221, 3501, 3601, 3611, or 3621 comprises the surface-modifying layer 113 (e.g., fingerprint-hiding coating), disposed over the first major surface 105 of the substrate 103. The surface-modifying layer 113 comprises an inner surface 117 facing the first major surface 105 of the substrate 103. In aspects, as shown in FIG. 1, the surface-modifying layer 113 (e.g., inner surface 117) can be disposed on and/or bonded to the first major surface 105 of the substrate 103. In aspects, as shown in FIGS. 2A-2C and 36A-36C, the surface-modifying layer 113 (e.g., fingerprint-hiding coating) can be disposed on the optical stack 203, 203a, or 203b. In aspects as shown in FIG. 35, the surface-modifying layer 113 (e.g., inner surface 117) can be disposed on and/or bonded to the first surface area 125 of the planarization layer 123 (discussed below). In aspects, as shown in FIGS. 1, 2A-2C, the surface-modifying layer 113 (e.g., fingerprint-hiding coating) comprises an exterior surface 115 that forms an exterior surface of the coated article 101, 201, 211, 221, 3501, 3601, 3611, or 3621. Consequently, a user would interact with the coated article 101, 201, 211, 221, 3501, 3601, 3611, or 3621 by, for example, touching the exterior surface 115 or viewing an image through the exterior surface 115. A surface-modifying thickness 119 is defined as an average distance between the inner surface 117 and the exterior surface 115. In aspects, the surface-modifying thickness 119 can be about 1 nm or more, about 2 nm or more, about 3 nm or more, about 5 nm or more, about 10 nm or more, about 20 nm or more, about 50 nm or more, about 75 nm or less, about 50 nm or less, about 25 nm or less, about 15 nm or less, about 10 nm or less, about 8 nm or less, about 7 nm or less, about 6 nm or less, about 5 nm or less, or about 4 nm or less. In aspects, the surface-modifying thickness 119 can be in a range from about 1 nm to about 75 nm, from about 1 nm to about 50 nm, from about 1 nm to about 25 nm, from about 1 nm to about 15 nm, from about 2 nm to about 10 nm, from about 2 nm to about 8 nm, from about 2 nm to about 5 nm, from about 3 nm to about 5 nm, or any range or subrange therebetween. In aspects, the surface-modifying thickness 119 can be about 10 nm or less, for example in a range from about 1 nm to about 8 nm, from about 1 nm to about 5 nm, from about 2 nm to about 4 nm, or any range or subrange therebetween. The surface-modifying thickness 119 is determined using ellipsometry.

Throughout the disclosure, “surface-modifying layer” refers to a layer that is characterized by changing a physical property or other behavior of the coated article. For example, a surface-modifying layer can modify one or more of a water contact angle, an oleic contact angle, a visibility of a fingerprint (e.g., simulated fingerprint), and/or an ability to remove a fingerprint (e.g., by wiping).

In aspects, the surface-modifying layer can be an anti-fingerprint coating. Throughout the disclosure, a surface-modifying layer is an “anti-fingerprint” coating if the coating on a substrate can reduce the visibility of, reduce a color shift of, and/or reduce droplet formation of fingerprint oil disposed thereon relative to the substrate without the coating. As used herein, the visibility of a fingerprint refers to an absolute value of a difference in brightness (e.g., CIELAB L* value) for a portion of the anti-fingerprint coating with the fingerprint oil and another portion of the anti-fingerprint coating without the fingerprint oil. As used herein, the color shift of the substrate refers to a difference in measured color as √((a₁*−a₂*)²+(b₁*−b₂*)²), where a* refers to CIELAB a* values, b* refers to CIELAB b* values, subscript 1 refers to a portion of the anti-fingerprint coating without fingerprint oil, and subscript 2 refers to a portion of the anti-fingerprint coating with fingerprint oil. An anti-fingerprint coating can reduce droplet formation, which can increase a visibility and/or color shift of fingerprint oil, by being oleophilic, as defined below. Additionally, the anti-fingerprint coating can enable the removal of aqueous material (e.g., water droplets, sweat droplets) from the coating, for example, by being hydrophobic, as defined below. In further aspects, the anti-fingerprint coating can exhibit an (e.g., as-formed) water contact angle from 90° to 120°, an (e.g., as-formed) oleic acid contact angle of 40° or less, and a coefficient of friction of 0.25 or less. In further aspects, the easy-to-clean coating can be substantially free and/or free of fluorine. In aspects, a diiodomethane contact angle of an anti-fingerprint coating (e.g., as-formed) can be about 60° or more, about 62° or more, about 65° or more, about 80° or less, about 75° or less, about 73° or less, or about 70° or less. In aspects, a diiodomethane contact angle of an anti-fingerprint coating (e.g., as-formed) can range from about 60° to about 80°, from about 62° to about 75°, from about 65° to about 72°, or any range or subrange therebetween. In aspects, an anti-fingerprint coating can be oleophilic. In aspects, a hexadecane contact angle and/or an oleic acid contact angle of an anti-fingerprint coating (e.g., as-formed) can be about 45° or less, about 40° or less, about 30° or less, about 25° or less, about 20° or less, or the anti-fingerprint coating can wet hexadecane and/or oleic acid. In further aspects, the anti-fingerprint coating (e.g., as formed) wets hexadecane and/or oleic acid. Providing a low diiodomethane contact angle (e.g., about 60° or less) and/or a low hexadecane contact angle (e.g., about 30° or less) can reduce the visibility and/or color shift associated with fingerprints by enabling fingerprint oil to be dispersed across the anti-fingerprint coating rather than beading up into pronounced droplets.

In aspects, the surface-modifying layer can be a fingerprint-hiding coating. Throughout the disclosure, a “fingerprint-hiding coating” can reduce the visibility of and/or reduce a color shift of fingerprint oil disposed thereon relative to a glass-based substrate without the coating. As used herein, the visibility of a fingerprint refers to an absolute value of a difference in brightness (e.g., CIELAB L* value) for a portion of the fingerprint-hiding coating with the fingerprint oil and another portion of the fingerprint-hiding coating without the fingerprint oil. As used herein, the color shift of the glass-based substrate refers to a difference in measured color as √((a₁*−a₂*)²+(b₁*−b₂*)²), where a* refers to CIELAB a* values, b* refers to CIELAB b* values, subscript 1 refers to a portion of the fingerprint-hiding coating without fingerprint oil, and subscript 2 refers to a portion of the fingerprint-hiding coating with fingerprint oil. Specifically, the fingerprint-hiding coating can cause fingerprint oil to spread out over the surface of the fingerprint-hiding coating. Reducing the thickness of fingerprint oil droplets and/or increasing an area of fingerprint-hiding coating covered by the fingerprint oil can decrease a color shift and/or visibility associated with the fingerprint oil. Fingerprint-hiding coatings that can be oleophilic are to be contrasted with other coatings (e.g., anti-fingerprint coatings) that can reduce droplet formation by being oleophobic. Additionally, the fingerprint-hiding coating can enable the removal of aqueous material (e.g., water droplets, sweat droplets) from the coating, for example, by being hydrophobic, as discussed herein. In further aspects, the fingerprint-hiding coating can exhibit an (e.g., as-formed) water contact angle from 90° to 120°, an (e.g., as-formed) oleic acid contact angle of 400 or less, and a coefficient of friction of 0.25 or less. In further aspects, the fingerprint-hiding coating can be a fluorine-containing material. Alternatively, in further aspects, the fingerprint-hiding coating can be substantially free and/or free of fluorine. In further aspects, the finger-hiding coating can exhibit a hexadecane contact angle of 20° or less (or wet hexadecane) and/or a diiodomethane contact angle of 60° or more.

In aspects, the surface-modifying layer can be an easy-to-clean coating. Throughout the disclosure, a surface-modifying layer is an “easy-to-clean” coating if the coating on a glass-based substrate can repel material and/or facilitate removal of material disposed thereon relative to the glass-based substrate without the coating. As used herein, an ability to repel material is determined based on a contact angle with higher contact angles associated with greater repulsion. As used herein, an ability to remove material is measured by wiping the material disposed on the surface (e.g., coating or glass-based substrate) with a cheesecloth (see details from the Cheesecloth Abrasion Test with the modification that the material is disposed on the surface before wiping) and the visibility of the material is monitored. A decreased visibility (e.g., fewer wiping cycles to achieve a predetermined reduction is visibility) is associated with a coating facilitating removal of material disposed thereon. In further aspects, the easy-to-clean coating can exhibit an (e.g., as-formed) water contact angle from 90° to 120°, an (e.g., as-formed) oleic acid contact angle of 50° or more, and a coefficient of friction of 0.25 or less. In further aspects, the easy-to-clean coating can be a fluorine-containing material. Alternatively, in further aspects, the easy-to-clean coating can be substantially free and/or free of fluorine. In aspects, a diiodomethane contact angle of an anti-fingerprint coating (e.g., as-formed) can be about 60° or more, about 62° or more, about 65° or more, about 80° or less, about 75° or less, about 73° or less, or about 70° or less. In aspects, a diiodomethane contact angle of an anti-fingerprint coating (e.g., as-formed) can range from about 60° to about 80°, from about 62° to about 75°, from about 65° to about 72°, or any range or subrange therebetween. In aspects, the an anti-fingerprint coating can be oleophilic. In aspects, a hexadecane contact angle of the an anti-fingerprint coating (e.g., as-formed) can be about 45° or less, about 40° or less, about 30° or less, about 25° or less, about 20° or less, or the an anti-fingerprint coating can wet hexadecane. In further aspects, the an anti-fingerprint coating (e.g., as formed) wets hexadecane. Providing a low diiodomethane contact angle (e.g., about 60° or less) and/or a low hexadecane contact angle (e.g., about 30° or less) can reduce the visibility and/or color shift associated with fingerprints by enabling fingerprint oil to be dispersed across the surface-modifying layer rather than beading up into pronounced droplets.

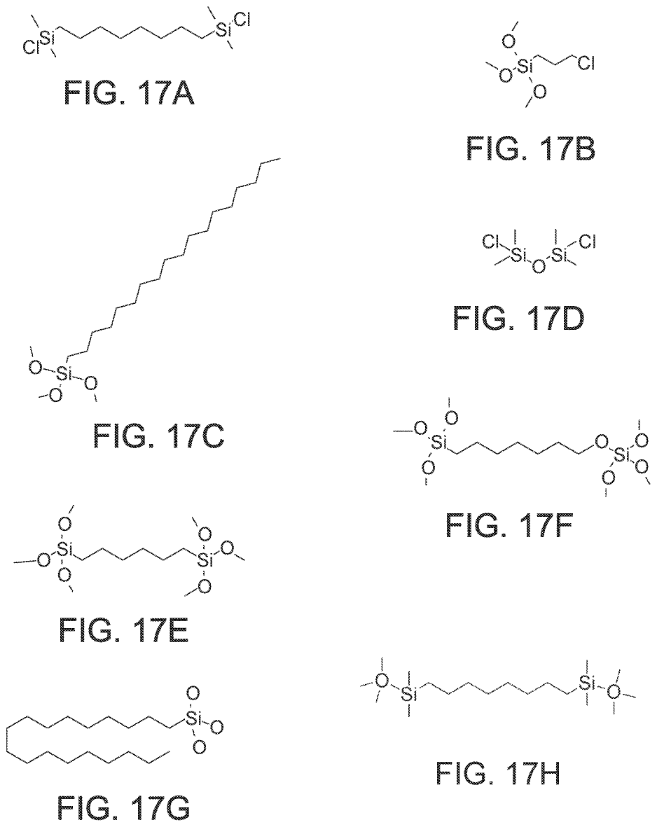

In aspects, the surface-modifying layer 113 (e.g., fingerprint-hiding coating) can comprise at least one alkyl silane at the exterior surface 115 and bonded to the rest of the coated article 101, 201, 211, 212, 3501, 3601, 3611, and/or 3621 (e.g., planarization layer 123, optical stack 203, 203a, or 203b, and/or substrate 103). As used herein, an “alkyl silane” refers to a compound comprising an alkyl chain directly bonded to a silicon atom of a silane group, and the silane group can be bonded to other silane groups (e.g., forming a siloxane or siloxane-like network). In further aspects, the alkyl silane can comprise a string of contiguous carbon atoms from 3 carbons to about 34 carbons (i.e., a C₃-C₃₄ alkyl group), for example, from 4 carbons to 34 carbons (i.e., a C₄-C₃₄ alkyl group) from 6 carbons to 34 carbons (i.e., a C₆-C₃₄ alkyl group), from 8 carbons to 20 carbons (i.e. a C₈-C₂₀ alkyl group). In aspects, an alkyl group of the alkyl silane can comprise from 4 carbons to about 34 carbons (i.e., a C₄-C₃₄ alkyl group) (e.g., from 6 carbons to 34 carbons (i.e., a C₆-C₃₄ alkyl group), from 8 carbons to 20 carbons (i.e. a C₈-C₂₀ alkyl group)), for example, an iso-octyl alkyl group, a dodecyl alkyl group, an octadecyl alkyl group, or combinations thereof. Exemplary aspects of alkyl silanes include propyl silanes (e.g., chloropropyltrimethoxysilane—see FIG. 17B), hexyl silanes (e.g., 1,6-bis(trichlorosilyl)hexane), octylsilanes (e.g., 1,8-bis(chlorodimethylsilyl)octane—see FIG. 17A and 1,8-bis(dimethylmethoxysilyl)octane—see FIG. 17H), iso-octylsilanes (e.g., iso-octyltrimethoxysilane), dodecylsilanes (e.g., dodecyltrimethoxysilane), octadecylsilanes (e.g., octadecyltrimethoxysilane—see FIG. 17G), or combinations thereof. In aspects, the alkyl silane may comprise a bipodal or multipodal alkyl silane with two or more silane head groups on each end of the alkyl group of the alkyl silane (e.g. bis-silane or tris-silane). Exemplary aspects of such bipodal alkyl silanes include 1,6-bis(trimethoxysilyl)hexane (bishexane) (see FIG. 17E) and 1,8-bis(trimethoxysilyl)octane (BISMO) (see FIG. 17F). In aspects, the alkyl silane may include a combination of one or more monopodial alkyl silanes and one or more bipodal alkyl silanes. A mixture of the alkyl silanes can be used to obtain various desirable attributes, e.g. finger-print hiding in combination with good durability. The coating therefore can be composed of two or more functionalities. For instance, the alkyl silane may include one or more bipodal alkyl silanes, such as 1,8-bis(chlorodimethylsilyl) octane, 1,8-bis(dimethylmethoxysilyl)octane, 1,6-bis(trichlorosilyl) hexane, bis(triethoxysilyl) methane, 1,2-bis(triethoxysilyl) ethane, 1,6-bis(trimethoxysilyl) hexane, 1,8-bis(triethoxysilyl) octane, 1,8-bis(trimethoxysilyl) octane, or combinations thereof in addition to one or more monopodial alkyl silanes, such as octadecyl trimethoxysilane, dodecyl trimethoxysilane, or combinations thereof. Without intending to be bound by any particular theory, it is believed that multipodal alkyl silanes (e.g. bipodal alkyl silanes) are thought to create longer chains by polycondensation between molecules. In the case of the mono-functional silanes the non-reactive methyl groups may disrupt chain packing. In the case of di- or tri-functional silanes, polycondensation can occur from multiple sites and the molecule can become more branched, resulting in poor ordering. Due to their bipodal nature, these materials may contain unreacted, terminal hydroxyl groups. In some aspects, it may be beneficial to react or “cap” these groups with a monofunctional, monopodial silane or other molecule. Such examples include monofunctional alkylsilanes where the alkyl chain comprises 3 to 36 carbons. Other suitable steps include methylation such as through the use of hexamethyldisilazane (HMDS). Suitable functionalization for improved durability include linear alkylsilanes where the alkyl chain comprises 3 to 26 carbons. Certain examples include octadecyltrimethoxysilane and dodecyltrimethoxysilane. Such examples are thought to form well ordered SAMs that maintain high water contact angles, even after rubber abrasion testing on bare glass. Good rubber abrasion performance on bare glass result in enhanced durability (steelwool, cheesecloth) when combined with the planarization layer 123. In aspects, a ratio between the monopodial alkyl silanes to the multipodal alkyl silanes used to form the polymer at the surface-modifying layer 113 may be selected to tune the finger-print hiding attributes and the cleanability and/or durability attributes of the surface-modifying layer 113 (e.g., fingerprint-hiding coating) formed therefrom. Without intending to be bound by any particular theory, it is believed that the monopodial alkyl silane may increase the cleanability and/or durability of the surface-modifying layer 113 formed therefrom, and the bipodal silane may increase finger-print hiding attributes of the surface-modifying layer 113 formed therefrom. The deposition of monopodial silanes and multipodal silanes at the surface-modifying layer 113 may include various ratios between the monopodial silanes and the multipodal silanes of the alkyl silane. In embodiments, the alkyl silane may comprise a ratio of the multimodal alkyl silane to the monopodial alkyl silane of from 10:1 to 1:10, such as from 10:1 to 1:9, 1:8, 1:7, 1:6, 1:5, 1:4, 1:3, 1:2, or 1:1, from 9:1 to 1:9, 1:8, 1:7, 1:6, 1:5, 1:4, 1:3, 1:2, or 1:1, from 8:1 to 1:9, 1:8, 1:7, 1:6, 1:5, 1:4, 1:3, 1:2, or 1:1, from 7:1 to 1:9, 1:8, 1:7, 1:6, 1:5, 1:4, 1:3, 1:2, or 1:1 from 6:1 to 1:9, 1:8, 1:7, 1:6, 1:5, 1:4, 1:3, 1:2, or 1:1 from 5:1 to 1:9, 1:8, 1:7, 1:6, 1:5, 1:4, 1:3, 1:2, or 1:1 from 4:1 to 1:9, 1:8, 1:7, 1:6, 1:5, 1:4, 1:3, 1:2, or 1:1 from 2:1 to 1:9, 1:8, 1:7, 1:6, 1:5, 1:4, 1:3, 1:2, or 1:1 from 2:1 to 1:9, 1:8, 1:7, 1:6, 1:5, 1:4, 1:3, 1:2, or 1:1, or from 1:1 to 1:9, 1:8, 1:7, 1:6, 1:5, 1:4, 1:3, or 1:2. In aspects, the alkyl silane can be free of one or more of an alkene, an aryl group, an alkenyl group, a ketone, a carboxylic acid group, chlorine, or combinations thereof. In further aspects, the alkyl silane may comprise a methoxy silane (e.g., trimethoxy silane) and/or a trialkoxy silane (e.g., trimethyl silane or triethylsilane in addition to the above-mentioned alkyl group). In further aspects, the silane may comprise an alkyl trimethoxysilane, an alkyl triethoxysilane, an alkyl trichlorosilane, an alkyl trimethoxy silane, an alkyl triethoxy silane, or combinations thereof (e.g. dichloromethylsilane, chlorodimethoxysilane). In further aspects, the alkyl silane may comprise a chlorosilane, a methyl silane, a methoxy silane, a trimethoxy silane, a triethoxy silane, or combinations thereof (e.g., chlorodimethylsilane, chlorodimethoxysilane, trichlorosilane). Providing an alkyl silane can reduce a surface energy (e.g., total, dispersive, polar) of the surface-modifying layer (e.g., fingerprint-hiding coating), which can enable the surface-modifying layer (e.g., fingerprint-hiding coating) to be oleophilic. Reacting the substrate and/or an initial coating with an alkoxy silane or a chlorosilane can be well-bonded to the initial coating and enable low surface energy (e.g., total surface energy or about 30 mN/m or less, polar surface energy of about 5 mN/m or less).

In further aspects, as discussed above, the alkyl silane can comprise a one or more of the silanes discussed above in addition to an additional alkyl silane that can contribute to the siloxane part of the structure (i.e., the [Si(R″)₂O]ₙ part of the polymeric structure discussed in the following paragraphs). In even further aspects, the additional alkyl silane can comprise a dialkylsilane with silanes at both ends of the dialkylsilane, and the alkyl groups of dialkyl silane can be methyl, ethyl, or a combination thereof. An exemplary aspect of the dialkyl silane is a dimethyl silane, namely, dichloro-tetramethyl-disiloxane (see FIG. 17D), although other leaving groups can independently be groups other chlorine (e.g., selected from those discussed in the previous paragraph). In even further aspects, an amount of the additional alkyl silane as a wt % of a total amount of alkyl silanes can be about 1 wt % or more, about 5 wt % or more, about 10 wt % or more, about 20 wt % or more, about 25 wt % or more, about 30 wt % or more, about 35 wt % or more, about 40 wt % or more, about 45 wt % or more, about 50 wt % or more, about 55 wt % or more, about 60 wt % or more, about 65 wt % or more, about 70 wt % or more, about 75 wt % or more, about 90 wt % or less, about 85 wt % or less, about 80 wt % or less, about 75 wt % or less, about 70 wt % or less, about 65 wt % or less, about 60 wt % or less, about 55 wt % or less, about 50 wt % or less, about 45 wt % or less, about 40 wt % or less, about 35 wt % or less, or about 30 wt % or less. In even further aspects, an amount of the additional alkyl silane as a wt % of a total amount of the alkyl silanes can be in a range from about 1 wt % to about 90 wt %, from about 5 wt % to about 90 wt %, from about 10 wt % to about 85 wt %, from about 20 wt % to about 80 wt %, from about 25 wt % to about 75 wt %, from about 30 wt % to about 70 wt %, from about 35 wt % to about 65 wt %, from about 40 wt % to about 60 wt %, from about 45 wt % to about 55 wt %, from about 45 wt % to about 50 wt %, or any range or subrange therebetween. In preferred aspects, an amount of the additional alkyl silane as a wt % of a total amount of the alkyl silanes can be from 1 wt % to 90 wt % or from 25 wt % to 75 wt %. Alternatively, the alkyl silanes can exclude an additional alkyl silane and/or consist of a single alkyl silane selected from those discussed in the previous paragraph.

In aspects, alkyl silane at the exterior of the surface-modifying layer 113 (e.g., fingerprint-hiding coating) can be bonded to another part of the surface-modifying layer 113 (e.g., fingerprint-hiding coating) by a silane group. In further aspects, the bond between the alkyl silane and the another part of the coated article can be a disiloxane group. A disiloxane group can be formed by the condensation of silanes. In even further aspects, the disiloxane group can include one or more dialkyl siloxanes (e.g., dimethylsiloxane(s) and/or diethylsiloxane(s)). As discussed in the in the following paragraphs, the alkyl silane at the exterior of the surface-modifying layer 113 (e.g., fingerprint-hiding coating) can be part of (i) a polymer of the alkyl silane or (ii) a block copolymer of the alkyl silane and a siloxane-based polymer.

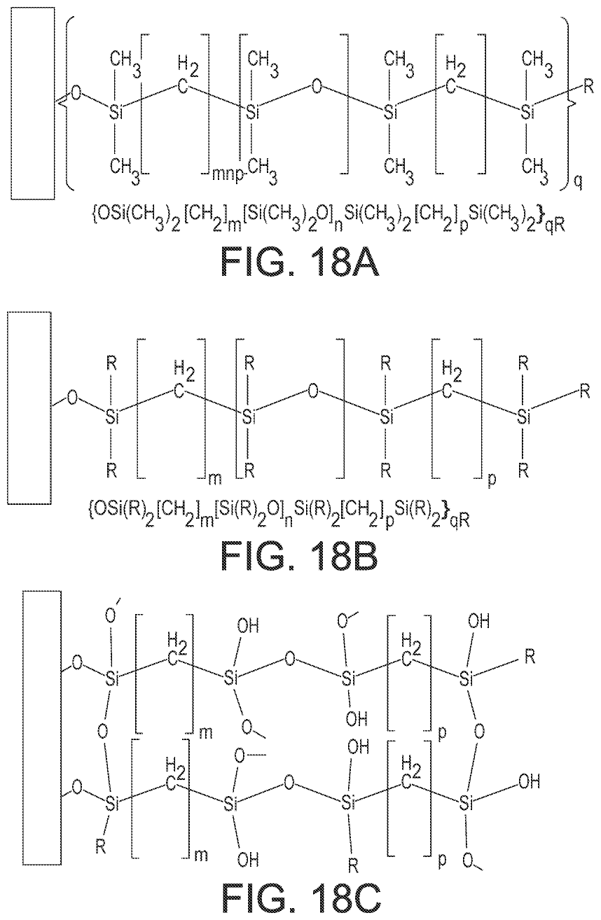

In further aspects, the alkyl silane can be part of a polymer of the alkyl silane that is bonded to another part of the coated article (e.g., the first major surface 105 of the substrate or the fourth major surface 207 of the optical stack 203 or 203a). In even further aspects, the polymer of the alkyl silane can be a dialkyl siloxane (e.g., dimethylsiloxane, diethylsiloxane, or combinations thereof) polymer. In even further aspects, the monomers of the polymer of the alkyl silane can be bonded together by a disiloxane group. In even further aspects, the disiloxane may bond together the monomers of the polymer of the alkyl silane and one or more alkyl chains. In even further aspects, the disiloxane group can include one or more dimethyl siloxanes, diethyl siloxanes, or combinations thereof. For example, a structure of the polymer may comprise {OSi(R′)₂[CH₂]ₘ[Si(R″)₂O]ₙSi(R′)₂[CH₂]ₚSi(R″)₂}_{q}R, wherein m and p are independently selected from 3 to 34, R′ and R″ are independently selected from CH₃ and CH₂CH₃, n is 1 or more, q can be 1 or more and/or can be a degree of polymerization. In still further aspects, R can be a hydroxyl group, a chloro group, a bromo group, an alkyl silane, an alkoxide, or combinations thereof. In particular aspects, R can be an alkoxide including a methoxy group, an ethoxy group, or combinations thereof. In yet further aspects, R can be a hydroxyl group or a chloro group. In yet further aspects, when n is 1, one or more of the following can also be true: R′ can be CH₃, R″ can be CH₃, m can be 8, p can be 8, or combinations thereof. In still further aspects, n can be 1, and q can be within one or more of the corresponding ranges later in this paragraph. In still further aspects, n can be 2 or more (e.g., from 2 to 10, from 2 to 5, or 2), and q can be within one or more of the corresponding ranges later in this paragraph. For example, when n is 2 or more, one or more of the following can also be true: R′ can be CH₃, R″ can be CH₃, m can be 8, p can be 8, or combinations thereof. In yet further aspects, n can be 2, and q can be within one or more of the corresponding ranges later in this paragraph. For example, when n is 2, one or more of the following can also be true: R′ can be CH₃, R″ can be CH₃, m can be 8, p can be 8, or combinations thereof. In still further aspects, R′ and R″ can be CH₃, which results in the structure shown in FIG. 18A as both a skeletal structure and SMILES. Further, as shown in FIG. 18A, the shown structure can be directly bonded to a surface of the substrate or optical film. In even further aspects, a degree of polymerization of the polymer can be 1 or more, 2 or more, 5 or more, 10 or more, 20 or more, 50 or more, 100 or less, 75 or less, 60 or less, 40 or less, 25 or less, 15 or less, 10 or less, or 5 or less. In even further aspects, a degree of polymerization of the polymer can be in a range from 1 to 100, from 2 to 100, from 5 to 75, from 10 to 60, from 20 to 40, or any range or subrange therebetween. In even further aspects, a degree of polymerization of the polymer can be about 40 or less, for example, from 1 to 40, from 1 to 25, from 1 to 15, from 1 to 10, from 2 to 5, or any range or subrange therebetween.

In even further aspects, a polymer of the alkyl silane may comprise a structure {OSi(R)₂[CH₂]ₘ[Si(R)₂O]ₙSi(R)₂[CH₂]ₚSi(R)₂}_{q}R, wherein m and p are independently selected from 3 to 34, each R is independently selected from OCH₃, OH, and OSi(R′)₂[CH₂]_{m′}, m′ is independently selected from 3 to 34, n is 1 or more, q is 1 or more, and each R′ is independently selected from a group consisting of OCH₃, and OH. In aspects, n is 1 and q is 1, which results in the structure shown in FIG. 18B. Further, as shown in FIG. 18B, the shown structure can be directly bonded to a surface of the substrate or optical film. In aspects where R is OSi(R′)₂[CH₂]_{m′}, one or more monomers of the alkyl silane may form one or more branches, as shown in FIG. 18C. In yet further aspects, when n is 1, one or more of the following can also be true: R can be OCH₃, m can be 8, p can be 8, or combinations thereof. In still further aspects, n can be 1, and q can be within one or more of the corresponding ranges later in this paragraph. In still further aspects, n can be 2 or more (e.g., from 2 to 10, from 2 to 5, or 2), and q can be within one or more of the corresponding ranges later in this paragraph. For example, when n is 2 or more, one or more of the following can also be true: R′ can be CH₃, R″ can be CH₃, m can be 8, p can be 8, or combinations thereof. In yet further aspects, n can be 2, and q can be within one or more of the corresponding ranges later in this paragraph. For example, when n is 2, one or more of the following can also be true: R can be OCH₃, m can be 8, p can be 8, or combinations thereof. In still further aspects, R′ and R″ can be CH₃, which results in the structure shown in FIG. 18A as both a skeletal structure and SMILES. Further, as shown in FIG. 18A, the shown structure can be directly bonded to a surface of the substrate or optical film. In even further aspects, a degree of polymerization of the polymer can be 1 or more, 2 or more, 5 or more, 10 or more, 20 or more, 50 or more, 100 or less, 75 or less, 60 or less, 40 or less, 25 or less, 15 or less, 10 or less, or 5 or less. In even further aspects, a degree of polymerization of the polymer can be in a range from 1 to 100, from 2 to 100, from 5 to 75, from 10 to 60, from 20 to 40, or any range or subrange therebetween. In even further aspects, a degree of polymerization of the polymer can be about 40 or less, for example, from 1 to 40, from 1 to 25, from 1 to 15, from 1 to 10, from 2 to 5, or any range or subrange therebetween.

In even further aspects, the polymer of the alkyl silane may comprise a condensation product of monomeric units comprising {Si(R′)₂[CH₂]ₘSi(R′)₂O}, wherein each R′ is independently selected from CH₃ and CH₂CH₃, and m is from 3 to 34. In further aspects, one or more of the following can also be true: R′ may be CH₃, and may be 8. In further embodiments, the condensation product may further comprise monomeric units comprising {R″Si(OCH₃)₂}, {R″Si(OCH₃)}, {R″Si}, {R″Si(OCH₃)₂(OH)}, {R″Si(OCH₃)(OH)₂}, {R″Si(OH)₃}, or combinations thereof, wherein R″ is a (C5-C38) alkyl. In aspects, a ratio of the monomeric units comprising {Si(R′)₂[CH₂]ₘSi(R′)₂O} to the monomeric units comprising {R″Si(OCH₃)₂}, {R″Si(OCH₃)}, {R″Si}, {R″Si(OCH₃)₂(OH)}, {R″Si(OCH₃)(OH)₂}, {R″Si(OH)₃} or combinations thereof, may be from 10:1 to 1:10, such as from 10:1 to 1:9, 1:8, 1:7, 1:6, 1:5, 1:4, 1:3, 1:2, or 1:1, from 9:1 to 1:9, 1:8, 1:7, 1:6, 1:5, 1:4, 1:3, 1:2, or 1:1, from 8:1 to 1:9, 1:8, 1:7, 1:6, 1:5, 1:4, 1:3, 1:2, or 1:1, from 7:1 to 1:9, 1:8, 1:7, 1:6, 1:5, 1:4, 1:3, 1:2, or 1:1 from 6:1 to 1:9, 1:8, 1:7, 1:6, 1:5, 1:4, 1:3, 1:2, or 1:1 from 5:1 to 1:9, 1:8, 1:7, 1:6, 1:5, 1:4, 1:3, 1:2, or 1:1 from 4:1 to 1:9, 1:8, 1:7, 1:6, 1:5, 1:4, 1:3, 1:2, or 1:1 from 2:1 to 1:9, 1:8, 1:7, 1:6, 1:5, 1:4, 1:3, 1:2, or 1:1 from 2:1 to 1:9, 1:8, 1:7, 1:6, 1:5, 1:4, 1:3, 1:2, or 1:1, or from 1:1 to 1:9, 1:8, 1:7, 1:6, 1:5, 1:4, 1:3, or 1:2. In even further aspects, the polymer of the alkyl silane may comprise a condensation product of monomeric units comprising {OSi(CH₃)₂[CH₂]₈Si(CH₃)₂} and monomeric units comprising {(CH₃)(CH₂)₁₇Si(OCH₃)}, {(CH₃)(CH₂)₁₇Si}, or combinations thereof. In aspects, a ratio of the monomeric units {OSi(CH₃)₂[CH₂]₈Si(CH₃)₂} to the monomeric units comprising {(CH₃)(CH₂)₁₇Si(OCH₃)}, {(CH₃)(CH₂)₁₇Si}, or combinations thereof, may be from 10:1 to 1:10, such as from 10:1 to 1:9, 1:8, 1:7, 1:6, 1:5, 1:4, 1:3, 1:2, or 1:1, from 9:1 to 1:9, 1:8, 1:7, 1:6, 1:5, 1:4, 1:3, 1:2, or 1:1, from 8:1 to 1:9, 1:8, 1:7, 1:6, 1:5, 1:4, 1:3, 1:2, or 1:1, from 7:1 to 1:9, 1:8, 1:7, 1:6, 1:5, 1:4, 1:3, 1:2, or 1:1 from 6:1 to 1:9, 1:8, 1:7, 1:6, 1:5, 1:4, 1:3, 1:2, or 1:1 from 5:1 to 1:9, 1:8, 1:7, 1:6, 1:5, 1:4, 1:3, 1:2, or 1:1 from 4:1 to 1:9, 1:8, 1:7, 1:6, 1:5, 1:4, 1:3, 1:2, or 1:1 from 2:1 to 1:9, 1:8, 1:7, 1:6, 1:5, 1:4, 1:3, 1:2, or 1:1 from 2:1 to 1:9, 1:8, 1:7, 1:6, 1:5, 1:4, 1:3, 1:2, or 1:1, or from 1:1 to 1:9, 1:8, 1:7, 1:6, 1:5, 1:4, 1:3, or 1:2.

In even further aspects, the polymer of the alkyl silane may comprise a condensation product of monomeric units comprising {(OSi(R)₂[CH₂]ₘSi(R)₂}, wherein each R is independently selected from OCH₃ and OH, and m is from 3 to 34. In further aspects, one or more of the following can also be true: R may be OCH₃, and m may be 6 or 8. In aspects where R is OCH₃, the monomeric units may be modified to remove one or more methoxy groups during the formation of the polymer of the alkyl silane. In further aspects, the condensation product may further comprise monomeric units comprising {R″Si(OCH₃)₂}, {R″Si(OCH₃)}, {R″Si}, {R″Si(OCH₃)₂(OH)}, {R″Si(OCH₃)(OH)₂}, {R″Si(OH)₃} or combinations thereof, wherein R″ is a (C5-C38) alkyl. In aspects, a ratio of the monomeric units comprising {(OSi(R)₂[CH₂]ₘSi(R)₂} to the monomeric units comprising {R″Si(OCH₃)₂}, {R″Si(OCH₃)}, {R″Si}, {R″Si(OCH₃)₂(OH)}, {R″Si(OCH₃)(OH)₂}, {R″Si(OH)₃}, or combinations thereof, may be from 10:1 to 1:10, such as from 10:1 to 1:9, 1:8, 1:7, 1:6, 1:5, 1:4, 1:3, 1:2, or 1:1, from 9:1 to 1:9, 1:8, 1:7, 1:6, 1:5, 1:4, 1:3, 1:2, or 1:1, from 8:1 to 1:9, 1:8, 1:7, 1:6, 1:5, 1:4, 1:3, 1:2, or 1:1, from 7:1 to 1:9, 1:8, 1:7, 1:6, 1:5, 1:4, 1:3, 1:2, or 1:1 from 6:1 to 1:9, 1:8, 1:7, 1:6, 1:5, 1:4, 1:3, 1:2, or 1:1 from 5:1 to 1:9, 1:8, 1:7, 1:6, 1:5, 1:4, 1:3, 1:2, or 1:1 from 4:1 to 1:9, 1:8, 1:7, 1:6, 1:5, 1:4, 1:3, 1:2, or 1:1 from 2:1 to 1:9, 1:8, 1:7, 1:6, 1:5, 1:4, 1:3, 1:2, or 1:1 from 2:1 to 1:9, 1:8, 1:7, 1:6, 1:5, 1:4, 1:3, 1:2, or 1:1, or from 1:1 to 1:9, 1:8, 1:7, 1:6, 1:5, 1:4, 1:3, or 1:2. In even further aspects, the polymer of the alkyl silane may comprise a condensation product of monomeric units comprising {(OSi(OCH₃)₂[CH₂]₈Si(OCH₃)₂} and monomeric units comprising {(CH₃)(CH₂)₁₇Si(OCH₃)}, {(CH₃)(CH₂)₁₇Si}, or combinations thereof. In aspects, a ratio of the monomeric units comprising {(OSi(OCH₃)₂[CH₂]₈Si(OCH₃)₂} to the monomeric units comprising {(CH₃)(CH₂)₁₇Si(OCH₃)}, {(CH₃)(CH₂)₁₇Si}, or combinations thereof, may be from 10:1 to 1:10, such as from 10:1 to 1:9, 1:8, 1:7, 1:6, 1:5, 1:4, 1:3, 1:2, or 1:1, from 9:1 to 1:9, 1:8, 1:7, 1:6, 1:5, 1:4, 1:3, 1:2, or 1:1, from 8:1 to 1:9, 1:8, 1:7, 1:6, 1:5, 1:4, 1:3, 1:2, or 1:1, from 7:1 to 1:9, 1:8, 1:7, 1:6, 1:5, 1:4, 1:3, 1:2, or 1:1 from 6:1 to 1:9, 1:8, 1:7, 1:6, 1:5, 1:4, 1:3, 1:2, or 1:1 from 5:1 to 1:9, 1:8, 1:7, 1:6, 1:5, 1:4, 1:3, 1:2, or 1:1 from 4:1 to 1:9, 1:8, 1:7, 1:6, 1:5, 1:4, 1:3, 1:2, or 1:1 from 2:1 to 1:9, 1:8, 1:7, 1:6, 1:5, 1:4, 1:3, 1:2, or 1:1 from 2:1 to 1:9, 1:8, 1:7, 1:6, 1:5, 1:4, 1:3, 1:2, or 1:1, or from 1:1 to 1:9, 1:8, 1:7, 1:6, 1:5, 1:4, 1:3, or 1:2. In even further aspects, the polymer of the alkyl silane may comprise a condensation product of monomeric units comprising {(OSi(OCH₃)₂[CH₂]₆Si(OCH₃)₂} and monomeric units comprising {(CH₃)(CH₂)₁₇Si(OCH₃)}, {(CH₃)(CH₂)₁₇Si}, or combinations thereof. In aspects, a ratio of the monomeric units comprising {(OSi(OCH₃)₂[CH₂]₆Si(OCH₃)₂} to the monomeric units comprising {(CH₃)(CH₂)₁₇Si(OCH₃)}, {(CH₃)(CH₂)₁₇Si}, or combinations thereof, may be from 10:1 to 1:10, such as from 10:1 to 1:9, 1:8, 1:7, 1:6, 1:5, 1:4, 1:3, 1:2, or 1:1, from 9:1 to 1:9, 1:8, 1:7, 1:6, 1:5, 1:4, 1:3, 1:2, or 1:1, from 8:1 to 1:9, 1:8, 1:7, 1:6, 1:5, 1:4, 1:3, 1:2, or 1:1, from 7:1 to 1:9, 1:8, 1:7, 1:6, 1:5, 1:4, 1:3, 1:2, or 1:1 from 6:1 to 1:9, 1:8, 1:7, 1:6, 1:5, 1:4, 1:3, 1:2, or 1:1 from 5:1 to 1:9, 1:8, 1:7, 1:6, 1:5, 1:4, 1:3, 1:2, or 1:1 from 4:1 to 1:9, 1:8, 1:7, 1:6, 1:5, 1:4, 1:3, 1:2, or 1:1 from 2:1 to 1:9, 1:8, 1:7, 1:6, 1:5, 1:4, 1:3, 1:2, or 1:1 from 2:1 to 1:9, 1:8, 1:7, 1:6, 1:5, 1:4, 1:3, 1:2, or 1:1, or from 1:1 to 1:9, 1:8, 1:7, 1:6, 1:5, 1:4, 1:3, or 1:2. In aspects, at least a portion of the monomeric units may be linked to the substrate. In further aspects, the condensation product may further comprise monomeric units comprising {R″Si(R′″)₂}, {R″Si(R′″)}, {R″Si}, {R″Si(R′″)₂(OH)}, {R″Si(R′″)(OH)₂}, {R″Si(OH)₃}, or combinations thereof, wherein R″ is a (C5-C38) alkyl, and each R′″ is selected from a methoxy group, an ethoxy group, a hydroxy, or a linkage to the substrate.

In even further aspects, the polymer can be a homopolymer of a single alkyl silane (e.g., a single bis-silane). Alternatively, in even further aspects, the polymer can be a copolymer of more than one alkyl silane. For example, the polymer can be a copolymer of an alkyl silane and an addition alkyl silane that contributes to the siloxane part of the structure, as discussed above. An exemplary aspect of a copolymer in the structure discussed herein is the product of copolymerizing 1,8-bis(chlorodimethylsilyl)octane (see FIG. 17A) and dichloro-tetramethyl-disiloxane (see FIG. 17D). An additional exemplary aspect of a copolymer in the structure discussed herein is the product of copolymerizing 1,8-bis(dimethylmethoxysilyl)octane (see FIG. 17H) and dichloro-tetramethyl-disiloxane (see FIG. 17D). In still further aspects, at least one of the alkyl silanes in the copolymer can be a bis-silane and at least one of the alkyl silanes can include a non-fluorine halogen. For example, a structure of the copolymer can be {OSi(R′)₂[CH₂]ₘ[Si(R″)₂O]ₙSi(R′)₂[CH₂]p[Si(R″)₂]ₓ}_{q}R, where m and p are independently selected from 3 to 34, but m and p can be vary between adjacent monomers, R′ and R″ are independently selected from CH₃ and CH₂CH₃, n is 1 or more (e.g., n is 1, n is 2 or more, and/or n is 2) and can vary between adjacent monomers, and x is 0 or 1. R can be a hydroxyl group, a chloro group, a bromo group, an alkoxide, an alkyl silane, or combinations thereof. In particular aspects, R can be an alkoxide including a methoxy group, an ethoxy group, or combinations thereof. In still further aspects, n can be 1. In still further aspects, n can be 2 or more (e.g., from 2 to 10, from 2 to 5, or 2), and q can be within one or more of the corresponding ranges later in this paragraph. For example, when n is 2 or more (e.g., from 2 to 10, from 2 to 5, or 2), one or more of the following can also be true: R′ can be CH₃, R″ can be CH₃, m can be 8, p can be 8, or combinations thereof. In even further aspects, a degree of polymerization of the polymer can be 1 or more, 2 or more, 5 or more, 10 or more, 20 or more, 50 or more, 100 or less, 75 or less, 60 or less, 40 or less, 25 or less, 15 or less, or 9 or less. In even further aspects, a degree of polymerization of the polymer can be in a range from 1 to 100, from 2 to 100, from 5 to 75, from 10 to 60, from 20 to 40, or any range or subrange therebetween. In even further aspects, a degree of polymerization of the polymer can be about 40 or less, for example, from 1 to 40, from 1 to 25, from 1 to 15, from 1 to 10, from 2 to 5, or any range or subrange therebetween.

In further aspects, the alkyl silane can be part of a block copolymer of the alkyl silane that is bonded to the first major surface 105 of the substrate, the planarization layer 123, and/or or the fourth major surface 207 of the optical stack 203, 203a, or 203b. In even further aspects, a block copolymer can include a block corresponding to the polymer described in the preceding paragraph. In even further aspects, the block copolymer can comprise a dialkyl siloxane (e.g., dimethylsiloxane and/or diethylsiloxane, or combinations thereof) block. In further aspects, the block copolymer contains alternating blocks (i) containing a C₃-C₃₄ alkyl group and (ii) a dialkyl siloxane (e.g., dimethylsiloxane, diethylsiloxane, or combinations thereof). In even further aspects, the monomers in one or more blocks of the block copolymer can be bonded together by a disiloxane group. In even further aspects, the disiloxane group can include one or more dialkyl siloxanes (e.g., dimethylsiloxane, diethylsiloxane, or combinations thereof). In even further aspects, the copolymer can alternate between blocks of one more bis alkyl silanes and an additional alkyl silanes that contribute primarily to the siloxane (e.g., dialkylsiloxane, dimethylsiloxane) part of the resulting copolymer. In even further aspects, a dialkyl siloxane (e.g., dimethylsiloxane, diethylsiloxane, or combinations thereof) block of the block copolymer can correspond to the silica-like network described in the following paragraphs for the planarization layer 123.

As used herein, a “free end” of a molecule refers to an end of multiatom chain that is not bonded to another molecule (or another part of the same molecule at the free end. In this sense, the “free end” is “free” to interact with a potential fingerprint or other material. The “free end” can correspond to a terminal monomer (and/or a terminal portion thereof) of a polymeric material. In aspects, a silane group of the alkyl silane can be at a free end of the alkyl silane. Alternatively or additionally, a free end of the alkyl silane can comprise a non-fluoro halogen (e.g., chlorine). In aspects, the alkyl silane can be a bis-silane or a tris-silane. An exemplary aspect of a bis-silane is 1,8-bis(chlorodimethylsilyl)octane), as shown in see FIG. 17A. As discussed above, the alkyl silane can comprise the structure shown in FIG. 18A, for example, as (i) the product of homopolymerization of bis(chlorodimethylsilyl)octane) (see FIG. 17A) and/or (ii) the product of copolymerizing 1,8-bis(chlorodimethylsilyl)octane (see FIG. 17A) and dichloro-tetramethyl-disiloxane (see FIG. 17D). Another exemplary aspect of a bis-silane is 1,8-bis(dimethylmethoxysilyl)octane, as shown in see FIG. 17H. As discussed above, the alkyl silane can comprise the structure shown in FIG. 18A, for example, as (i) the product of homopolymerization of 1,8-bis(dimethylmethoxysilyl)octane (see FIG. 17H) and/or (ii) the product of copolymerizing 1,8-bis(dimethylmethoxysilyl)octane (see FIG. 17H) and dichloro-tetramethyl-disiloxane (see FIG. 17D). In aspects, the surface-modifying layer 113 (e.g., fingerprint-hiding coating) can comprise the alkyl silane bonded directly to another part of the coated article (e.g., first major surface 105 of the substrate, planarization layer 123, the fourth major surface 207 of the optical stack 203, 203a, or 230b). In further aspects, the alkyl silane can be directly bonded through a silane group of the alkyl silane. Alternatively or additionally, a free end of the alkyl silane can comprise a non-fluoro halogen (e.g., chlorine) and/or another silane (e.g., the alkyl silane can be a bis-silane).

As used herein, an elemental composition of the surface-modifying layer 113 (e.g., fingerprint-hiding coating) is determined using X-ray photoelectron spectroscopy (XPS). In aspects, the surface-modifying layer can be fluorine-free. In aspects, the surface-modifying layer 113 (e.g., fingerprint-hiding coating) can comprise silicon atoms, oxygen atoms, carbon atoms, and hydrogen atoms. In further aspects, the surface-modifying layer 113 (e.g., fingerprint-hiding coating) can further comprise nitrogen atoms. In further aspects, oxygen atoms in the surface-modifying layer can be more common than any other atom in the surface-modifying layer detected by XPS. In further aspects, the surface-modifying layer can comprise about 30 atom % carbon or less, about 25 atom % carbon or less, about 10 atom % carbon or less, about 2 atom % carbon or more, or about 5 atom % carbon or more. Providing a fluorine-free surface-modifying layer 113 (e.g., fingerprint-hiding coating) can be cheaper to produce and/or more environmentally friendly.

In aspects, an exterior (e.g., exterior surface 115) of the surface-modifying layer 113 (e.g., fingerprint-hiding coating) can be fluorine-free. In aspects, an exterior (e.g., exterior surface 115) of the surface-modifying layer 113 (e.g., fingerprint-hiding coating) can be free of a transition-metal containing compound. In aspects, an exterior (e.g., exterior surface 115) of the surface-modifying layer 113 (e.g., fingerprint-hiding coating) can contain a non-zero amount of a non-fluorine halogen (e.g., chlorine, bromine, iodine). In further aspects, an amount of the non-fluorine halogen at the exterior of the surface-modifying layer 113 can be about 0.5 atom % or more, about 0.7 atom % or more, about 0.8 atom % or more, about 1 atom % or more, about 1.2 atom % or more, about 1.5 atom % or more, about 2 atom % or less, about 1.5 atom % or less, about 1.3 atom % or less, about 1 atom % or less, about 0.9 atom % or less, about 0.8 atom % or less, or about 0.7 atom % or less. In further aspects, an amount of the non-fluorine halogen at the exterior of the surface-modifying layer 113 (e.g., fingerprint-hiding coating) can be in a range from about 0.5 atom % to about 2 atom %, from about 0.7 atom % to about 1.5 atom %, from about 0.8 atom % to about 1.5 atom %, from about 1 atom % to about 1.3 atom %, or any range or subrange therebetween. In further aspects, the non-fluorine halogen can be chlorine, and the amount of chlorine at the exterior of the surface-modifying layer 113 (e.g., fingerprint-hiding coating) can be within one or more of the ranges mentioned above in this paragraph.

As shown in FIGS. 35 and 36A-36C, the coated article 3501, 3601, 3611, or 3621 comprises the planarization layer 123 positioned between the substrate 103 (e.g., disposed over the first major surface 105 of the substrate 103) and the surface-modifying layer 113 (e.g., inner surface 117 of the surface-modifying layer 113). The planarization layer 123 comprises a first surface area 125 facing the first major surface 105 of the substrate 103 and a second surface area 127 (opposite the first surface area 125) facing and/or bonded to the surface-modifying layer 113 (e.g., inner surface 117 of the surface-modifying layer 113). In aspects, as shown in FIG. 35, the planarization layer 123 (e.g., second surface area 127) can be disposed on and/or bonded to the first major surface 105 of the substrate 103. In aspects, as shown in FIGS. 36A-36C, the planarization layer 123 e.g., second surface area 127) can be disposed over, disposed on, and/or contact the optical stack 203, 203a, or 203b positioned between the planarization layer 123 and the substrate 103. A planarization thickness 129 is defined as an average distance between the first surface area 125 and the second surface area 127. In aspects, the planarization thickness 129 can be about 10 nm or more, about 20 nm or more, about 50 nm or more, about 100 nm or more, about 200 nm or more, about 600 nm or less, about 500 nm or less, about 400 nm or less, about 350 nm or less, or about 300 nm or less. In aspects, the planarization thickness 129 can range from about 10 nm to about 500 nm, from about 20 nm to about 400 nm, from about 20 nm to about 300 nm, from about 20 nm to about 200 nm, from about 20 nm to about 150 nm, from about 20 nm to about 100 nm, from about 50 nm to about 100 nm, or any range or subrange therebetween. In aspects, the planarization thickness 129 can range from about 10 nm to about 600 nm, from about 20 nm to about 500 nm, from about 50 nm to about 400 nm, from about 100 nm to about 350 nm, from about 200 nm to about 300 nm, or any range or subrange therebetween. In exemplary aspects, the planarization thickness 129 can be from 10 nm to 600 nm or from 20 nm to 100 nm. The planarization thickness 129 is determined from ellipsometry.

In aspects, the silica-like network of the planarization layer 123 present disclosure can be readily distinguished from other silicon-containing oxides (e.g., a silica capping layer) by the properties discussed herein (e.g., hydroxyl content, hardness, refractive index, power spectral density of the surface, surface roughness Ra). For example, the silica-like network can comprise a greater hydroxyl content than a hydroxyl content of the capping layer; and/or the silica-like network can exhibit a lower hardness, lower elastic modulus, and/or higher refractive index than the corresponding property of the capping layer. As used herein, the term “planarization layer” is not intended to be limited by a specific surface roughness Ra (or a specific reduction in surface roughness Ra relative to the surface that the planarization layer is disposed on). Instead, the planarization can comprise any of the aspects discussed herein, including the hydroxyl content and/or the power spectral density in addition to or instead of surface roughness Ra properties.

Throughout the disclosure, an elastic modulus (e.g., Young's modulus) of the planarization layer 123 is determined using nanoindentation with a Berkovich diamond indenter tip. See: Fischer-Cripps, A. C., “Critical Review of Analysis and Interpretation of Nanoindentation Test Data,” Surface & Coatings Technology, 200, 4153-4165 (2006); and Hay, J., Agee, P, and Herbert, E., “Continuous Stiffness measurement During Instrumented Indentation Testing, Experimental Techniques,” 34 (3) 86-94 (2010). For coatings, instantaneous estimates of the elastic modulus are measured as a function of indentation depth. The elastic modulus is taken as the maximum value of the instantaneous estimate of the elastic modulus for measurements within the 50% of the planarization thickness 129 closest to the exterior surface 115 (i.e., first surface area 125) minus 5 nm of the planarization layer 123 from the exterior surface 115. Without wishing to be bound by theory, if a coating is of sufficient thickness, then it is then possible to isolate the properties of the coating from an adjacent coating based on the resulting response profiles as a function of depth. Extraction of reliable nanoindentation data is based on well-established protocols described in the above-mentioned references. Otherwise, these metrics can be subject to significant errors.

Throughout the disclosure, hardness is measured for planarization layers with a thickness of at least 30 nm as the maximum hardness recorded in a range of from 20 nm the first surface area 125 of the planarization layer 123 to 60% of the planarization thickness 129 (from the first surface area 125 of the planarization layer 123) in a Berkovich Indenter Hardness Test. It has been found that measurements closer to the surface than 20 nm tend to underestimate the hardness while measurements closer than 40% of the planarization thickness to an underlying layer can be significantly influenced by the properties of the underlying layer. For planarization layers with a thickness of 30 nm or less, it is believed that no reliable hardness measurement can be obtained. In aspects, an elastic modulus of the planarization layer 123 can be about 9 GPa or more, about 10 GPa or more, about 12 GPa or more, about 15 GPa or more, about 20 GPa or more, about 25 GPa or more, about 70 GPa or less, about 60 GPa or less, about 50 GPa or less, about 40 GPa or less, about 38 GPa or less, about 35 GPa or less, about 30 GPa or less, or about 25 GPa or less. In aspects, an elastic modulus of the planarization layer 123 can range from about 9 GPa to about 70 GPa, from about 9 GPa to about 60 GPa, from about 9 GPa to about 50 GPa, from about 10 GPa to about 40 GPa, from about 12 GPa to about 38 GPa, from about 15 GPa to about 35 GPa, from about 20 GPa to about 30 GPa, or any range or subrange therebetween.

In aspects, the planarization layer 123 can comprise a silica or a partial silica-like network. A silica-like network refers to a coordination of silicon atoms bonded together by oxygen atoms with four Si—O bonds for a silicon atom, corresponding to a SiO₂ network. As used herein, a fraction of silicon atoms in a silica-like-network is determined by Fourier-transform infrared (FTIR) spectroscopy based on an intensity of an absorbance associated with a Si—O—Si bend (e.g., from about 1000 cm⁻¹ to 1060 cm⁻¹) relative all Si—O—Si bends (including the T-type stretch of POSS at about 1105 cm⁻¹). In aspects, a percentage of silicon atoms in the planarization layer 123 in a silica-like network can be about 50% or more, about 60% or more, about 65% or more, about 70% or more, about 90% or less, about 80% or less, about 75% or less, or about 70% or less. In aspects, a percentage of silicon atoms in the planarization layer 123 in a silica-like network can range from about 50% to about 90%, from about 60% to about 80%, from about 65% to about 75%, or any range or subrange therebetween. Providing a partial silica-like network can enable the planarization layer to be stiff (e.g., elastic modulus of about 9 GPa or more) while remaining flexible enough to withstand abrasion with the surface-modifying layer disposed thereon.

A ratio of Si—O—Si bonds to silicon atoms of the planarization layer 123 can be measured using (a) XPS to determine an amount of Si—O bonds based on Si 2p fine structure relative to an overall amount of Si or (b) ²⁹Si solid-state nuclear magnetic resonance (NMR) based on fitting the observed chemical shifts to 6 Gaussian curves corresponding to different coordination structures (e.g., a T-unit, a D-unit, a M-unit, and three Q-units with different numbers of hydroxyls), where the functional group bonded to the silicon atom can be substituted with an organic group (e.g., carbon). In aspects, a ratio of Si—O—Si bonds to silicon atoms in the planarization layer 123 can be about 2 or more, about 2.2 or more, about 2.4 or more, about 2.6 or more, about 3 or less, about 2.9 or less, about 2.8 or less, or about 2.75 or less. In aspects, a ratio of Si—O—Si bonds to silicon atoms in the planarization layer 123 can range from about 2 to about 3, from about 2.2 to about 2.9, from about 2.4 to about 2.8, from about 2.6 to about 2.75, or any range or subrange therebetween.

In aspects, the planarization layer 123 can comprise one or more of (1) a percentage of silicon atoms in a silica-like network within one or more of the ranges discussed above (e.g., from about 50% to about 90%) or (2) a ratio of Si—O—Si bonds to silicon atoms within one or more of the ranges discussed above (e.g., from about 2 to about 3). In aspects, the planarization layer 123 can comprise nitrogen atoms, for example with nitrogen atoms bonded to silicon atoms. For example, the planarization layer 123 can be the product of at least partially curing a polysilazane over and/or on the first major surface 105 of the substrate 103 that can be reacted with a silane after being at least partially cured (to form a surface-modifying layer thereon). Alternatively, the planarization layer 123 can be free from nitrogen. In aspects, the planarization layer 123 can be the product of impinging an ion beam on the first major surface 105 of the substrate during and/or after a functionalized polyhedral oligomeric silsesquioxane (POSS) (defined below) is disposed over and/or on the first major surface 105 and reacted with a silane after the ion beam treatment (to form a surface-modifying layer thereon). In aspects, the planarization layer 123 can be the result of thermally curing a POSS (e.g., hydrogen POSS) compound disposed over and/or the first major surface 105 of the substrate 103 that can be reacted with a silane after being thermally cured (to form a surface-modifying layer thereon). In aspects, the surface-modifying layer 113 (e.g., fingerprint-hiding coating) can comprise at least one alkyl silane at the exterior surface 115 and bonded to (either directly or indirectly) Si—O groups in the planarization layer 123. In aspects, the surface-modifying layer 113 and/or the planarization layer 123 be free from fluorine and/or nitrogen. In aspects, the surface-modifying layer 113 and/or the planarization layer can consist of carbon, oxygen, silicon, hydrogen, and oxygen.

One way to quantify an amount (e.g., density) of hydroxyl in the surface-modifying layer 113 (e.g., below the alkyl silane) is based on molar ratios determined by secondary-ion mass spectroscopy (SIMS). Unless otherwise indicated, samples were cleaned with a low-energy Ar gas cluster ion beam (GCIB) source before analysis with SIMS. A molar ratio at the surface can be measured using static SIMS. Unless otherwise indicated, the molar ratio is for a bulk of the surface-modifying layer using dynamic SIMS (D-SIMS). Unlike static SIMS, dynamic SIMS erodes the surface to provide depth-resolved compositional information. As used herein, D-SIMS was conducted using a time-of-flight secondary ion mass spectrometer (ToF-SIMS) with a dual beam configuration. Unless otherwise indicated, the TOF-SIMS used for the results reported herein was a TOF-SIMS M6 instrument (available from IONTOF GmbH) equipped with a Nanoprobe50 bismuth source. The TOF-SIMS M6 instrument was operated with a dual-beam configuration, where the analysis beam was a 30 kilo-electronVolts (keV) Bi₃⁺ beam with a current of about 0.1 pA and the sputter beam was 2 keV Cs⁺ with a current of about 120 nA. The sputter beam was configured form a 300 μm by 300 μm sputter “crater,” and the analysis beam was configured to impinge a 75 μm by 75 μm area centered in the sputter “crater.” Charge compensation was achieved using an electron flood gun operating with 20 nA beam current, 20 eV electron energy, and a 1.5 mm spot size focused on the location impinged by the analysis beam. The chamber was evacuated to a pressure of 5×10⁻⁷ Pascals (5×10⁻⁹ millibar) before being brought to and maintained at a pressure of 5×10⁻⁵ Pascals (5×10⁻⁷ millibar) using argon (e.g., 99.99999% purity). Data was collected in negative ion mode with the analyzer in the “all purpose” mode, an analyzer energy of 3000 V and a cycle time of 100 microseconds. Data was processed using Surface Lab software (version 7.3.125519 available from IONTOF GmbH). To obtain molar ratios from ¹⁶O¹H⁻, ¹⁸O⁻, and ²⁸Si⁻ signals, the known isotope ratio between ¹⁸O⁻ and ¹⁷O⁻ was used to calculate and subtract the ¹⁷O⁻ interference from the ¹⁶O¹H⁻ signal. A normalized intensity was defined as the mass-interference-corrected ¹⁶O¹H⁻ signal divided by the ²⁸Si⁻ signal. The normalized intensity (¹⁶O¹H⁻/²⁸Si⁻) was further corrected to remove background signals (as determined from the normalized intensity (¹⁶O¹H⁻/²⁸Si⁻) contemporaneously measured from GE Type 124 fused quartz) to determine a “corrected signal.” The corrected signal was converted to a hydrogen to silicon molar ratio (“molar ratio”) using a calibration curve (derived from a series of natural mid-ocean-ridge basaltic (MORB) glasses with known —OH concentrations and other silica and silicate minerals covering a range from 0.0 wt % to 1.98 wt %) with an equation of “molar ratio”=1.26*“corrected signal”−0.025.

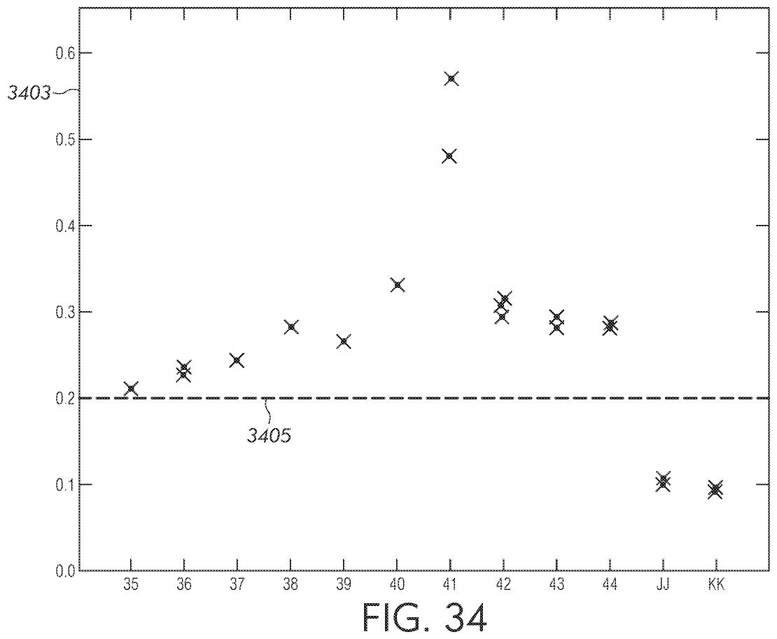

Throughout the disclosure, the “molar ratio” refers to a molar ratio of hydrogen to silicon (i.e., a molar amount of hydrogen divided by a molar amount of silicon) as determined by SIMS analysis of a material (e.g., surface-modifying layer below the alkyl silane). Without wishing to be bound by theory, it is believed that hydrogen is indicative of hydroxyl groups (e.g., silanol, Si—O—H). In aspects, a molar ratio (of hydrogen to silicon) of the surface-modifying layer below the alkyl silane can be about 0.2 or more (e.g., about 0.2 or more), about 0.21 or more, about 0.22 or more, about 0.23 or more, about 0.24 or more, about 0.25 or more, about 0.45 or less, about 0.4 or less, about 0.37 or less, about 0.35 or less, about 0.32 or less, about 0.30 or less, or about 0.28 or less. In aspects, a molar ratio (of hydrogen to silicon) can be in a range from about 0.2 to about 0.45, from about 0.20 to about 0.4 (e.g., from about 0.2 to about 0.4), from about 0.21 to about 0.37, from about 0.22 to about 0.35, from about 0.23 to about 0.32, from about 0.24 to about 0.32, from about 0.24 to about 0.30, from about 0.25 to about 0.28, or any range or subrange therebetween. In exemplary aspects, the molar ratio of hydrogen to silicon can be in a range from 0.20 to 0.4 or from about 0.22 to about 0.35. For example, as discussed below with reference to FIG. 34, the surface-modifying layers in accordance with aspects of the present disclosure (e.g., Examples 35-44) exhibits a molar ratio of hydrogen to silicon of 0.20 or more, from about 0.20 to 0.4, or from about 0.22 to about 0.35. In contrast, conventional methods of silica deposition (Comparative Examples JJ-KK) have a molar ratio of about 0.10 or less, meaning that Examples 35-44 have at least about double (2×) the molar ratio of Comparative Examples JJ-KK. In aspects, the molar ratio at the surface can be within any of the ranges recited above in this paragraph. In aspects, the molar ratio (of hydrogen to silicon) of the surface-modifying layer can be greater than the molar ratio of a reactively sputtered silica layer by a multiple of 2 or more, 2.5 or more, 3 or more, 4 or more, 10 or less, 7 or less, 5 or less, or 4 or less. In aspects, the molar ratio (of hydrogen to silicon) of the surface-modifying layer can be greater than the molar ratio of a reactively sputtered silica layer by a multiple in a range from about 2 to 10, from 2 to 7, from 2.5 to 5, from 2.5 to 4, from 3 to 4, or any range or subrange therebetween. In aspects, an ion intensity of carbon (as a ratio to the ion intensity of silicon) can be about 0.01 or less, about 0.005 or less, about 0.002 or less, or about 0.001 or less, for example, in a range from about 0.00001 to about 0.01, from about 0.00005 to about 0.005, from about 0.0001 to about 0.002, from about 0.0005 to about 0.001, or any range or subrange therebetween. The intensity of carbon is based on measurements that are corrected to remove background signals (as determined from the intensity of carbon measured from fused quartz).

In aspects, the surface-modifying layer 113 (e.g., fingerprint-hiding coating) and/or the coated article 101, 201, 211, 221, 3501, 3601, 3611, or 3621 can comprise an average transmittance (as described above) of about 80% or more, about 85% or more, about 88% or more, about 89% or more, about 90% or more, about 91% or more, about 92% or more, or about 93% or more. In aspects, the average transmittance of the surface-modifying layer 113 (e.g., fingerprint-hiding coating) and/or the coated article 101, 201, 211, 221, 3501, 3601, 3611, or 3621 can range from about 80% to 100%, from about 85% to about 99%, from about 88% to about 97%, from about 89% to about 97%, from about 90% to about 96%, from about 91% to about 95%, from about 92% to about 94%, or any range or subrange therebetween. In aspects, the transmittance of the surface-modifying layer 113 (e.g., fingerprint-hiding coating) and/or the coated article 101, 201, 211, 221, 3501, 3601, 3611, or 3621 at 550 nm can be within one or more of the ranges mentioned above in this paragraph for the average transmittance.

As used herein, haze refers to transmission haze that is measured through the surface-modifying layer 113 (e.g., fingerprint-hiding coating) and/or the coated article 101, 201, 211, 221, 3501, 3601, 3611, or 3621 (through the exterior surface 115) in accordance with ASTM D1003-21 at 0° relative to a direction normal to the exterior surface 115. Haze is measured using a HAZE-GARD PLUS available from BYK Gardner with an aperture over the source port. The aperture has a diameter of 8 mm. A CIE C illuminant is used as the light source for illuminating the surface-modifying layer 113 (e.g., fingerprint-hiding coating) and/or the coated article 101, 201, 211, 221, 3501, 3601, 3611, or 3621. In aspects, the surface-modifying layer 113 (e.g., fingerprint-hiding coating) and/or the coated article 101, 201, 211, 221, 3501, 3601, 3611, or 3621 comprises a haze of about 5% or less, about 2% or less, about 1.5% or less, about 1% or less, about 0.5% or less, or about 0.1% or less, for example from about 0.01% to about 5%, from about 0.01% to about 2%, from about 0.05% to about 1.5%, from about 0.05% to about 1%, from about 0.1% to about 0.5%, or any range or subrange therebetween.

Throughout the disclosure, contact angles are determined for a drop of a corresponding liquid disposed on the exterior surface (not treated with plasma nor corona) using a 30 gauge needle with the contact angle measured using a goniometer in accordance with ASTM D5946. If a contact angle cannot be reliably determined due to a high degree of droplet spread corresponding to a contact angle of 15° or less, then the coating is said to “wet” the droplet material. As used herein, water contact angles are measured using a drop of deionized water. As used herein, a coating is “hydrophobic” if it has a water contact angle of 90° or more. As used herein, a coating is “superhydrophobic” if it has a water contact angle of 130° or more. As used herein, an “as-formed” coating refers to a coating that has not been subjected to an abrasive (e.g., see Steel Wool Abrasion Test and Cheesecloth Abrasion Test below). As used herein, a coating is “oleophilic” if it has a hexadecane contact angle of less than 40°.

As used herein, a “uniformity” of a water contact angle is determined based on measurements of water contact angle at least every 5 mm over an area of 50 mm×50 mm of the exterior surface. Here, Uniformity is calculated as (Maximum−Minimum)/(2*Average)*100%, where “Maximum” and “Minimum” refer to the corresponding extremum, and “Average” is the mean value of the water contact angle measurements. In aspects, the surface-modifying layer 113 (e.g., fingerprint-hiding coating) can exhibit a uniformity of a water contact angle of about 10% or less or about 9% or less. In aspects, the surface-modifying layer 113 (e.g., fingerprint-hiding coating) can exhibit a uniformity of a water contact angle in a range from 1% to 10%, from 5% to 9%, or any range or subrange therebetween.

In aspects, the surface-modifying layer 113 (e.g., fingerprint-hiding coating) (e.g., as-formed) is hydrophobic but not superhydrophobic. In aspects, the water contact angle of the surface-modifying layer 113 (e.g., fingerprint-hiding coating) (e.g., as-formed) can be about 90° or more, about 95° or more, about 100° or more, about 105° or more, about 110° or more, about 115° or more, about 120° or less, about 115° or less, about 110° or less, or about 105° or less. In aspects, the water contact angle of the surface-modifying layer 113 (e.g., fingerprint-hiding coating) (e.g., as-formed) can range from about 90° to about 120°, from about 95° to about 115°, from about 95° to about 110°, from about 100° to about 110°, from about 105° to about 110°, or any range or subrange therebetween. In aspects, a diiodomethane contact angle of the surface-modifying layer 113 (e.g., fingerprint-hiding coating) (e.g., as-formed) can be about 60° or more, about 61° or more, about 62° or more, about 65° or more, about 80° or less, about 75° or less, about 73° or less, or about 70° or less. In aspects, a diiodomethane contact angle of the surface-modifying layer 113 (e.g., fingerprint-hiding coating) (e.g., as-formed) can range from about 60° to about 80°, from about 61° to about 75°, from about 61° to about 72°, from about 62° to about 70°, or any range or subrange therebetween. In aspects, the surface-modifying layer 113 (e.g., fingerprint-hiding coating) can be oleophilic. In aspects, an oleic acid contact angle of the surface-modifying layer 113 (e.g., fingerprint-hiding coating) (e.g., as-formed) can be about 50° or less, about 45° or less, about 400 or less, about 350 or less, about 300 or less, about 250 or less, about 200 or less, or the surface-modifying layer 113 (e.g., fingerprint-hiding coating) can wet oleic acid. In further aspects, the surface-modifying layer 113 (e.g., fingerprint-hiding coating) (e.g., as formed) wets oleic acid. Providing a low diiodomethane contact angle (e.g., about 60° or more) and/or a low hexadecane contact angle (e.g., about 20° or less) can reduce the visibility and/or color shift associated with fingerprints by enabling fingerprint oil to be dispersed across the surface-modifying layer 113 (e.g., fingerprint-hiding coating) rather than beading up into pronounced droplets. Providing a high water contact angle (e.g., about 90° or more, about 95° or more, or about 100° or more) can enhance the removal of aqueous material (e.g., water droplets, sweat droplets) from the surface-modifying layer 113 (e.g., fingerprint-hiding coating).

Throughout the disclosure, surface energy (e.g., total surface energy) and components thereof (e.g., polar, dispersive) are calculated using the Wu model based on contact angle measurements, as described above. In aspects, the surface-modifying layer 113 (e.g., fingerprint-hiding coating) can comprise a total surface energy of about 35 milliNewtons per meter (mN/m) or less, about 32 mN/m or less, about 31 mN/m or less, about 30 mN/m or less, about 29 mN/m or less, about 28 mN/m or less, about 27 mN/m or less, about 25 mN/m or more, about 26 mN/m or more, about 28 mN/m or more, about 30 mN/m or more, about 31 mN/m or more, or about 32 mN/m or more. In aspects, the surface-modifying layer 113 (e.g., fingerprint-hiding coating) can comprise a total surface energy ranging from about 25 mN/m to about 35 mN/m, from about 26 mN/m to about 32 mN/m, from about 26 mN/m to about 30 mN/m, from about 26 mN/m to about 29 mN/m, from about 26 mN/m to about 28 mN/m or any range or subrange therebetween. In aspects, the surface-modifying layer 113 (e.g., fingerprint-hiding coating) can comprise a dispersive surface energy of about 30 mN/m or less, about 28 mN/m or less, about 27 mN/m or less, about 26 mN/m or less, about 25 mN/m or less, about 24 mN/m or less, or about 23 mN/m or less. In aspects, the surface-modifying layer 113 (e.g., fingerprint-hiding coating) can comprise a dispersive surface energy ranging from about 15 mN/m to about 30 mN/m, from about 18 mN/m to about 30 mN/m, from about 20 mN/m to about 28 mN/m, from about 22 mN/m to about 28 mN/m, from about 24 mN/m to about 27 mN/m, or any range or subrange therebetween. In aspects, the surface-modifying layer 113 (e.g., fingerprint-hiding coating) can comprise a polar surface energy of about 6 mN/m or less, about 5 mN/m or less, about 4 mN/m or less, about 3 mN/m or less, or about 2 mN/m or less. In aspects, the surface-modifying layer 113 (e.g., fingerprint-hiding coating) can comprise a dispersive surface energy ranging from about 0.5 mN/m to about 6 mN/m, from about 1 mN/m to about 6 mN/m, from about 1.5 mN/m to about 6 mN/m, from about 2 mN/m to about 6 mN/m, from about 2 mN/m to about 5 mN/m, from about 2 mN/m to about 4 mN/m, or any range or subrange therebetween. Providing a low polar surface energy and/or a high dispersive surface energy a can enable oils (e.g., fingerprint oil) to be dispersed across the surface (e.g., oleophilic) of the surface-modifying layer 113 (e.g., fingerprint-hiding coating), which can decrease a visibility and/or a color shift associated with fingerprints.

Throughout the disclosure, the “Steel Wool Abrasion Test” is used to determine the durability of a coating. For the Steel Wool Abrasion Test, steel wool (Bonstar #0000) was cut into strips (25 mm×12 mm) and placed on a sheet of aluminum foil to bake in an oven for 2 hours at 100° C. A steel wool strip was fitted to an attachment (10 mm×10 mm) of an abrader (5750, Taber Industries) using a zip tie. Weights totaling 720 grams were added to the Taber arm to result in a total applied load of 1 kilogram. The stroke length was set at 25 mm, the speed was set to 60 cycles per minute, and testing occurred at 23° C. The area to be abraded was marked onto the back of the sample for tracking. A sample of the coating was secured in the abraded and subjected to 2,000 cycles or 3,500 cycles. After the coating is abraded for the predetermined number of cycles, an abraded water contact angle is measured in accordance with the method for the contact angle described above. A high contact angle (e.g., about 80° or more, about 85° or more, about 90° or more) is indicative of the surface-modifying layer 113 (e.g., fingerprint-hiding coating) surviving the Steel Wool Abrasion Test. Decreases in the contact angle below 70° correlate with a loss of the surface-modifying layer 113 (e.g., fingerprint-hiding coating). In aspects, the abraded water contact angle after 2,000 cycles and/or 35,000 cycles in the Steel Wool Abrasion Test can be about 80° or more, 85° or more, about 88° or more, or about 90° or more.

Throughout the disclosure, the “Cheesecloth Abrasion Test” is also used to determine the durability of a coating. In the Cheesecloth Abrasion Test, 4 layers of cheesecloth wrap (Crockmeter Squares for American Standards, 200877; SDL Atlas USA, Rock Hill, SC) are affixed to a cylindrical tip with a radius of 2 cm of a Linear Taber Abrader (Model 5750; Taber Industries, North Tonawanda, NY) with a constant load of 750 grams. The path-length of each swipe is 15 mm, with each cycle comprising a forward and backward swipe to return the tip to its original position before proceeding with the next cycle. The speed was 30 cycles per minute, testing occurred at 23° C. After the coating is abraded for 200,000 cycles, a cheesecloth-abraded water contact angle is measured in accordance with the method for the contact angle described above. In aspects, a cheesecloth-abraded water contact angle of the surface-modifying layer 113 (e.g., fingerprint-hiding coating) can be about 80° or more, about 85° or more, about 90° or more, about 95° or more, about 100° or more, about 105° or more, or about 110° or more. In aspects a difference between the water contact angle of the surface-modifying layer 113 (e.g., fingerprint-hiding coating) (as-formed) and the cheesecloth-abraded water contact angle (after 200,000 cycles) can be about 150 or less, about 120 or less, about 10° or less, or about 8° or less. As demonstrated by the results of the Steel Wool Abrasion Test and the Cheesecloth Abrasion Test, the surface-modifying layer 113 (e.g., fingerprint-hiding coating) of the present disclosure can withstand abrasion and maintain good contact angles.

Throughout the disclosure, the “Rubber Abrasion Test” is also used to determine the durability of a coating. In the Rubber Abrasion Test, a 6 mm diameter by 20 mm rod of rubber is affixed to a cylindrical tip with a length of 5 mm of a Linear Taber Abrader (Model 5750; Taber Industries, North Tonawanda, NY) with a constant load of 1 kg. The rod of rubber used herein was a Testick (available from Hwarang) with a hardness of 88 (HDC, as measured by a durometer). The path-length of each swipe is 15 mm, with each cycle comprising a forward and backward swipe to return the tip to its original position before proceeding with the next cycle. The speed was 40 cycles per minute, testing occurred at 23° C. After the coating is abraded for 3,000 cycles, a rubber-abraded water contact angle is measured in accordance with the method for the contact angle described above. In aspects, a rubber-abraded water contact angle of the surface-modifying layer 113 (e.g., fingerprint-hiding coating) can be about 80° or more, about 85° or more, about 90° or more, about 95° or more, about 100° or more, about 105° or more, or about 110° or more. In aspects a difference between the water contact angle of the surface-modifying layer 113 (e.g., fingerprint-hiding coating) (as-formed) and the rubber-abraded water contact angle (after 3,000 cycles) can be about 15° or less, about 12° or less, about 10° or less, or about 8° or less.

As used herein, “surface roughness” means the Ra surface roughness, which is an arithmetical mean of the absolute deviations of a surface profile from an average position in a direction normal to the surface of the test area. Ra surface roughness values for an 2 μm by 2 μm test area using atomic force microscopy (AFM). In aspects, the surface-modifying layer 113 and/or the planarization layer 123 can comprise a surface roughness Ra (e.g., as-formed) of about 1 nm or less, 0.8 nm or less, 0.7 nm or less, about 0.6 nm or less, about 0.5 nm or less, about 0.1 nm or more, about 0.2 nm or more, about 0.3 nm or more, or about 0.4 nm or more. In aspects, the surface-modifying layer 113 and/or the planarization layer 123 can comprise a surface roughness Ra (e.g., as-formed) ranging from about 0.1 nm to about 1 nm, from about 0.2 nm to about 0.8 nm, from about 0.3 nm to about 0.7 nm, from about 0.4 nm to about 0.5 nm, or any range or subrange therebetween.

Throughout the disclosure, a coefficient of friction refers to a dynamic coefficient of friction measured in accordance with ASTM D1894-14. In aspects, the exterior surface 115 of the surface-modifying layer 113 (e.g., fingerprint-hiding coating) can comprise a dynamic coefficient of friction of about 0.25 or less, about 0.22 or less, about 0.20 or less, about 0.18 or less, or about 0.15 or less. In aspects, the exterior surface 115 of the surface-modifying layer 113 (e.g., fingerprint-hiding coating) can comprise a dynamic coefficient of friction in a range from 0.05 to about 0.25, from about 0.10 to about 0.22, from about 0.12 to about 0.20, from about 0.15 to about 0.18, or any range or subrange therebetween.

Throughout the disclosure, a refractive index of coatings and films is measured by spectroscopic ellipsometry using a Woollam M-2000 and modelled using Wollam CompleteEase software. Unless otherwise specified, refractive index is measured at 550 nm. In aspects, a refractive index of the planarization layer 123 can be about 1.37 or more, about 1.38 or more, about 1.4 or more, about 1.42 or more, about 1.44 or more, about 1.48 or more, about 1.5 or more, about 1.55 or less, about 1.53 or less, about 1.49 or less, about 1.44 or less, about 1.42 or less, or about 1.4 or less. In aspects, a refractive index of the planarization layer 123 can range from about from about 1.37 to about 1.55, 1.38 to about 1.55, from about 1.42 to about 1.55, from about 1.44 to about 1.55, from about 1.44 to about 1.53, from about 1.48 to about 1.51, or any range or subrange therebetween. In aspects, the refractive index of the planarization layer 123 can be about 1.51 or less, for example, in a range from about 1.37 to about 1.51, from about 1.37 to about 1.50, from about 1.37 to about 1.49, from about 1.38 to about 1.44, from about 1.4 to about 1.42, or any range or subrange therebetween. In aspects, a refractive index of the substrate 103 can be greater than or less than the refractive index of the planarization layer 123. As discussed below, different compositions of the planarization layer 123 can have different refractive index values or ranges.

Throughout the disclosure, properties of the surface-modifying layer 113 (e.g., fingerprint-hiding coating) are characterized in terms of a behavior of a simulated fingerprint applied in a Simulated Fingerprint Test. As used herein, the Simulated Fingerprint Test comprises: (1) cleaning a surface of the sample to be tested and an artificial silicone fingerprint with isopropyl alcohol; (2) heating artificial sebum in a glass petri dish and then letting the artificial sebum cool to room temperature (25° C.); (3) pressing a fingerprint portion of the artificial silicone finger into the cooled artificial sebum; and (3) placing the fingerprint portion of the artificial silicon finger onto the surface of the sample to be tested and transferring the artificial sebum from the fingerprint portion to the surface as a simulated fingerprint.

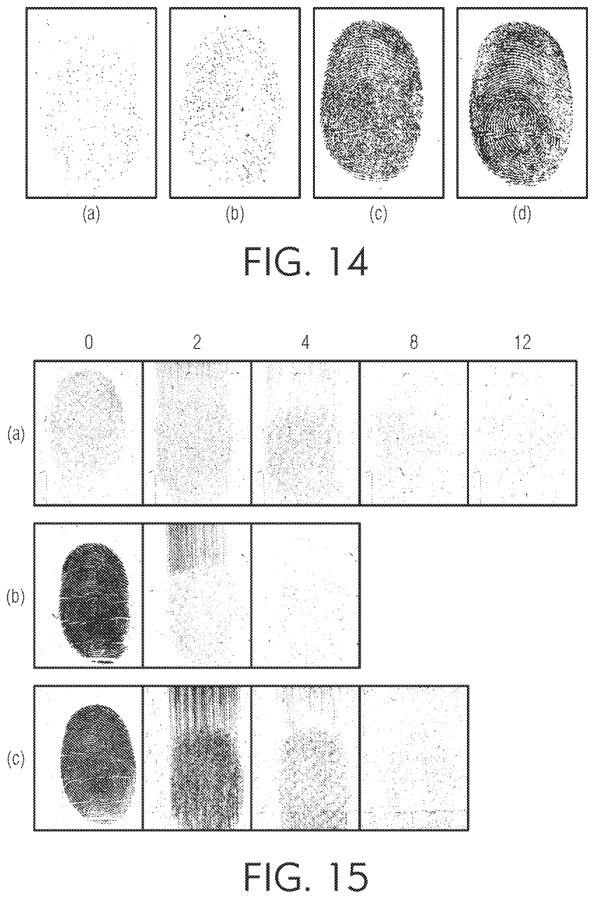

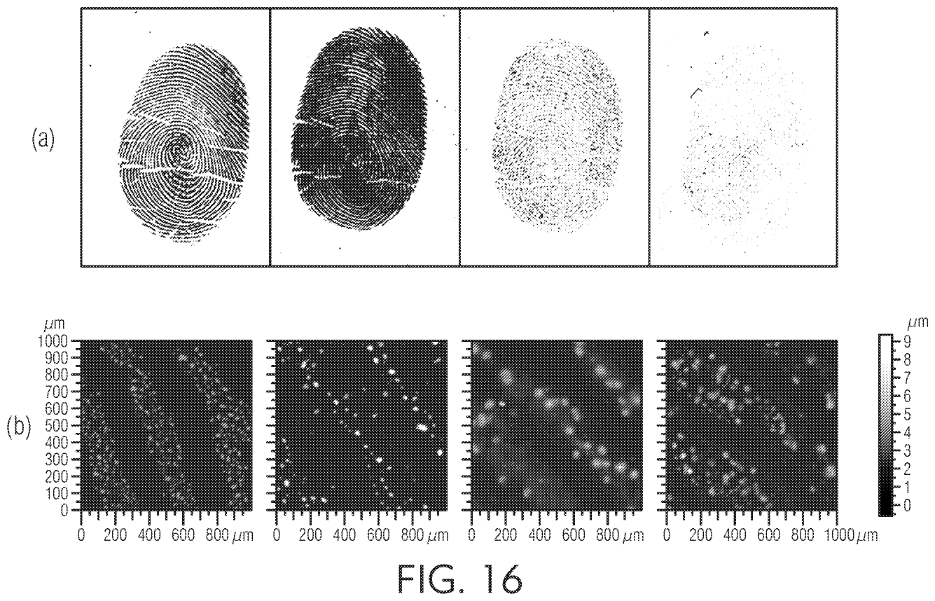

In aspects, a visibility of a fingerprint on the surface-modifying layer 113 (e.g., fingerprint-hiding coating), as defined above as an absolute value of a difference between CIELAB L* values for a portion of the surface-modifying layer 113 (e.g., fingerprint-hiding coating) with and without fingerprint oil, can be about 15 or less, about 10 or less, about 8 or less, about 5 or less, about 2 or less. In aspects, a visibility of a fingerprint on the surface-modifying layer 113 (e.g., fingerprint-hiding coating) can range from 0 to 15, from about 0.5 to about 10, from about 1 to about 8, from about 2 to about 5, or any range or subrange therebetween. In aspects, a color shift of a fingerprint on the surface-modifying layer 113 (e.g., fingerprint-hiding coating), as defined above as √((a₁*−a₂*)²+(b₁*−b₂*)²), can be about 15 or less, about 10 or less, about 8 or less, about 5 or less, about 2 or less. In aspects, a color shift of a fingerprint on the surface-modifying layer 113 (e.g., fingerprint-hiding coating) can range from 0 to 15, from about 0.5 to about 10, from about 1 to about 8, from about 2 to about 5, or any range or subrange therebetween. FIG. 14 and FIG. 16(a) show a photograph of the simulated fingerprint applied to various coated articles (discussed in more detail in the Examples) with the Simulated Fingerprint Test.

As used herein, “haze” refers to transmission haze that is measured through the surface-modifying layer 113 of the coated article 101, 201, 211, 221, 3501, 3601, 3611, or 3621 (through the exterior surface 115) in accordance with ASTM D1003-21 at 0° relative to a direction normal to the exterior surface 115. Haze is measured using a HAZE-GARD PLUS available from BYK Gardner with an aperture over the source port. The aperture has a diameter of 8 mm. A CIE C illuminant is used as the light source for illuminating the surface-modifying layer 113 and/or through the coated article 101, 201, 211, 221, 3501, 3601, 3611, or 3621. In aspects, when a simulated fingerprint is applied to the surface-modifying layer 113 in the Simulated Fingerprint Test, the surface-modifying layer 113 exhibits a haze (i.e., transmission haze measured after the simulated fingerprint is applied) of 8% or less, 7% or less, 6% or less, 5% or less, 4% or less, 1% or more, 2% or more, 3% or more, 4% or more, or 5% or more. In aspects, the surface-modifying layer 113 exhibits a haze (i.e., transmission haze measured after the simulated fingerprint is applied) in a range from 1% to 8%, from 2% to 7%, from 3% to 7%, from 3% to 6%, or any range or subrange therebetween. As discussed below, the Comparative Examples exhibits a haze greater than 10%, which is different from the above-mentioned ranges in statistically significant way and demonstrates that the surface-modifying layer 113 (e.g., fingerprint-hiding coating) of the present disclosure does a better job of “hiding” visual effects associated with an applied fingerprint than the Comparative Examples.

As used herein, a “mean gray level” was determined in a Gray Level Test using the Simulated Fingerprint Test. Specifically, the Gray Level Test involves photographing the surface-modifying layer 113 (e.g., fingerprint-hiding coating) before and after application of the simulated fingerprint in the Simulated Fingerprint Test using a Canon Rebel T7 DSLR camera equipped with a Canon EF-S 60 mm Macro Lens and illuminated using a ring light; the camera was operating in manual mode with manual focus; photographs were captured in the RAW format and were processed with ImageJ to determine the mean gray level value in the photograph after application of the simulated fingerprint, where a range of physically possible mean gray values from 0 to 609. In aspects, the surface-modifying layer 113 (e.g., fingerprint-hiding coating) exhibits a mean gray value from the application of a simulated fingerprint in the Simulated Fingerprint Test of 150 or less, 145 or less, 140 or less, 135 or less, 130 or less, 125 or less, 120 or less, 115 or less, 110 or less, 105 or less, 100 or less, 50 or more, 60 or more, 70 or more, 80 or more, 90 or more, 95 or more, 98 or more, or 100 or more. In aspects, the surface-modifying layer 113 (e.g., fingerprint-hiding coating) exhibits a mean gray value from the application of a simulated fingerprint in the Simulated Fingerprint Test in a range from 50 to 150, from 60 to 140, from 70 to 130, from 50 to 125, from 60 to 120, from 70 to 115, from 80 to 110, from 90 to 105, from 95 to 100, or any range or subrange therebetween. As discussed below, the Comparative Examples exhibits a mean gray value greater than 140 (e.g., greater than 300), which is different from the above-mentioned ranges in statistically significant way. As discussed below, the Comparative Examples exhibits a mean gray value greater than 140 (or greater than 300) which is different from the above-mentioned ranges in statistically significant way and demonstrates that the surface-modifying layer 113 (e.g., fingerprint-hiding coating) of the present disclosure does a better job of “hiding” visual effects associated with an applied fingerprint than the Comparative Examples.

As used herein, a “normalized gray level” was determined using a Normalized Gray Level Test. In the Normalized Gray Level Test uses the before and after photographs described in the previous paragraph for the Gray Level Test that are processed with ImageJ to determine the average gray level values in each photograph. The Normalized Gray Level Test takes a ratio of the average gray level value of the after (with the simulated fingerprint) photograph to the average gray level of the before photograph (i.e., after divided by before). For example, a normalized gray level of 1.0 means that the simulated fingerprint did not change the average gray levels at all while a normalized gray level of 2.0 means that the average gray value of the simulated fingerprint is twice that of the average gray value in the before (reference) photograph. In aspects, the normalized gray level (as measured in the Normalized Gray Level Test) of the coated article (having the surface-modifying layer 113) with the simulated fingerprint applied to the surface-modifying layer 113 (e.g., fingerprint-hiding coating) in the Simulated Fingerprint can be about 2.0 or less, about 1.95 or less, about 1.90 or less, about 1.85 or less, about 1.70 or less, about 1.65 or less, about 1.6 or less, about 1.55 or less, about 1.5 or less, about 1.45 or less, about 1.40 or less, about 1.35 or less, about 1.30 or less, about 1.25 or less, about 1.0 or more, about 1.05 or more, about 1.10 or more, about 1.15 or more, about 1.20 or more, or about 1.25 or more. In aspects, the normalized gray level (as measured in the Normalized Gray Level Test) of the coated article (having the surface-modifying layer) with the simulated fingerprint applied to the surface-modifying layer 113 (e.g., fingerprint-hiding coating) in the Simulated Fingerprint can be in a range from about 1.0 to about 1.5, from about 1.05 to about 1.45, from about 1.10 to about 1.40, from about 1.15 to about 1.35, from about 1.20 to about 1.30, from about 1.25 to about 1.30, or any range therebetween. As discussed in the examples herein, surface-modifying layers (e.g., fingerprint-hiding coating) in accordance with the presence disclosure can provide a normalized gray level of about 2.0 or less or 1.5 or less that can be 50% or less of other (comparative) coatings tested (e.g., based on functionalized poly(dimethyl siloxane) (PDMS)).

Unless otherwise, indicated, additional properties exhibited by the surface-modifying layer 113 (e.g., fingerprint-hiding coating) when the simulated fingerprint is applied in the Simulated Fingerprint Test are measured using Bruker ContourGT-X white light interferometer and the vertical scanning interferometry (VSI) method at 20× objective lens and 0.55× magnification of four 1 mm×1 mm areas per sample. As used herein, properties measured with the vertical scanning interferometry method are measured and reported consistent with ISO 25178 and ISO 21920.

In aspects, the surface-modifying layer 113 (e.g., fingerprint-hiding coating) exhibits a mean height of the droplets of the simulated fingerprint applied in the Simulated Fingerprint Test of 0.17 μm or less, 0.15 μm or less, 0.13 μm or less, 0.12 μm or less 0.11 μm or less, or 0.10 μm or less. In aspects, the surface-modifying layer 113 (e.g., fingerprint-hiding coating) exhibits a mean height of the droplets of the simulated fingerprint applied in the Simulated Fingerprint Test in a range from 0.01 μm to 0.17 μm, from 0.05 μm to 0.15 μm, from 0.06 μm to 0.13 μm, from 0.07 μm to 0.12 μm or less, from 0.08 μm to 0.11 μm, or from 0.09 μm to 0.10 μm, or any range or subrange therebetween. As discussed below, the Comparative Examples exhibit a mean height of 0.20 μm or more (e.g., 0.65 μm or more) that is different from the above-mentioned ranges in statistically significant way and conveys a difference in the size of the droplets formed, which may be related to differences in the oleic acid contact angle (e.g., oleophilic versus oleophobic).

In aspects, the surface-modifying layer 113 (e.g., fingerprint-hiding coating) exhibits a ratio of a height of a droplet of the simulated fingerprint applied in the Simulated Fingerprint Test to an area of the droplet of 0.006 μm/μm² or less, 0.005 μm/μm² or less, 0.0045 μm/μm² or less, or 0.004 μm/μm² or less. In aspects, the surface-modifying layer 113 (e.g., fingerprint-hiding coating) exhibits a ratio of a height of a droplet of the simulated fingerprint applied in the Simulated Fingerprint Test to an area of the droplet in a range from 0.001 μm/μm² to 0.006 μm/μm², from 0.002 μm/μm² to 0.005 μm/μm², from 0.0025 μm/μm² to 0.0045 μm/μm², from 0.003 μm/μm² to 0.004 μm/μm², or any range or subrange therebetween. As discussed below, the Comparative Examples exhibit a height to area ratio of 0.008 μm/μm² or more (e.g., 0.023 μm/μm² or more) that is different from the above-mentioned ranges, which may be related to differences in the oleic acid contact angle (e.g., oleophilic versus oleophobic).

In aspects, the surface-modifying layer 113 (e.g., fingerprint-hiding coating) exhibits a ratio of a volume of a droplet of the simulated fingerprint applied in the Simulated Fingerprint Test to an area of the droplet of 0.78 μm³/μm² or less, 0.76 μm³/μm² or less, 0.75 μm³/² or less, 0.74 μm³/μm² or less, 0.73 μm³/μm² or less, 0.70 μm³/μm² or less, 0.60 μm³/² or less, 0.55 μm³/μm² or less, or 0.50 μm³/μm² or less. In aspects, the surface-modifying layer 113 (e.g., fingerprint-hiding coating) exhibits a ratio of a volume of a droplet of the simulated fingerprint applied in the Simulated Fingerprint Test to an area of the droplet in a range from 0.10 μm³/μm² to 0.78 μm³/μm², from 0.20 μm³/μm² to 0.76 μm³/μm², from 0.25 μm³/μm² to 0.75 μm³/μm², from 0.30 μm³/μm² to 0.74 μm³/μm², from 0.35 μm³/μm² to 0.73 μm³/μm², from 0.40 μm³/μm² to 0.72 μm³/μm², or any range or subrange therebetween.

In aspects, the surface-modifying layer 113 (e.g., fingerprint-hiding coating) exhibits a radius of a spherical cap fitted to a droplet of the simulated fingerprint applied in the Simulated Fingerprint Test of 40 μm or more, 50 μm or more, 60 μm or more, 70 μm or more, 80 μm or more, 90 μm or more, or 100 μm or more. In aspects, the surface-modifying layer 113 (e.g., fingerprint-hiding coating) exhibits a radius of a spherical cap fitted to a droplet of the simulated fingerprint applied in the Simulated Fingerprint Test in a range from 40 μm to 200 μm, from 50 μm to 180 μm, from 60 μm to 160 μm, from 70 μm to 140 μm, from 80 μm to 120 μm, from 90 μm to 110 μm, or any range or subrange therebetween. As discussed below, the Comparative Examples exhibit a spherical cap radius of 21 μm or less (e.g., 10 μm or less) that is different from the above-mentioned ranges in statistically significant way and conveys a difference in the size of the droplets formed, which may be related to differences in the oleic acid contact angle (e.g., oleophilic versus oleophobic).

In aspects, the surface-modifying layer 113 (e.g., fingerprint-hiding coating) exhibits a center of sphere fitted to a droplet of the simulated fingerprint applied in the Simulated Fingerprint Test that is away from the exterior surface of the surface-modifying layer 113 (e.g., fingerprint-hiding coating) by 30 μm or more, 40 μm or more, 50 μm or more, 60 μm or more, 70 μm or more, 80 μm or more, or 90 μm or more. In aspects, the surface-modifying layer 113 (e.g., fingerprint-hiding coating) exhibits a center of sphere fitted to a droplet of the simulated fingerprint applied in the Simulated Fingerprint Test that is away from the exterior surface of the surface-modifying layer 113 (e.g., fingerprint-hiding coating) by from 30 μm to 200 μm, from 40 μm to 180 μm, from 50 μm to 160 μm, from 60 μm to 140 μm, from 80 μm to 120 μm, from 90 μm to 110 μm, or any range or subrange therebetween. As discussed below, the Comparative Examples exhibit a center of a fitted sphere that is within of 20 μm (e.g., 6 μm or less) from the exterior surface that is different from the above-mentioned ranges in statistically significant way and conveys a difference in the size of the droplets formed, which may be related to differences in the oleic acid contact angle (e.g., oleophilic versus oleophobic).

In aspects, the surface-modifying layer 113 (e.g., fingerprint-hiding coating) exhibits a mean effective diameter of a droplet of the simulated fingerprint applied in the Simulated Fingerprint Test of 10 μm or more, 11 μm or more, 12 μm or more, 13 μm or more, 14 μm or more, 15 μm or more, 16 μm or more, 17 μm or more, or 18 μm or more. In aspects, the surface-modifying layer 113 (e.g., fingerprint-hiding coating) exhibits a mean effective diameter of a droplet of the simulated fingerprint applied in the Simulated Fingerprint Test in a range from 10 μm to 40 μm, from 11 μm to 35 μm, from 12 μm to 30 μm, from 13 μm to 28 μm, from 14 μm to 26 μm, from 15 μm to 24 μm, from 16 μm to 22 μm, from 17 μm to 20 μm, or any range or subrange therebetween. As discussed below, the Comparative Examples exhibit a mean effective diameter that is less than 8 μm that is different from the above-mentioned ranges in statistically significant way and conveys a difference in the size of the droplets formed, which may be related to differences in the oleic acid contact angle (e.g., oleophilic versus oleophobic).

In aspects, the surface-modifying layer 113 (e.g., fingerprint-hiding coating) exhibits a mean area of a droplet of the simulated fingerprint applied in the Simulated Fingerprint Test of 200 μm² or more, 400 μm² or more, 600 μm² or more, 700 μm² or more, 800 μm² or more, 900 μm² or more, or 1000 μm² or more. In aspects, the surface-modifying layer 113 (e.g., fingerprint-hiding coating) coating exhibits a mean area of a droplet of the simulated fingerprint applied in the Simulated Fingerprint Test in a range from 200 μm² to 3000 μm², from 400 μm² to 2500 μm², from 500 μm² to 2000 μm², from 600 μm² to 1900 μm², from 700 μm² to 1800 μm², from 800 μm² to 1700 μm², or any range or subrange therebetween. As discussed below, the Comparative Examples exhibit a mean area that is less than 200 μm² (e.g., 125 μm² or less) that is different from the above-mentioned ranges in statistically significant way and conveys a difference in the size of the droplets formed, which may be related to differences in the oleic acid contact angle (e.g., oleophilic versus oleophobic).

In aspects, the surface-modifying layer 113 (e.g., fingerprint-hiding coating) exhibits a total area of all droplets associated with the simulated fingerprint applied in the Simulated Fingerprint Test of 150,000 μm² or more, 170,000 μm² or more, 200,000 μm² or more, 220,000 μm² or more, 240,000 μm² or more, or 250,000 μm² or more. In aspects, the surface-modifying layer 113 (e.g., fingerprint-hiding coating) exhibits a total area of all droplets associated with the simulated fingerprint applied in the Simulated Fingerprint Test in a range from 150,000 μm² to 1,000,000 μm², from 170,000 μm² to 800,000 μm², from 200,000 μm² to 600,000 μm², from 220,000 μm² to 500,000 μm², from 240,000 μm² to 400,000 μm², from 250,000 μm² to 300,000 μm², or any range or subrange therebetween. As discussed below, the Comparative Examples exhibit a mean area that is less than 120,000 μm² (e.g., 55,000 μm² or less) that is different from the above-mentioned ranges in statistically significant way and conveys a difference in the size of the droplets formed, which may be related to differences in the oleic acid contact angle (e.g., oleophilic versus oleophobic).

In aspects, the surface-modifying layer 113 (e.g., fingerprint-hiding coating) exhibits a mean hill form factor Sdff of a droplet of the simulated fingerprint applied in the Simulated Fingerprint Test of 0.65 or more, 0.67 or more, 0.68 or more, 0.69 or more, or 0.70 or more. In aspects, the surface-modifying layer 113 (e.g., fingerprint-hiding coating) exhibits a mean hill form factor Sdff of a droplet of the simulated fingerprint applied in the Simulated Fingerprint Test of from 0.65 to 1.00, from 0.65 to 0.90, from 0.67 to 0.85, from 0.68 to 0.80, from 0.69 to 0.75, from 0.70 to 0.73, or any range or subrange therebetween.

In aspects, the surface-modifying layer 113 (e.g., fingerprint-hiding coating) exhibits a mean hill equivalent diameter Shed of a droplet of the simulated fingerprint applied in the Simulated Fingerprint Test of 60 μm or more, 65 μm or more, 70 μm or more, 75 μm or more, 80 μm or more, 85 μm or more, or 90 μm or more. In aspects, the surface-modifying layer 113 (e.g., fingerprint-hiding coating) exhibits a mean hill equivalent diameter Shed of a droplet of the simulated fingerprint applied in the Simulated Fingerprint Test in a range from 60 μm to 200 μm, from 65 μm to 150 μm, from 70 μm to 130 μm, from 75 μm to 110 μm, from 80 μm to 100 μm, or any range or subrange therebetween.

In aspects, the surface-modifying layer 113 (e.g., fingerprint-hiding coating) exhibits a material ratio of hills Smrk1 of a droplet of the simulated fingerprint applied in the Simulated Fingerprint Test of 25% or more, 28% or more, 30% or more, 310% or more, 32% or more, 33% or more, or 34% or more. In aspects, the surface-modifying layer 113 (e.g., fingerprint-hiding coating) exhibits a material ratio of hills Smrk1 of a droplet of the simulated fingerprint applied in the Simulated Fingerprint Test in a range from 25% to 50%, from 28% to 45%, from 30% to 40%, from 31% to 38%, from 32% to 35%, or any range or subrange therebetween.

In aspects, the surface-modifying layer 113 (e.g., fingerprint-hiding coating) exhibits an inverse areal material ratio Smc for an areal material ratio of 10% of a droplet of the simulated fingerprint applied in the Simulated Fingerprint Test of 0.2 μm or more, 0.22 μm or more, 0.25 μm or more, 0.27 μm or more, 0.29 μm or more, 0.32 μm or more, 0.35 μm or more, 0.37 μm or more, or 0.40 μm or more. In aspects, the surface-modifying layer 113 (e.g., fingerprint-hiding coating) exhibits an inverse areal material ratio Smc for an areal material ratio of 10% of a droplet of the simulated fingerprint applied in the Simulated Fingerprint Test in a range from 0.2 μm to 0.7 μm, 0.22 μm to 0.65 μm, 0.25 μm to 0.60 μm, 0.27 μm to 0.55 μm, 0.29 μm to 0.50 μm, from 0.32 μm to 0.45 μm, from 0.35 μm to 0.40 μm, or any range or subrange therebetween.

In aspects, the surface-modifying layer 113 (e.g., fingerprint-hiding coating) exhibits an areal sectional height difference between areal material ratios of 10% and 90% a droplet of the simulated fingerprint applied in the Simulated Fingerprint Test of 0.40 μm or more, 0.45 μm or more, 0.5 μm or more, 0.55 μm or more, 0.6 μm or more, 0.65 μm or more, 0.70 μm or more, or 0.75 μm or more. In aspects, the surface-modifying layer 113 (e.g., fingerprint-hiding coating) exhibits an areal sectional height difference between areal material ratios of 10% and 90% a droplet of the simulated fingerprint applied in the Simulated Fingerprint Test in a range from 0.40 μm to 2.0 μm, from 0.45 μm to 1.5 μm, from 0.5 μm to 1.4 μm, from 0.55 μm to 1.3 μm, from 0.6 μm to 1.2 μm, from 0.65 μm to 1.1 μm, from 0.7 μm to 1.0 μm, from 0.75 μm to 0.90 μm, or any range or subrange therebetween.

In aspects, the surface-modifying layer 113 (e.g., fingerprint-hiding coating) exhibits a core material value Vmc between areal material ratios of 10% and 90% a droplet of the simulated fingerprint applied in the Simulated Fingerprint Test of 0.10 μm³/μm² or more, 0.12 μm³/μm² or more, 0.15 μm³/μm² or more, 0.18 μm³/μm² or more, or 0.20 μm³/μm² or more. In aspects, the surface-modifying layer 113 (e.g., fingerprint-hiding coating) exhibits a core material value Vmc between areal material ratios of 10% and 90% a droplet of the simulated fingerprint applied in the Simulated Fingerprint Test in a range from 0.10 μm³/μm² to 1.0 μm³/μm², from 0.12 μm³/μm² to 0.8 μm³/μm², from 0.15 μm³/μm² to 0.6 μm³/μm², from 0.18 μm³/μm² or to 0.4 μm³/μm² or, from 0.20 μm³/μm² to 0.30 μm³/μm², or any range or subrange therebetween.

In aspects, the surface-modifying layer 113 (e.g., fingerprint-hiding coating) exhibits a root mean square height Sq of the simulated fingerprint applied in the Simulated Fingerprint Test of 0.45 μm or more, 0.50 μm or more, 0.55 μm or more, 0.60 μm or more, or 0.65 μm or more. In aspects, the surface-modifying layer 113 (e.g., fingerprint-hiding coating) exhibits a root mean square height Sq of the simulated fingerprint applied in the Simulated Fingerprint Test in a range from 0.45 μm to 1.0 μm, from 0.50 μm to 0.90 μm, from 0.55 μm to 0.8 μm, from 0.60 μm to 0.75 μm, or any range or subrange therebetween.

In aspects, the surface-modifying layer 113 (e.g., fingerprint-hiding coating) exhibits an auto-correlation length Sal of the simulated fingerprint applied in the Simulated Fingerprint Test of 20 μm or more, 25 μm or more, 30 μm or more, 35 μm or more, or 40 μm or more. In aspects, the surface-modifying layer 113 (e.g., fingerprint-hiding coating) exhibits an auto-correlation length Sal of the simulated fingerprint applied in the Simulated Fingerprint Test in a range from 20 μm to 100 μm, from 25 μm to 80 μm, from 30 μm to 60 μm, from 35 μm to 55 μm, from 40 μm to 50 μm, or any range or subrange therebetween.

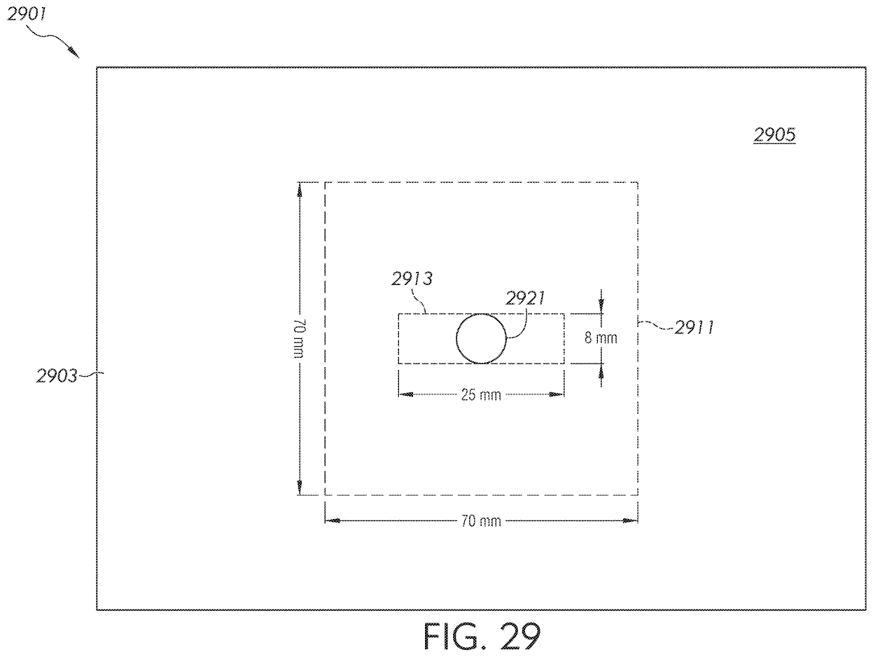

Throughout the disclosure, electrostatic charging is measured using the Tribocharging Test. With reference to FIG. 29, the Tribocharging apparatus 2901 comprises a rubbing head 2921 comprising a silver coated nylon mesh having circular cross-section with a diameter of 8 mm. The rubbing head 2921 is rubbed along a 25 mm long track (denoted by rubbing region 2913) in a straight line (forward and backward constituting 1 cycle) for 100 cycles. The rubbing induces a surface charge in the surface 2905 of the material 2903 being tested. The surface charge developed over the surface 2905 is measured using a non-contact fieldmeter (Monroe 244A) as a voltage at multiple locations across the surface in a 70 mm by 70 mm square (denoted by measurement region 2911 with a total area of 4900 mm²) centered in the middle of the track (i.e., middle of the rubbing region 2913), which is where the rubbing head 2921 is shown in FIG. 29. The measurements are taken 100 seconds after finishing the 100 rubbing cycles.

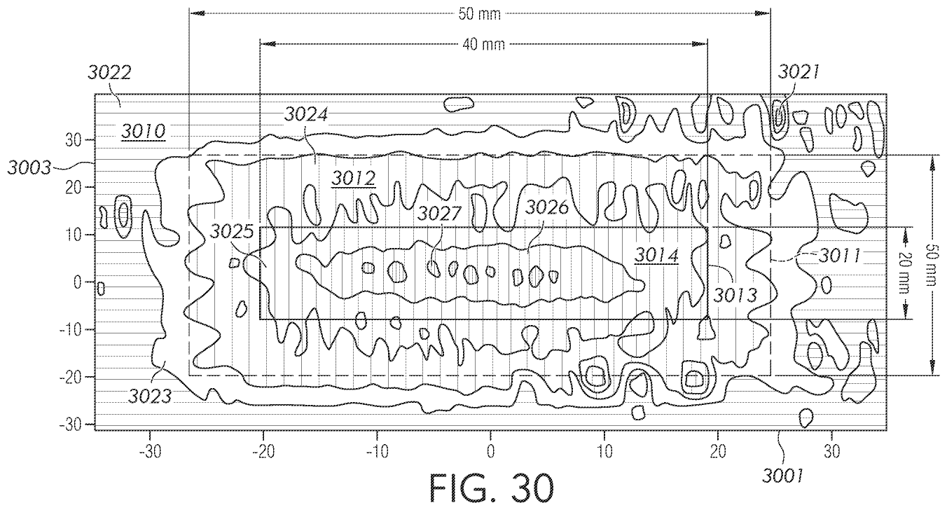

FIG. 30 shows an example contour plot of voltages measured by the non-contact fieldmeter. In FIG. 30, the vertical axis 3003 (i.e., y-axis) and the horizontal axis 3001 (i.e., x-axis) correspond to the physical distance from the middle of track along the corresponding axis. The 70 mm×70 mm measurement region (e.g., measurement region 2911 in FIG. 29 corresponding to the entire region shown in FIG. 30) is divided into 3 regions: an peripheral contact region, inner region, and a center region. The center contact region 3014 is defined by an central boundary 3013 that is centered at the middle of the track extending 40 mm in the direction that the rubbing head 2921 (see FIG. 29) travelled along the track and 20 mm perpendicular to that direction (800 mm² total area). The inner region 3012 is defined between the central boundary 3013 (discussed in the previous sentence) and an inner boundary 3011 that is centered at the middle of the track extending 50 mm in the direction that the rubbing head travelled along the track and 50 mm perpendicular to that direction (excluding the center contact region 3014) (2500 mm²−800 mm²=1700 mm² total area) The peripheral contact region 3010 is defined as the area beyond the inner boundary 3011 (discussed in the previous sentence) that is still within the 70 mm by 70 mm measurement region (4900 mm²−2500 mm²=2400 mm² total area). For the example contour plot of voltages shown in FIG. 30, the contours go from area 3027 with the greatest voltage build-up (tribocharging) to area 3021 with the least tribocharging. As shown, the greatest tribocharging was observed in area 3027 followed by region 3026 that are primarily located in the center contact region 3014. Lesser tribocharging was seen in area 3025 followed by region 3024 that were present in the center contact region 3014 and the inner region 3012. Area 3023 straddles the inner boundary 3011 with even less tribocharging seen in area 3022 in the peripheral contact region 3010 and the least tribocharging in area 3021. Without wishing to be bound by theory, surfaces with lower tribocharging are better able to disperse charge across the surface than other surfaces with higher tribocharging.

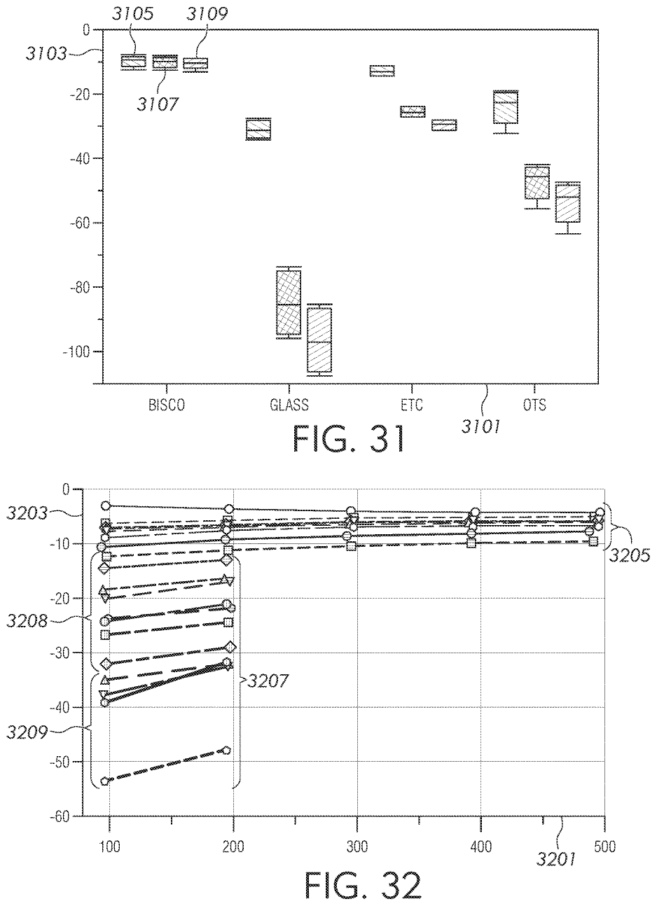

In the Tribocharging test, a single value can be extracted equal to the absolute value of the average voltage measured in the center contact region 3014. Also, three voltages can be extracted corresponding to the average voltage in each of the center contact region 3014, the inner region 3012, and the peripheral contact region 3010. Further, a voltage difference equal to the absolute value of a difference between the average voltage in the peripheral contact region 3010 and the average voltage in the center contact region 3014. In aspects, a voltage measured in the Tribocharging test (i.e., corresponding to the absolute value of the average voltage measured in the center contact region 3014) can be about 15 Volts (V) or less, about 12 V or less, about 10 V or less, about 8 V or less, about 6 V or less, about 5 V or less, about 0 V or more, about 1 V or more, about 2 V or more, about 3 V or more, about 4 V or more, or about 5 V or more. In aspects, a voltage measured in the Tribocharging test (i.e., corresponding to the absolute value of the average voltage measured in the center contact region 3014) can be in a range from about 0 V to about 15 V, from about 1 V to about 12 V, from about 1 V to about 10 V, from about 2 V to about 8 V, from about 3 V to about 6 V, from about 4 V to about 5 V, or any range or subrange therebetween. In aspects, a voltage difference between a peripheral contact region 3010 and a center contact region 3014 (i.e., the absolute value of a difference between the average voltage in the peripheral contact region 3010 and the average voltage in the center contact region 3014) can be about 5 V or less, about 4 V or less, about 3 V or less, about 2 V or less, about 1 V or less, about 0 V or more, about 0.5 V or more, about 1 V or more, about 1.5 V or more, about 2 V or more, or about 2.5 V or less. In aspects, a voltage difference between a peripheral contact region 3010 and a center contact region 3014 (i.e., the absolute value of a difference between the average voltage in the peripheral contact region 3010 and the average voltage in the center contact region 3014) can be in a range from about 0 V to about 5 V, from about 0.5 V to about 4 V, from about 1 V to about 3 V, from about 1.5 V to about 2 V, or any range or subrange therebetween. As discussed herein with reference to FIGS. 31-32, surface-modifying coatings (e.g., fingerprint-hiding coatings) in accordance with aspects of the present disclosure can exhibit an absolute value of the average voltage of the center contact region 3014 of less than 15 V (e.g., less than 10 V, less than 8 V, or about 5 V) and a voltage difference between a peripheral contact region 3010 and a center contact region 3014 of less than 5 V (e.g., less than 3 V, about 2 V or less, or about 1 V).

Aspects of the disclosure can comprise a consumer electronic product. The consumer electronic product can comprise a front surface, a back surface, and side surfaces. The consumer electronic product can further comprise electrical components at least partially within the housing. The electrical components can comprise a controller, a memory, and a display. The display can be at or adjacent to the front surface of the housing. The display can comprise liquid crystal display (LCD), an electrophoretic displays (EPD), an organic light-emitting diode (OLED) display, or a plasma display panel (PDP). The consumer electronic product can comprise a cover substrate disposed over the display. In aspects, at least one of a portion of the housing or the cover substrate comprises the coated article and/or the surface-modifying layer 113 (e.g., fingerprint-hiding coating) discussed throughout the disclosure. The consumer electronic product can comprise a portable electronic device, for example, a smartphone, a tablet, a wearable device, or a laptop.

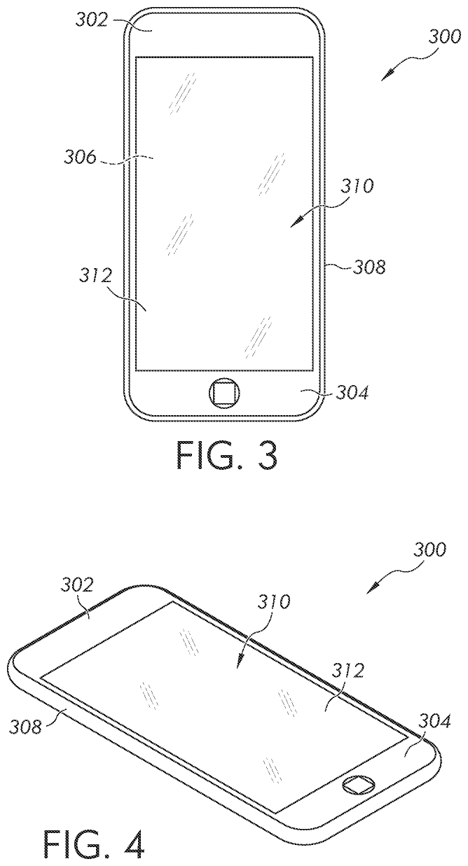

The coated article and/or surface-modifying layer 113 (e.g., fingerprint-hiding coating) disclosed herein may be incorporated into another article, for example, an article with a display (or display articles) (e.g., consumer electronics, including mobile phones, tablets, computers, navigation systems, wearable devices (e.g., watches), and the like), architectural articles, transportation articles (e.g., automotive, trains, aircraft, sea craft, etc.), appliance articles, or any article that may benefit from some transparency, scratch-resistance, abrasion resistance or a combination thereof. An exemplary article incorporating any of the coated articles and/or surface-modifying layers (e.g., fingerprint-hiding coatings) disclosed herein is shown in FIGS. 3-4. Specifically, FIGS. 3-4 show a consumer electronic device 300 including a housing 302 having front 304, back 306, and side surfaces 308. Although not shown, the consumer electronic device can comprise electrical components that are at least partially inside or entirely within the housing. For example, electrical components include at least a controller, a memory, and a display. As shown in FIGS. 3-4, the display 310 can be at or adjacent to the front surface of the housing 302. The consumer electronic device can comprise a cover substrate 312 at or over the front surface of the housing 302 such that it is over the display 310. In aspects, at least one of the cover substrate 312 or a portion of housing 302 may include any of the coated articles and/or surface-modifying layers (e.g., fingerprint-hiding coatings) disclosed herein.

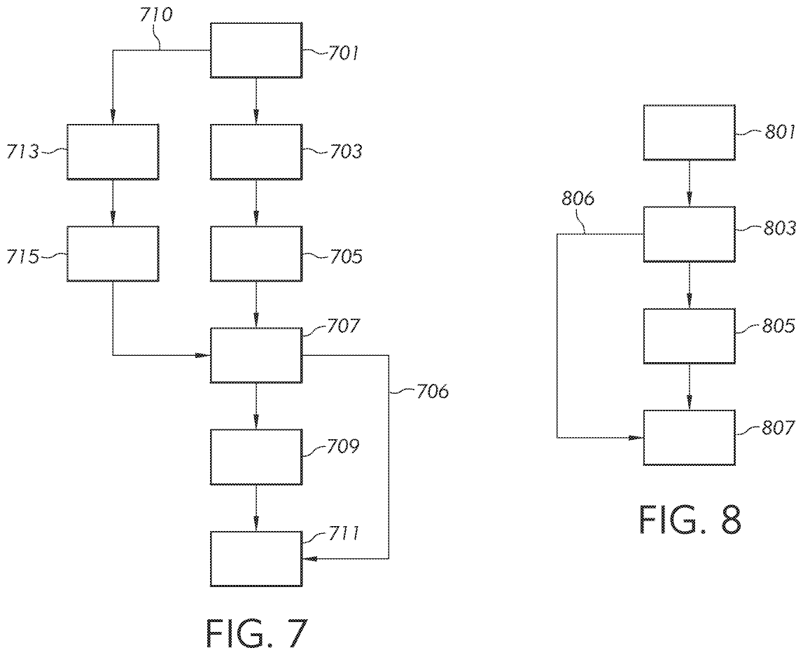

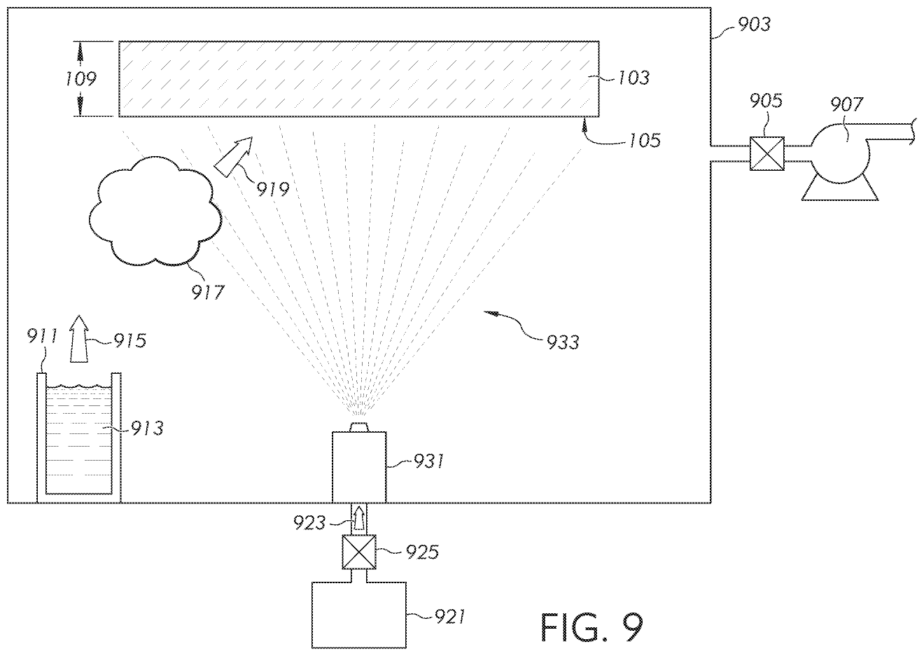

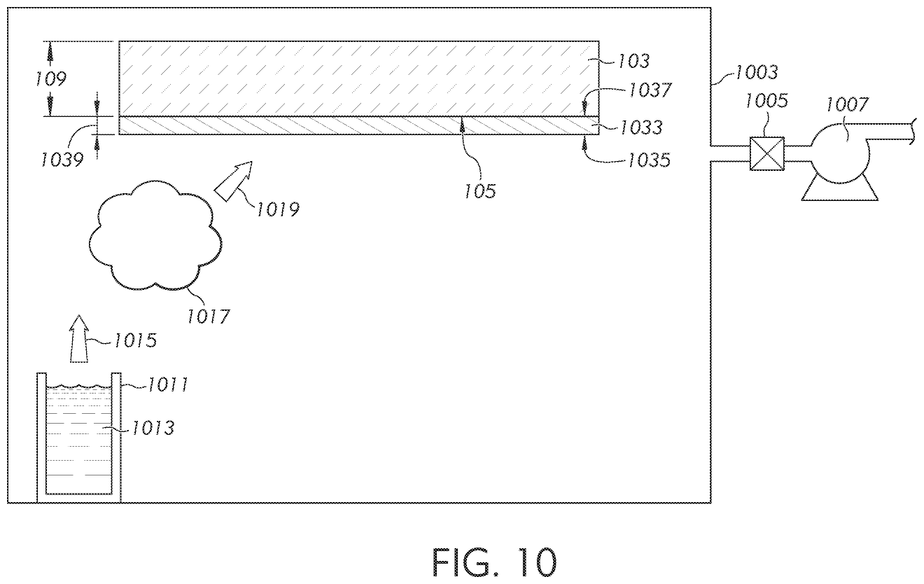

Aspects of methods of making the foldable apparatus and/or foldable substrate in accordance with aspects of the disclosure will be discussed with reference to the flow chart in FIGS. 7-8 and example method steps illustrated in FIGS. 9-13.

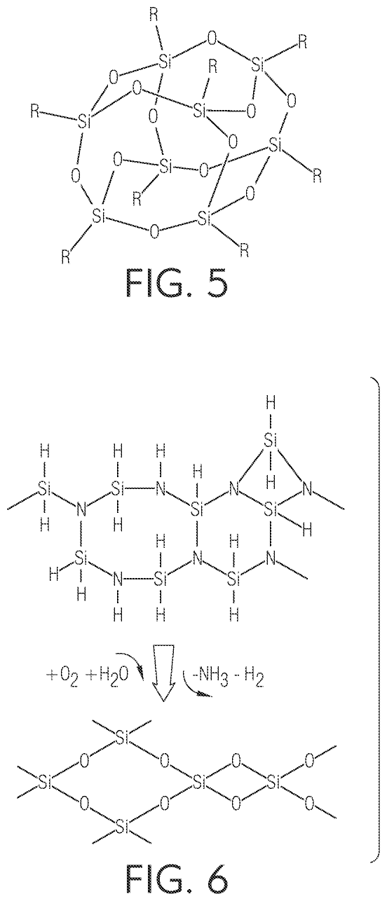

Example aspects of making a coated article 3501, 3601, 3611, or 3621 (e.g., with the surface-modifying layer disposed on the planarization layer 123) will now be discussed with reference to FIGS. 5-6 and 9-12 and the flow chart in FIG. 7. In a first step 701, methods can start with obtaining a substrate 103. In aspects, the substrate 103 may be provided by purchase or otherwise obtaining a substrate or by forming the substrate. In aspects, the substrate 103 can comprise a glass-based material, a glass-ceramic material, and/or a ceramic-based material. In further aspects, glass-based substrates, glass-ceramic substrates and/or ceramic-based substrates can be provided by forming them with a variety of ribbon forming processes, for example, slot draw, down-draw, fusion down-draw, up-draw, press roll, redraw, or float. In further aspects, glass-ceramic substrates and/or ceramic-based substrates can be provided by heating a glass-based substrate to crystallize one or more ceramic crystals. The substrate 103 comprises a first major surface 105 that can extend along a first plane 104. In aspects, as indicated in FIGS. 2A-2C and 36A-36B, an optical stack 203 comprising an anti-reflective coating and/or a gradient coating comprising a refractive index gradient can be disposed on and/or bonded to the first major surface 105. Although not shown in FIGS. 9-10, it is to be understood that the optical stack 203 can be disposed on the first major surface 105. In aspects, the substrate 103 can be chemically strengthened with one or more compressive stress regions (or central tension regions) comprising any of the aspects related to depth of compression, maximum compressive stress, and/or tensile stress discussed above for the corresponding property.

In aspects, step 701 can further comprise obtaining a functionalized polyhedral oligomeric silsesquioxane (POSS). As used herein, a polyhedral oligomeric silsesquioxane (POSS) refers to a functionalized oligomer silsesquioxane consisting of RSiO_{1.5} monomers. Exemplary aspects of functionalized POSS can comprise 6, 8, 10, or 12 RSiO_{1.5} monomers, although other aspects are possible. For example, functionalized oligomeric silsesquioxane consisting of 8 RSiO_{1.5} monomers is an octahedral functionalized POSS (e.g., polyoctahedral silsesquioxane). FIG. 5 shows a functionalized POSS, namely, an octahedral functionalized POSS, where R are functional groups that can be independently selected from the functional groups discussed below.

In aspects, functionalized oligomeric silsesquioxanes can be formed from condensation reactions of silane. As used herein, a condensation reaction produces an R₂O byproduct, where R can include any of the R units discussed below and can further comprise hydrogen (e.g., with a hydroxyl or water byproduct). For example, silanes (e.g., R₃OSi) can be reacted to form terminal RSiO₂ monomers. For example, a terminal RSiO₂ monomer can react with another RSiO₂ monomer (e.g., terminal, non-terminal) to form an RSiO_{1.5} monomer as an oxygen atom of one monomer forms a bond with a silicon atom of another monomer, producing the condensation byproduct. It is to be understood that the RSiO_{1.5} silsesquioxane monomers are different from siloxane monomers, which can include M-type siloxane monomers (e.g., R₃SiO_{0.5}), D-type siloxane monomers (e.g., R₂SiO₂), and/or silica-type siloxane monomers (SiO₂).

Functionalized oligomeric silsesquioxanes can be functionalized by one or more functional groups. For methods discussed with reference to the flow chart in FIG. 7 (e.g., thermally evaporating the functionalized oligomeric silsesquioxane), a functional group functionalizing the functionalized oligomeric silsesquioxane can exclude hydrogen. In aspects, the functional group functionalizing the functionalized oligomeric silsesquioxane can exclude bisphenols, fluorine-containing functional groups isocyanates, epoxies, glycidyls, oxirane, sulfur-containing functional groups (e.g., thiols), anhydrides, acrylates, methacrylates, and/or alkynes. In aspects, the functional group functionalizing the functionalized oligomeric silsesquioxane be an alkyl group, an alkene group, an aromatic group (e.g., a phenyl group), a silane (e.g., an alkyl silyl group), or combinations thereof. As used herein, an alkyl group contains a saturated hydrocarbon with carbon-carbon single bonds and hydrogen bonded to carbon atoms. In aspects, alkyl functional groups can range from 1 to 10 carbons (i.e., C₁-C₁₀ alkyl), for example, from 1 carbon to 8 carbons (i.e., C₁-C₈ alkyl) or from 1 to 4 carbons (i.e., C₁-C₄ alkyl). Exemplary aspects of alkyl functional groups include methyl, isobutyl, and dimethylsilyl. An exemplary aspect of an aromatic functional group is a phenyl group. An exemplary aspect of a silane includes a dimethylsilyl group. As used herein, an alkene group contains an unsaturated hydrocarbon with one or more carbon-carbon double bonds. Alkenes can optionally include one or more carbon-carbon single bonds (e.g., alkyl chains in the alkene group). In even further aspects, the functionalized POSS can be at least partially functionalized by alkenes containing from 2 to 8 carbons (i.e., C₂-C₈ alkenes). At least partially functionalized by a functional group B means that one or more of the R-groups shown in FIG. 5 is B. Completely functionalized mean that 95% or more of all R-groups shown in FIG. 5 are B. An exemplary aspect of an alkene functionalized POSS is a vinyl POSS, for example, partially vinyl functionalized vinyl/isobutyl POSS (OL1123 available from Hybrid Plastics) or octavinyl POSS (OL1170 available from Hybrid Plastics). An exemplary aspect of an aromatic functionalized POSS is octaphenyl POSS (MS0840 available from Hybrid Plastics). Exemplary aspects of alkyl functionalized POSS are octamethyl POSS (MS0830 available from Hybrid Plastics) and octa(iso-butyl) POSS (MS0825 available from Hybrid Plastics). Providing a short chain (e.g., about 8 carbons or less) for functionalizing the functionalized POSS can enable the functionalized POSS to be evaporated during step 703. Providing one or more of the functional groups discussed above functionalizing the functionalizing POSS can reduce the reactivity of the functionalized POSS before it is impinged by the ion beam and/or disposed on the substrate (e.g., by sterically hindering interactions between functionalized POSS), which can enable be used to produce the partially condensed silica-like network described above.

Alternatively, for example, when methods are to proceed to step 713 (e.g., applying the functionalized oligomeric silsesquioxane as a solution)—instead of step 703 (e.g., evaporating a functionalized POSS)—, the functional group functionalizing the functionalized oligomeric silsesquioxane can be hydrogen or an alkyl group. In aspects, the functional group functionalizing the functionalized oligomeric silsesquioxane can exclude bisphenols, fluorine-containing functional groups isocyanates, epoxies, glycidyls, oxirane, sulfur-containing functional groups (e.g., thiols), anhydrides, acrylates, methacrylates, and/or alkynes. In aspects, the functional group functionalizing the functionalized oligomeric silsesquioxane can be hydrogen, an alkyl group, an alkene group, an aromatic group, a silane, or combinations thereof. For example, the functional group can be one or more of the functional groups discussed above in the previous paragraph in addition to hydrogen. In further aspects, the functional group functionalizing the functionalized oligomeric silsesquioxane can consist of carbon and/or hydrogen. In even further aspects, the functionalized oligomeric silsesquioxane can be at least partially functionalized by and/or completely functionalized by hydrogen. In further aspects, the functionalized POSS can be at least partially functionalized by alkenes containing from 2 to 8 carbons (i.e., C₂-C₈ alkenes), for example, an ethene, a propene, a butene, a pentene, a hexene, a heptane, or a octene. In even further aspects, the functionalized POSS can be at least partially functionalized by alkenes containing from 2 to 8 carbons (i.e., C₂-C₈ alkenes).

Throughout the disclosure, an effective diameter of a molecule (e.g., functionalized POSS) is measured using dynamic light scattering in accordance with ISO 22412:2017. In aspects, an effective diameter of a functionalized POSS can be about 20 nm or less, about 15 nm or less, about 10 nm or less, about 6 nm or less, about 1 nm or more, about 2 nm or more, or about 4 nm or more. In aspects, an effective diameter of a functionalized POSS can be in a range from about 1 nm to about 20 nm, from about 1 nm to about 15 nm, from about 2 nm to about 15 nm, from about 2 nm to about 10 nm, from about 4 nm to about 10 nm, from about 4 nm to about 6 nm, from about 1 nm to about 6 nm, from about 2 nm to about 6 nm, or any range or subrange therebetween. In further aspects, a mean effective diameter of the functionalized POSS can be within one or more of the ranges discussed above in this paragraph. In further aspects, substantially all and/or all of the functionalized POSS can be within one or more of the ranges for the effective diameter of a functionalized oligomeric silsesquioxane discussed above.

After step 701, as shown in FIG. 9, methods can proceed to step 703 comprising evaporating a functionalized POSS onto the first major surface 105 of the substrate 103. In aspects, as shown, step 703 can comprise placing the substrate 103 in a chamber 903 (e.g., vacuum chamber) that can be maintained at a reduced pressure. In aspects, the reduced pressure can be about 50,000 Pascals (Pa) or less, about 1,000 Pa or less, about 1 Pa or less, about 0.5 Pa or less, about 10⁻⁶ Pa or more, about 10⁻⁴ Pa or more, or about 10⁻³ Pa. In aspects, the reduced pressure can range from about 10⁻⁶ Pa to about 1,000 Pa, from about 10⁻⁴ to about 1 Pa, from about 10⁻³ to about 0.5 Pa, from about 10⁻³ Pa to about 10⁻¹ Pa, or any range or subrange therebetween. In aspects, the pressure (e.g., reduced pressure) of the chamber 903 can be maintained by operating one or more of the valve 905 and 925. In further aspects, the pressure of the chamber 903 can be reduced or maintained by opening the valve 905 connected to a pump 907 that can remove gas from the chamber 903. In further aspects, the pressure of the chamber 903 can be increased or maintained by opening the valve 925 connected to a gas source 921, which adds gas to the chamber, as indicated by arrow 923. In aspects, the gas source 921 can provide a non-reactive gas (e.g., argon, helium, krypton), oxygen, nitrogen, air, or a combination thereof. Providing a reduced pressure when evaporating the functionalized POSS can increase a rate of evaporation and/or enable a wide range of functionalized POSS materials to be used.

As shown in FIG. 9, the functionalized POSS 913 can be positioned in a container 911 placed within the chamber 903. In the chamber 903, the functionalized POSS 913 can evaporate (as indicated by arrow 915) into the gas phase (as indicated by 917) that can be disposed on the first major surface 105 of the substrate 103 (as indicated by arrow 919). Exemplary aspects of the container 911 include a Knudsen cell or an effusion cell. In aspects, the container 911 can be maintained at a temperature of about 50° C. or more, about 65° C. or more, about 75° C. or more, about 90° C. or more, about 110° C. or less, about 200° C. or less, about 170° C. or less, about 150° C. or less, about 135° C. or less, about 120° C. or less, or about 110° C. or less. In aspects, the container 911 can be maintained at a temperature ranging from about 50° C. to about 200° C., from about 65° C. to about 170° C., from about 75° C. to about 150° C., from about 90° C. to about 135° C., from about 110° C. to about 135° C., or any range or subrange therebetween. Heating the container can facilitate evaporation of the functionalized POSS, which can increase a deposition rate.

In aspects, a deposition rate of the functionalized POSS 913 can be monitored using a sensor comprising a surface that is positioned a predetermined distance from the surface (e.g., first major surface 105 of the substrate 103). In further aspects, the sensor can be configured to detect nanogram differences in mass from material deposited on the surface, where the increase in mass and predetermined surface area of the surface can be used to determine an effective deposition rate. It is to be understood that the “effective deposition rate” is not necessarily the actual deposition rate on the surface (e.g., first major surface 105), and, in fact, may overestimate the actual deposition rate by as much as a factor or 2 or 3. An exemplary aspect of the sensor is a quartz crystal microbalance (QCM). As used herein, the “deposition rate” or “evaporation rate” refers to the effective deposition rate as measured by a QCM positioned 500 mm below the surface and 150 mm above the container 911.

Although not shown, it is to be understood that if an optical stack 203 was disposed on the first major surface 105 that the functionalized POSS 913 would be disposed over the first major surface 105 and disposed on the optical stack 203. In aspects, an evaporation rate of the functionalized POSS 913 onto the first major surface 105 can be about 0.01 nanometers per second (nm/s) (0.1 A/s) or more, about 0.03 nm/s (0.3 A/s) or more, about 0.05 nm/s (0.5 A/s) or more, about 0.1 nm/s or more (1 A/s), about 0.5 nm/s or less (5 A/s), about 0.3 nm/s (3 A/s) or less, about 0.2 nm/s (2 A/s) or less, or about 0.15 nm/s (1.5 A/s) or less. In aspects, an evaporation rate of the functionalized POSS 913 onto the first major surface 105 can range from about 0.01 nm/to about 0.5 nm/s, from about 0.03 nm/s to about 0.3 nm/s, from about 0.05 to about 0.2 nm/s, from about 0.1 nm/s to about 0.15 nm/s, or any range or subrange therebetween. Controlling the evaporation rate within one or more of the above-mentioned ranges can efficiently (e.g., quickly) deposit a substantially uniform coating of the functionalized POSS on the first major surface. In aspects, at the end of step 703, a thickness of the functionalized POSS disposed on the first major surface 105 can be within one or more of the ranges discussed above with reference to the planarization thickness 129. Without wishing to be bound by theory, it is believed that the evaporation of the functionalized POSS and deposition onto the first major surface does not in itself chemically (e.g., covalently) bond the functionalized POSS to the first major surface or modify the structure of the functionalized POSS. An Exemplary aspect of the container 911 in a Radak II cell that can be used in the chamber 903, for example, an Angstrom Engineering Evovac chamber. Although not shown, it is to be understood that if an optical stack 203 was disposed on the first major surface 105 that the functionalized POSS 913 would be disposed over the first major surface 105 and disposed on the optical stack 203.

After step 703 (or concurrent with step 703), as shown in FIG. 9, methods can proceed to step 705 comprising impinging an ion beam traveling as a plume 933 on the first major surface 105 of the substrate 103. As shown, the substrate 103 can be in the chamber 903, which can be the same chamber 903 discussed above with reference to step 703. In aspects, as shown in FIG. 9, a beam source 931 can be configured to emit an ion beam traveling as a plume 933 that is incident on the first major surface 105 of the substrate 103 (or the optical stack). The beam source 931 can be operated such that the ion beam traveling as a plume 933 impinges the entire first major surface 105. In aspects, the ion beam source 931 can comprise an end-Hall ion source, a grided ion source, or an inductively coupled plasma (ICP) ion source. An exemplary aspect of a beam source 931 is an end-Hall ion source. In aspects, the beam source 931 can generate the ion beam using a discharge current. Without wishing to be bound by theory, it is believed that an extent of reaction (e.g., from functionalized POSS to partial silica-like network) is influenced by the ion beam energy and discharge current. In further aspects, the discharge current can be about 0.25 Amps (A) or more, about 0.3 A or more, about 0.35 A or more, about 1 A or less, about 0.75 A or less, or about 0.5 A or less. In further aspects, the discharge current can range from about 0.25 A to about 1 A, from about 0.3 A to about 0.75 A, from about 0.35 A to about 0.5 Å, or any range or subrange therebetween. In aspects, the beam source 931 can be operated at a voltage of about 100 Volts (V), for example, from about 50 V to about 220 V, from about 70 V to about 120 V, from about 90 V to about 110 V, or any range or subrange therebetween. In aspects, the ion beam can comprise ions of oxygen, ions of argon, or combinations thereof. The composition of the ion beam can be adjusted through choice of the gas source 921 and controlling an amount of gas released from the gas source 921 (e.g., using the valve 925). In aspects, the chamber 903 (e.g., vacuum chamber) can be maintained at a reduced pressure within one or more of the ranges discussed above for the reduced pressure in step 703 (e.g., from about 10⁻⁸ Pa to about 10⁻⁷ Pa).

Without wishing to be bound by theory, it is believed that the ion beam disrupts the cage structure of the functionalized POSS, volatilizes the functional groups functionalizing the functionalized POSS, and/or causes the functionalized POSS to become bonded to the surface it is disposed on (e.g., the first major surface 105 as shown in FIG. 9 or the fourth major surface 207 of the optical stack 203, if present). At the end of step 705, the coating 1033 (see FIG. 10) formed can comprise a partial silica-like network, for example, with a percentage of silicon atoms in the coating being in a silica-like network within one or more of the ranges discussed above for the percentage of silica atoms in the planarization layer 123 in a silica-like network. Additionally or alternatively, at the end of step 705, the coating 1033 (see FIG. 10) formed can comprise a ratio of Si—O—Si bonds to silicon atoms within one or more of the ranges discussed above for the ratio of Si—O—Si bonds to silicon atoms. In further aspects, impinging the ion beam in step 705 can convert at least a fraction of the silicon atoms in a cage structure of the functionalized POSS to a partial Si—O—Si network (i.e., Si—O—Si bonds). In even further aspects, the fraction of silicon atoms converted in step 705 can range from about 50% to about 90%, from about 60% to about 80%, from about 65% to about 75%, or any range or subrange therebetween. In aspects, the coating thickness 1039 of the coating 1033 defined between opposing surfaces 1035 and 1037 can be within one or more of the ranges discussed above for the planarization thickness 129, and/or the coating 1033 can correspond to the planarization layer 123.

In aspects, the evaporating the functionalized POSS 913 of step 703 and the impinging the ion beam traveling along a beam path of step 705 can occur simultaneously. As used herein, steps 703 and 705 occurring “simultaneously” means that there is at least one point in time where the activities of steps 703 and 705 are both occurring. It is to be understood that it can still be simultaneous if one of the steps begins before the other step ends and/or if one of the steps ends before the other one ends, although both steps 703 and 705 can begin at the same time and/or end at the same time in further aspects. As shown in FIG. 9, the container 911 (e.g., Knudsen cell or an effusion cell), the substrate 103, and at least a portion of the beam path can be positioned in the chamber 903 such that the functionalized POSS 913 in the gas phase (as indicated by 917) and/or disposed on the first major surface 105 can be impinged by the ion beam travelling along the beam path. Performing steps 703 and 705 simultaneously can facilitate the formation of a coating 1033 (see FIG. 10) with good adhesion to the substrate 103 and/or that is relatively homogenous. Providing a discharge current of about 0.25 A or more can facilitate the formation of the coating 1033 (see FIG. 10), for example, producing an ion beam with sufficient energy to cause the functionalized POSS to react with other functionalized POSS and/or the first major surface 105 of the substrate 103 at an appreciable rate (e.g., compared to lower discharge currents). Providing a discharge current of about 1 A or less can provide an ion beam that is not so strong as to remove any POSS material being disposed by the evaporating. Additionally, performing steps 703 and 705 simultaneously can decrease processing time.

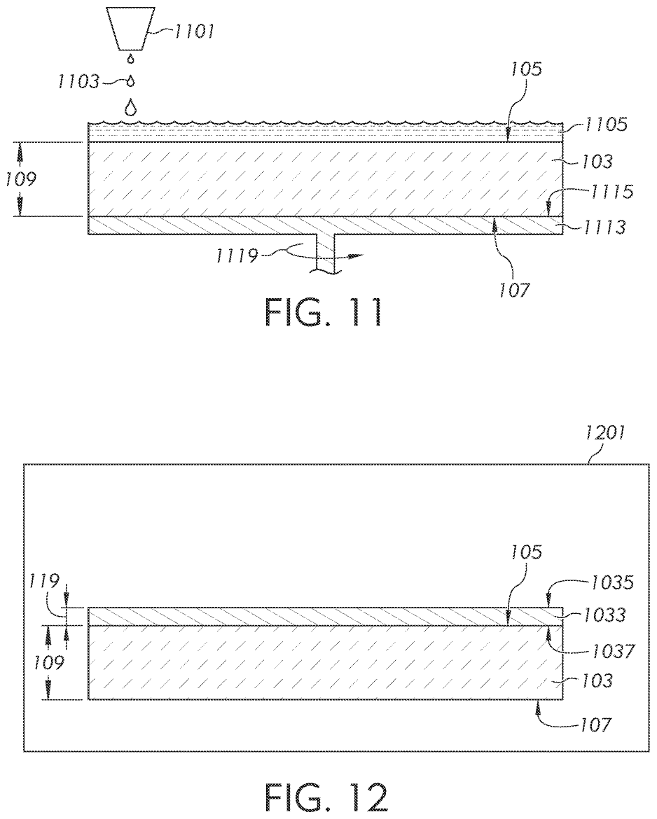

Alternatively, after step 701, as shown in FIG. 11, methods can proceed to step 713 comprising disposing the precursor solution 1103 over the first major surface 105 of the substrate 103. The precursor solution 1103 can comprise the polysilazane or the POSS in a concentration within one or more of the ranges discussed in the previous paragraph. In aspects, as shown FIG. 11, the precursor solution 1103 can be dispensed from a container 1101 (e.g., conduit, flexible tube, micropipette, ink-jet print head, or syringe) over (e.g., onto) the first major surface 105 of the substrate 103 to form a precursor layer 1105. In further aspects, as shown, step 803 can comprise spin coating the precursor solution 1103 over (e.g., onto) the first major surface 105, for example, by disposing the second major surface 107 of the substrate over a surface 1115 of a holder 1113 and the holder can be rotated (as shown by arrow 1119) while and/or after the precursor solution 1103 is disposed over the first major surface 105. In even further aspects, the holder 1113 can be rotated at 200 revolutions per minute (rpm) or more, about 500 rpm or more, about 700 rpm or more, about 4,000 rpm or less, about 2,500 rpm or less, or about 1,500 rpm or less. In even further aspects, the holder 1113 can be rotated from 200 rpm to about 4,000 rpm, from about 500 rpm to about 2,500 rpm, from about 700 rpm to about 1,500 rpm, or any range or subrange therebetween. Spin coating the precursor solution can form a substantially uniform precursor layer over the first major surface of the substrate.

After step 713, as shown in FIG. 12, methods can proceed to step 715 comprising heating the precursor layer 1105 of the precursor solution 1103 (see FIG. 11) at a first temperature for a first period of time to form the coating 1033. In aspects, as shown, the substrate 103 can be placed in an oven 1201 maintained at the first temperature for the first period of time. In aspects, the first temperature can be about 150° C. or more, about 170° C. or more, about 190° C. or more, about 400° C. or less, about 300° C. or less, about 250° C. or less, about 230° C. or less, or about 210° C. or less. In aspects, the first temperature can range from about 150° C. to about 400° C., from about 150° C. to about 300° C., from about 150° C. to about 250° C., from about 170° C. to about 230° C., from about 190° C. to about 210° C., or any range or subrange therebetween. In aspects, the first period of time can be about 5 minutes or more, about 10 minutes or more, about 20 minutes or more, about 25 minutes or more, about 2 hours or less, about 1.5 hours or less, about 1 hour or less, or about 40 minutes or less. In aspects, the first period of time can range from about 5 minutes to about 2 hours, from about 10 minutes to about 1.5 hours, from about 20 minutes to about 1 hour, from about 25 minutes to about 40 minutes, or any range or subrange therebetween. In aspects, the precursor solution 1103 can comprise a catalyst or be free from a catalyst. In aspects, the precursor solution 1103 can contain a silane in addition to the polysilazane or the POSS. The silane can comprise any of the aspects discussed above for silanes.

Without wishing to be bound by theory, heating the precursor layer of the precursor solution can remove solvent from the precursor layer and/or partially cure the polysilazane or the POSS, for example, to form a silica or a partial silica-like network (e.g., corresponding to the planarization layer 123). For example, heating the POSS can cause the silicon-oxygen network to rearrange to a silica-like network and/or bond to a surface (e.g., first major surface 105) that the precursor solution is disposed on. For example, as shown in FIG. 6, the polysilazane can undergo a reaction where ammonia and hydrogen is evolved and oxygen and water is consumed to transform from a structure with an alternating silicon-nitrogen backbone to a silica-like network with silicon-oxygen bonds. Since the polysilazane may only partially undergo this reaction, at the end of the step 715, the coating 1033 can comprise silicon, oxygen, nitrogen, and/or hydrogen. Also, it is to be understood that these reactions may continue in subsequent steps (e.g., step 707).

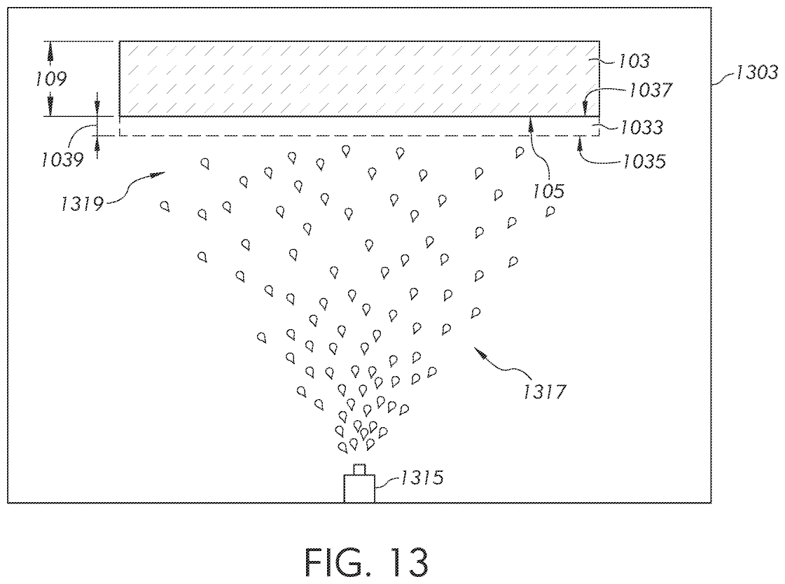

After step 705 or 715, as shown in FIGS. 10 and 13, methods can proceed to step 707 comprising reacting material (e.g., coating 1033) at the first major surface 105 of the substrate 103 with an alkyl silane to form a surface-modifying layer 113 (e.g., fingerprint-hiding coating) that can be disposed over the substrate 103 and/or the coating 1033. In aspects, the alkyl silane 1013 (e.g., droplets 1317) can comprise an alkyl silane. In further aspects, the alkyl silane can comprise four or more carbons, for example, from 3 carbons to 34 carbons (e.g., C₃-C₃₄ alkyl), from 4 carbons to about 34 carbons (i.e., a C₄-C₃₄ alkyl group), from 6 carbons to 20 carbons (e.g., C6-C34 alkyl), from 8 carbons to 18 carbons (e.g., C₈-C₁₈ alkyl), from 8 carbons to 12 carbons (e.g., C₈-C₁₂ alkyl), or any range or subrange therebetween. Exemplary aspects of alkyl silanes include iso-octyltrimethoxysilane, dodecyltrimethoxysilane, octadecyltrimethoxysilane, or combinations thereof. In further aspects, the alkyl silane can comprise at least two reactive groups. Each of the at least two reactive groups can be independently selected from a silane, a non-fluorine halogen, or a combination thereof provided that at least one of the at least two reactive groups is a silane. In even further aspects, at least two of the at least two reactive groups can be located at opposite ends of the alkyl silane. In further aspects, the alkyl silane can be a bis-silane or a tris-silane. In further aspects, a silane of the alkyl silane can be a trichlorosilane, a dichloromethoxy silane, a chlorodimethoxysilane, a dichlorodimethylsilane, a chlorodimethylsilane, a trimethoxy silane, a triethoxy silane, or combinations thereof. Exemplary aspects of the alkyl silane include 1,8-bis(chlorodimethylsilyl)ocatane (see FIG. 17A), chloropropyltrimethoxysilane (see FIG. 17B), or combinations thereof. In aspects, the alkyl silane may comprise a bipodal or multipodal alkyl silane with two or more silane head groups on each end of the alkyl group of the alkyl silane (e.g. bis-silane or tris-silane). Exemplary aspects of bipodal alkyl silanes include 1,6-bis(trimethoxysilyl)hexane (bishexane) (see FIG. 17E) and 1,8-bis(trimethoxysilyl)octane (BISMO) (see FIG. 17F). In aspects, the alkyl silane may include a combination of one or more monopodial alkyl silanes and one or more bipodal alkyl silanes. A mixture of the alkyl silanes can be used to obtain various desirable attributes, e.g. finger-print hiding in combination with good durability. The coating therefore can be composed of two or more functionalities. For instance, the alkyl silane may include one or more bipodal alkyl silanes, such as 1,8-bis(chlorodimethylsilyl) octane, 1,8-bis(dimethylmethoxysilyl)octane, 1,6-bis(trichlorosilyl) hexane, bis(triethoxysilyl) methane, 1,2-bis(triethoxysilyl) ethane, 1,6-bis(trimethoxysilyl) hexane, 1,8-bis(triethoxysilyl) octane, 1,8-bis(trimethoxysilyl) octane, or combinations thereof in addition to one or more monopodial alkyl silanes, such as octadecyl trimethoxysilane, dodecyl trimethoxysilane, or combinations thereof. Without intending to be bound by any particular theory, it is believed that multipodal alkyl silanes (e.g. bipodal alkyl silanes) are thought to create longer chains by polycondensation between molecules. In the case of the mono-functional silanes the non-reactive methyl groups may disrupt chain packing. In the case of di- or tri-functional silanes, polycondensation can occur from multiple sites and the molecule can become more branched, resulting in poor ordering. Due to their bipodal nature, these materials may contain unreacted, terminal hydroxyl groups. In some aspects, it may be beneficial to react or “cap” these groups with a monofunctional, monopodial silane or other molecule. Such examples include monofunctional alkylsilanes where the alkyl chain comprises 3 to 36 carbons. Other suitable steps include methylation such as through the use of hexamethyldisilazane (HMDS). Suitable functionalization for improved durability include linear alkylsilanes where the alkyl chain comprises 3 to 26 carbons. Certain examples include octadecyltrimethoxysilane and dodecyltrimethoxysilane. Such examples are thought to form well ordered SAMs that maintain high water contact angles, even after rubber abrasion testing on bare glass. In aspects, a ratio between the monopodial alkyl silanes to the multipodal alkyl silanes used to form the polymer at the surface-modifying layer 113 may be selected to tune the finger-print hiding attributes and the cleanability and/or durability attributes of the surface-modifying layer 113 (e.g., fingerprint-hiding coating) formed therefrom. Without intending to be bound by any particular theory, it is believed that the monopodial alkyl silane may increase the cleanability and/or durability of the surface-modifying layer 113 formed therefrom, and the multipodal silane may increase finger-print hiding attributes of the surface-modifying layer 113 formed therefrom. The deposition of monopodial silanes and multipodal silanes at the surface-modifying layer 113 may include various ratios between the monopodial silanes and the multipodal silanes of the alkyl silane. In embodiments, the alkyl silane may comprise a ratio of the multimodal alkyl silane to the monopodial alkyl silane of from 10:1 to 1:10, such as from 10:1 to 1:9, 1:8, 1:7, 1:6, 1:5, 1:4, 1:3, 1:2, or 1:1, from 9:1 to 1:9, 1:8, 1:7, 1:6, 1:5, 1:4, 1:3, 1:2, or 1:1, from 8:1 to 1:9, 1:8, 1:7, 1:6, 1:5, 1:4, 1:3, 1:2, or 1:1, from 7:1 to 1:9, 1:8, 1:7, 1:6, 1:5, 1:4, 1:3, 1:2, or 1:1 from 6:1 to 1:9, 1:8, 1:7, 1:6, 1:5, 1:4, 1:3, 1:2, or 1:1 from 5:1 to 1:9, 1:8, 1:7, 1:6, 1:5, 1:4, 1:3, 1:2, or 1:1 from 4:1 to 1:9, 1:8, 1:7, 1:6, 1:5, 1:4, 1:3, 1:2, or 1:1 from 2:1 to 1:9, 1:8, 1:7, 1:6, 1:5, 1:4, 1:3, 1:2, or 1:1 from 2:1 to 1:9, 1:8, 1:7, 1:6, 1:5, 1:4, 1:3, 1:2, or 1:1, or from 1:1 to 1:9, 1:8, 1:7, 1:6, 1:5, 1:4, 1:3, or 1:2. The alkyl-silane of the method may include any aspects described herein with regards to the alkyl-silane of the surface-modifying layer 113 described herein. In aspects, formation of the surface-modifying layer 113 with two or more alkyl silanes, as described herein may be done simultaneously with forming the planarization layer 123 or may be subsequent to forming the planarization layer 123. In other embodiments, the functionalities may be separately inkjet printed (e.g., in a CMYK printer setup) in various patterns. This would allow for spatial variation of the functionality. For instance, such aspects may change the functionality over a sensor or camera, or to change the tactile response in a certain area. Capping of any non-reactive end groups, such as hydroxyls, may be achieved in the same solution or via a separate step. Providing an alkyl silane can reduce a surface energy (e.g., total, dispersive, polar) of the coating, which can enable the resulting surface-modifying layer 113 (e.g., fingerprint-hiding coating) to be oleophilic. At the end of step 707, the silane can be bonded to the material of the coating 1033 to form the surface-modifying layer 113 (see FIGS. 35 and 36A-36C).

In further aspects, as discussed above, the alkyl silane can comprise a one or more of the silanes discussed above in addition to an additional alkyl silane that can contribute to the siloxane part of the structure (i.e., the [Si(R″)₂O]ₙ part of the polymeric structure discussed in the following paragraphs). In even further aspects, the additional alkyl silane can comprise a dialkylsilane with silanes at both ends of the dialkylsilane, and the alkyl groups of dialkyl silane can be methyl, ethyl, or a combination thereof. An exemplary aspect of the dialkyl silane is a dimethyl silane, namely, dichloro-tetramethyl-disiloxane (see FIG. 17D), although other leaving groups can independently be groups other chlorine (e.g., selected from those discussed in the previous paragraph). In even further aspects, an amount of the additional alkyl silane as a wt % of a total amount of alkyl silanes can be about 1 wt % or more, about 5 wt % or more, about 10 wt % or more, about 20 wt % or more, about 25 wt % or more, about 30 wt % or more, about 35 wt % or more, about 40 wt % or more, about 45 wt % or more, about 50 wt % or more, about 55 wt % or more, about 60 wt % or more, about 65 wt % or more, about 70 wt % or more, about 75 wt % or more, about 90 wt % or less, about 85 wt % or less, about 80 wt % or less, about 75 wt % or less, about 70 wt % or less, about 65 wt % or less, about 60 wt % or less, about 55 wt % or less, about 50 wt % or less, about 45 wt % or less, about 40 wt % or less, about 35 wt % or less, or about 30 wt % or less. In even further aspects, an amount of the additional alkyl silane as a wt % of a total amount of the alkyl silanes can be in a range from about 1 wt % to about 90 wt %, from about 5 wt % to about 90 wt %, from about 10 wt % to about 85 wt %, from about 20 wt % to about 80 wt %, from about 25 wt % to about 75 wt %, from about 30 wt % to about 70 wt %, from about 35 wt % to about 65 wt %, from about 40 wt % to about 60 wt %, from about 45 wt % to about 55 wt %, from about 45 wt % to about 50 wt %, or any range or subrange therebetween. In preferred aspects, an amount of the additional alkyl silane as a wt % of a total amount of the alkyl silanes can be from 1 wt % to 90 wt % or from 25 wt % to 75 wt %. For example, the alkyl silane (e.g., one or more alkyl silanes) and the additional silane can form a copolymer (e.g., roughly alternating copolymer). An exemplary aspect is a mixture of 1,8-bis(chlorodimethylsilyl)octane (see FIG. 17A) and dichloro-tetramethyl-disiloxane (see FIG. 17D). An additional exemplary aspect is a mixture of 1,8-bis(dimethylmethoxysilyl)octane (see FIG. 17H) and dichloro-tetramethyl-disiloxane (see FIG. 17D). Alternatively, the alkyl silanes can exclude an additional alkyl silane and/or consist of a single alkyl silane selected from those discussed in the previous paragraph.

FIG. 10 shows one method of silanization. Methods can be performed at atmospheric pressure and/or a pressure within one or more of the ranges discussed above for step 703. For example, the chamber 1003 can be an inert ampoule is heated by an oven at from about 60° C. to about 200° C. (e.g., about 60° C. or more, about 80° C. or more, about 90° C. or more, about 100° C. or more, about 120° C. or more, about 140° C. or more, about 250° C. or less, about 220° C. or less, about 200° C. or less, about 180° C. or less, or about 160° C. or less). Samples are optionally plasma treated for surface activation with an O₂ or Ar plasma, and placed in the ampoule with a drop of silane, sealed and heated for from about 2 hours to about 5 hours. Providing an elevated temperature when evaporating the silane and reacting the silane with the coating can increase a rate of evaporation, enable a wide range of silanes to be used, increase a reaction rate or reactivity of the silane, and/or promote the formation of a covalent bonding to surface 1035 of the coating 1033 (e.g., planarization layer 123). In further aspects, as shown in FIG. 10, the substrate 103 can be placed in a chamber 1003, which can be the same as the chamber 903 discussed above with reference to step 703 and/or step 705. In further aspects, the chamber 1003 can be maintained at a reduced pressure, which can be within one or more of the ranges discussed above for the reduced pressure in step 703. In aspects, the chamber 1003 can be maintained at a temperature within one or more of the range discussed above for the temperature in step 705. Providing a reduced pressure and/or elevated temperature when evaporating the silane and reacting the silane with the coating (e.g., planarization layer 123) can increase a rate of evaporation, enable a wide range of silanes to be used, increase a reaction rate or reactivity of the silane, and/or promote the formation of a silica-like network. As shown in FIG. 10, an alkyl silane 1013 can be positioned in a container 1011 placed within the chamber 1003. In the chamber 1003, the alkyl silane 1013 can evaporate (as indicated by arrow 1015) into the gas phase (as indicated by 1017) that can be disposed on the exterior surface 1035 of the coating 1033 (as indicated by arrow 1019). In aspects, an evaporation rate of the alkyl silane 1013 can be controlled to efficiently (e.g., quickly) deposit and react the silane with the material of the coating (e.g., on the first major surface).

Alternatively, a low vacuum chamber with a vapor source such as a YES—1124P (available from Yield Engineering Systems) can be used in step 707. For example, the chamber can be heated at a temperature from about 100° C. to about 200° C. and evacuated to a pressure of about 10 Pa. Substrates are optionally exposed to a Ar or O₂ capacitively coupled plasma generated by low or high frequency RF. After pumping to base pressure the silane precursor vapor is introduced to the chamber. The silane precursor vapor can be generated using a liquid vaporizer, where liquid can be injected by a pulse pump into a heated vaporization cell with independent temperature control to vaporize it and the vapor can travel through independently heated passage into the chamber. With independent temperature control, condensation in the passage can be prevented. Vaporization of the silane can raise the chamber pressure by from about 1 Pa to about 100 Pa, and the substrates are exposed to the vapor for a time (e.g., from about 2 minutes to about 20 minutes) and the chamber is evacuated with the pump to remove excess vapors and condensation products.

Alternatively, in another embodiment, a high vacuum coating chamber similar to FIG. 9 can be used in step 707. Substrates can be cleaned with the End-Hall or ICP ion source, and the silane can be vaporized from either a liquid injection source (similar to that described above), or desorbed from a sorbate (typically enclosed in a canister) using a thermal source (e.g., a resistively heated tungsten boat, an effusion or Knudesn cell, or an electron beam evaporator). Deposition rate and total thickness can be monitored in these systems with a quartz crystal monitor (QCM). This type of chamber is commonly used in production of fluorinated ETC coatings on handheld devices such as cellphones.

Alternatively or additionally, the alkyl silane (e.g., alkyl silane) can react with the surface (e.g., first major surface 105, a surface of an optical stack 203, 203a, or 203b, or a surface of the planarization layer 123) to from the surface-modifying layer 113 for a predetermined period of time at a temperature from about 20° C. to about 40° C., from about 20° C. to about 36° C., from about 22° C. to about 30° C., from about 25° C. to about 30° C., or any range or subrange therebetween. For example, the alkyl silane can form the surface-modifying layer at ambient conditions (e.g., from about 25° C. to about 30° C.) to form the surface-modifying layer. In aspects, the predetermined period of time for the alkyl silane to form the surface-modifying layer can be about 1 hour or more, about 2 hours or more, about 3 hours or more, about 4 hours or more, about 6 hours or more, about 24 hours or less, about 12 hours or less, about 8 hours or less, about 6 hours or less, about 4 hours or less, about 3 hours or less, or about 2 hours or less. In aspects, the predetermined period of time for the alkyl silane to form the surface-modifying layer can be in a range from about 1 hour to about 24 hours, from about 2 hours to about 12 hours, from about 3 hours to about 8 hours, from about 4 hours to about 6 hours, or any range or subrange therebetween. It is to be understood that the lower-temperature curing of the alkyl silane to form the surface-modifying layer can be used with any method of disposing the alkyl silane on the surface (e.g., printing, spray, evaporating, solution coating, etc.).

Alternatively, in another embodiment, although not shown, step 707 can comprise solution coating the substrate with a solution containing the alkyl silane. For example, disposing the silane on the substrate can comprise dip coating the substrate in a solution comprising the silane can comprise spin coating the substrate with the solution comprising the silane, spray coating the substrate with a solution comprising the silane, or printing on the substrate with a solution comprising the silane. In aspects, the silane solution can comprise the silane, as a wt % of the silane solution, of about 0.01 wt % or more, 0.05 wt % or more, 0.1 wt % or more, about 0.2 wt % or more, about 0.5 wt % or more, about 1 wt % or more, about 25 wt % or less, about 15 wt % or less, about 10 wt % or less, about 6 wt % or less, about 5 wt % or less, or about 2 wt % or less. In aspects, the silane solution can comprise the silane, as a wt % of the silane solution, can range from about 0.01 wt % to about 25 wt %, from about 0.05 wt % to about 15 wt %, from about 0.1 wt % to about 15 wt %, from about from about 0.2 wt % to about 10 wt %, from about 0.2 wt % to about 6 wt %, from about 0.2 wt % to about 5 wt %, from about 0.5 wt % to about 5 wt %, from about 1 wt % to about 2 wt %, or any range or subrange therebetween. In further aspects, the solution containing the alkyl silane can comprise a pH from 6 to 8, from 6 to 7, from 6.5 to 7.5, or from 7 to 8. In further aspects, the solution can comprise a solvent that can be polar aprotic solvent, for example, a ketone (e.g., acetone, methyl ethyl ketone), an acetate (e.g., ethyl acetate, propylene glycol methyl ether acetate), toluene. An exemplary aspect of the solvent is propylene glycol methyl ether acetate.

Alternatively, in yet another embodiment, as shown in FIG. 13, the alkyl silane (e.g., droplets 1317) can be sprayed from a nozzle 1315 towards the first major surface 105 of the substrate 103 and/or the surface 1035 of the coating 1033 (e.g., partially condensed silica film). In aspects, the alkyl silane (e.g., droplets 1317) can be spray coated on the coating 1033 (e.g., partially condensed silica film). In further aspects, the droplets 1317 can comprise a solution containing the alkyl silane, where a pH of the solution can be from 6 to 8, from 6 to 7, from 6.5 to 7.5, or from 7 to 8. In further aspects, as shown, the spray coating can occur in a chamber 1303 that can also be used to subsequently heat the substrate 103. Alternatively, the spray coating can occur elsewhere and then the substrate can be transported to the chamber. After disposing the alkyl silane over the substrate 103 and/or coating 1033 (e.g., partially condensed silica film), step 707 can further comprise heating the substrate at a temperature from about 80° C. to about 250° C. (e.g., about 80° C. or more, about 90° C. or more, about 100° C. or more, about 120° C. or more, about 140° C. or more, about 250° C. or less, about 220° C. or less, about 200° C. or less, about 180° C. or less, or about 160° C. or less, from about 90° C. to about 220° C., from about 100° C. to about 200° C., from about 120° C. to about 180° C., from about 140° C. to about 160° C., or any range or subrange therebetween) for a period of time from about 10 minutes to about 8 hours (e.g., about 10 minutes or more, about 20 minutes or more, about 30 minutes or more, about 45 minutes or more, about 60 minutes or more, about 8 hours or less, about 4 hours or less, about 2 hours or less, about 1.5 hours or less, about 1 hours or less, about 45 minutes or less, from about 20 minutes to about 4 hours, from about 30 minutes to about 2 hours, from about 45 minutes to about 1.5 hours, or any range or subrange therebetween). Heating the substrate 103 and/or coating 1033 (e.g., partially condensed silica film) with the alkyl silane disposed thereon can cause the alkyl silane to react with the partially condensed silica film to form the surface-modifying layer 113 (e.g., fingerprint-hiding coating and/or disposed on the planarization layer 123).

In aspects, the reacting of the alkyl silane with the partially condensed silica film in step 707 can produce block copolymer of the alkyl silane and a siloxane-based polymer. For example, a structure of a block of the block copolymer and/or the polymer can be {OSi(R′)₂[CH₂]ₘ[Si(R″)₂O]ₙSi(R′)₂[CH₂]ₚSi(R″)₂}_{q}R, wherein m and p are independently selected from 3 to 34, R′ and R″ are independently selected from CH₃ and CH₂CH₃, n is 1 or more, q is 1 or more and/or a degree of polymerization. R can be a hydroxyl group, a chloro group, a bromo group, an alkyl silane, an alkoxide, or combinations thereof. In still further aspects, R can be a hydroxyl group, a chloro group, a bromo group, an alkyl silane, an alkoxide, or combinations thereof. In particular aspects, R can be an alkoxide including a methoxy group, an ethoxy group, or combinations thereof. In yet further aspects, R can be a hydroxyl group or a chloro group. In yet further aspects, when n is 1, one or more of the following can also be true: R′ can be CH₃, R″ can be CH₃, m can be 8, p can be 8, or combinations thereof. In still further aspects, n can be 1, and q can be within one or more of the corresponding ranges later in this paragraph. In still further aspects, n can be 2 or more, and q can be within one or more of the corresponding ranges later in this paragraph. For example, when n is 2 or more, one or more of the following can also be true: R′ can be CH₃, R″ can be CH₃, m can be 8, p can be 8, or combinations thereof. In yet further aspects, n can be 2, and q can be within one or more of the corresponding ranges later in this paragraph. For example, when n is 2, one or more of the following can also be true: R′ can be CH₃, R″ can be CH₃, m can be 8, p can be 8, or combinations thereof. In aspects, a block of the block copolymer can be a homopolymer of a single alkyl silane (e.g., a single bis-silane) or a block of the block copolymer can itself be a copolymer of more than one alkyl silane. In aspects, a bond between one or more pairs of monomers of the copolymer can be a dialkyl siloxane (e.g., (e.g., dimethylsiloxane, diethylsiloxane, or combinations thereof) polymer. In further aspects, one or more pairs of monomers of the copolymer can be bonded together by a disiloxane group. In even further aspects, the disiloxane group can include one or more dialkyl siloxanes (e.g., dimethylsiloxane(s) and/or diethylsiloxane(s)). As discussed above, the resulting alkyl silane of the surface-modifying layer can comprise the structure shown in FIG. 18A, for example, as (i) the product of homopolymerization of bis(chlorodimethylsilyl)octane) (see FIG. 17A), (ii) the product of copolymerizing 1,8-bis(chlorodimethylsilyl)octane (see FIG. 17A) and dichloro-tetramethyl-disiloxane (see FIG. 17D) (iii) the product of homopolymerization of 1,8-bis(dimethylmethoxysilyl)octane (see FIG. 17H) and/or (i) the product of copolymerizing 1,8-bis(dimethylmethoxysilyl)octane (see FIG. 17H) and dichloro-tetramethyl-disiloxane (see FIG. 17D).

In aspects, the alkyl silane can be part of a block copolymer of the alkyl silane that is bonded to the first major surface 105 of the substrate or the fourth major surface 207 of the optical stack 203 or 203a. In further aspects, a block copolymer can include a block corresponding to the polymer described in the preceding paragraph. In even further aspects, the block copolymer can comprise a dialkyl siloxane (e.g., dimethylsiloxane, diethylsiloxane, or combinations thereof) block. In further aspects, the block copolymer contains alternating blocks (i) containing a C₃-C₃₄ alkyl group and (ii) a dialkyl siloxane (e.g., dimethylsiloxane, diethylsiloxane, or combinations thereof). In further aspects, the monomers in one or more blocks of the block copolymer can be bonded together by a disiloxane group. In further aspects, the disiloxane group can include one or more dialkyl siloxanes (e.g., dimethylsiloxane(s) and/or diethylsiloxane(s). In further aspects, a dialkyl siloxane block of the block copolymer can correspond to the silica-like network described in the following paragraph.

In aspects, after step 707, methods can proceed to step 709 comprising assembling the coated article comprising the surface-modifying layer 113 into a consumer electronic device. For example, the surface-modifying layer 113 can comprise an exterior surface of a display portion of a display device and/or a touch-sensor. For example, the surface-modifying layer 113 can comprise an exterior surface of at least a portion of a consumer electronic device.

After step 707 or 709, methods can proceed to step 711, where methods of making the coated article can be complete. In aspects, methods of making a coated article in accordance with aspects of the disclosure can proceed along steps 701, 703, 705, 707, 709, and 711 of the flow chart in FIG. 7 sequentially, as discussed above. In aspects, methods can follow arrow 706 from step 707 to step 711, for example, if methods of making the coated article are complete at the end of step 707. Any of the above options may be combined to make a foldable apparatus in accordance with the embodiments of the disclosure.

It is known that POSS materials can be cured at high temperatures (e.g., about 600° C. or more). However, the methods discussed above with reference to the flow chart in FIG. 7 can subject the functionalized POSS to a maximum temperature (e.g., through the evaporating of the functionalized POSS, impingement with the ion-beam, and subsequent functionalization with a silane) of about 250° C. or less (e.g., about 220° C. or less, about 200° C. or less, about 180° C. or less, about 160° C. or less, about 120° C. or less, or about 50° C. or less) to obtain the planarization layer 123 (e.g., with the surface-modifying layer 113 disposed thereon). Consequently, the properties of planarization layer 123 formed in this way can exhibit a silica or a partial silica-like network (e.g., from about 50% to about 90%) as opposed to a substantially complete silica-like network, which could be formed from higher temperature treatments. As discussed below, the increased elastic modulus associated with exposing functionalized POSS materials to higher temperatures is associated with poor abrasion resistance.

At the end of methods discussed above with reference to the flow chart in FIG. 7, the coated article 101, 201, 211, 221, 3501, 3601, 3611, or 3621 and/or the surface-modifying layer 113 (e.g., fingerprint-hiding coating) can comprise any one or more of the aspects discussed above. In aspects, methods of making a coated article in accordance with aspects of the disclosure can proceed along steps 701, 703, 705, 707, 709, and 711 of the flow chart in FIG. 7 sequentially, as discussed above. In aspects, methods can follow arrow 710 to step 713, for example, if the partially condensed silica film is to be formed by disposing a solution on the first major surface (as opposed to evaporating material in step 703). In aspects, methods can follow arrow 706 from step 707 to step 711, for example, if methods of making the coated article are complete at the end of step 707. Any of the above options may be combined to make a foldable apparatus in accordance with the embodiments of the disclosure.

Example aspects of making a coated article 101, 201, 211, or 221 (e.g., without a planarization layer or in methods where the planarization layer 123 is already present at the end of step 801) will now be discussed with reference to FIG. 13 and the flow chart in FIG. 8. In a first step 801, methods can start with obtaining a substrate 103. In aspects, the substrate 103 may be provided by purchase or otherwise obtaining a substrate or by forming the substrate. In aspects, the substrate 103 can comprise a glass-based substrate, a glass-ceramic substrate, and/or a ceramic-based substrate. In further aspects, glass-based substrates and/or ceramic-based substrates can be provided by forming them with a variety of ribbon forming processes, for example, slot draw, down-draw, fusion down-draw, up-draw, press roll, redraw, or float. In further aspects, glass-ceramic substrates and/or ceramic-based substrates can be provided by heating a glass-based substrate to crystallize one or more ceramic crystals. The substrate 103 comprises a first major surface 105 that can extend along a first plane 104. In aspects, as indicated in FIG. 1, an optical stack 203 comprising an anti-reflective coating and/or a gradient coating comprising a refractive index gradient can be disposed on and/or bonded to the first major surface 105. Although not shown in FIGS. 11-12, it is to be understood that the optical stack 203 can be disposed on the first major surface 105. In aspects, the substrate 103 can be chemically strengthened with one or more compressive stress regions (or central tension regions) comprising any of the aspects related to depth of compression, maximum compressive stress, and/or tensile stress discussed above for the corresponding property.

After step 801, as shown in FIG. 13, methods can proceed to step 803 comprising disposing an alkyl silane over a first major surface 105 of the substrate 103 and reacting the alkyl silane to form the surface-modifying layer 113 (e.g., fingerprint-hiding coating). In aspects, although not shown, disposing the alkyl silane can comprise solution coating the substrate with a solution containing the alkyl silane, for example, as discussed above with reference to step 707 discussed above. In aspects, although not shown, disposing the alkyl silane can comprise evaporating the alkyl silane, for example, as shown in FIG. 10 with reference to step 707 discussed above.

Alternatively, in aspects, as shown in FIG. 13, the alkyl silane (e.g., droplets 1317) can be sprayed from a nozzle 1315 towards the first major surface 105 of the substrate 103. In further aspects, as shown by the dashed line in FIG. 13, the droplets 1317 can be disposed directly on the first major surface 105 of the substrate 103 (or an optical stack) without a coating 1033. In aspects, the alkyl silane (e.g., droplets 1317) can be spray coated on the coating 1033 (e.g., partially condensed silica film). In further aspects, the droplets 1317 can comprise a solution containing the alkyl silane, where a pH of the solution can be from 6 to 8, from 6 to 7, from 6.5 to 7.5, or from 7 to 8. In further aspects, as shown, the spray coating can occur in a chamber 1303 that can also be used to subsequently heat the substrate 103. Alternatively, the spray coating can occur elsewhere and then the substrate can be transported to the chamber. After disposing the alkyl silane over and/or on the substrate 103, step 803 can further comprise heating the substrate at a temperature from about 80° C. to about 250° C. (e.g., about 80° C. or more, about 90° C. or more, about 100° C. or more, about 120° C. or more, about 140° C. or more, about 250° C. or less, about 220° C. or less, about 200° C. or less, about 180° C. or less, or about 160° C. or less, from about 90° C. to about 220° C., from about 100° C. to about 200° C., from about 120° C. to about 180° C., from about 140° C. to about 160° C., or any range or subrange therebetween) for a period of time from about 10 minutes to about 8 hours (e.g., about 10 minutes or more, about 20 minutes or more, about 30 minutes or more, about 45 minutes or more, about 60 minutes or more, about 8 hours or less, about 4 hours or less, about 2 hours or less, about 1.5 hours or less, about 1 hours or less, about 45 minutes or less, from about 20 minutes to about 4 hours, from about 30 minutes to about 2 hours, from about 45 minutes to about 1.5 hours, or any range or subrange therebetween). Heating the substrate 103 and/or coating 1033 (e.g., partially condensed silica film) with the alkyl silane disposed thereon can cause the alkyl silane to react with the partially condensed silica film to form the surface-modifying layer 113 (e.g., fingerprint-hiding coating) disposed on the planarization layer 123.

Alternatively, the alkyl silane (e.g., alkyl silane) can react with the surface (e.g., first major surface 105, a surface of an optical stack 203, 203a, or 203b, or a surface of the planarization layer 123) to from the surface-modifying layer 113 for a predetermined period of time at a temperature from about 20° C. to about 40° C., from about 20° C. to about 36° C., from about 22° C. to about 30° C., from about 25° C. to about 30° C., or any range or subrange therebetween. For example, the alkyl silane can form the surface-modifying layer at ambient conditions (e.g., from about 25° C. to about 30° C.) to form the surface-modifying layer. In aspects, the predetermined period of time for the alkyl silane to form the surface-modifying layer can be about 1 hour or more, about 2 hours or more, about 3 hours or more, about 4 hours or more, about 6 hours or more, about 24 hours or less, about 12 hours or less, about 8 hours or less, about 6 hours or less, about 4 hours or less, about 3 hours or less, or about 2 hours or less. In aspects, the predetermined period of time for the alkyl silane to form the surface-modifying layer can be in a range from about 1 hour to about 24 hours, from about 2 hours to about 12 hours, from about 3 hours to about 8 hours, from about 4 hours to about 6 hours, or any range or subrange therebetween.

The alkyl silane 1013 can comprise any one or more of the silanes discussed above with reference to step 707. For example, the silane can be an alkyl silane. The alkyl silane can comprise 3 or more carbons (e.g., C₃-C₃₄ alkyl, C₆-C₃₄ alkyl, C₆-C₂₀ alkyl, C₈-C₁₈ alkyl, or C₈-C₁₂ alkyl). Exemplary aspects of alkyl silanes include iso-octyltrimethoxysilane, dodecyltrimethoxysilane, octadecyltrimethoxysilane, or combinations thereof. The silane can be a bis-silane and/or tris-silane, which can be bonded to the rest of the coating in more than one location. For example, the bis-silane and/or tri-silane can comprise multiple silane groups at the same end of the silane, which can help orient a functional group of the silane. Providing an alkyl silane can reduce a surface energy (e.g., total, dispersive, polar) of the coating, which can enable the resulting surface-modifying layer 113 (e.g., fingerprint-hiding coating) to be oleophilic.

In further aspects, as discussed above, the alkyl silane can comprise a one or more of the silanes discussed above in addition to an additional alkyl silane that can contribute to the siloxane part of the structure (i.e., the [Si(R″)₂O]ₙ part of the polymeric structure discussed in the following paragraphs). In even further aspects, the additional alkyl silane can comprise a dialkylsilane with silanes at both ends of the dialkylsilane, and the alkyl groups of dialkyl silane can be methyl, ethyl, or a combination thereof. An exemplary aspect of the dialkyl silane is a dimethyl silane, namely, dichloro-tetramethyl-disiloxane (see FIG. 17D), although other leaving groups can independently be groups other chlorine (e.g., selected from those discussed in the previous paragraph). In even further aspects, an amount of the additional alkyl silane as a wt % of a total amount of alkyl silanes can be about 1 wt % or more, about 5 wt % or more, about 10 wt % or more, about 20 wt % or more, about 25 wt % or more, about 30 wt % or more, about 35 wt % or more, about 40 wt % or more, about 45 wt % or more, about 50 wt % or more, about 55 wt % or more, about 60 wt % or more, about 65 wt % or more, about 70 wt % or more, about 75 wt % or more, about 90 wt % or less, about 85 wt % or less, about 80 wt % or less, about 75 wt % or less, about 70 wt % or less, about 65 wt % or less, about 60 wt % or less, about 55 wt % or less, about 50 wt % or less, about 45 wt % or less, about 40 wt % or less, about 35 wt % or less, or about 30 wt % or less. In even further aspects, an amount of the additional alkyl silane as a wt % of a total amount of the alkyl silanes can be in a range from about 1 wt % to about 90 wt %, from about 5 wt % to about 90 wt %, from about 10 wt % to about 85 wt %, from about 20 wt % to about 80 wt %, from about 25 wt % to about 75 wt %, from about 30 wt % to about 70 wt %, from about 35 wt % to about 65 wt %, from about 40 wt % to about 60 wt %, from about 45 wt % to about 55 wt %, from about 45 wt % to about 50 wt %, or any range or subrange therebetween. In preferred aspects, an amount of the additional alkyl silane as a wt % of a total amount of the alkyl silanes can be from 1 wt % to 90 wt % or from 25 wt % to 75 wt %. For example, the alkyl silane (e.g., one or more alkyl silanes) and the additional silane can form a copolymer (e.g., roughly alternating copolymer). An exemplary aspect is a mixture of 8-bis(chlorodimethylsilyl)octane (see FIG. 17A) and dichloro-tetramethyl-disiloxane (see FIG. 17D). Alternatively, the alkyl silanes can exclude an additional alkyl silane and/or consist of a single alkyl silane selected from those discussed in the previous paragraph.

In aspects, the reacting of the alkyl silane can produce a polymer of the alkyl silane. In further aspects, the polymer of the alkyl silane can be bonded directly to the first major surface 105 of the substrate 103, the planarization layer 123, or the fourth major surface 207 of the optical stack 203, 203a, or 203b. In further aspects, the bond between the alkyl silane and the another part of the surface-modifying layer 113 (e.g., fingerprint-hiding coating) and/or the planarization layer 123 can be a disiloxane group. In even further aspects, the disiloxane group can include one or more dialkyl siloxanes (e.g., dimethylsiloxane, diethylsiloxane, or combinations thereof). In further aspects, the polymer of the alkyl silane can be a dialkyl siloxane (e.g., dimethylsiloxane, diethylsiloxane, or combinations thereof) polymer. In further aspects, the monomers of the polymer of the alkyl silane can be bonded together by a disiloxane group. In further aspects, the disiloxane group can include one or more dialkyl siloxanes (e.g., dimethylsiloxane(s) and/or diethylsiloxane(s)). For example, a structure of the polymer can be {OSi(R′)₂[CH₂]ₘ[Si(R″)₂O]ₙSi(R′)₂[CH₂]ₚSi(R″)₂}_{q}R, wherein m and p are independently selected from 3 to 34, R′ and R″ are independently selected from CH₃ and CH₂CH₃, n is 1 or more, q is 1 or a degree of polymerization. R can be a hydroxyl group, a chloro group, a bromo group, an alkyl silane, an alkoxide, or combinations thereof. In particular aspects, R can be an alkoxide including a methoxy group, an ethoxy group, or combinations thereof. In still further aspects, R can be a hydroxyl group, a chloro group, a bromo group, an alkyl silane, an alkoxide, or combinations thereof. In yet further aspects, R can be a hydroxyl group or a chloro group. In yet further aspects, when n is 1, one or more of the following can also be true: R′ can be CH₃, R″ can be CH₃, m can be 8, p can be 8, or combinations thereof. In still further aspects, n can be 1, and q can be within one or more of the corresponding ranges later in this paragraph. In still further aspects, n can be 2 or more, and q can be within one or more of the corresponding ranges later in this paragraph. For example, when n is 2 or more, one or more of the following can also be true: R′ can be CH₃, R″ can be CH₃, m can be 8, p can be 8, or combinations thereof. In yet further aspects, n can be 2, and q can be within one or more of the corresponding ranges later in this paragraph. For example, when n is 2, one or more of the following can also be true: R′ can be CH₃, R″ can be CH₃, m can be 8, p can be 8, or combinations thereof. In still further aspects, R′ and R″ can be CH₃, which results in the structure shown in FIG. 18A as both a skeletal structure and SMILES. Further, as shown in FIG. 18A, the shown structure can be directly bonded to a surface of the substrate or optical film.

In particular aspects that use an alkyl silane having an alkoxide leaving group, such as 1,8-bis(dimethylmethoxysilyl)octane—see FIG. 17H), such aspects may provide one or more advantages over other aspects that use an alkyl silane have a chloro leaving group, such as 1,8-bis(chlorodimethylsilyl)ocatane (see FIG. 17A), as discussed herein. Alkyl silanes that include a chloro leaving group may result in the production of HCl during the hydrolysis of the chlorosilanes. Methods of forming the coated articles described herein may use one or more stainless steel parts prior to and/or during spray coating. It is believed that the production of HCl during the hydrolysis of the chlorosilanes may increase a corrosion rate of the stainless steel parts used in the methods described herein. Accordingly, it is believed that by using an alkyl silane having an alkoxide leaving group rather than a chlor leaving group may reduce a corrosion rate of the stainless steel materials used in the methods described herein.

In even further aspects, the polymer can be a homopolymer of a single alkyl silane (e.g., a single bis-silane). Alternatively, in further aspects, the polymer can be a copolymer of more than one alkyl silane. In still further aspects, at least one of the alkyl silanes in the copolymer can be a bis-silane and at least one of the alkyl silanes can include a non-fluorine halogen. For example, a structure of the copolymer can be {OSi(R′)₂[CH₂]ₘ[Si(R″)₂O]ₙSi(R′)₂[CH₂]p[Si(R″)₂]ₓ}_{q}R, where m and p are independently selected from 3 to 34, but m and p can be vary between adjacent monomers, R′ and R″ are independently selected from CH₃ and CH₂CH₃, n is 1 or more, and can vary between adjacent monomers, and x is 0 or 1. R can be a hydroxyl group, a chloro group, a bromo group, an alkyl silane, an alkoxide, or combinations thereof. In particular aspects, R can be an alkoxide including a methoxy group, an ethoxy group, or combinations thereof. In still further aspects, n can be 1, and q can be within one or more of the corresponding ranges later in this paragraph. In still further aspects, n can be 2, and q can be within one or more of the corresponding ranges later in this paragraph. In even further aspects, a degree of polymerization of the polymer can be 2 or more, 5 or more, 10 or more, 20 or more, 50 or more, 100 or less, 75 or less, 60 or less, 40 or less, 25 or less, 15 or less, or 9 or less. In even further aspects, a degree of polymerization of the polymer can be in a range from 2 to 100, from 5 to 75, from 10 to 60, from 20 to 40, or any range or subrange therebetween.

In aspects, after step 803, methods can proceed to step 805 comprising assembling the coated article comprising the surface-modifying layer 113 into a consumer electronic device. For example, the surface-modifying layer 113 can comprise an exterior surface of a display portion of a display device and/or a touch-sensor. For example, the surface-modifying layer 113 can comprise an exterior surface of at least a portion of a consumer electronic device.

After step 805, methods can proceed to step 807, where methods of making the coated article can be complete. In aspects, methods of making a coated article in accordance with aspects of the disclosure can proceed along steps 801, 803, 805, and 807 of the flow chart in FIG. 8 sequentially, as discussed above. In aspects, methods can follow arrow 806 from step 803 to step 807, for example, if methods of making the coated article are complete at the end of step 803. Any of the above options may be combined to make a foldable apparatus in accordance with the embodiments of the disclosure.

### EXAMPLES

Various aspects will be further clarified by the following examples. Examples A-C, 1-8, 35-44, AA-GG, JJ-NN, and XX-ZZ comprised a glass-based substrate (Composition 1 having a nominal composition in wt % of: 61.9 SiO₂; 19.7 Al₂O₃; 12.9 Na₂O; 3.9 B₂O₃, 1.5 MgO, and 0.1 K₂O) with a thickness of 0.55 mm. Examples D-I and Comparative Examples DD-II comprised a glass-based substrate (Composition 1) with a thickness of 1 mm.

Comparative Example AA was just the glass-based substrate. Comparative Example BB comprised a SiO₂ coating disposed on the glass-based substrate using high-density plasma chemical vapor deposition (HDPCVD). Comparative Examples AA-BB had water contact angles <60°. Comparative Example CC comprised a coating of octavinyl POSS (OV-POSS) disposed on the glass-based substrate by thermally evaporating the OV-POSS at a rate of 0.2 nm/s. Unless otherwise, indicated, thermal evaporation of functionalized POSS occurred using a Radak II cell in an Angstrom Engineering Evovac chamber.

Infrared (IR) absorption spectra representing the normalized absorbance of OV-POSS shows a large peak at about 1105 cm⁻¹ corresponding to the Si—O—Si bonds of the T-type (RSiO_{1.5}) units in the POSS cage and smaller peaks around 1270 cm⁻¹, 1010 cm⁻¹ and 980 cm⁻¹ are visible. IR absorption spectra rep of Comparative Example CC, where the OV-POSS was thermally evaporated onto the glass-based substrate, is identical to that of untreated OV-POSS, which indicates that the OV-POSS thermally evaporated onto the glass-based substrate has not reacted with itself or the glass-based substrate. Also, the coating of Comparative Example CC was easily removed with a fingernail and exhibited poor abrasion resistance.

As used in this section, the ion beam formed from an end-Hall source (KRI EH-400 from Kaufman & Robinson) operated at a voltage of 100 V. To explore the effect of ion beam intensity on coating formation during evaporation of the OV-POSS at 0.1 A/s, the discharge current was adjusted while the chamber pressure was about 1.3×10⁻² Pa of argon (Ar) gas (maintained with a flow of 2.7 sccm Ar). At a discharge current of 2.5 A, no coating was observed. The discharge current was decreased until coating formation was observed, which occurred at a discharge current of about 1 A. It is believed that the ion beam removed and/or decomposed the OV-POSS at the same rate or faster than it was deposited by thermal evaporation. Also, coatings were formed with different discharge current while the chamber pressure was maintained at about 2.7×10⁻² Pa of oxygen (O₂) gas (maintained with a flow of 7 sccm O₂). The discharge current was increased from 0 A to determine the lowest discharge current that a coating that could not be easily removed with a fingernail was obtained, which resulted in a minimum discharge current of about 0.25 A. Consequently, it is believed that the coatings can be formed using a discharge current of from about 0.25 A to about 1 A with the end-Hall source.

The properties of Examples A-C and Comparative Examples AA-CC are shown in Table 1. In Table 1, “IAD” refers to ion-assisted deposition and refers to the use of the ion beam in conjunction with the evaporation. In Table 1, the reported refractive index values and extinction coefficient values were taken at an optical wavelength of 550 nm and 400 nm, respectively. The thickness of the coatings was measured using ellipsometry, as described above, and is reported in Table 1.

Examples A-C were formed by thermally evaporating the OV-POSS at a rate of about 0.07 nm/s (slightly lower than in Comparative Example CC due to the ion beam) and simultaneously impinging an ion beam formed from an end-Hall source (KRI EH-400 from Kaufman & Robinson) operated at a voltage of 100 V and a discharge current of 0.25 A. For Example A, the chamber pressure was about 1.3×10⁻² Pa of argon (Ar) gas (maintained with a flow of 2.7 sccm Ar). For Example B, the chamber pressure was about 2.7×10⁻² Pa of oxygen (O₂) gas (maintained with a flow of 7 sccm O₂). For example C, the chamber pressure was about 4×10⁻² Pa of a 70 mol % Ar 30 mol % O₂ mix (maintained with a flow of 10 sccm of the mixture). In Examples A-C, the evaporation and ion-beam treatment continued until a coating of about 400 nm was obtained.

TABLE 1
Properties of Examples A-C and Comparative Examples AA-CC

| | | | | | Elastic | % Silica- | |
|---|---|---|---|---|---|---|---|
| | | t | Refractive | Extinction | Modulus | like | Ra |
| Ex. | Coating | (nm) | Index | Coefficient | (GPa) | Network | (nm) |
| A | OV-POSS | 460 | 1.55 | 0.006 | 20 | 85 | 0.59 |
| | (Ar IAD) | | | | | | |
| B | OV-POSS | 465 | 1.48 | <0.003 | 30 | 65 | 0.42 |
| | (O₂ IAD) | | | | | | |
| C | OV-POSS | 77 | 1.54 | 0.005 | — | 75 | — |
| | (Ar/O₂ | | | | | | |
| | IAD) | | | | | | |
| AA | n/a | n/a | — | — | n/a | n/a | — |
| BB | SiO₂ | 305 | 1.46 | <0.003 | 48 | 100 | 0.39 |
| CC | OV-POSS | 400 | 1.48 | 0.003 | 5 | 0 | — |
| | (evap) | | | | | | |

IR spectra for Examples A-C have large peaks from about 1000 cm⁻¹ to about 1060 cm⁻¹ that is not present to this extent for Comparative Example CC. This peak is attributed to the formation of Q-type (i.e., silica-like) Si—O—Si bonds, which demonstrates that the ion beam treatment transforms the OV-POSS. Indeed, the intensity of the peak around 1105 cm⁻¹ decreases going from Comparative Example CC to Example A to Example B to Example C. This demonstrates that the ion-beam treatment at least partially disrupts the cage structure, for example, by transforming T-type structures into Q-type structures. Also, the greater fraction of oxygen in the chamber (and thus in the ion beam) is associated with greater disruption of the T-type structures.

Based on the IR peaks, a % silica-type network is calculated, as discussed above, and reported in Table 1. Also, the elastic modulus of the coatings was measured using nanoindentation, as discussed above, and reported in Table 1. As shown, the elastic modulus increases as the fraction of the coating in a silica-like network increases. Example A comprises an elastic modulus of 20 GPa and about 65% of the coating is in a silica-type network. Example B comprises an elastic modulus of 30 GPa and about 85% of the coating is in a silica-type network. Based on the increased fraction of silica-type network in Example B relative to Example A, it appears that the oxygen ion beam achieves a greater extent of reaction (from OV-POSS to silica-type network) than the argon ion beam (and thermal evaporation along does not cause this reaction to occur).

Refractive index and extinction coefficient curves as a function of optical wavelength were measured for Examples A-B. As shown in Table 1, Example B (1.48) has a greater refractive index than Example A (1.55), which can be attributed to the greater disruption of the POSS cage structure by the oxygen ion beam compared to the argon ion beam resulting in a more silica-like structure. The extinction coefficient for Example B drops to zero before an optical wavelength of 250 nm and remains there throughout the visible spectrum, which is associated with low absorption of visible light. For Example A, the extinction coefficient decreases as optical wavelength increases, but the extinction coefficient at 400 nm is still about 0.006.

Transmittance as a function of optical wavelength for Examples A-V and Comparative Examples AA-CC. Comparative Examples AA-CC have substantially the same transmittance over the visible spectrum. Comparatively, Example B has decreased transmittance for optical wavelengths less than 400 nm, but the transmittance is about the same as Comparative Examples AA-CC for optical wavelengths of about 400 nm or more. Example A has decreased transmittance for optical wavelengths less than 600 nm, but the transmittance is about the same as Comparative Examples AA-CC for optical wavelengths of about 600 nm or more. Based on these results, the oxygen ion beam produces coatings with decreased extinction coefficient and increased transmittance than those produced with the argon ion beam.

Examples A-B and Comparative Example CC were characterized by secondary-ion mass spectrometry (SIMS) in terms of mass-to-charge distributions. Samples were cleaned with a low-energy Ar gas cluster ion beam (GCIB) source before analysis with SIMS. The results indicated that Comparative Example CC has peaks that correspond to large fragments of OV-POSS, which is consistent with the observations above that evaporation of OV-POSS alone does not physically bond or otherwise react with the first major surface of the substrate (e.g., Comparative Example CC). The results for Example B include dehydrogenated silicate clusters, which is believed to be associated with higher content of silica-like networks.

Examples A-B and Comparative Example CC were characterized by X-ray photoelectron spectroscopy (XPS). All of the Examples had 0.1 atom % or less of argon and nitrogen. Example CC has the most carbon and the least oxygen. Compared to the about 45 atom % carbon for Comparative Example CC, Example A has about half the carbon (about 23 atom %) while Example B has about 5 atom % carbon. It is believed that the 5 atom % carbon level is about the level of background environmental contamination present when the samples were analyzed. Example B had the least carbon and the least oxygen, which corresponds to the greater extent of reaction caused by the oxygen ion beam, for example, resulting in the vinyl functional groups at the exterior surface being removed. The silicon amounts are about the same for Examples A-B and Comparative Example CC.

Also, the binding energy for electrons in the 2p orbital of silicon atoms in Examples A-B and Comparative Example CC were also measured using XPS. Comparative Example CC had the highest binding energy, which is lower than that for pure Si—CH═CH₂ bonding but greater than that for pure silica-like networks. Examples A-B are symmetric and have the same peak binding energy, which is about the same as a reference value for a pure silica-like network.

Also, the binding energy for electrons in the 2p orbital of carbon atoms in Examples A-B and Comparative Example CC were also measured using XPS. Only Comparative Example CC had binding energies associated with carbon-carbon double-bonds, which is consistent with the above explanation that the ion beam treatment reacts and/or removes the vinyl functional groups.

²⁹Si chemical shifts were measured from solid-state nuclear magnetic resonance (NMR) (SS-NMR) for a sample prepared the same as Example B, but on a Si-coated KBr substrate to form a thickness of 2.7 μm using 8 deposition cycles to improve signal resolution. The 2.7 μm thick coating was scraped off the glass-based substrate and analyzed using SS-NMR to remove contributions from the glass-based substrate. The overall signal detected was fitted using 6 smaller curves corresponding an M-type structure (e.g., (SiO)Si(OH)₃), a T-type structure found in POSS (e.g., (SiO)₃Si(R) or RSiO_{1.5}), a D-type structure (e.g., (SiO)2Si(OH)(R)), and three of the smaller curves are associated with Q-type structures (e.g., silica-type networks with (SiO)ₓSi(OH)₄₋ₓ, where x is an integer from 2 to 4). Based on the assignment of these fitted curves and the associated area, ratios of 1.4 Si—OH per Si, 0.14 Si—R per Si (where R is an organic group), and 2.72 Si—O—Si per Si were determined. The low amount of Si—R bonds is consistent with the oxygen ion beam decreasing the organic content of the OV-POSS. The large preponderance of Q-type structures is indicative of the large (but not complete—e.g., from about 50% to about 90%) silica-type network formed using the deposition conditions of Example B.

The adhesion of the Examples A-C and Comparative Examples AA-BB was tested by disposing a 2 μm thick silicon nitride (SiNₓ) coating on thereon with the surface of the coating cleaned with either (a) a Branson inductively coupled plasma (ICP) asher (Branson L3200 ICP Plasma Asher) operated at 600 W and a chamber pressure of 160 Pa with 300 sccm of oxygen for 10 minutes and/or (b) a Versaline HDPCVD (available from Plasma-Therm) operated at 2,000 W and a chamber pressure of about 1 Pa with 50 sccm of oxygen for 1 minute before disposing the silicon nitride coating. A diamond scribe was used to make three parallel 20 mm long scratches that penetrated through all coatings to the first major surface of the glass-based substrate. Then, the coatings were covered with 0.1 wt % Triton X-100 in deionized water for 1 minute before a plastic razor blade was used to squeegee perpendicular to the scratches 25 times in both directions. The samples were inspected using optical microscopy (100× magnification) as-formed and then after the samples were scratched, covered, and squeegeed for blisters or other signs of delamination. The 2 μm thick silicon nitride coating makes it clearer whether delaminations occur and subjects the coating to the sorts of stresses that would be encountered in when used in conjunction with other coatings (e.g., anti-reflective, gradient index).

Table 2 presents the results of this adhesion testing. Comparative Examples AA-BB exhibited no blisters and 0 or 1 delaminations. For Examples A and C, the Branson cleaning prevented the blister seen without it and reduced the number of delaminations from 50 or 28 to 4 or 5. For Example B, no blistering was observed for any condition with either 0 or 1 delamination. It is unexpected that Example B (oxygen ion beam) would provide no blisters and 0 or 1 delaminations under these harsh conditions.

TABLE 2
Adhesion testing for Examples A-B
and Comparative Examples AA-CC

| | Branson | Takachi | | |
|---|---|---|---|---|
| Ex. | cleaning? | cleaning? | Blisters | Delaminations |
| A | N | Y | Y | 50 |
| A | Y | Y | N | 4 |
| B | N | N | N | 0 |
| B | N | Y | N | 0 |
| B | Y | Y | N | 1 |
| C | N | Y | Y | 28 |
| C | Y | Y | N | 5 |
| AA | N | N | N | 1 |
| AA | N | Y | N | 1 |
| BB | N | N | N | 0 |

The chemical stability of Examples A-B and Comparative Example BB were tested by measuring the changing in thickness and refractive index after the coatings were sequentially subjected to (1) 20 minutes in 2 wt % alkaline detergent solution (Semi Clean KG) at 50° C. and (2) 20 minutes in deionized water. All samples exhibited a thickness loss of less than 7 nm and less than 2%, with Example A having a thickness loss of about 1.2 nm, Example B having a thickness loss of about 6.7 nm (1.4%), and Comparative Example BB having a thickness loss of 5.1 nm (1.7%). All examples exhibited a change in refractive index of less than 0.002 with Example A having an increase in refractive index of 0.0008, Example B having an increase in refractive index of 0.004, and Comparative Example BB having a decrease in refractive index of 0.0013. This demonstrates that the chemical stability of Examples A-B is comparable to if not better than that of a silica coating (Comparative Example BB).

The thermal stability of Examples A-B were evaluated by heating samples at a temperature of 200° C., 300° C., or 400° C. for 10 minutes. For all conditions, changes in thickness were less than 5%. At 300° C., the change in thickness was less than 3% for Example A and about 1% for Example B. At 200° C., the change in thickness for Example B was less than 2.5% and less than 0.5% for Example A. Likewise, IR spectra after these thermal treatments (not shown) were substantially the same with changes in normalized absorbance of less than 0.05. from 500 cm⁻¹ to 1500 cm⁻¹. This demonstrates that the coatings are thermally stable. However, as discussed above, it is believed that prolonged heating at high temperatures can form a greater amount of silica-like network (e.g., greater than 90%) that is detrimental to abrasion resistance.

Table 3 presents contact angles and surface energy values for Examples D-I and Comparative Example DD-GG, which were prepared by disposing an initial coating and then optionally reacting this coating with an evaporated silane. The initial coating for Examples D-F was formed by evaporating OV-POSS at 0.78 A/s while impinging an oxygen ion beam generated by an end-Hall source (KRI EH-400) operated at 100 V with a discharged current of 0.25 and a chamber pressure of 5.3×10⁻⁵ Pa of oxygen (O₂) gas (maintained with a flow of 3 sccm O₂), which produced a thickness of about 105 nm, a refractive index of 1.486, and relatively strong O—H stretch by FTIR (“high OH”). The initial coating for Examples G-I was formed by evaporating OV-PSS at 18.9 A/s while impinging an oxygen ion beam generated by an end-Hall source (KRI EH-400) operated at 100 V with a discharged current of 0.25 and a chamber pressure of 5.3×10⁻⁵ Pa of oxygen (O₂) gas (maintained with a flow of 3 sccm O₂), which had a slight gray color attributed to residual vinyl groups, which was confirmed by FTIR showing the C═C vinyl stretch and a relatively weak O—H stretch (“low OH”). Then, the initial coatings (e.g., low OH, high OH) were placed upright in Salvillex PFA vials along with 25 μL of a silane disposed away from the sample; after the lid was secured, it was heated at 170° C. for 5 hours before removing the lid and allowing the sample to cool to room temperature (e.g., about 25° C.) naturally.

As used in Table 3, “18TMS” refers to octadecyltrimethoxysilane, “i8TMS” refers to iso-octadecyltrimethoxysilane, “12TES” refers to dodecyltriethoxysilane, and “ETMS” refers to ethoxytrimethylsilane. 18TMS, i8TMS, 12TES, and ETMS are alkyl silanes (e.g., trialkoxy alkyl silanes). 18TMS, i8TMS, and 12TES are methoxysilanes while ETMS is an ethoxysilane. “POTS” refers to heptadecafluoro-1,1,2,2-tetrahdryotrimethoxysilane, which is a fluorine-containing silane. As used herein, “WCA” refers to the water contact angle (as-formed), “HDCA” refers to the hexadecane contact angle (as-formed), and “DIMCA” refers to the diiodomethane contact angle (as-formed).

As shown in Table 3, Comparative Examples DD and GG are not hydrophobic, have total surface energies of 40 mN/m or more, and polar surface energies of 7 mN/m or more, which suggests that the initial coating of OV-POSS alone would not be suitable as a fingerprint-hiding coating. Also, Comparative Examples FF and II are not hydrophobic, have total surface energies of 34 mN/m or more, and polar surface energies of 8 mN/m or more, which suggests that the single ethoxy silane may not be suitable for functionalizing the initial coating of OV-POSS to form a fingerprint-hiding coating. On the other hand, Comparative Examples EE and HH uses a fluorine-containing silane, which produces a hydrophobic water contact angle, a low total surface energy, and a low polar surface energy.

TABLE 3
Contact angles and surface energy for Examples

| | | | | | | Total | Dispersive | Polar |
|---|---|---|---|---|---|---|---|---|
| | | | | | | Surface | Surface | Surface |
| | Initial | | | | | Energy | Energy | Energy |
| Ex | Coating | Silane | WCA | HDCA | DIMCA | (mN/m) | (mN/m) | (mN/m) |
| D | High OH | 18TMS | 103.5° | wet | 66.6° | 29.2 | 27.3 | 1.9 |
| E | High OH | i8TMS | 100.2° | 27.1° | 73.9° | 26.9 | 23.6 | 3.4 |
| F | High OH | 12TES | 101.6° | 18.1° | 73.5° | 28.5 | 25.7 | 2.9 |
| G | Low OH | 18TMS | 96.9° | wet | 55.1° | 32.2 | 27.9 | 4.3 |
| H | Low OH | i8TMS | 99.1° | 31.9° | 63.3° | 28.1 | 23.6 | 4.5 |
| I | Low OH | 12TES | 102.9° | 42.8° | 73.8° | 24.9 | 21.1 | 3.8 |
| J | PHPS | 18TMS | 103° | 17° | 65° | 28.6 | 26.1 | 2.6 |
| DD | High OH | n/a | 31.8° | 28.4° | 48.1° | 63.7 | 24.8 | 38.9 |
| EE | High OH | POTS | 110.5° | 70.2° | 101.6° | 17.3 | 13.6 | 3.7 |
| FF | High OH | ETMS | 67.6° | 29.3° | 83.5° | 35.1 | 24.6 | 10.5 |
| GG | Low OH | n/a | 87.0° | 19.6° | 48.9° | 40.2 | 33.4 | 6.8 |
| HH | Low OH | POTS | 108.3° | 55.9° | 82.2° | 20.4 | 17.4 | 3.0 |
| II | Low OH | ETMS | 86.8° | 23.1° | 58.8° | 34.5 | 25.7 | 8.8 |

Examples D-I are hydrophobic with water contact angles of 90° or more and 95° or more. Examples D-F and I have water contact angles of 100° or more. Examples D-I are oleophilic. Examples D-I either wet hexadecane or has a hexadecane water contact of 45° or less. Examples D-H either wet hexadecane or has a hexadecane water contact angle of 40° or less or about 35° or less. Examples D-G either wet hexadecane or has a hexadecane water contact angle of 30° or less. This suggests that “high OH” initial coating (e.g., with the lower evaporation rate of the functionalized POSS). Examples D-F and G-I have a diiodomethane contact angle from about 60° to about 80°. Examples D-F and H-I have a total surface energy of 30 mN/m or less. Examples D-I have a dispersive surface energy of 30 mN/m or less. Examples D-I have a polar surface energy of 5 mN/m or less. Examples D-F and I have a surface energy of 4 mN/m or less. Example D and F have a polar surface energy of 3 mN/m or less. Compared to Comparative Examples EE and HH (fluorine-containing silane), Examples D-I are more oleophilic (lower hexadecane contact angle) and have a lower diiodomethane contact angle, which suggests that Examples D and F are better suited for fingerprint-hiding applications than Comparative Examples EE and HH.

Table 4 presents results of the Steel Wool Abrasion Test for Examples D-E, G-H, and J as well as Comparative Examples EE and HH-II. For Comparative Example EE, the contact angle decreased by from about 21° from as-formed to 3,500 cycles while the contact angle decreased by more than 40° for Comparative Examples HH and II. As discussed above, Examples D-E, G-H, and J are hydrophobic as-formed. After 2,500 cycles and after 3,500 cycles Examples D and J is still hydrophobic. In fact, the water contact angle for Example D only decreased by from 3° to 5° (compared to more than 40° for Comparative Examples HH and II or 21° for Comparative Example EE) after 3,500 cycles, which demonstrates that Examples D and J have good abrasion resistance and can maintain a high water contact angle after abrasion.

TABLE 4
Results of Steel Wool Abrasion Test

| | | | WCA | Abraded WCA | Abraded WCA |
|---|---|---|---|---|---|
| | Initial | | (as- | (2,000 | (3,500 |
| Ex | Coating | Silane | formed) | cycles) | cycles) |
| D | High OH | 18TMS | 102° | 100° | 99° |
| E | High OH | i8TMS | 92° | 73° | 67° |
| G | Low OH | 18TMS | 91° | 65° | 64° |
| H | Low OH | i8TMS | 96° | 69° | 72° |
| J | PHPS | 18TMS | 102° | 97° | 97° |
| EE | High OH | POTS | 109° | 89° | 88° |
| HH | Low OH | POTS | 104° | 69° | 61° |
| II | n/a | 18TMS | 104° | 60° | 57° |

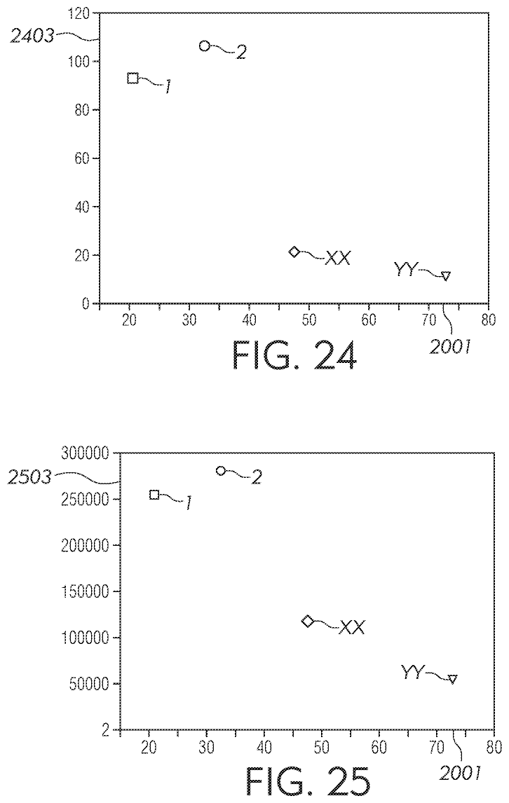

In Example J, a precursor solution comprising 3% by volume (% v/v) perhydropolysilazane (PHPS) without catalyst in dibutyl ether (Durazane 2250) was spin coated on a glass-based substrate comprising Composition 2 at 1,000 rpm for 30 seconds before being heated at 250° C. for 30 minutes to form an initial coating. The PHPS films of example J were functionalized with 18TS applied via dip coating in a solution of 2 vol % of 18TMS was added to toluene. The samples were immersed in this solution for 30 min. Following this the samples were transferred to an oven set at 150° C. for 30 min. If necessary, the samples were wiped with a toluene soaked wipe to remove visible haze. As shown in Table 3, the resulting coating has a water contact angle (as-formed) of 103°, a hexadecane contact angle of 17°, and a diiodomethane contact angle of 65°. Example J was hydrophobic and oleophilic. Example J had a total surface energy of 28.6 mN/m, a dispersive surface energy of 26.1 mN/m, and a polar surface energy of 2.6 mN/m. As shown in Table 4 and FIG. 24, Example J maintains a hydrophobic surface with a water contact angle of 97° after 2,000 cycles and 3,500 cycles in the Steel Wool Abrasion Test with only a 5° decrease in water contact angle as a result of the Steel Wool Abrasion Test.

A precursor solution comprising 1% by volume (% v/v) of hydrogen POSS was spin-coated on a glass-based substrate comprising Composition 2 at 1200 rpm for 30 seconds before being heated at 400° C. or at 600° C. for 30 minutes. When heated at 400° C., the cured hydrogen POSS coating had an elastic modulus of about 9.4 GPa. When heated at 600° C., the cured hydrogen POSS coating had an elastic modulus of about 56.5 GPa. It is predicted that improved abrasion resistance can be obtained for curing hydrogen POSS-containing solutions at temperatures from about 400° C. to about 530° C. Further, it is expected that this will also apply to solutions containing hydrogen POSS and one or more of the silanes discussed above.

Examples 1-2 and Comparative Example XX were prepared by spraying a 2 vol % solution of an alkyl silane dissolved in propylene glycol methyl ether acetate on a glass substrate (Composition 1) and heated at 150° C. for 30 minutes. For Example 1, the alkyl silane was 1,8-bis(chlorodimethylsilyl)octane (BISCO), which is shown in FIG. 17A. For Example 2, the alkyl silane was chloropropyltrimethoxysilane (chloropropyl), which is shown in FIG. 17B. For Comparative Example XX, the alkyl silane was octadecyltrimethoxysilane (OTS), which is shown in FIG. 17C. Comparative Example YY was a fluorine-based “easy-to-clean” (ETC) coating (i.e., Daiken UD-509 ETC). Comparative Example ZZ was untreated glass. It is expected that Examples 1-2 will have similar or better abrasion resistance to those of Examples D-E discussed above.

Table 5 presents the properties of Examples 1-2 and Comparative Example XX. Examples 1-2 have a total surface energy, a higher polar surface energy, and a higher dispersive surface energy than Comparative Example XX. Also, Examples 1-2 have lower hexadecane contact angles and oleic contact angles than Comparative Example XX, indicating that Examples 1-2 are more oleophilic than Comparative Example XX.

TABLE 5
Properties of Examples 1-2 and Comparative Example XX

| | | | Comparative |
|---|---|---|---|
| Parameter | Example 1 | Example 2 | Example XX |
| Coefficient of Friction | 0.19 | 0.23 | 0.15 |
| Total Surface Energy | 31.0 | 31.9 | 26.6 |
| (mN/m) | | | |
| Polar Surface Energy | 4.1 | 5.0 | 1.7 |
| (mN/m) | | | |
| Dispersive Surface | 26.9 | 26.9 | 24.9 |
| Energy (mN/m) | | | |
| Water Contact Angle | 97.7 | 99.0 | 105.7 |
| (°) | | | |
| Hexadecane Contact | 7.4 | 8.3 | 26.0 |
| Angle (°) | | | |
| Diiodomethane | 61.9 | 61.9 | 67.5 |
| Contact Angle (°) | | | |
| Oleic Acid Contact | 21.0 | 32.9 | 47.5 |
| Angle (°) | | | |

FIG. 14 schematically shows photographs taken after application of the simulated fingerprint in the Simulated Fingerprint Test using a Canon Rebel T7 DSLR camera equipped with a Canon EF-S 60 mm Macro Lens and illuminated using a ring light for Examples 1-2 and Comparative Examples XX-YY. FIG. 14(a) corresponds to Example 1, and the fingerprint is barely visible. FIG. 14(b) corresponds to Example 2, and the fingerprint is visible but not pronounced. FIGS. 14(c)-(d) correspond to Comparative Examples XX-YY, respectively, and the fingerprints are quite visible. This demonstrates that Examples 1-2 perform a “fingerprint-hiding” function relative to Comparative Examples XX-YY.

FIG. 16(a) schematically shows another set of photographs taken after application of the simulated fingerprint in the Simulated Fingerprint Test using a Canon Rebel T7 DSLR camera equipped with a Canon EF-S 60 mm Macro Lens and illuminated using a ring light for Examples 1-2 and Comparative Examples XX-YY. Going from left to right, the photographs are OTS (Comparative Example XX), ETC (Comparative Example YY), chloropropyl (Example 2), and BISCO (Example 1). FIG. 16(b) shows height maps based on white light interferometry measurements of the photographs shown in FIG. 16(a), where the horizontal axis (i.e. x-axis) and vertical axis (i.e., y-axis) in FIG. 16(b) correspond to physical locations in μm. As shown, the height maps for Examples 1-2 (rightmost two images of FIG. 16(b)) is significantly different than the height maps for Comparative Examples XX-YY.

Table 6 presents the properties of Examples 1-2 and Comparative Examples XX-YY measured with application of the simulated fingerprint in accordance with the Simulated Fingerprint Test described herein. The measurement for the properties presented in Table 6 is described above. As noted above, many of the properties of Examples 1-2 (and the corresponding ranges described above) are different from the corresponding properties of Comparative Examples XX-YY in a statistically significant way. The oleic acid contact angle (Table 5) is generally correlated with the mean gray level, haze, mean height, sphere cap radius, height to area ratio, total area, and volume to area ratio reported in Table 6.

TABLE 6
Properties of Examples 1-2 and Comparative Examples XX-YY

| | | | Comparative | Comparative |
|---|---|---|---|---|
| Parameter | Example 1 | Example 2 | Example XX | Example YY |
| Mean Gray Level | 125 ± 3 | 103 ± 10 | 196 ± 3 | 310 ± 5 |
| Baseline Gray Level | 75 ± 3 | 81 ± 6 | 75 ± 3 | 71 ± 5 |
| Normalized Gray | 1.7 ± 0.1 | 1.3 ± 0.2 | 2.6 ± 0.1 | 4.4 ± 0.3 |
| Level | | | | |
| Haze (%) | 6.8 ± 0.4 | 3.0 ± 0.2 | 10.4 ± 0.3 | 12.0 ± 0.1 |
| RMS height | 0.68 ± 0.13 | 0.44 ± 0.19 | 0.40 ± 0.05 | 0.99 ± 0.21 |
| Sq (μm) | | | | |
| Inverse Areal | 0.59 ± 0.18 | 0.29 ± 0.09 | 0.07 ± 0.12 | −0.11 ± 0.04 |
| Material Ratio | | | | |
| Smc (μm) | | | | |
| Areal Sectional | 1.00 ± 0.23 | 0.49 ± 0.15 | 0.20 ± 0.15 | 0.06 ± 0.02 |
| Height Difference | | | | |
| (10%, 90%) | | | | |
| Sdc (μm) | | | | |
| Auto-correlation | 47.8 ± 9.3 | 37.6 ± 6.2 | 15.5 ± 3.2 | 15.7 ± 2.6 |
| Length | | | | |
| Sal (μm) | | | | |
| Core material Value | 0.26 ± 0.05 | 0.12 ± 0.03 | 0.04 ± 0.03 | 0.02 ± 0.01 |
| (10%, 90%) | | | | |
| Vmc (μm³/μm²) | | | | |
| Material Ratio of | 31.3 ± 8.5 | 35.8 ± 7.6 | 21.6 ± 4.9 | 14.5 ± 3.4 |
| Hills | | | | |
| Smrk1 (%) | | | | |
| Mean Area (μm²) | 1680 ± 580 | 765 ± 340 | 120 ± 30 | 120 ± 40 |
| Total Area (μm²) | 279000 ± 28000 | 255000 ± 53000 | 115000 ± 32000 | 50000 ± 12000 |
| Mean Effective | 17.2 ± 3.4 | 12.3 ± 0.9 | 7.5 ± 1.3 | 7.5 ± 1.4 |
| Diameter (μm) | | | | |
| Height/Area Ratio | 0.0042 ± 0.0009 | 0.0039 ± 0.0012 | 0.0085 ± 0.0013 | 0.023 ± 0.06 |
| (μm/μm²) | | | | |
| Volume/Area Ratio | 0.73 ± 0.20 | 0.48 ± 0.24 | 0.81 ± 0.15 | 2.95 ± 0.65 |
| (μm³/μm²) | | | | |
| Cap Sphere Radius | 106.1 ± 10.3 | 93.7 ± 24.1 | 20.6 ± 3.0 | 9.7 ± 3.1 |
| (μm) | | | | |
| Distance from | 105.2 ± 10.3 | −92.6 ± 25.0 | −19.5 ± 3.2 | −5.9 ± 3.2 |
| Surface to Center of | | | | |
| Sphere (μm) | | | | |
| Mean Height (μm) | 0.12 ± 0.04 | 0.09 ± 0.05 | 0.20 ± 0.05 | 0.67 ± 0.20 |
| Mean Hill | 97.7 ± 8.3 | 78.5 ± 17.8 | 43.5 ± 5.5 | 77.3 ± 18.5 |
| Equivalent Diameter | | | | |
| Shed (μm) | | | | |
| Mean Hill Form | 0.73 ± 0.04 | 0.68 ± 0.08 | 0.57 ± 0.011 | 0.62 ± 0.09 |
| Factor | | | | |
| Sdff | | | | |

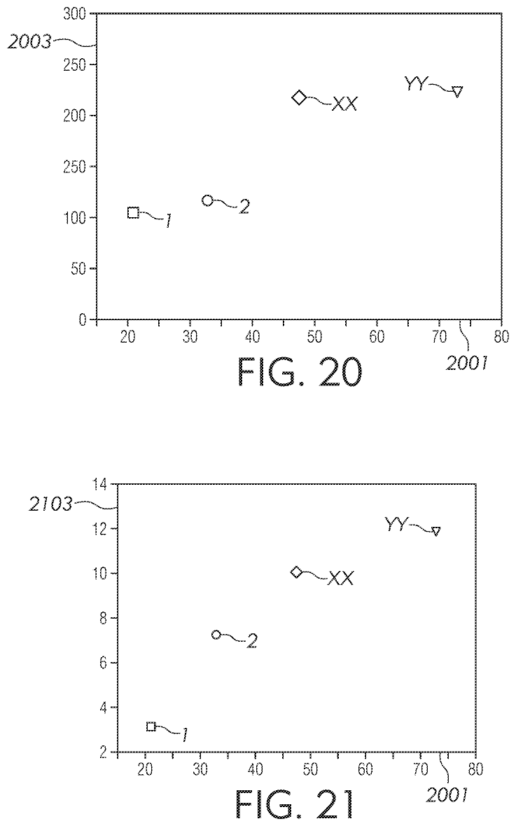

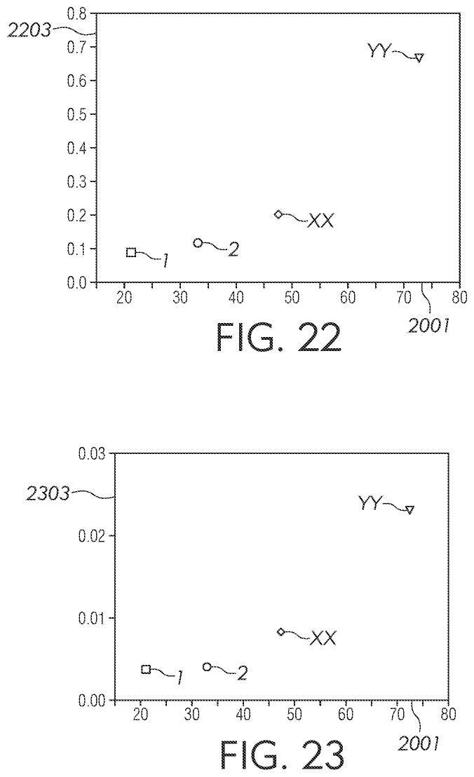

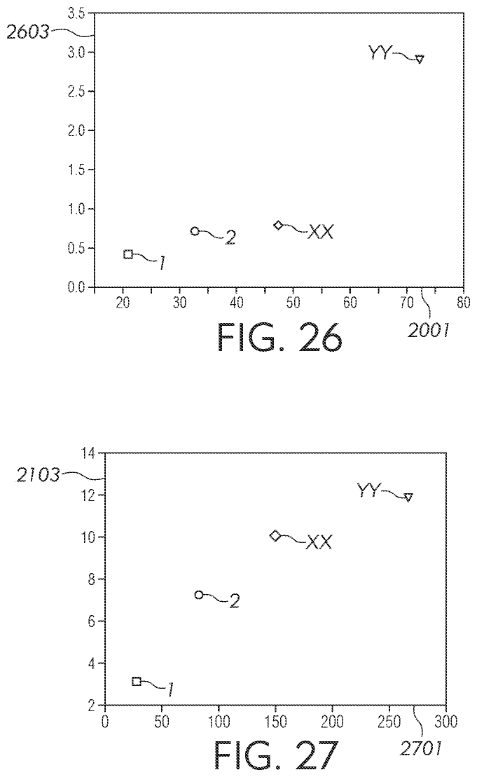

FIGS. 20-27 shows relationships between the properties reported in Table 6 for Examples 1-2 and Comparative Examples XX-YY, with the points labeled by the corresponding Example or Comparative Example. In FIGS. 20-26, the horizontal axis 2001 (i.e., x-axis) corresponds to the oleic acid contact angle in degrees. In FIG. 27, the horizontal axis 2701 (i.e. x-axis) corresponds to the mean gray level reported in Table 6. In FIG. 20, the vertical axis 2003 (i.e. y-axis) corresponds to the mean gray level reported in Table 6. In FIGS. 21 and 27, the vertical axis 2103 (i.e. y-axis) corresponds to the haze measured in percent after application of the simulated fingerprint and as reported in Table 6. In FIG. 22, the vertical axis 2203 (i.e. y-axis) corresponds to the mean height of droplets of the simulated fingerprint in micrometers as reported in Table 6. In FIG. 23, the vertical axis 2303 (i.e. y-axis) corresponds to a ratio of a height (i.e., mean height) of a droplet of the simulated fingerprint to an area (i.e., mean area) of droplets of the simulated fingerprint in μm/μm² (μm¹) as reported in Table 6. In FIG. 24, the vertical axis 2403 (i.e. y-axis) corresponds to spherical cap radius (“cap sphere radius” in Table 6) measured in μm, as defined above. In FIG. 25, the vertical axis 2503 (i.e. y-axis) corresponds to a total area of droplets of the simulated fingerprint in μm² as reported in Table 6. In FIG. 26, the vertical axis 2603 (i.e. y-axis) corresponds to a ratio of a volume (i.e., mean volume) of a droplet of the simulated fingerprint to an area (i.e., mean area) of droplets of the simulated fingerprint in μm³/μm² (μm) as reported in Table 6. In FIG. 23, the vertical axis 2303 (i.e. y-axis) corresponds to a ratio of a height (i.e., mean height) of a droplet of the simulated fingerprint to an area (i.e., mean area) of droplets of the simulated fingerprint in μm/μm² as reported in Table 6.

As shown in FIGS. 20-26 and Table 5, Examples 1-2 exhibit an oleic contact angle of less than 40° (e.g., less than 35°) while the oleic contact angle of Comparative Examples XX-YY is greater than 40° (e.g., greater than 45°). As shown in FIGS. 20 and 27 and Table 6, Examples 1-2 exhibit a mean gray value of less than 140 (e.g., less than 125) while the mean gray value of Comparative Examples XX-YY is greater than 140. As shown in FIGS. 21 and 27 and Table 6, Examples 1-2 exhibit a haze value of less than 10% (e.g., less than 8%) while the haze value of Comparative Examples XX-YY is greater than 10%. As shown in FIG. 22 and Table 6, Examples 1-2 exhibit a mean height of droplets of the simulated fingerprint of less than 0.2 μm while the mean height of droplets in Comparative Examples XX-YY is greater than 0.2 μm. As shown in FIG. 23 and Table 6, Examples 1-2 exhibit a ratio of height to area of the droplets of the simulated fingerprint is less than 0.008 μm/μm² (e.g., less than 0.006 μm/μm²) while the corresponding ratio (height/area) of Comparative Examples XX-YY is greater than 0.008 μm/μm². As shown in FIG. 26 and Table 6, Examples 1-2 exhibit a ratio of volume to area of droplets of the simulated fingerprint is less than 0.8 μm³/μm² while the corresponding ratio (volume/area) of Comparative Examples XX-YY is greater than 0.8 μm³/μm². Also, FIGS. 20-23 and 26, the oleic contact angle is positively (e.g., directly) correlated with the mean gray level, haze, mean height, ratio of height to area, spherical cap radius, and ratio of volume to area measured with the simulated fingerprint. As discussed above, the oleic acid contact angle, the mean gray value, the haze, the mean height, and the height to area ratio values of Example 1-2 are different from the corresponding values of Comparative Examples XX-YY different from the above-mentioned ranges in statistically significant way and demonstrates that the fingerprint-hiding coating of the present disclosure (e.g., Examples 1-2) does a better job of “hiding” visual effects associated with an applied fingerprint than the Comparative Examples.

As shown in FIG. 24 and Table 6, Examples 1-2 exhibit a spherical cap radius of droplets of the simulated fingerprint that is greater 60 μm (e.g., greater than 80 μm or greater than 90 μm) while the spherical cap radius of Comparative Examples XX-YY is less than 60 μm (e.g., less than 40 μm or less than 30 μm). As shown in FIG. 25 and Table 6, Examples 1-2 exhibit a total area of droplets of the simulated fingerprint greater than 200,000 μm² (e.g., greater than 250,000 μm²) while the total area of droplets for Comparative Examples XX-YY is less than 200,000 μm² (e.g., less than 150,000 μm). As shown in FIGS. 24-25, the oleic acid contact angle is negatively (e.g., directly) correlated with the spherical cap radius and the total area of the droplets of the simulated fingerprint. As shown in FIG. 27, the mean gray level is positively (e.g., directly) correlated with haze as measured with the simulated fingerprint.

Tables 7-13 presents additional properties of Examples 1-2 and Comparative Examples XX-YY measured with application of the simulated fingerprint in accordance with the Simulated Fingerprint Test described herein. The measurement for the properties presented in Tables 7-10 is described above. Table 7 presents height parameters (Ssk, Sku, Sp, Sv, Sz, and Sa), functional parameters (Smr), spatial parameters (Str, Std, Ssw), and hybrid parameters (Sdr). Table 8 presents functional parameters in terms of volume (Vm, Vv, Vmp, Vvc, Vvv). Table 9 presents parametric features (Spd, Spc, S5p, Sha, Sdv, Shv, Svc, Shh, Shhx, Shhq, Shax, Shaq, Shvx, Shvq, Sdd, Sddx). Table 10 presents functional parameters characterizing stratified surfaces (Sk, Spk, Svk, Smrk2, Sak1, Sak2, Spkx*, Svkx) and characterizing watershed or shape properties (Shin, Shrnx, Shmq, Shff, Shffx, Shffq, Shed, Shedx, Shedq, Shar, Sharx, Sharq, Sdm, Sdmx, Sdmq, Sdff, Sdffx, Sdffq, Sded, Sdedx, Sdedq, Sdar, Sdarx, Sdarq). Table 11 presents dimensions of the droplets (perimeter, external perimeter, equivalent radius, equivalent diameter, minimum diameter, maximum diameter, maximum caliber, X-extent, Y-extent), volume (mean material volume, void volume, total volume, sphere center x-extent, sphere center y-extent). Table 12 presents properties related to the height of droplets (z-minimum, z-maximum, z-mean, mean contour height, minimum contour height, maximum contour height, maximum depth, mean depth, maximum height). Table 13 presents properties related to the shape or orientation of droplets (form factor, aspect ratio, roundness, compactness, convexity, elongation, solidity, orientation angle, angle of minimum diameter, angle of maximum diameter, length, width, height).

TABLE 7
Properties of Examples 1-2 and Comparative Examples XX-YY

| | | | Comparative | Comparative |
|---|---|---|---|---|
| Parameter | Example 1 | Example 2 | Example XX | Example YY |
| Skew Ssk | 3.9 ± 0.5 | 6.2 ± 2.7 | 5.2 ± 0.9 | 8.3 ± 1.5 |
| Kurtosis Sku | 24 ± 7 | 72 ± 73 | 33 ± 10 | 79 ± 28 |
| Maximum Peak | 8.6 ± 2.3 | 8.6 ± 6.8 | 5.1 ± 0.7 | 12.9 ± 2.2 |
| Height Sp (μm) | | | | |
| Maximum Pit Height | 0.54 ± 0.11 | 0.8 ± 1.4 | 0.62 ± 0.13 | 1.9 ± 0.9 |
| Sv (μm) | | | | |
| Maximum Height | 9.1 ± 2.4 | 9.4 ± 8.2 | 5.7 ± 0.7 | 14.8 ± 2.6 |
| Sz (μm) | | | | |
| Arithmetic | 0.40 ± 0.08 | 0.22 ± 0.07 | 0.18 ± 0.04 | 0.29 ± 0.08 |
| Roughness Sa (μm) | | | | |
| Peak Material Portion | 0.02 ± 0.01 | 0.03 ± 0.02 | 0.06 ± 0.10 | 0.06 ± 0.03 |
| Smr | | | | |
| Texture Aspect Ratio | 0.5 ± 0.3 | 0.7 ± 0.2 | 0.8 ± 0.1 | 0.8 ± 0.1 |
| Str | | | | |
| Texture Direction | 47 ± 52 | 126 ± 54 | 128 ± 44 | 136 ± 27 |
| Std (°) | | | | |
| Maximum Pit Height | 5.9 ± 0.6 | 7 ± 4 | 13 ± 3 | 26 ± 8 |
| Ssw (μm) | | | | |
| Root Mean Square | 0.05 ± 0.01 | 0.05 ± 0.03 | 0.08 ± 0.01 | 0.18 ± 0.03 |
| Gradient | | | | |
| Sdq (μm/μm) | | | | |
| Developed Interfacial | 0.12 ± 0.03 | 0.13 ± 0.13 | 0.33 ± 0.08 | 1.3 ± 0.4 |
| Area Ratio Sdr | | | | |

TABLE 8
Properties of Examples 1-2 and Comparative Examples XX-YY

| | | | Comparative | Comparative |
|---|---|---|---|---|
| Parameter | Example 1 | Example 2 | Example XX | Example YY |
| Material Volume | 0.11 ± 0.02 | 0.07 ± 0.03 | 0.08 ± 0.01 | 0.15 ± 0.05 |
| Vm(10%) (μm) | | | | |
| Void Volume | 0.7 ± 0.2 | 0.4 ± 1 | 0.15 ± 0.12 | 0.04 ± 0.01 |
| Vv (10%) (μm³) | | | | |
| Peak Material Volume | 0.11 ± 0.02 | 0.07 ± 0.03 | 0.08 ± 0.01 | 0.15 ± 0.05 |
| Vmp(10%) (μm) | | | | |
| Core Material Volume | 0.69 ± 0.19 | 0.35 ± 0.12 | 0.15 ± 0.12 | 0.04 ± 0.01 |
| Vvc(10%, 90%) (μm) | | | | |
| Dale Void Volume | 0.010 ± 0.006 | 0.005 ± 0.004 | 0.0025 ± 0.0002 | 0.0032 ± 0.0007 |
| Vvv(10%, 80%) (μm³) | | | | |
| Density of Peaks | 0.0001 ± 0.0001 | 0.0001 ± 0.0001 | 0.0004 ± 0.002 | 0.0002 ± 0.0001 |
| Spd (#/mm²) | | | | |
| Arithmetic Mean Peak | 0.08 ± 0.01 | 0.09 ± 0.06 | 0.08 ± 0.01 | 0.25 ± 0.06 |
| Curvature Spc (μm) | | | | |
| Five-point Peak Height | 6.9 ± 1.4 | 6.3 ± 3.9 | 4.3 ± 0.4 | 11.9 ± 1.7 |
| S5p (μm) | | | | |
| Mean Hill Area | 9150 ± 160 | 6900 ± 3000 | 2200 ± 700 | 6300 ± 3000 |
| Sha(5%) (μm²) | | | | |
| Mean Dale Volume | 34 ± 33 | 108 ± 210 | 28 ± 16 | 40 ± 13 |
| Sdv(5%) (μm³) | | | | |
| Mean Hill Volume | 990 ± 230 | 500 ± 460 | 210 ± 50 | 1100 ± 700 |
| Shv(5%) (μm³) | | | | |

TABLE 9
Properties of Examples 1-2 and Comparative Examples XX-YY

| | | | Comparative | Comparative |
|---|---|---|---|---|
| Parameter | Example 1 | Example 2 | Example XX | Example YY |
| Svc | −0.34 ± 0.17 | −0.2 ± 0.3 | −0.11 ± 0.04 | −0.34 ± 0.12 |
| Mean Hill Height | 1.6 ± 0.3 | 1.2 ± 0.8 | 1.2 ± 0.2 | 4.7 ± 0.8 |
| Shh (μm) | | | | |
| Maximum Hill Height | 7.1 ± 1.7 | 4.9 ± 1.7 | 4.8 ± 0.7 | 12.3 ± 2.5 |
| Shhx (μm) | | | | |
| Standard Deviation of | 1.5 ± 0.2 | 0.8 ± 0.3 | 0.9 ± 0.2 | 3.1 ± 0.6 |
| Hill Height Shhq (μm) | | | | |
| Shax | 38000 ± 9000 | 48000 ± 12000 | 47000 ± 3000 | 58000 ± 34000 |
| Shaq | 7700 ± 1900 | 9000 ± 4000 | 4000 ± 2000 | 8000 ± 4000 |
| Maximum Hill | 8000 ± 2000 | 3800 ± 1300 | 3200 ± 900 | 11000 ± 5000 |
| Volume Shvx (μm³) | | | | |
| Standard Deviation of | 1600 ± 400 | 800 ± 400 | 410 ± 150 | 1800 ± 1100 |
| Hill Volume | | | | |
| Shvq (μm³) | | | | |
| Sdd | 1.2 ± 0.4 | 0.3 ± 0.1 | 0.4 ± 0.1 | 1.4 ± 1.0 |
| Sddx | 2.5 ± 0.8 | 0.4 ± 0.2 | 0.5 ± 0.2 | 1.6 ± 1.0 |
| Sddq | 0.7 ± 0.3 | 0.02 ± 0.02 | 0.08 ± 0.09 | 0.13 ± 0.14 |
| Sdax | 1800 ± 400 | 4000 ± 7000 | 17000 ± 2000 | 800 ± 300 |
| Sdaq | 600 ± 1200 | 1500 ± 2900 | 4000 ± 5000 | 260 ± 130 |
| Sdvx | 120 ± 160 | 200 ± 400 | 60 ± 40 | 70 ± 20 |
| Sdvq | 40 ± 60 | 90 ± 180 | 10 ± 10 | 17 ± 10 |
| Shn | 60 ± 20 | 100 ± 50 | 360 ± 190 | 120 ± 90 |
| Sdn | 5.0 ± 1.7 | 1.8 ± 1.0 | 11 ± 11 | 4 ± 3 |

TABLE 10
Properties of Examples 1-2 and Comparative Examples XX-YY

| | | | Comparative | Comparative |
|---|---|---|---|---|
| Parameter | Example 1 | Example 2 | Example XX | Example YY |
| Core Height Sk (μm) | 0.38 ± 0.13 | 0.13 ± 0.05 | 0.07 ± 0.03 | 0.05 ± 0.02 |
| Reduced Peak Height | 1.4 ± 0.2 | 0.8 ± 0.4 | 1.0 ± 0.3 | 2.2 ± 0.5 |
| Spk (μm) | | | | |
| Reudced Dale Height | 0.06 ± 0.05 | 0.04 ± 0.04 | 0.03 ± 0.02 | 0.05 ± 0.01 |
| Svk (μm) | | | | |
| Material Ratio of Hills | 95 ± 4 | 92 ± 6 | 93 ± 2 | 91 ± 2 |
| Smrk2 (%) | | | | |
| Arithmetic Core | 0.22 ± 0.06 | 0.13 ± 0.03 | 0.10 ± 0.02 | 0.16 ± 0.05 |
| Height Sak1(μm) | | | | |
| Arithmetic Core | 0.002 ± 0.004 | 0.002 ± 0.004 | 0.0009 ± 0.0004 | 0.0020 ± 0.0004 |
| Height Sak2 (μm) | | | | |
| Peak Extreme Height | 9 ± 2 | 9 ± 7 | 5.2 ± 0.7 | 13 ± 2 |
| Spkx (2.5%, 50%) | | | | |
| (μm) | | | | |
| Reduced Dale Height | 0.1 ± 0.1 | 0.6 ± 1.4 | 0.5 ± 0.1 | 1.8 ± 0.8 |
| Svkx (μm) | | | | |
| Mean Hill Roundness | 0.53 ± 0.02 | 0.54 ± 0.02 | 0.53 ± 0.01 | 0.51 ± 0.03 |
| Shrn | | | | |
| Maximum Hill | 0.80 ± 0.04 | 0.80 ± 0.03 | 0.83 ± 0.04 | 0.80 ± 0.08 |
| Roundness Shrnx | | | | |
| Standard Deviation of | 0.13 ± 0.01 | 0.12 ± 0.01 | 0.12 ± 0.01 | 0.12 ± 0.01 |
| Hill Roundness Shrnq | | | | |
| Mean Hill Form Factor | 0.48 ± 0.02 | 0.46 ± 0.03 | 0.47 ± 0.02 | 0.37 ± 0.04 |
| Shff | | | | |
| Maximum Hill Form | 0.78 ± 0.04 | 0.75 ± 0.05 | 0.85 ± 0.05 | 0.78 ± 0.13 |
| Factor Shffx | | | | |
| Standard Deviation of | 0.12 ± 0.01 | 0.13 ± 0.01 | 0.12 ± 0.01 | 0.11 ± 0.01 |
| Hill Form Factor Shffq | | | | |
| Mean Hill Equivalent | 98 ± 8 | 79 ± 18 | 43 ± 5 | 77 ± 18 |
| Diameter Shed (μm) | | | | |
| Maximum Hill Form | 220 ± 20 | 240 ± 30 | 230 ± 70 | 260 ± 70 |
| Factor Shedx (μm) | | | | |
| Standard Deviation of | 42 ± 6 | 45 ± 12 | 27 ± 8 | 39 ± 11 |
| Hill Form Factor | | | | |
| Shedq (μm) | | | | |
| Mean Hill Area | 2.2 ± 0.1 | 2.2 ± 0.1 | 2.3 ± 0.1 | 2.7 ± 0.5 |
| Shar(5%) | | | | |
| Maximum Hill Area | 6 ± 2 | 6 ± 2 | 10 ± 3 | 9 ± 4 |
| Sharx(5%) | | | | |
| Standard Deviation of | 0.9 ± 0.3 | 0.8 ± 0.2 | 1.0 ± 0.3 | 1.4 ± 0.8 |
| Hill Area | | | | |
| Sharq(5%) | | | | |
| Developed Interfacial | 0.62 ± 0.04 | 0.63 ± 0.09 | 0.56 ± 0.02 | 0.54 ± 0.12 |
| Area Ratio Sdrn | | | | |
| Maximum Developed | 0.71 ± 0.05 | 0.67 ± 0.06 | 0.71 ± 0.09 | 0.66 ± 0.17 |
| Interfacial Area Ratio | | | | |
| Sdrnx | | | | |
| Standard Deviation of | 0.08 ± 0.03 | 0.04 ± 0.05 | 0.08 ± 0.05 | 0.09 ± 0.06 |
| Developed Interfacial | | | | |
| Area Ratio Sdrnq | | | | |
| Mean Dale Form | 0.73 ± 0.04 | 0.68 ± 0.08 | 0.57 ± 0.011 | 0.62 ± 0.09 |
| Factor Sdff | | | | |
| Maximum Dale Form | 0.81 ± 0.04 | 0.71 ± 0.05 | 0.73 ± 0.07 | 0.72 ± 0.13 |
| Factor Sdffx | | | | |
| Standard Deviation of | 0.08 ± 0.05 | 0.03 ± 0.04 | 0.11 ± 0.07 | 0.07 ± 0.04 |
| Dale Form Factor | | | | |
| Sdffq | | | | |
| Mean Dale Equivalent | 15 ± 7 | 34 ± 40 | 44 ± 12 | 20 ± 3 |
| Diameter Sded (μm) | | | | |
| Maximum Dale | 30 ± 40 | 40 ± 60 | 120 ± 90 | 30 ± 8 |
| Equivalent Diameter | | | | |
| Sdedx (μm) | | | | |
| Standard Deviation of | 8 ± 13 | 11 ± 19 | 30 ± 20 | 7 ± 4 |
| Dale Equivalent | | | | |
| Diameter Sdedq (μm) | | | | |
| Developed Area | 1.8 ± 0.2 | 1.7 ± 0.2 | 2.1 ± 0.2 | 2.1 ± 0.6 |
| Sdar (μm²) | | | | |
| Developed Area | 2.2 ± 0.4 | 1.8 ± 0.4 | 3.3 ± 1.5 | 2.8 ± 0.9 |
| Sdarx (μm²) | | | | |
| Developed Area | 0.3 ± 0.1 | 0.1 ± 0.2 | 0.5 ± 0.4 | 0.4 ± 0.3 |
| Sdarq (μm²) | | | | |

TABLE 11
Properties of Examples 1-2 and Comparative Examples XX-YY

| | | | Comparative | Comparative |
|---|---|---|---|---|
| Parameter | Example 1 | Example 2 | Example XX | Example YY |
| Perimeter (μm) | 91 ± 17 | 65 ± 13 | 31 ± 6 | 28 ± 5 |
| External Perimeter | 88 ± 15 | 62 ± 9 | 31 ± 5 | 28 ± 5 |
| (μm) | | | | |
| Equivalent Radius | 9.1 ± 1.7 | 6.6 ± 0.4 | 4.1 ± 0.7 | 4.0 ± 0.7 |
| (μm) | | | | |
| Equivalent Diameter | 18 ± 3 | 13 ± 1 | 8 ± 1 | 8 ± 1 |
| (μm) | | | | |
| Minimum Diameter | 12 ± 3 | 8.9 ± 1.3 | 6.1 ± 0.9 | 6.6 ± 1.0 |
| (μm) | | | | |
| Maximum Diameter | 27 ± 4 | 19 ± 1 | 11 ± 2 | 10 ± 2 |
| (μm) | | | | |
| Maximum Caliber | 28 ± 4 | 19.7 ± 1.5 | 11.0 ± 1.9 | 10 ± 2 |
| (μm) | | | | |
| X-extent (μm) | 25 ± 5 | 18 ± 2 | 10 ± 2 | 10 ± 2 |
| Y-extent (μm) | 23 ± 3 | 16 ± 1 | 10 ± 2 | 10 ± 2 |
| Mean Volume (μm³) | 1300 ± 600 | 310 ± 90 | 90 ± 30 | 370 ± 190 |
| Void Volume (μm³) | 0.46 ± 0.15 | 0.42 ± 0.09 | 0.44 ± 0.14 | 0.89 ± 0.33 |
| Total Volume (μm³) | 200000 ± 40000 | 110000 ± 30000 | 90000 ± 20000 | 150000 ± 42000 |
| Sphere Center | 440 ± 30 | 520 ± 50 | 470 ± 20 | 460 ± 30 |
| (x-extent) (μm) | | | | |
| Sphere Center | 510 ± 50 | 470 ± 50 | 480 ± 30 | 470 ± 50 |
| (y-extent) (μm) | | | | |

TABLE 12
Properties of Examples 1-2 and Comparative Examples XX-YY

| | | | Comparative | Comparative |
|---|---|---|---|---|
| Parameter | Example 1 | Example 2 | Example XX | Example YY |
| Z-minimum (μm) | 0.5 ± 0.1 | 0.8 ± 1.4 | 0.6 ± 0.1 | 1.9 ± 0.9 |
| Z-maximum (μm) | 1.1 ± 0.3 | 1.2 ± 1.5 | 1.1 ± 0.2 | 3.6 ± 1.2 |
| Z-mean (μm) | 0.7 ± 0.1 | 0.9 ± 1.4 | 0.8 ± 0.2 | 2.5 ± 1.0 |
| Mean Contour Height | 0.5 ± 0.1 | 0.8 ± 1.4 | 0.6 ± 0.1 | 2.0 ± 0.9 |
| (μm) | | | | |
| Minimum Contour | 0.5 ± 0.1 | 0.8 ± 1.4 | 0.6 ± 0.1 | 1.9 ± 0.9 |
| Height (μm) | | | | |
| Maximum Contour | 0.6 ± 0.1 | 0.9 ± 1.4 | 0.7 ± 0.1 | 2.1 ± 0.9 |
| Height (μm) | | | | |
| Maximum Depth (μm) | 0.02 ± 0.00 | 0.03 ± 0.01 | 0.05 ± 0.01 | 0.11 ± 0.03 |
| Mean Depth (μm) | 0.01 ± 0.00 | 0.01 ± 0.00 | 0.02 ± 0.01 | 0.04 ± 0.01 |
| Maximum Height | 0.5 ± 0.2 | 0.3 ± 0.2 | 0.5 ± 0.1 | 1.7 ± 0.4 |
| (μm) | | | | |

TABLE 13
Properties of Examples 1-2 and Comparative Examples XX-YY

| | | | Comparative | Comparative |
|---|---|---|---|---|
| Parameter | Example 1 | Example 2 | Example XX | Example YY |
| Form factor | 0.86 ± 0.01 | 0.85 ± 0.02 | 0.86 ± 0.02 | 0.90 ± 0.02 |
| Aspect Ratio | 1.57 ± 0.05 | 1.70 ± 0.12 | 1.60 ± 0.09 | 1.45 ± 0.14 |
| Roundness | 0.72 ± 0.01 | 0.69 ± 0.03 | 0.69 ± 0.02 | 0.74 ± 0.20 |
| Compactness | 0.84 ± 0.01 | 0.82 ± 0.02 | 0.83 ± 0.01 | 0.85 ± 0.02 |
| Convexity | 0.98 ± 0.00 | 0.98 ± 0.00 | 0.98 ± 0.01 | 0.99 ± 0.00 |
| Elongation | 0.25 ± 0.01 | 0.28 ± 0.04 | 0.29 ± 0.02 | 0.24 ± 0.04 |
| Solidity | 1.01 ± 0.01 | 1.01 ± 0.01 | 1.03 ± 0.01 | 1.05 ± 0.01 |
| Orientation (°) | 84 ± 7 | 87 ± 6 | 91 ± 4 | 89 ± 7 |
| Angle of Minimum | −13 ± 7 | −8 ± 5 | −4 ± 3 | −7 ± 5 |
| Diameter (°) | | | | |
| Angle of Maximum | −6 ± 5 | −5 ± 4 | −8 ± 2 | −10 ± 5 |
| Diameter (°) | | | | |
| Length (μm) | 37 ± 6 | 24 ± 2 | 14 ± 2 | 13 ± 2 |
| Width (μm) | 21 ± 4 | 14 ± 1 | 9 ± 1 | 10 ± 1 |
| Height (μm) | 0.7 ± 0.1 | 0.92 ± 1.4 | 0.8 ± 0.2 | 2.5 ± 1.0 |

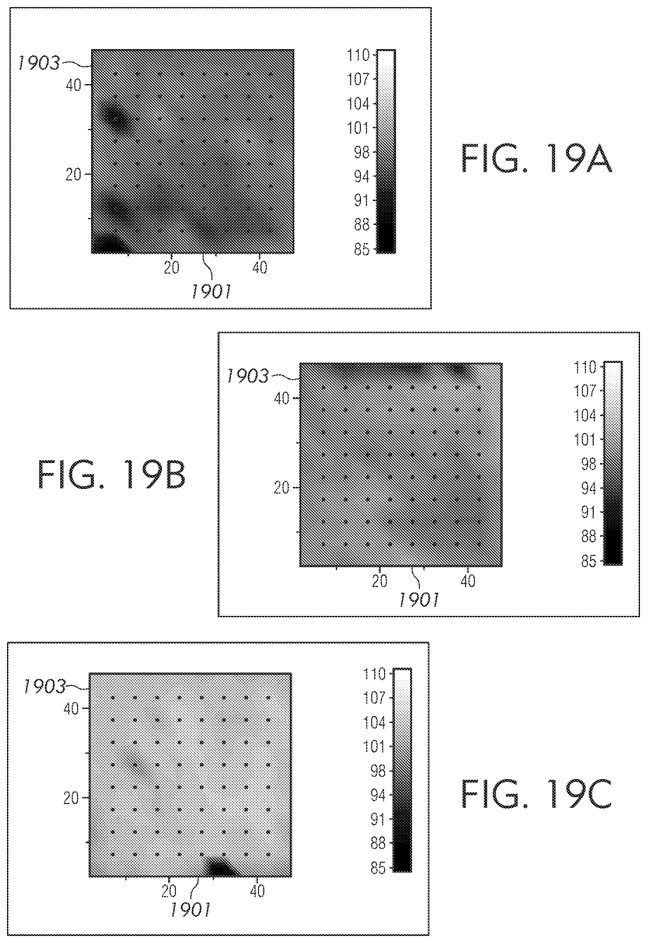

FIGS. 19A-19C show spatial plots of water contact angle for Examples 1-2 and Comparative Example XX, respectively. As shown, Examples 1-2 and Comparative Example XX produce largely uniform surfaces, which is to be expected. Properties of the spatial variation in the water contact angle based on FIGS. 19A-19C are shown in Table 14. In FIG. 19, the horizontal axis 1901 (i.e., x-axis) is position in mm, and the vertical axis 1903 (i.e., y-axis) is position in mm. As shown in Table 14, the average water contact angle is consistent with the values reported in Table 5. Example 2 has a minimum water contact angle greater than 90°, which demonstrates that the entire surface is hydrophobic. As used in Table 14, Uniformity=(Maximum−Minimum)/(2*Average)*100%. The uniformity provide a measure of the spread in water contact angle over the surface. Examples 1-2 have uniformity values of less than 10% (e.g., less than 9%), which is lower than the uniformity value for Example XX.

TABLE 14
Properties of Examples 1-2 and Comparative Example XX

| Water Contact | | | Comparative |
|---|---|---|---|
| Angle (°) | Example 1 | Example 2 | Example XX |
| Average | 97 ± 2 | 99 ± 2 | 105 ± 3 |
| Minimum | 82.7 | 92.8 | 80.1 |
| Maximum | 99.6 | 103.7 | 107.1 |
| Uniformity (%) | 8.7 | 5.4 | 12.9 |

FIG. 15 shows the results of attempts to clean (i.e., remove) applied simulated fingerprints from Example 1 and Comparative Examples YY-ZZ. FIG. 15(a) corresponds to BISCO (Example 1), FIG. 15(b) corresponds to ETC (Comparative Example YY), and FIG. 15(c) corresponds to untreated glass (Comparative Example ZZ). The applied simulated fingerprint was wiped with microfiber cloth attached to Taber linear abrader (see above) with an applied load of 1 kg along a path length of 15 mm at rate of 60 cycles per minute. Images are reproduced in FIG. 15 (from left to right) after 0 cycles (as-applied), 2 cycles, 4 cycles, 8 cycles, and 12 cycles. As shown in FIG. 15(a), the initial fingerprint (0 cycles) is barely visible; after 2 and 4 cycles of wiping smeared the fingerprint and slightly increased the visibility; however, the fingerprint is barely visible again after 8 or more wiping cycles. As shown in FIG. 15(b), the initial fingerprint is noticeably visible and quite pronounced; after 2 cycles, the fingerprint has smeared and is still visible but less so; and after 4 cycles, the fingerprint is not noticeable. As shown in FIG. 15(c), the initial fingerprint is clearly visible; after 2 cycles, the fingerprint has smeared and is still quite visible; after 4 cycles, the smearing has dissipated but the fingerprint is still visible, and after 8 cycles, the fingerprint is less visible. This demonstrates that Example 1 does a better job at hiding fingerprint than Comparative Examples YY-ZZ, and after 8 cycles of wiping, the fingerprint is not noticeable for Example 1.

FIG. 34 presents the molar ratio of hydrogen to silicon in Examples 35-44 and Comparative Examples JJ-KK as measured by SIMS. In FIG. 34, the vertical axis 3403 (i.e., y-axis) is the molar ratio of hydrogen to silicon. As discussed above, it is believed that hydrogen is indicative of hydroxyl groups (e.g., silanol, Si—O—H). As discussed above, D-SIMS was conducted using a time-of-flight secondary ion mass spectrometer (ToF-SIMS) with a dual beam configuration. Unless otherwise indicated, the TOF-SIMS used for the results reported herein was a TOF-SIMS M6 instrument (available from IONTOF GmbH) equipped with a Nanoprobe50 bismuth source. The TOF-SIMS M6 instrument was operated with a dual-beam configuration, where the analysis beam was a 30 kilo-electronVolts (keV) Bi₃⁺ beam with a current of about 0.1 pA and the sputter beam was 2 keV Cs⁺ with a current of about 120 nA. The sputter beam was configured form a 300 μm by 300 μm sputter “crater,” and the analysis beam was configured to impinge a 75 μm by 75 μm area centered in the sputter “crater.” Charge compensation was achieved using an electron flood gun operating with 20 nA beam current, 20 eV electron energy, and a 1.5 mm spot size focused on the location impinged by the analysis beam. The chamber evacuated to a pressure of 5×10⁻⁷ Pascals (5×10⁻⁹ millibar) before being brought to and maintained at a pressure of 5×10⁻⁵ Pascals (5×10⁻⁷ millibar) using argon (e.g., 99.99999% purity). Data was collected in negative ion mode with the analyzer in the “all purpose” mode, an analyzer energy of 3000 V and a cycle time of 100 microseconds. Data was processed using Surface Lab software (version 7.3.125519 available from IONTOF GmbH). To obtain molar ratios from ¹⁶O¹H⁻, ¹⁸O⁻, and ²⁸Si⁻ signals, the known isotope ratio between ¹⁸O⁻ and ¹⁷O⁻ was used to calculate and subtract the ¹⁷O⁻ interference from the ¹⁶O¹H⁻ signal. A normalized intensity was defined as the mass-interference-corrected ¹⁶O¹H⁻ signal divided by the ²⁸Si⁻ signal. The initial ¹⁶O¹H⁻/²⁸Si⁻ ratio was further corrected to remove background signals (as determined from the normalized intensity (¹⁶O¹H⁻/²⁸Si⁻) from contemporaneously measured from GE Type 124 fused quartz) to determine a “corrected signal.” The normalized intensity (¹⁶O¹H⁻/²⁸Si⁻) was converted to a hydrogen to silicon molar ratio (“molar ratio”) using a calibration curve (derived from a series of natural mid-ocean-ridge basaltic (MORB) glasses with known —OH concentrations and other silica and silicate minerals covering a range from 0.0 wt % to 1.98 wt %) with an equation of “molar ratio”=1.26*“corrected signal”−0.025.

The deposition conditions for Examples 1-10 and Comparative Examples JJ-KK are shown in Table 15. As used in this section for Examples 1-10, the ion-assisted deposition (IAD) process included thermal evaporation of functionalized POSS using a Radak II cell in an Angstrom Engineering Evovac chamber; an ion beam formed from an end-Hall source (KRI EH-400 from Kaufman & Robinson) operated at a voltage of 60 V and a discharge current of 0.25 amps (A); the chamber pressure was about 6.7×10⁻³ Pa (5×10⁻⁵ Torr) of oxygen (O₂) gas (maintained with a flow of 6.6 sccm O₂); and the “deposition rate” is measured by QCM positioned 500 nm above the Radak II cell and 150 nm below the surface. Example 35 was formed by spin coating a of 1% by volume (% v/v) solution of hydrogen POSS (i.e., POSS with R═H in FIG. 5) (HSQ) on the glass-based substrate at 1,200 rpm for 30 seconds before being heated at 400° C. for 30 minutes. Example 36 was formed by spin coating a 3% by volume (% v/v) solution of perhydropolysilazane (PHPS—see FIG. 6) without catalyst in dibutyl ether (Durazane 2250) on the glass-based substrate at 1,000 rpm for 30 seconds before being heated at 250° C. for 30 minutes. Examples 37-41 used octa-iso-butyl-functionalized POSS (OBPOSS) (i.e., POSS with R=iso-butyl in FIG. 5) in the IAD process (described above) with the deposition rates from 0.5 A/s to 2.0 A/s stated in Table 15. Examples 42-44 used octavinyl POSS (OVPOSS)((i.e., POSS with R=vinyl in FIG. 5) in the IAD process (described above) to achieve a thickness from 50 nm to 200 nm as shown in Table 15. Comparative Example JJ was formed by plasma-enhanced chemical vapor deposition (PECVD). Comparative Example KK was formed by reactive sputtering using an Evovac sputter tool (Angstrom Engineering) impinging a p-type silicon target with 525 Watt pulses with a pulse length of 40 microseconds (μs) and repetition rate of 50 kiloHertz (kHz) in vacuum chamber with a pressure of 0.27 Pa (0.002 Torr) maintained by 40 sccm Ar and 10 sccm O2, which achieved a deposition rate of 2.5 A/s at 23° C.

TABLE 15
Deposition Conditions for Examples 35-44
and Comparative Examples JJ-KK

| Example | Material | Method | Molar Ratio (H/Si) |
|---|---|---|---|
| 35 | HSQ | Spin Coating | 0.21 |
| 36 | PHPS | Spin Coating | 0.23 |
| 37 | OBPOSS | IAD: 0.5 A/s | 0.24 |
| 38 | OBPOSS | IAD: 0.7 A/s | 0.28 |
| 39 | OBPOSS | IAD 0.9 A/s | 0.26 |
| 40 | OBPOSS | IAD: 1.3 A/s | 0.31 |
| 41 | OBPOSS | IAD 2.0 A/s | 0.52 |
| 42 | OVPOSS | IAD: 50 nm | 0.30 |
| 43 | OVPOSS | IAD: 100 nm | 0.28 |
| 44 | OVPOSS | IAD: 200 nm | 0.28 |
| JJ | Silica | PECVD | 0.10 |
| KK | Silica | Reactive Sputtering | 0.09 |

Dashed line 3405 corresponds to a molar ratio of hydrogen to silicon of 0.20. As shown in FIG. 34, Comparative Examples JJ-KK have molar ratios of hydrogen to silicon of about 0.10 (about half of dashed line 3405). As shown in FIG. 34, Examples 35-44 all have molar ratios of 0.2 or more. Consequently, Examples 35-44 have at least about double (2×) the molar ratio of Comparative Examples JJ-KK. Increasing the deposition rate for OBPSS (Examples 37-44) generally increases the molar ratio. However, increasing the thickness formed by OVPSS IAD from 50 nm to 200 nm (Examples 42-44) slightly decreases or does not substantially change the molar ratio. Also, Examples 36-40 and 42-44 have a molar ratio from 0.2 to 0.4 or from 0.22 to 0.35.

FIG. 29 schematically shows photographs taken after application of the simulated fingerprint in the Simulated Fingerprint Test using a Canon Rebel T7 DSLR camera equipped with a Canon EF-S 60 mm Macro Lens and illuminated using a ring light for Examples 3-8 and Comparative Examples DD-GG. The coatings shown in Table 16 and FIG. 29 were formed by spray coating the material as a 2 vol % solution in propylene glycol methyl ether acetate that was then heated at 150° C. for 30 minutes. The materials and properties for Examples 3-8 and Comparative Examples DD-GG are presented in Table 16. As shown in Table 16 and FIG. 29, the functionalized poly(dimethyl siloxane) (PDMS) coatings (Comparative Examples DD-GG) exhibited Normalized Gray Levels of 2.5 or more with Comparative Examples DD-EE and GG having a Normalized Gray Level of greater than 3. As used herein, DCTMDS refers to 1,3,-dichloro-tetramethyl-disiloxane. For Example 3, the coating was formed from DCTMDS and had a Normalized Gray Level less than 2 (about 1.56). Example 8 was formed from BISCO and had a Normalized Gray Level less than 1.5 (e.g., about 1.4, namely 1.37). Examples 5-7 were formed from mixtures of BISCO and DCTMDS and exhibited Normalized Gray Levels less than 1.5 (e.g., about 1.4 or less, from 1.2 to 1.4). This demonstrates that Examples 3-8 (or Examples 4-8) exhibit reduced visibility of fingerprints (e.g., fingerprint-hiding) than Comparative Examples DD-GG by a difference of more than 1 in Normalized Gray Level (and Examples 4-8 have less than 50% the Normalized Gray Level of Comparative Examples DD-EE and GG).

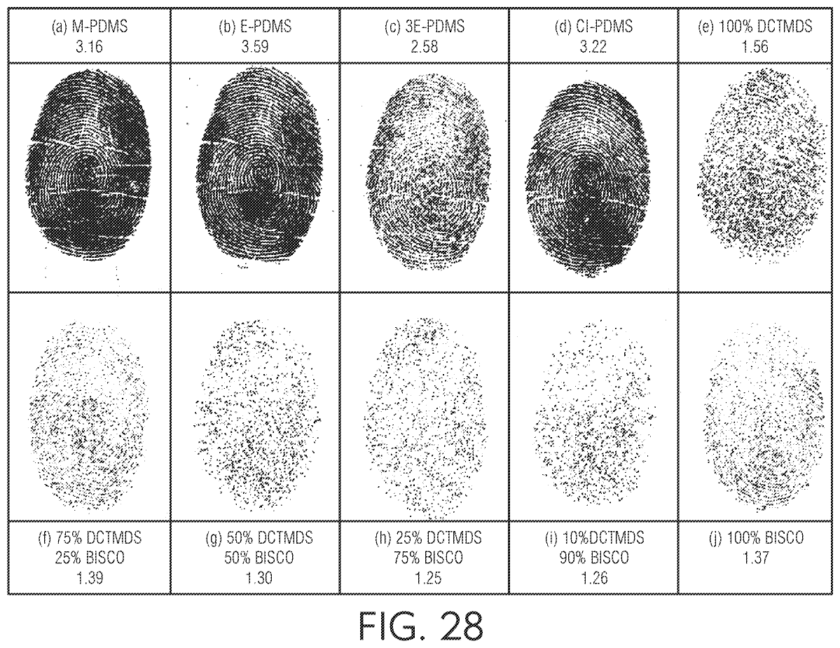

TABLE 16
Materials and Properties of Examples
3-8 and Comparative Examples DD-GG

| | | Material | Normalized | Mean Gray |
|---|---|---|---|---|
| Example | FIG. 28 | (wt %) | Gray Level | Level |
| DD | a | Methoxy- | 3.16 | 243 |
| | | terminated | | |
| | | PDMS | | |
| | | (M-PDMS) | | |
| EE | b | Ethoxy- | 3.59 | 281 |
| | | terminated | | |
| | | PDMS | | |
| | | (E-PDMS) | | |
| FF | c | Triethoxy | 2.58 | 201 |
| | | terminated- | | |
| | | PDMS | | |
| | | (3E-PDMS) | | |
| GG | d | Chloro- | 3.22 | 251 |
| | | terminated | | |
| | | PDMS | | |
| | | (Cl-PDMS) | | |
| 3 | e | DCTMDS | 1.56 | 120 |
| | | (100%) | | |
| 4 | f | 90% DCTMDS + | 1.39 | 102 |
| | | 10% BISCO | | |
| 5 | g | 75% DCTMDS + | 1.30 | 96 |
| | | 25% BISCO | | |
| 6 | h | 50% DCTMDS + | 1.25 | 96 |
| | | 50% BISCO | | |
| 7 | i | 25% DCTMDS + | 1.26 | 100 |
| | | 75% BISCO | | |
| 8 | j | BISCO (100%) | 1.37 | 104 |

FIG. 31 schematically illustrates the average voltages measured for the three regions described above with reference to the Tribocharging Test. For each example, going from left to right, the voltage averages are for the peripheral contact region 3105, the inner region 3107, and the central contact region 3109. In FIG. 31, BISCO corresponds to Example 8, “GLASS” corresponds to Comparative Example AA, ETC corresponds to Comparative Example YY (Daiken UD-509 ETC), and OTS corresponds to Comparative Example XX. As shown in FIG. 31, GLASS (Comparative Example AA) has an average voltage in the central contact region of about 100 V and voltage difference between the peripheral contact region and the central contact region of about 70 V. Comparative Example XX (OTS) fairs better, but still has an average voltage in the central contact region of more than 50 V and voltage difference between the peripheral contact region and the central contact region of about 30 V. Comparative Example YY (ETC) has an average voltage in the central contact region of about 30 V or more and a voltage difference between the peripheral contact region and the central contact region of about 20V or more. In contrast, Example 8 (BISCO) has an average voltage in the central contact region of about 15 V or less (e.g., about 10 V), which is about 10% of Comparative Example AA, about 20% of Comparative Example XX, and about 30% of Comparative Example YY. This decrease in average voltage in the central contact region is an unexpected benefit associated with surface-modifying layers (e.g., fingerprint-hiding coatings in accordance with aspects of the present disclosure). Also, Example 7 (BISCO) has a voltage difference between the peripheral contact region and the central contact region of less than 5 V, which is more than an order of magnitude better than Comparative Example AA, less than 20% of Comparative Example XX and less than 30% or Comparative Example YY.

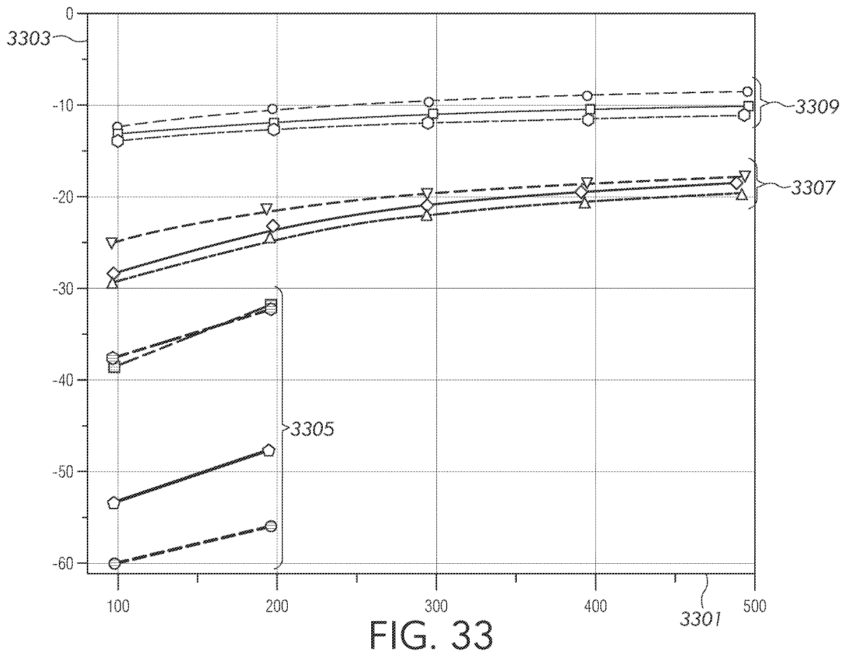

FIGS. 32-33 schematically present the change in average voltage in Volts shown on the vertical axis 3203 and 3303 (i.e., y-axis) as a function of time in seconds after the measurements are normally taken in the Tribocharging test on the horizontal axis 3201 and 3301 (i.e., x-axis). The time evolution shown in FIGS. 32-33 gives a sense of how quickly or slowly charge dissipates across the surfaces. In FIG. 32, curves 3209 correspond to Comparative Example AA (GLASS), and curves 3208 correspond Comparative Example YY. Curves 3208 and 3209 (collectively curves 3207 were only measured at two time points since the significant surface voltage remained above 15 V. Curve 3205 corresponds to Examples DD-GG (shown together) that had initial voltages (100 seconds after the usual measurement) of about 10 V and the voltage is shown to slightly decrease over the next 500 seconds. In FIG. 33, curves 3305 correspond to Comparative Example AA that again has significant voltages in excess of 15 V (e.g., 30 V or more). Curves 3307 correspond to Comparative Example XX, which performed worse that the replicates shown in FIG. 32 as curves 3208. Curves 3309 correspond to Example 8 that had voltages of about 15 V or less and decreased to about 10 V over the following 400 seconds.

In Examples 46-53, 1,8-bis(chlorodimethylsilyl)octane (BISCO) and/or octadecyl trimethoxysilane (OTS) were mixed by volume in the percentages listed to a total silane concentration of 2 vol % in propylene glycol methyl ether acetate and spray coated on glass coupons. The samples were cured at 150° C. for 30 min. The formulation can be tailored to achieve the desirable levels of fingerprint visibility, durability, and hydrophobicity. The two silanes were mixed at different ratios for a total silane concentration of 2% in PGMEA. Parts were either dipped or sprayed coated in these solutions and evaluated. Coefficient of friction (CoF), is measured by placing the sample on a load cell (SMT1-5.6, Interface, Inc., Scottsdale, AZ). Office paper is affixed to a 20 mm square attachment on a Linear Taber Abrader (Model 5750; Taber Industries, North Tonawanda, NY). A load of 300 g is applied and the attachment is moved a 5 mm stroke for 30 cycles at 15 cycles/min. The load cell records the force applied to the sample during this motion and this is used to calculate the coefficient of friction, contact angle and surface energy data of the various BISCO/OTS mixtures are shown in Table 17. For the applications of interest, the water contact angle is sufficiently high for all the mixtures tested. Therefore, pristine static water contact angle was not a metric considered when deciding the final optimized ratio.

TABLE 17
Materials and Properties of Examples 46-53

| | | | | | | Static Contact Angle (°) | | |
|---|---|---|---|---|---|---|---|---|
| | Alkyl Silanes | | Surface Energy (mN/m) | | | | Diiodo- | |
| Example | (vol %) | CoF | Total | Polar | Dispersive | Water | methane | Oleic |
| 46 | 100% | 0.18 | 31.8 | 0.91 | 30.9 | 94.4 | 56.0 | 22.1 |
| | BISCO 0% | | | | | | | |
| | OTS | | | | | | | |
| 47 | 75% BISCO | 0.19 | 28.8 | 5.0 | 23.8 | 96.9 | 65.9 | 28.9 |
| | 25% OTS | | | | | | | |
| 48 | 70% BISCO | 0.13 | 32.8 | 5.65 | 27.23 | 92.5 | 55.6 | 20.1 |
| | 30% OTS | | | | | | | |
| 49 | 50% | 0.17 | 36.0 | 4.1 | 32.0 | 94.7 | 57.0 | 24.3 |
| | BISCO 50% | | | | | | | |
| | OTS | | | | | | | |
| 50 | 40% BISCO | 0.15 | 34.4 | 3.5 | 30.9 | 96.8 | 59.2 | 32.3 |
| | 60% OTS | | | | | | | |
| 51 | 30% BISCO | 0.16 | 31.0 | 3.5 | 27.5 | 98.8 | 66.2 | 33.1 |
| | 70% OTS | | | | | | | |
| 52 | 25% BISCO | 0.21 | 27.2 | 1.5 | 25.7 | 97.66 | 63.4 | 45.5 |
| | 75% OTS | | | | | | | |
| 53 | 0% BISCO | 0.15 | 23.0 | 2.0 | 21.0 | 105.6 | 67.4 | 49.0 |
| | 100% OTS | | | | | | | |

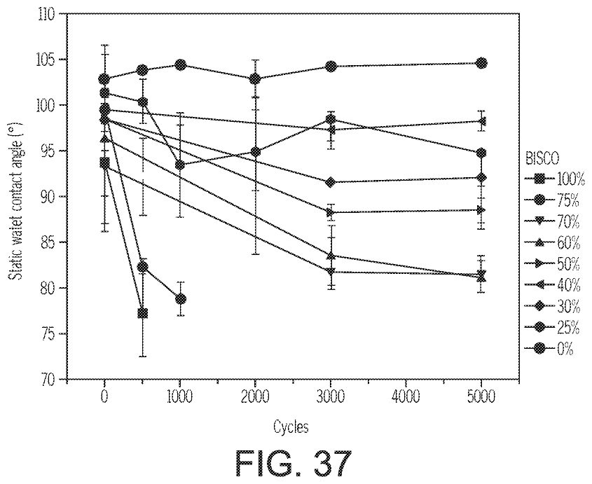

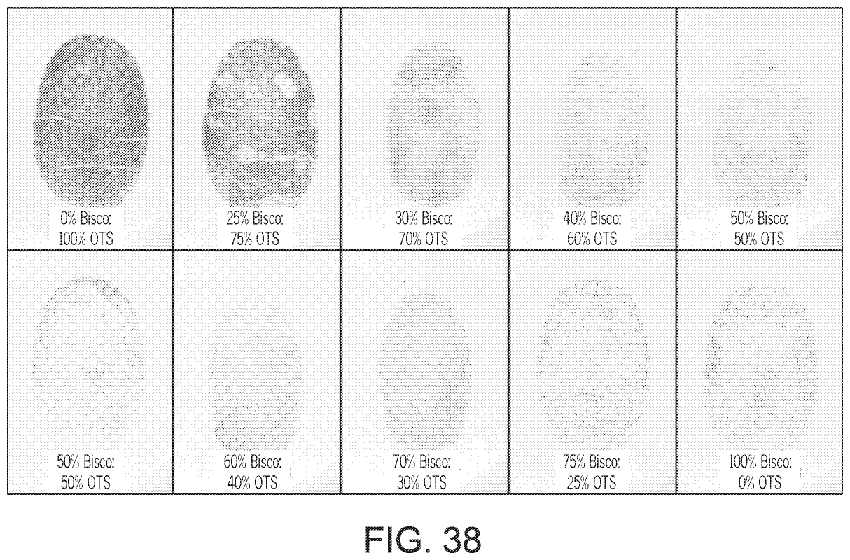

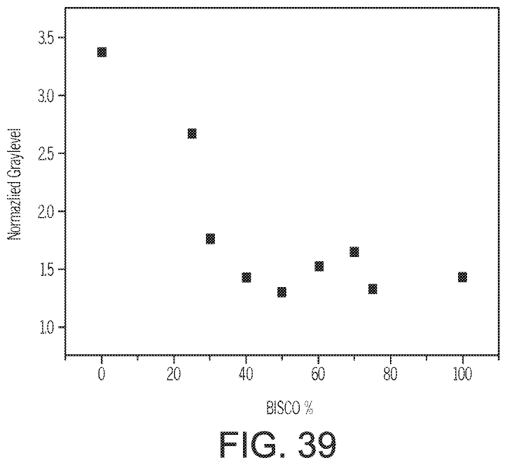

The durability of the coatings formed from the BISCO/OTS mixtures of Examples 46-53 were evaluated by checking a contact angle following a rubber abrasion test. FIG. 37 shows static water contact angle in degrees on the vertical axis (i.e., y-axis) as a function of rubber abrasion test cycles on the horizontal axis (i.e., x-axis) for Example 46-53; For 100% BISCO (Example 46), the contact angle dropped below 80 degrees after 500 cycles. For 100% OTS (Example 53), the contact angle did not substantially change after 5000 cycles. Mixtures ranging between 100% BISCO (0% OTS) and 0% BISCO (100% OTS) were found to fall between these two extremes. For fingerprint visibility, a human fingerprint was deposited on the glass coupons of Examples 46-53. Prior to the application of the fingerprint the sample was wiped with isopropanol. Pictures were taken before and after the fingerprint was deposited using a Canon Rebel T7 DSLR camera equipped with a Canon EF-S 60 mm Macro Lens and illuminated using a ring light. The camera was operating in manual mode with manual focus. Images were captured in the RAW format and were processed with ImageJ. Gray level values of fingerprints were compared among various surfaces. FIG. 38 schematically illustrates simulated fingerprints applied to Examples 46-63. FIG. 39 shows normalized gray level on the vertical axis (i.e., y-axis) as a function of BISCO volume percent relative to a total amount of BISCO and octadecyl trimethoxysilane on the horizontal axis (i.e., x-axis) for Examples 46-63. The visibility of the fingerprints is lowest using 100% BISCO (Example 46) and highest using 0% BISCO (Example 53).

In Examples 54-57, 1,8-bis(trimethoxysilyl)octane (BISMO) and/or octadecyl trimethoxysilane (OTS) were mixed by volume in the percentages listed to a total silane concentration of 2 vol % in propylene glycol methyl ether acetate and spray coated on glass coupons. The samples were cured at 150° C. for 30 min. The formulation can be tailored to achieve the desirable levels of fingerprint visibility, durability, and hydrophobicity. The two silanes were mixed at different ratios for a total silane concentration of 2% in PGMEA. Parts were either dipped or sprayed coated in these solutions and evaluated. CoF, contact angle and surface energy data of the various BISMO/OTS mixtures are shown in Table 18.

TABLE 18
Materials and Properties of Examples 54-57

| | | | | | | Static Contact Angle (°) | | |
|---|---|---|---|---|---|---|---|---|
| | Alkyl Silanes | | Surface Energy (mN/m) | | | | Diiodo- | |
| Example | (vol %) | CoF | Total | Polar | Dispersive | Water | methane | Oleic |
| 54 | 100% BISMO | 0.33 | 47.4 | 11.8 | 35.6 | 74.4 | 49.6 | 25.2 |
| | 0% OTS | | | | | | | |
| 55 | 30% BISMO | 0.16 | 34.0 | 2.4 | 31.5 | 99.5 | 57.9 | 28.9 |
| | 70% OTS | | | | | | | |
| 56 | 20% BISMO | 0.14 | 32.1 | 2.8 | 29.3 | 99.6 | 62.4 | 33.4 |
| | 80% OTS | | | | | | | |
| 57 | 10% BISCO | 0.11 | 31.2 | 2.7 | 31.1 | 100.5 | 64.1 | 38.1 |
| | 90% OTS | | | | | | | |

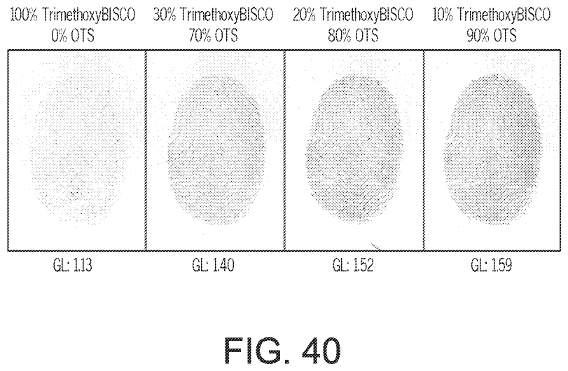

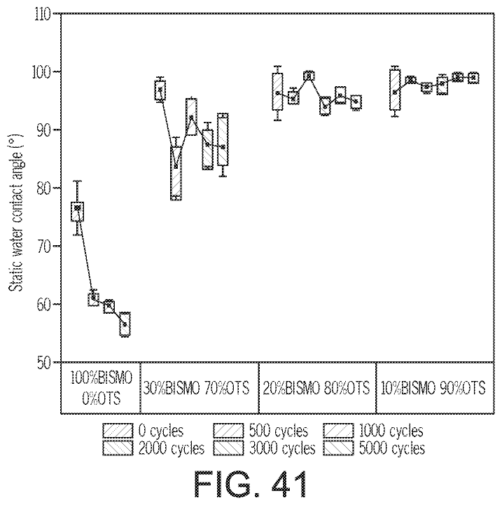

For fingerprint visibility, a human fingerprint was deposited on the glass coupons of Examples 54-57. Prior to the application of the fingerprint the sample was wiped with isopropanol. Pictures were taken before and after the fingerprint was deposited using a Canon Rebel T7 DSLR camera equipped with a Canon EF-S 60 mm Macro Lens and illuminated using a ring light. The camera was operating in manual mode with manual focus. Images were captured in the RAW format and were processed with ImageJ. Gray level values of fingerprints were compared among various surfaces. FIG. 40 schematically illustrates simulated fingerprints applied to Examples 54-57. FIG. 41 shows static water contact angle in degrees on the vertical axis (i.e., y-axis) as a function of rubber abrasion test cycles on the horizontal axis (i.e., x-axis) to Examples 54-57. As shown in Table 18, increasing the amount of OTS resulted in an increase of the CoF. Finger-print visibility was acceptable even at only 10% BISMO.

In Examples 58-61, 1,8-bis(trimethoxysilyl)hexane (bishexane) and/or octadecyl trimethoxysilane (OTS) were mixed by volume in the percentages listed to a total silane concentration of 2 vol % in propylene glycol methyl ether acetate and spray coated on glass coupons. The samples were cured at 150° C. for 30 min. The formulation can be tailored to achieve the desirable levels of fingerprint visibility, durability, and hydrophobicity. The two silanes were mixed at different ratios for a total silane concentration of 2% in PGMEA. Parts were either dipped or sprayed coated in these solutions and evaluated. CoF, contact angle and surface energy data of the various bishexane/OTS mixtures are shown in Table 19.

TABLE 19
Materials and Properties of Examples 58-61

| | | | | | | Static Contact Angle (°) | | |
|---|---|---|---|---|---|---|---|---|
| | Alkyl Silanes | | Surface Energy (mN/m) | | | | Diiodo- | |
| Examples | (vol %) | CoF | Total | Polar | Dispersive | Water | methane | Oleic |
| 58 | 100% Bishexane | 0.52 | 47.5 | 11.3 | 36.2 | 75.1 | 48.4 | 14.9 |
| | 0% OTS | | | | | | | |
| 59 | 30% Bishexane | 0.17 | 40.9 | 5.6 | 35.3 | 89.0 | 50.3 | 26.6 |
| | 70% OTS | | | | | | | |
| 60 | 20% Bishexane | 0.18 | 40.7 | 6.4 | 34.2 | 87.4 | 52.4 | 27.0 |
| | 80% OTS | | | | | | | |
| 61 | 10% Bishexane | 0.17 | 34.3 | 3.3 | 31.0 | 97.2 | 59.0 | 31.4 |
| | 90% OTS | | | | | | | |

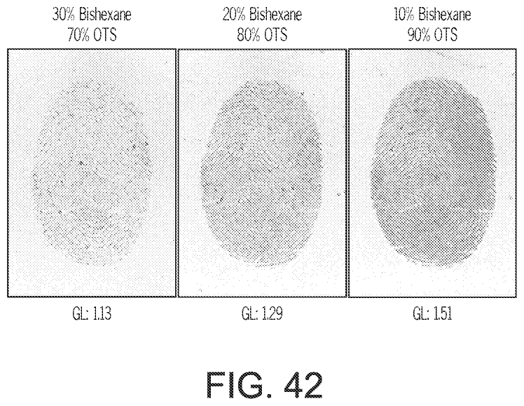

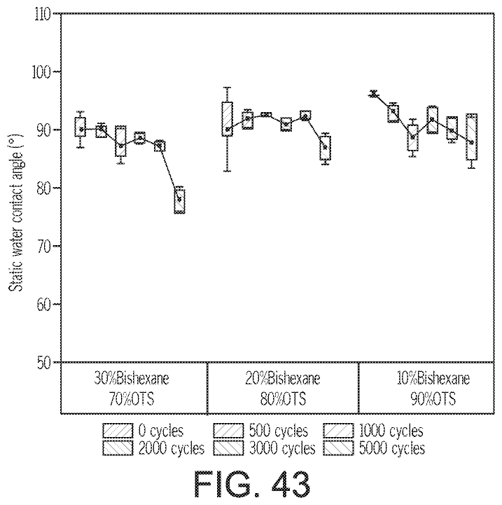

For fingerprint visibility, a human fingerprint was deposited on the glass coupons of Examples 58-61. Prior to the application of the fingerprint the sample was wiped with isopropanol. Pictures were taken before and after the fingerprint was deposited using a Canon Rebel T7 DSLR camera equipped with a Canon EF-S 60 mm Macro Lens and illuminated using a ring light. The camera was operating in manual mode with manual focus. Images were captured in the RAW format and were processed with ImageJ. Gray level values of fingerprints were compared among various surfaces. FIG. 42 schematically illustrates simulated fingerprints applied to Examples 58-61. FIG. 43 shows static water contact angle in degrees on the vertical axis (i.e., y-axis) as a function of rubber abrasion test cycles on the horizontal axis (i.e., x-axis) for Examples 58-61. As shown in Table 19, increasing the amount of OTS resulted in an increase of the CoF. Finger-print visibility was acceptable even at only 10% BISMO.

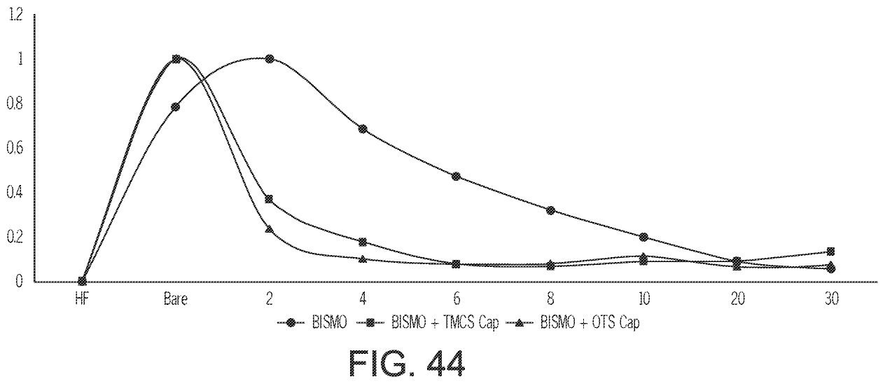

Both BISMO (used Examples 54-57) and bishexane (used in Examples 58-61) are bipodal with trimethoxy groups on both ends. Therefore, they are not expected to form straight chain block copolymers as shown in FIG. 18A. Instead, they may form branched block copolymer structures with a general structure as shown in FIG. 18B, where the R groups may be OCH₃, OH, or additional blocks of BISMO or bishexane. Conceptually, such a structure would have, multiple bonds to the surface, to adjacent chains, or unreacted methoxy or hydroxyl groups, as shown in FIG. 18C. As made, the resulting coating will likely include a certain amount of free hydroxyl from the hydrolyzed trimethoxy end groups. In certain embodiments, these can be further reacted with monopodial, monofunctional silanes such as chloro(dimethyl) octadecylsilane or trimethyl chlorosilane. Doing so may improve the cleanability of fingerprints from the surface, with minimal impact to fingerprint visibility. The fingerprint cleanability of Example 54 (100% BISMO), Example 54 treated with trimethylsilyl chloride (TMCS) as a capping agent, and Example 54 treated with OTS as a capping agent were evaluated. For TMCS capping, substrates were placed in a vacuum desiccator along with a petri dish containing 1-2 mL of TMCS. The desiccator was then promptly sealed and allowed to react for approximately 1 hour. After reacting samples were then baked at 150° C. for 30 mins. For fingerprint cleanability, the fingerprint was wiped using a Taber linear abrader, with the 2″ universal attachment wrapped in pre-cut microfiber cloth (Uline, S-22767) at 500 g load. Images were captured at 2, 4, 6, 8, 10 and 20 linear cycles, 60 cycles/min. Average gray level of the fingerprint region was calculated by ImageJ. FIG. 44 shows normalized gray level of a human fingerprint on the vertical axis (i.e., y-axis) as a function of the number of wipes on the horizontal axis (i.e., x-axis) for Examples 54 before and after capping treatment. As shown in FIG. 11, including a capping agent on the BISMO coated glass resulted in increased cleanability.

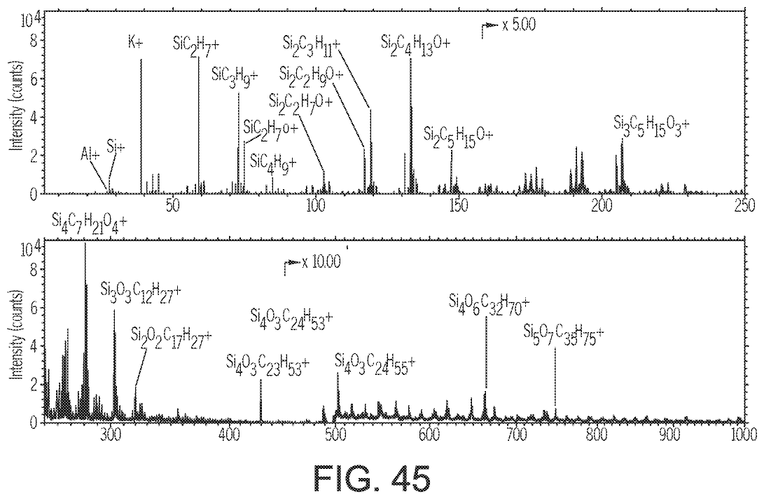

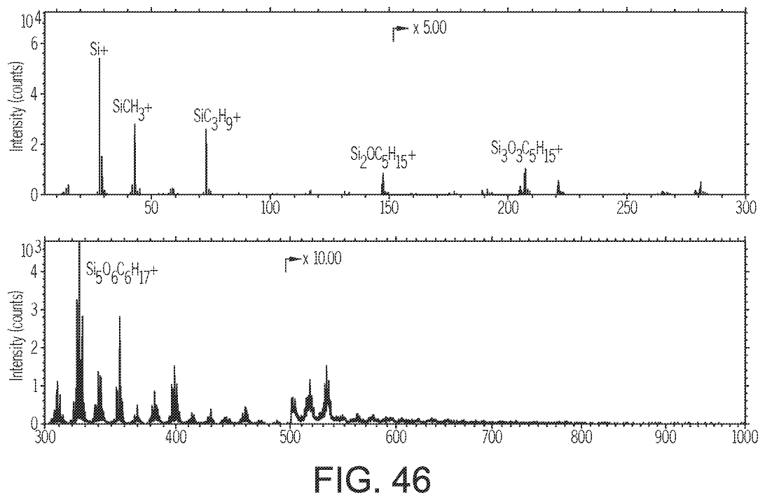

Example 46 (100% BISCO coated on glass surface) was further evaluated using Time-of-flight Secondary Ion Mass Spectrometry (TOF-SIMS). FIG. 45 schematically depicts a positive ion TOF-SIMS spectrum with intensity on the vertical axis (i.e., y-axis) as a function of mass-to-charge ratio (m/z) for Example 46, shows a positive ion spectrum with significant peaks labeled with tentative identifications. Several spectral features are present that differentiate BISCO from other related substances. BISCO has an intense signal at m/z 59 (SiC₂H₇⁺). Strong signals also appear at m/z 119 and 133, identified as Si₂C₃H₁₁O+ and Si₂C₄H₁₃O⁺, respectively. Many of the signals identified at higher mass likely stem from multimers of BISCO (up to around n=3). These higher-mass multimer signals have not appeared in all analyses of BISCO, and their formation may depend on deposition conditions. BISCO shares several peaks in common with PDMS (e.g., signals at m/z 73, 147, 207, and 221). FIG. 46 schematically depicts a positive ion Time-of-Flight Secondary Ion Mass Spectrometry (TOF-SIMS) spectra with intensity on the vertical axis (i.e., y-axis) as a function of mass-to-charge ratio (m/z) for polydimethylsiloxane (PDMS). Despite the presence of common signals, the BISCO spectrum is readily distinguishable from PDMS because of the intense signals at 59, 119, and 133. Some substrate signals also appear in the spectrum (e.g., Al, Si, and K). To a first approximation, these signals are useful indicators of coating thickness/coverage, where higher substrate signal intensities indicate a thinner or less continuous organic overlayer. As shown in FIG. 46, PDMS includes major signals at m/z 43, 73, 147, and 207. While BISCO shares some of these signals as well, the signals at 73 and 147 are relatively minor for BISCO. Likewise, key signals from BISCO at m/z 59, 119, and 131 are weak or absent in PDMS. As shown in FIGS. 45-46, BISCO has several unique spectral features that can readily distinguish it from analogous molecules.

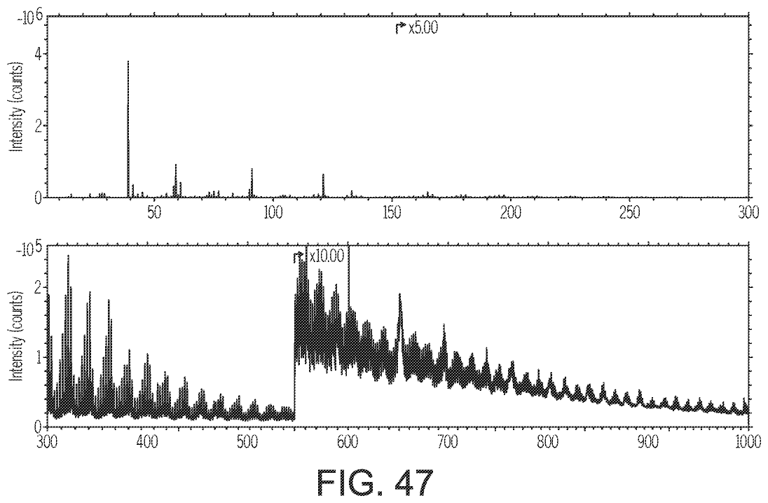

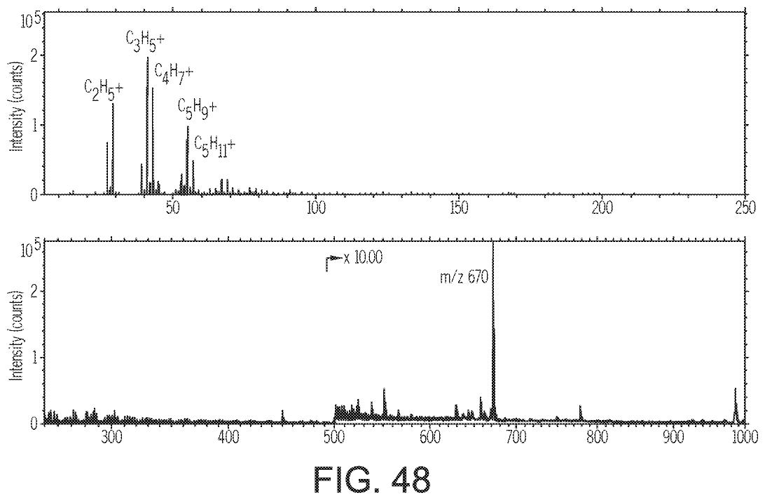

Example 54 (100% BISMO coated on glass surface) was further evaluated using Time-of-flight Secondary Ion Mass Spectrometry (TOF-SIMS). FIG. 47 schematically depicts a positive ionTime-of-Flight Secondary Ion Mass Spectrometry (TOF-SIMS) spectrum with intensity on the vertical axis (i.e., y-axis) as a function of mass-to-charge ratio (m/z) for Example 54. This spectrum varies notably from BISCO in several ways. First, the substrate signals (particularly K) are much more intense, suggesting either the coating has lower surface coverage or that K is present as a contaminant. Second, the other main signals are present at m/z 59, 91, and 121, and based on exact mass are best identified as SiOCH₃⁺, SiO₂C₂H₇⁺ and SiO₃C₃H₉+. These fragments appear to be from the trimethoxysilyl linking groups in the molecule with different numbers of methoxy groups still attached. FIG. 48 schematically depicts a Time-of-Flight Secondary Ion Mass Spectrometry (TOF-SIMS) spectrum with intensity on the vertical axis (i.e., y-axis) as a function of mass-to-charge ratio (m/z) for octadecyl trimethoxysilane (OTS). The TOF-SIMS spectrum of OTS is dominated by low-mass hydrocarbon fragments. Higher mass fragments or molecular/pseudomolecular ions do not appear, likely due to excessive fragmentation during the SIMS collision cascade. The fragment at m/z 671 was unidentified, though MS/MS analysis (not shown) suggested it may be related to a multimer of OTS.

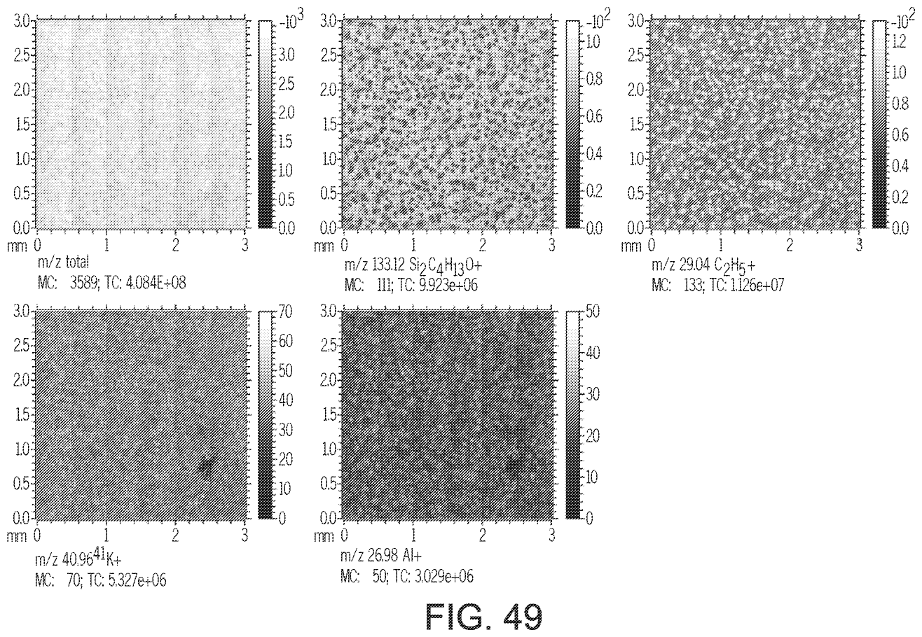

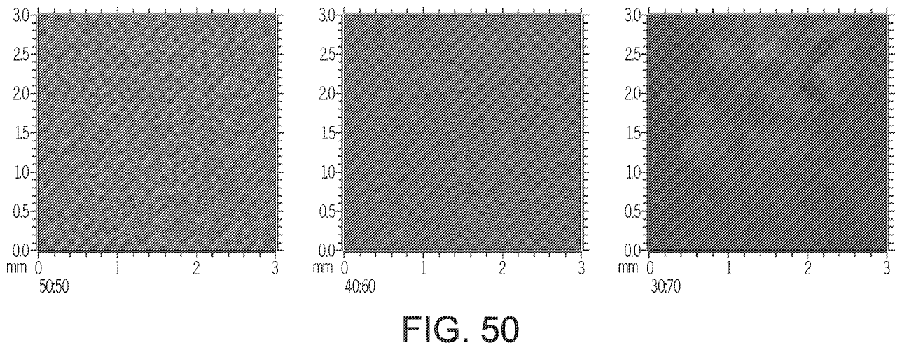

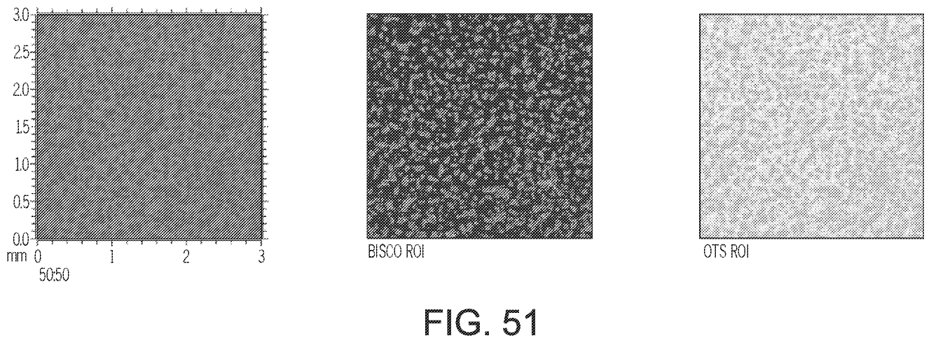

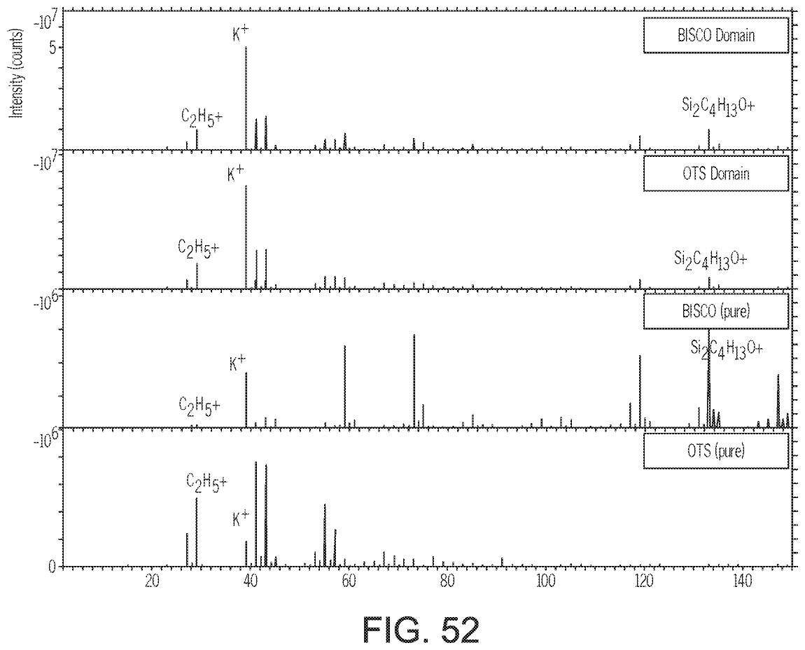

TOF-SIMS imaging of Example 49 (50:50 BISCO/OTS) showed the formation of distinct chemical domains, some of which were enriched in BISCO and some of which were enriched in OTS. FIG. 49 schematically depicts TOF-SIMS spatial plots at various mass-to-charge ratios (m/z) of Example 49, showing a representative 3×3 mm images from the sample. A distinct ‘leopard spot’ pattern can be seen in the images. The spots are rich in OTS, as indicated by the elevated C₂H₅⁺ signal, while the interstitial space show high intensity for BISCO-related signals (here, Si₂C₄H₁₃O⁺, m/z 133 is shown). Substrate signals like potassium and aluminum are the most intense in the OTS-rich domains, suggesting thinner and/or less continuous coating coverage in these regions. The OTS-rich domains are oblong and irregular in most cases. Measuring across 20 arbitrarily chosen domains in the narrow direction gives a domain width of 57±21 μm for this sample. Similar images were recorded for Example 50 and Example 51, which represent 40:60 and 30:70 BISCO/OTS mixtures, respectively. FIG. 50 schematically depicts TOF-SIMS spatial plots of green/blue overlay for C₂H₅⁺ and Si₂C₄H₁₃O⁺ of Examples 49-51 (BISCO:OTS of 50:50, 40:60, and 30:70). OTS domains cover a larger total fraction of the 40:60 sample than for the 50:50, sample consistent with an increasing OTS fraction in the mixture. For the 30:70 sample, small and well-segregated domains are no longer present and instead there is macroscopic phase separation with most of the BISCO being concentrated in large (˜1 mm²) irregular domains toward the center of the image. This may indicate that there is some mixture concentration threshold beyond which domain formation is no longer possible. This may also be influenced by solvent choice, and/or processing temperature, among other variables. To examine the compositions of the individual domains, a threshold function was applied to the Si₂C₄H₁₃O⁺ image from Example 49 to select regions of interest (ROIs) from which to generate spectra. Thresholding at 50% of the maximum intensity selected the BISCO-rich domains, and the inverse of this ROI was used to select the OTS-rich domains. FIG. 51 schematically depicts TOF-SIMS spatial plots at regions of interest for BISCO and OTS of Example 49 (BISCO:OTS of 50:50). FIG. 52 schematically depicts positive ion Time-of-Flight Secondary Ion Mass Spectrometry (TOF-SIMS) spectra with intensity on the vertical axis (i.e., y-axis) as a function of mass-to-charge ratio (m/z) for the BISCO region of interest of FIG. 51, the OTS region of interest of FIG. 51, a pure BISCO reference, and a pure OTS reference.

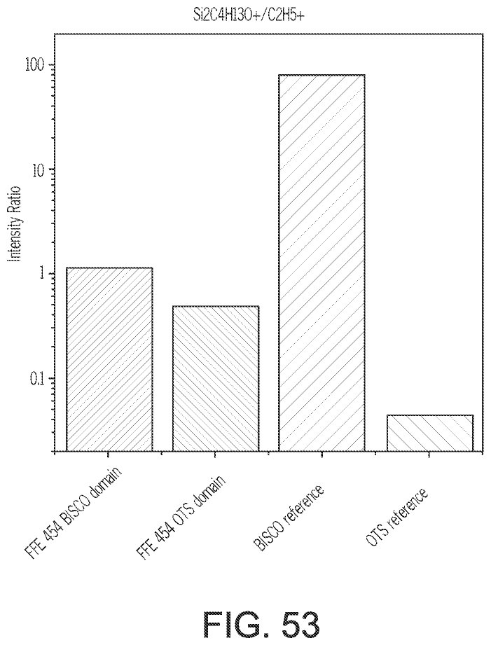

Comparing the Si₂C₄H₁₃O*/C₂H₅⁺ intensity ratios for the two regions of interest from Example 49 to those from the pure compounds provides a semiquantitative assessment of the level of compound purity within the respective BISCO-rich and OTS-rich domains. FIG. 53 shows an intensity of a Si₂C₄H₁₃O⁺/C₂H₅⁺ ratio on the vertical axis (i.e., y-axis), as measured in FIG. 52 for the BISCO region of interest of FIG. 51, the OTS region of interest of FIG. 51, the pure BISCO reference, and the pure OTS reference. There is an approximate 2× difference in the Si₂C₄H₁₄O⁺/C₂H₅⁺ intensity ratio between the BISCO-rich domain and the OTS rich domain, but neither is close to the ratios given by the pure components. The ratio for the pure BISCO reference is ˜67× higher than the nominally BISCO rich domain while the ratio for the pure OTS reference is ˜10× lower than for the OTS-rich domains. This suggests that while some phase segregation has occurred, both domains still have a mixture of OTS and BISCO. The data are sufficient to indicate that the domains are not a complete phase separation, but rather mixtures enriched in one component or the other to varying degrees.

In Examples 62-71, 1,8-bis(dimethylmethoxysilyl)octane was used. 1,8-bis(dimethylmethoxysilyl)octane was prepared by treating BISCO with sodium methoxide. The 1,8-bis(dimethylmethoxysilyl)octane product is referred to herein as “NaBISCO”. In particular, a 500 mL round bottom flask with a rubber septum was acquired to which approximately 30 mL of anhydrous THF and approximately 20 mL of anhydrous methanol were added followed by 10 mL of 1,8-bis(dimethylchlorosilyl)octane (BISCO). The solution appeared clear and no phase separation was observed. To this mixture, 15.18 mL of sodium methoxide (approximately 25% by wt. methanol) was added which would yield approximately a 2:1 molar ratio of sodium methoxide to 1,8-bis(dimethylchlorosilyl)octane in order to minimize excess chlorine atoms left following the reaction below:

$$2 {NaCH}_{3} O + {C}_{8} {{H}_{16} ( {Si ( {CH}_{2} )}_{2} Cl )}_{2} ↔ 2 NaCl + {C}_{8} {{H}_{16} ( {Si ( {CH}_{2} )}_{2} {OCH}_{3} )}_{2}$$

Upon adding the sodium methoxide to the solution, the mixture became cloudy and turbid (milky white) and the flask became warm to the touch. The flask was lowered into a dish of deionized water to cool it. After a few minutes the white precipitate began settling to the bottom of the flask. According to the reaction above it is believed that the white precipitate is NaCl, which is insoluble in the THF and methanol. The precipitation of NaCl drives the equilibrium of the reaction towards the right side and prevents the reverse reaction back to the chlorosilane. The flask was left in the fume hood over night. The following morning the contents of the flask were passed through filter paper to remove the NaCl. The supernatant was added back to the flask and attached to a rotovap to remove the excess THF and methanol, leaving approximately 10 mL of yellow-brownish liquid left of the product, 1,8-bis(dimethylmethoxysilyl)octane. The product was analyzed with NMR analysis, which revealed that the chlorosilanes had been completely replaced with methoxysilanes.

In Examples 62-67, 1,8-bis(dimethylmethoxysilyl)octane (NaBISCO) and/or octadecyl trimethoxysilane (OTS) were mixed by volume in the percentages listed to a total silane concentration of 2 vol % in propylene glycol methyl ether acetate and either spray coated or dipped on glass coupons. In Examples 68-71, 100% NaBISCO at a total silane concentration of 2 vol % was prepared in various solvents (THF, cyclohexane, hexadecane, or acetone) and spray or immersion coated on glass coupons. The samples were cured at 150° C. for 30 min. The formulation can be tailored to achieve the desirable levels of fingerprint visibility, durability, and hydrophobicity. Parts were either dipped or sprayed coated in these solutions and evaluated. Coefficient of friction (CoF), is measured by placing the sample on a load cell (SMT1-5.6, Interface, Inc., Scottsdale, AZ). Office paper is affixed to a 20 mm square attachment on a Linear Taber Abrader (Model 5750; Taber Industries, North Tonawanda, NY). A load of 300 g is applied and the attachment is moved a 5 mm stroke for 30 cycles at 15 cycles/min. The load cell records the force applied to the sample during this motion and this is used to calculate the coefficient of friction. Contact angle and surface energy data of the various NaBISCO/OTS mixtures are shown in Table 20. For the applications of interest, the water contact angle is sufficiently high for all the mixtures tested. Therefore, pristine static water contact angle was not a metric considered when deciding the final optimized ratio.

TABLE 20
Materials and Properties of Examples 62-71

| | Alkyl | | | | | | Static Contact Angle (°) | | |
|---|---|---|---|---|---|---|---|---|---|
| | Silanes | | | Surface Energy (mN/m) | | | | Diiodo- | Oleic |
| Example | (vol %) | Method | CoF | Total | Polar | Dispersive | Water | methane | Acid |
| 62 | 100% | Spray | 0.35 | 33.63 | 5.04 | 28.59 | 93.92 | 63.86 | 31.24 |
| | NaBISCO | | | | | | | | |
| | 0% OTS | | | | | | | | |
| 63 | 100% | Dip | 0.24 | 39.96 | 9.88 | 30.09 | 81.42 | 60.8 | 28.76 |
| | NaBISCO | | | | | | | | |
| | 0% OTS | | | | | | | | |
| 64 | 40% | Spray | 0.12 | 30.41 | 3.64 | 26.77 | 98.8 | 67.64 | 40.83 |
| | NaBISCO | | | | | | | | |
| | 60% OTS | | | | | | | | |
| 65 | 40% | Dip | 0.22 | 32.23 | 3.78 | 28.45 | 97.37 | 64.15 | 39.28 |
| | NaBISCO | | | | | | | | |
| | 60% OTS | | | | | | | | |
| 66 | 100% | Spray | 0.41 | 35.05 | 5.11 | 29.94 | 92.96 | 61.1 | 30.69 |
| | NaBISCO | | | | | | | | |
| | 0% OTS | | | | | | | | |
| 67 | 60% | Spray | 0.12 | 32.78 | 2.48 | 30.3 | 99.99 | 60.36 | 27.36 |
| | NaBISCO | | | | | | | | |
| | 40% OTS | | | | | | | | |
| 68 | 100% | Dip | 0.3 | 43.38 | 13.01 | 30.37 | 74.52 | 60.22 | 33.9 |
| | NaBISCO | | | | | | | | |
| | in THF | | | | | | | | |
| 69 | 100% | Dip | 0.3 | 42.91 | 12.3 | 30.61 | 75.87 | 59.73 | 30.9 |
| | NaBISCO | | | | | | | | |
| | in | | | | | | | | |
| | cyclohexane | | | | | | | | |
| 70 | 100% | Dip | 0.21 | 36.13 | 5.5 | 30.6 | 91.58 | 59.69 | 28.33 |
| | NaBISCO | | | | | | | | |
| | in | | | | | | | | |
| | hexadecane | | | | | | | | |
| 71 | 100% | Dip | 0.25 | 32.35 | 4.23 | 28.12 | 96.36 | 64.83 | 35.15 |
| | NaBISCO | | | | | | | | |
| | in acetone | | | | | | | | |

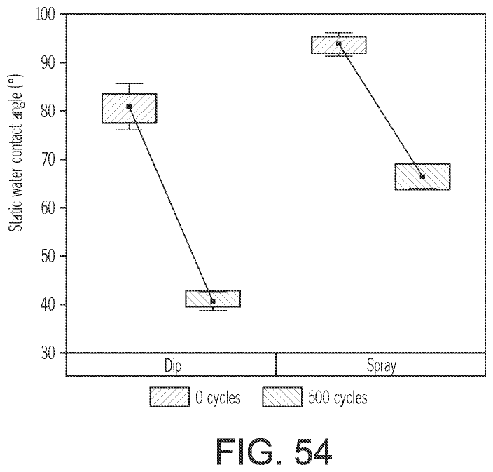

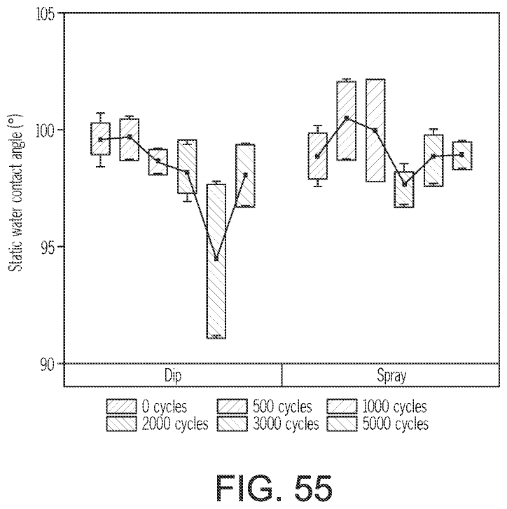

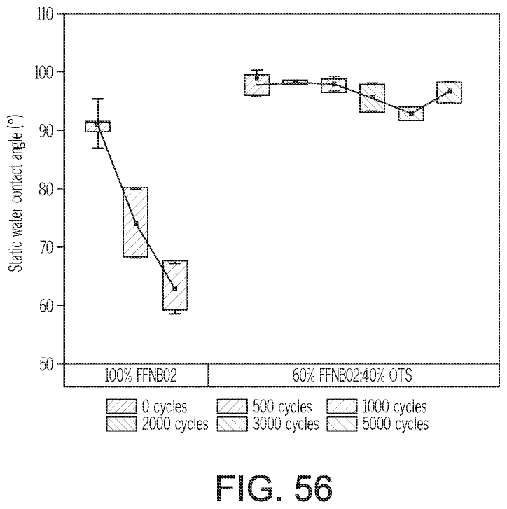

The durability of the coatings formed from the NaBISCO or NaBISCO/OTS mixtures of Examples 62-71 were evaluated by checking a contact angle following a rubber abrasion test. FIG. 54 shows static water contact angle in degrees on the vertical axis (i.e., y-axis) as a function of rubber abrasion test cycles on the horizontal axis (i.e., x-axis) for 100% NaBISCO using the spray method (Example 62) and dip method (Example 63). For both Example 62 and 63, the contact angle dropped below 80 degrees after 500 cycles. FIG. 55 shows static water contact angle in degrees on the vertical axis (i.e., y-axis) as a function of rubber abrasion test cycles on the horizontal axis (i.e., x-axis) for 40% NaBISCO/60% OTS using the spray method (Example 64) and dip method (Example 65). As shown in FIG. 55, the mixtures of NaBISCO and OTS are resilient to rubber abrasion out to at least 5000 cycles. FIG. 56 shows static water contact angle in degrees on the vertical axis (i.e., y-axis) as a function of rubber abrasion test cycles on the horizontal axis (i.e., x-axis) for 100% NaBISCO (Example 66) and 60% NaBISCO/40% OTS (Example 68). As shown in FIG. 56, the 60%/40% mixtures of NaBISCO and OTS are resilient to rubber abrasion out to at least 5000 cycles.

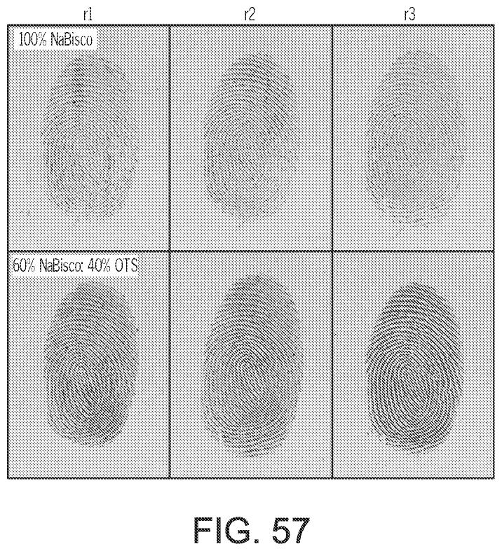

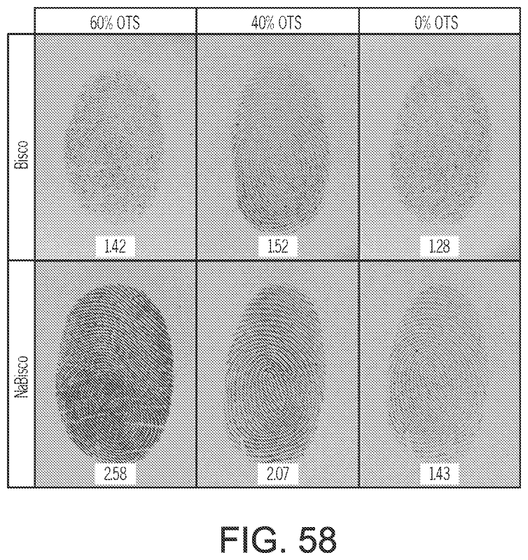

For fingerprint visibility, a human fingerprint was deposited on the glass coupons of Examples 66 and 67 (in triplicate). Prior to the application of the fingerprint the sample was wiped with isopropanol. Pictures were taken before and after the fingerprint was deposited using a Canon Rebel T7 DSLR camera equipped with a Canon EF-S 60 mm Macro Lens and illuminated using a ring light. The camera was operating in manual mode with manual focus. Images were captured in the RAW format and were processed with ImageJ. Gray level values of fingerprints were compared among various surfaces. FIG. 57 schematically illustrates simulated fingerprints applied to Examples 66-67. FIG. 58 schematically illustrates simulated fingerprints applied to various examples that were sprayed that include BISCO in combination with 60% OTS, 40% OTS, or 0% OTS in PGMEA (Examples 50, 56) or NaBISCO in combination with 60% OTS, 40% OTS, or 0% OTS in PGMEA (Examples 64, 67, 62) and includes the gray level value for the samples of FIG. 58.

The above observations can be combined to provide a surface-modifying layer 113 (e.g., fingerprint-hiding coating) or a coated article containing the same that can reduce a visibility and/or color shift associated with disposing a fingerprint thereon. Providing a low polar surface energy and/or a high dispersive surface energy a can enable oils (e.g., fingerprint oil) to be dispersed across the fingerprint-hiding surface (e.g., oleophilic), which can decrease a visibility and/or a color shift associated with fingerprints. For example, providing an alkyl silane can enable a low polar surface energy and high dispersive surface energy of the fingerprint-hiding coating, which can enable the fingerprint-hiding coating to be oleophilic. Providing a high diiodomethane contact angle (e.g., about 600 or more) and/or a low hexadecane contact angle (e.g., 200 or less) can reduce the visibility and/or color shift associated with fingerprints by enabling fingerprint oil to be dispersed across the surface-modifying layer 113 (e.g., fingerprint-hiding coating) rather than beading up into pronounced droplets. Providing a low oleic acid contact angle (e.g., about 400 or less or 350 or less) can reduce the visibility and/or color shift associated with fingerprints by enabling fingerprint oil to be dispersed across the surface-modifying layer 113 (e.g., fingerprint-hiding coating) rather than beading up into pronounced droplets. Providing a high water contact angle (e.g., about 90° or more or about 1000 or more) can enhance the removal of aqueous material (e.g., water droplets, sweat droplets) from the surface-modifying layer 113 (e.g., fingerprint-hiding coating). Consequently, the fingerprint-hiding coating can be hydrophobic and oleophilic.

Providing a surface-modifying layer 113 (e.g., fingerprint-hiding coating) in accordance with the aspects of the disclosure can exhibit good abrasion resistance (e.g., an abraded water contact angle of about 800 or more or 90° or more after 2,000 cycles and/or 3,500 cycles in a Steel Wool Abrasion Test, a cheesecloth-abraded water contact angle of about 800 or more or 90° or more after 200,000 cycles in a Cheesecloth Abrasion Test, or a rubber-abraded water contact angle of about 800 or more or 90° or more after 3,000 cycles in a Rubber Abrasion Test), for example, maintaining a hydrophobic and/or oleophilic character. The surface-modifying layer 113 (e.g., fingerprint-hiding coating) can exhibit good adhesion to the surface that is disposed on, for example, a surface of a substrate or an optical stack. Providing a thickness of the surface-modifying layer 113 (e.g., fingerprint-hiding coating) from about 1 nm to 75 nm (e.g., from about 2 nm to 5 nm) can provide good durability fingerprint-hiding coating while minimizing the amount of material required to achieve the above-mentioned effects.

As discussed herein, the properties of the present disclosure are different from the corresponding properties of Comparative Examples discussed herein in a statistically significant way that demonstrates that the surface-modifying layer 113 (e.g., fingerprint-hiding coating) of the present disclosure does a better job of “hiding” visual effects associated with an applied fingerprint than the Comparative Examples. Providing a fluorine-free fingerprint-hiding coating can be cheaper to produce and/or more environmentally friendly.

The surface-modifying layer 113 (e.g., fingerprint-hiding coating) can comprise a polymer of one or more alkyl silanes. The alkyl silane can be a bis-silane or a tris-silane, which can produce a polymer or copolymer with disiloxane bonds between at least a pair of monomers.

In aspects, the surface-modifying layer 113 (e.g., fingerprint-hiding coating) can be bonded to and/or disposed on a planarization layer 123. The planarization layer can comprise a silica or an at least partial silica-like network. Providing a silica or a partial silica-like network can enable the planarization layer to be stiff (e.g., elastic modulus of about 9 GPa or more) while allowing the surface-modifying layer 113 7(e.g., fingerprint-hiding coating) to remain flexible enough to withstand abrasion.

The substrate can comprise a glass-based, glass-ceramic, and/or ceramic-based material, which can provide good dimensional stability, good impact resistance, and/or good puncture resistance. The glass-based, glass-ceramic, and/or ceramic-based substrate can comprise one or more compressive stress regions, which can further provide increased impact resistance and/or increased puncture resistance.

Directional terms as used herein—for example, up, down, right, left, front, back, top, bottom—are made only with reference to the figures as drawn and are not intended to imply absolute orientation.

It will be appreciated that the various disclosed aspects may involve features, elements, or steps that are described in connection with that aspect. It will also be appreciated that a feature, element, or step, although described in relation to one aspect, may be interchanged or combined with alternate aspects in various non-illustrated combinations or permutations.

It is also to be understood that, as used herein, the terms “the,” “a,” or “an,” mean “at least one,” and should not be limited to “only one” unless explicitly indicated to the contrary. For example, reference to “a component” comprises aspects having two or more such components unless the context clearly indicates otherwise. Likewise, a “plurality” is intended to denote “more than one.”

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. Ranges can be expressed herein as from “about” one particular value, and/or to “about” another particular value. When such a range is expressed, aspects include from the one particular value and/or to the other particular value. Similarly, when values are expressed as approximations, by use of the antecedent “about,” it will be understood that the particular value forms another aspect. Whether or not a numerical value or endpoint of a range in the specification recites “about,” the numerical value or endpoint of a range is intended to include two aspects: one modified by “about,” and one not modified by “about.” It will be further understood that the endpoints of each of the ranges are significant both in relation to the other endpoint and independently of the other endpoint.

The terms “substantial,” “substantially,” and variations thereof, as used herein, are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In aspects, “substantially similar” may denote values within about 10% of each other, for example, within about 5% of each other, or within about 2% of each other.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred.

While various features, elements, or steps of particular aspects may be disclosed using the transitional phrase “comprising,” it is to be understood that alternative aspects, including those that may be described using the transitional phrases “consisting of” or “consisting essentially of,” are implied. Thus, for example, implied alternative aspects to an apparatus that comprises A+B+C include aspects where an apparatus consists of A+B+C and aspects where an apparatus consists essentially of A+B+C. As used herein, the terms “comprising” and “including”, and variations thereof shall be construed as synonymous and open-ended unless otherwise indicated.

The above aspects, and the features of those aspects, are exemplary and can be provided alone or in any combination with any one or more features of other aspects provided herein without departing from the scope of the disclosure.

It will be apparent to those skilled in the art that various modifications and variations can be made to the present disclosure without departing from the spirit and scope of the disclosure. Thus, it is intended that the present disclosure cover the modifications and variations of the aspects herein provided they come within the scope of the appended claims and their equivalents.

1-2. (canceled)

3. A coated article comprising,
a substrate comprising a first major surface; and
a fingerprint-hiding coating disposed over the first major surface, the fingerprint-hiding coating comprising an exterior surface of the coated article, wherein the fingerprint-hiding coating is fluorine-free,
wherein the fingerprint-hiding coating exhibits:
a water contact angle from 90° to 120°;
an oleic acid contact angle of 400 or less; and
a coefficient of friction of the exterior surface is 0.25 or less;
wherein the fingerprint-hiding coating comprises an alkyl silane at the exterior surface;
wherein:
the alkyl silane is bonded to the substrate by a silane group, the alkyl silane is bonded to another part of the fingerprint-hiding coating by a silane group, or both;
the silane group of the alkyl silane is at a free end of the alkyl silane; or
both; and
wherein the fingerprint-hiding coating comprises an oligomer of the alkyl silane, a polymer of the alkyl silane, or both.

4. The coated article of claim 3, wherein the oligomer of the alkyl silane, the polymer of the alkyl silane, or both comprises at least one of:
a dialkyl siloxane block;
a dimethylsiloxane block bonding monomers of the oligomer of the alkyl silane, the polymer of the alkyl silane, or both, together; or
a disiloxane group bonding monomers of the oligomer of the alkyl silane, the polymer of the alkyl silane, or both, together.

5-14. (canceled)

15. A coated article comprising,
a substrate comprising a first major surface; and
a fingerprint-hiding coating disposed over the first major surface, the fingerprint-hiding coating comprising an exterior surface of the coated article, wherein the fingerprint-hiding coating is fluorine-free,
wherein the fingerprint-hiding coating exhibits:
a water contact angle from 90° to 120°;
an oleic acid contact angle of 400 or less; and
a coefficient of friction of the exterior surface is 0.25 or less;
wherein the fingerprint-hiding coating comprises an alkyl silane at the exterior surface;
wherein:
the alkyl silane is bonded to the substrate by a silane group, the alkyl silane is bonded to another part of the fingerprint-hiding coating by a silane group, or both;
the silane group of the alkyl silane is at a free end of the alkyl silane; or
both; and
wherein the fingerprint-hiding coating comprises an oligomer of the alkyl silane, a polymer of the alkyl silane, or both, wherein the oligomer of the alkyl silane, the polymer of the alkyl silane, or both, comprise a structure {OSi(R)₂[CH₂]ₘ[Si(R)₂O]ₙSi(R)₂[CH₂]ₚSi(R)₂}_{q}R, wherein m and p are independently selected from 3 to 34, each R is independently selected from OCH₃, OH, and OSi(R′)₂[CH₂]_{m′}, m′ is independently selected from 3 to 34, n is 1 or more, q is 1 or more, and each R′ is independently selected from a group consisting of OCH₃, and OH.

16. The coated article of claim 15, wherein, in the structure, at least one:
n is 1, and q is from 1 to 100; or
n is 1, m is 8, p is 8, and q is from 1 to 100.

17. The coated article of claim 15, wherein, in the structure, at least one:
n is 1, and q is from 1 to 100; or
n is 1, m is 6, p is 6, and q is from 1 to 100.

18. The coated article of claim 15 wherein, in the structure, at least one of:
n is 2, and q is from 1 to 100;
n is 2, m is 8, p is 8, and q is from 1 to 100;
n is 2, m is 6, p is 6, and q is from 1 to 100;
n is 2 or more, and q is from 1 to 100;
n is 2 or more, m is 8, p is 8, and q is from 1 to 100; or
n is 2 or more, m is 6, p is 6, and q is from 1 to 100.

19. The coated article of claim 15 wherein the fingerprint-hiding coating comprises an oligomer of the alkyl silane, a polymer of the alkyl silane, or both, wherein the oligomer of the alkyl silane, the polymer of the alkyl silane, or both, comprise a condensation product of monomeric units comprising {(OSi(R)₂[CH₂]ₘSi(R)₂}, wherein each R is independently selected from OCH₃ and OH, and m is from 3 to 34.

20. The coated article of claim 18, wherein R is OCH₃, and m is 8.

21. The coated article of claim 18, wherein R is OCH₃, and m is 6.

22. (canceled)

23. The coated article of claim 21, wherein a ratio of the monomeric units comprising {(OSi(R)₂[CH₂]ₘSi(R)₂} to the monomeric units comprising {R″Si(OCH₃)₂}, {R″Si(OCH₃)}, {R″Si}, {R″Si(OCH₃)₂(OH)}, {R″Si(OCH₃)(OH)₂}, {R″Si(OH)₃}, or combinations thereof is from 10:1 to 1:10.

24-190. (canceled)

191. A method of forming a coated article comprising:
evaporating a functionalized polyhedral oligomeric silsesquioxane onto a first major surface of a substrate;
impinging an ion beam at the first major surface of the substrate, the impinging occurs in a chamber comprising a chamber pressure ranging from about 10⁻⁴ Pascal to about 1 Pascal, the ion beam is generated using a discharge current from about 0.25 Amps to about 1 Amp to form a planarization layer; and then
reacting material of the planarization layer with a alkyl silane to form a fingerprint-hiding coating, the alkyl silane comprising 3 or more carbons, wherein the silane comprises at least two reactive groups independently selected from a silane, a non-fluorine halogen, or combinations thereof,
wherein the fingerprint-hiding coating exhibits:
a water contact angle from 90° to 120°;
an oleic acid contact angle of 40° or less; and
a coefficient of friction of the exterior surface is 0.25 or less.

192. The method of claim 191, wherein the functionalized polyhedral oligomeric silsesquioxane is at least partially functionalized by at least one of: an alkene comprising from 2 to 8 carbons, an alkane comprising from 1 to 8 carbons, or combinations thereof.

193. The method of claim 191, wherein the evaporating the functionalized polyhedral oligomeric silsesquioxane and the impinging occur simultaneously.

194-284. (canceled)

285. The coated article of claim 16 wherein the fingerprint-hiding coating comprises an oligomer of the alkyl silane, a polymer of the alkyl silane, or both, wherein the oligomer of the alkyl silane, the polymer of the alkyl silane, or both, comprise a condensation product of monomeric units comprising {(OSi(R)₂[CH₂]ₘSi(R)₂}, wherein each R is independently selected from OCH₃ and OH, and m is from 3 to 34.

286. The coated article of claim 17 wherein the fingerprint-hiding coating comprises an oligomer of the alkyl silane, a polymer of the alkyl silane, or both, wherein the oligomer of the alkyl silane, the polymer of the alkyl silane, or both, comprise a condensation product of monomeric units comprising {(OSi(R)₂[CH₂]ₘSi(R)₂}, wherein each R is independently selected from OCH₃ and OH, and m is from 3 to 34.

287. The method of claim 192, wherein the evaporating the functionalized polyhedral oligomeric silsesquioxane and the impinging occur simultaneously.
